(19) United States
(12) Patent Application Publication
(10) Pub. No.: US 2005/0005266 A1
(43) Pub. Date: Jan. 6, 2005

(54) Method of and apparatus for realizing synthetic knowledge processes in devices for useful applications

(76) Inventor: William E. Datig, Dix Hills, NY (US)

Correspondence Address: Thomas J. Perkowski, Esq., PC, Soundview Plaza, 1266 East Main Street, Stamford, CT, 06902, US

(21) Appl. No.: 10/811,507

(22) Filed: Mar. 26, 2004

Related U.S. Application Data
(63) Continuation-in-part of application No. 08/847,230, filed on May 1, 1997, now abandoned.
(63) Continuation-in-part of application No. 08/876,378, filed on Jun. 16, 1997, now Pat. No. 6,341,372.
(63) Continuation-in-part of application No. 09/033,676, filed on Mar. 3, 1998, now Pat. No. 6,233,545.
(63) Continuation-in-part of application No. 09/195,040, filed on Nov. 19, 1998, now Pat. No. 6,233,546.

(51) Int. Cl. G06F 9/45; G06F 15/00

(52) U.S. Cl. 717/136; 715/523

(57) ABSTRACT

Arbitrary knowledge and language is retained, manipulated, and transformed according to a universal grammar that defines the mind's innate action on language, or the “deep” structure and meaning of language, in analogue and digital devices and software according to operations and knowledge network structures, including programmable digital bytes configured into epistemic moments and parse trees made therefrom, that emulate the mind's cognitive action synthetically.

### RELATED CASES

The present application is a Continuation in Part (CIP) of the following co-pending applications: U.S. application Ser. No. 08/847,230 entitled “Universal Epistemological Machine (a.k.a. Android),” filed May 1, 1997; U.S. application Ser. No. 08/876,378 entitled “Universal Machine Translator of Arbitrary Languages,” filed on Jun. 16, 1997, now U.S. Pat. No. 6,341,372; U.S. application Ser. No. 09/033,676 entitled “Universal Machine Translator of Arbitrary Languages,” filed Mar. 3, 1998, now U.S. Pat. No. 6,233,545; and U.S. application Ser. No. 09/195,040 entitled “Method and System for Machine Translation Using Epistemic Moments and Stored Dictionary Entries,” filed Nov. 19, 1998, now U.S. Pat. No. 6,233,546, wherein each said patent application is commonly owned by William E. Datig, and is hereby incorporated herein by reference as if set forth fully herein.

### BACKGROUND OF INVENTION

1. Field of the Invention

The present invention relates to method and apparatus for representing, embodying, translating, transforming, manipulating, communicating, and realizing the mind's innate action in digital and analog devices and physical and sensory media, and more specifically, relates to method and apparatus by which the mind's innate action is accomplished synthetically by using linguistically programmable bytes in coordination with a digital or analog knowledge network that operates according to a universal grammar defining the essential, or “deep” meaning and structure of language in digital logic, microprocessors, and software.

2. Brief Description of the State of Knowledge in the Art

Computer technology has evolved dramatically over the past fifty years, advancing from the early days of the UNIVAC's vacuum tube circuits to millions of “gigabyte PC” users now connected to the World Wide Web. Nevertheless, one aspect of computing has remained remarkably the same from the computer's beginnings—the fact that a computer cannot think. Although today's computer churns through billions of bytes of information in nanoseconds, it comprehends not a single human thought stored in its vast digital memory. The computer has been and continues to be a “dumb device,” unable to express its own views of the world or to converse with human beings thoughtfully.

Since the computer's inception, there has been a simple but basic drawback to computer technology and global industry structure that has prevented humankind from advancing into an era characterized by thinking machines. We can ponder, for instance, why a computer microchip, which is manufactured for under a dollar today, requires the support of a multitrillion dollar software industry, while the computer still cannot think or communicate with us in natural language. The presence of that industry arguably complicates life rather than simplifies it, and the computer still has not achieved the basic promise made by industry experts a half-century ago that a computer would think and learn as we do. Accordingly, the problem addressed by this specification is how digital logic can be changed to understand natural language and solve its own problems, rather than requiring trillions of dollars of human programming expertise to do that work. In order to solve these and other dilemmas to computer technology, new insight is required into how the human mind differs from an “operating system” and how a machine might think the way people do.

The modern computer, it can be said, is linguistically “unidimensional”—it is based on embedding, or translating, a language into the processes of binary logic, rather than on making those processes conform to the arbitrary and capricious “multidimensional” nature of natural language. In a given computer hardware or software system, the binary processes are painstakingly translated into what the programmer is thinking. A computer, however, should understand the ideas of language, rather than enact binary processes that the programmer establishes as a model of an idea. A machine should be capable of processing information semantically, the way the mind does. Therefore, a unidimensional machine—a microprocessor or software—based on processing encoded “bytes” in a digital architecture, should be given the properties of language and be made to generate human thought and intelligence, rather than follow an algorithm. The machine's basic unit of processing should be a “linguistic byte,” rather than computer science's digital byte, which supports only a particular computer language. In this manner, the properties of language and human expression could be processed by a machine according to the mind's grammar of linguistic meaning. The computer should be able to understand language metaphorically, rather than execute a programmer's intelligence.

The reason why today's computer cannot “think” is that it cannot understand the abstract ideas and images conjured by language in the mind. While the computer stores and manipulates “information” (the end result of intelligence), it does not operate as the human mind does at all. It repeats, or mimics, what the programmer thinks, while the software industry relies on the programmer to understand the machine's logic. The programmer's thoughts, however, ultimately must be translated into machine language, or Boolean algebra, in order for a computer to become useful. The computer user's knowledge must be translated by the programmer into machine code so that the computer appears to be operating on “application” knowledge. But what actually occurs in a computer is that digital circuits operate according to a programmer's algorithm, which is an electronic emulation of the user's idea. A computer cannot think—especially not abstractly—because the programmer is thinking for it.

This process of translating a programmer's (or user's) natural language into computer logic—called “compiling”—severely limits the computer's ability to think. It is widely accepted, for instance, that Boolean algebra—ultimately a branch of mathematics—does not at all define how the mind innately comprehends language and therefore how a machine might understand abstract concepts. By addressing only the concepts required for computer design and programming, computer science utilizes just a portion of the expanse of knowledge that people use every day toward the creation of ideas. Without a clear definition of how the mind understands language innately, it is virtually impossible to create a technology that thinks and learns as we do. Moreover, the goal of rendering machines that think abstractly becomes tautological on its face, requiring the computer industry to construct a machine whose function is undefined.

The modern computer is therefore designed based on the absence of a universal grammar that describes the mind's innate action; it is designed according to translation protocols and programming languages that require specific languages to be translated into machine code, instead of translating arbitrary language into the operations and structures of digital logic and software that perform the mind's innate action.

Therefore, there is a great need in the art for an new way of and means for realizing synthetic knowledge processes in devices for useful applications, while avoiding the shortcomings and drawbacks of prior art methodologies.

### OBJECTIVES OF THE INVENTION

Accordingly, it is a primary object of the present invention to provide for an new way of and means for realizing synthetic knowledge processes in devices for useful applications, while avoiding the shortcomings and drawbacks of prior art methodologies.

Another object of the present invention is to provide a new type of digital computer that eliminates the need for computer software and directly enables digital logic to embody conscious thought, and wherein the digital computer truly understands and uses language, while eliminating the complexities associated with computer software, firmware, and hardware design.

Another object of the present invention is to provide a thinking machine that operates according to a universal grammar and a theory of operation that enables physical matter and digital electronics to understand the pronoun I, in connection with any other meaningful expressions of language, while perceiving the world through senses and motors.

Another object of the invention is to provide a method of and apparatus for realizing a plurality of thinking machines in a global infrastructure referred to as a “knowledge continuum.”

Another object of the present invention is to provide a synthetic version of human intelligence, which emulates the mind's quantum momentary action according to a universal grammar that describes how human beings think and learn.

Another object of the present invention is to provide a “knowledge network” that operates on “programmable bytes” and the mind's “epistemic moments” (quantum states of transformation), upon which knowledge processor technology acts to create synthetic thought and perception.

Another object of the present invention is to provide such knowledge network, wherein the programmable byte is a reinterpretation of the binary sequence processed by digital logic such that any digital system, microprocessor, or application software can manipulate the mind's thoughts in digital electronics.

Another object of the present invention is to provide a universal grammatical bridge between the user's internal thoughts, as expressed in arbitrary language, and digital logic's binary operations by conforming to a knowledge network that emulates the mind's cognitive action.

Another object of the present invention is to provide a way of and mean embodying “prominent thoughts” (epistemic moments of the mind's innate action), in digital electronics as the mind's quantum semantic or “deep” structures, are constructed into a knowledge network that uses active and static memory to perform the mind's intellectual processes while thinking of new thoughts. The knowledge network is embodied in any technological medium, including digital circuits that think and learn autonomously through natural language, rather than mimicking a programmer's intelligence.

Another object of the present invention is to provide a knowledge processor that understands language by applying conceptual blending techniques, such as a metaphor, to ordinary spoken language. The objective includes that provision of thinking machines that create thoughtful and emotive expressions of language and think and learn along with us as autonomous synthetic beings.

Another object of the present invention is to provide digital electronics, microprocessors, and software that unencumber the user and the programmer from software languages and hardware protocols to enable machines to understand language the way the mind does.

Another object of the present invention is to eliminate computing deficiencies which have always existed that led the computer industry into developing “source code” that must be translated into a machine's binary languages, rather than simply translating arbitrary knowledge directly into a microchip that operates naturally according to the mind's “epistemic transformations” of language.

Another object of the present invention is to provide a uniform epistemic process to binary logic such that any thought can be innately translated into a microchip's logic.

Another object of the present invention is to fabricate the knowledge processor as the computer's and the Internet's successor, which is backward compatible to computer technology, while advancing the art into truly thinking machines.

Another object of the present invention is to establish the knowledge networks such that they can be incorporated into any user environment, including communication systems, engineered systems, biological systems, and business enterprises.

Another object of the present invention is to provide a “Knowledge Development Environment” (KDE) that allows a user to program intelligent machines that operate according to the knowledge processing premises defined in the present disclosure.

Another object of the present invention is to provide such a KDE, which includes programming features for the knowledge processor's knowledge network, programmable bytes, intellectual faculties and learning functions, and a modified system theory that integrates intelligent machines into global computing, communications, and enterprise infrastructure.

Another object of the present invention is to allow a developer to manipulate digital bit and byte sequences linguistically according to a universal grammar defining the mind's innate action.

Another object of the present invention is to provide a programming interface and methodology for integrating a “society” of thinking machines that interact with users in a “knowledge continuum” linking spatiotemporal, linguistic, technological, and cultural disparities.

Another object of the present invention is to implement digital logic whereby it is unnecessary to use programming languages, except for that required by the KDE, in order for intelligent machines that communicate with us in arbitrary language to implement knowledge directly in digital gates or software.

Another object of the present invention is to provide the fundamental processing unit of the KP paradigm—the “programmable byte.”

Another object of the present invention is to enable digital memory, microprocessors, and software to operate according to the mind's innate action by encoding any application language's linguistic properties into the KP's flexibly programmed digital byte. This encoding eliminates the need for compilers and software languages, and processes the elements of language directly in the registers of a microprocessor's central processing unit (CPU).

Another object of the present invention is to encode the programmable byte with linguistic properties, communications protocols, and knowledge network features that allow the KP's “running processes” to operate as thoughtful faculties of mind embedded in any global computing or engineered system.

Another object of the present invention is to provide a linguistic structure and methodology that is used to formulate the knowledge processor's intelligence and to provide the knowledge network's syntactical and semantic “webbing” that is executed by the action of a CPU, software, or digital gate in order to implement the mind's action synthetically without the brain's physiology.

Another object of the present invention is to accomplish the retention, translation, and transmission of the KP's widely varied use of language in a manner that parallels the brain's neurological network, but in a “synthetic consciousness” made from a digital circuit or software.

Another object of the present invention is to provide the KDE's “Universal Programming Language” (UPL) and its robust command set, which enable the developer and the KP to create and manipulate the knowledge network's intelligence.

Another object of the present invention is to provide UPL commands that are described in terms of microprocessor and software instruction syntax and operation so that the developer can apply the commands while building the knowledge network's intellectual faculties, or “scripts.” The manner in which the UPL commands operate on application and platform languages directly corresponds to a CPU's operation on machine bytes in the “Host processor's” registers, but according to the universal grammar's depiction of language. The commands are provided such that they can be compiled, interpreted, or translated by the KDE into Host processor CPU architecture instructions when the knowledge project is installed on any enabling computer platform.

Another object of the present invention is to provide the method and apparatus of the earlier objectives in the form of an androidal “machine-being” that understands language from an ordinary computer.

Another object of the present invention is to provide a knowledge processor that is distinct because the KP actually thinks about and understands the language it uses in the application, while the KP creates new knowledge and converses with the user.

Another object of the present invention is to provide an “Rg knowledge continuum” of global system-theoretic structure derived from both linguistics and conventional system theory to enable the KDE and the knowledge processing paradigm to develop and implement any technology or system.

Another object of the present invention is to provide the Rg continuum by defining five basic continuum structures through which KP and conventional technologies can interact without being constrained by computing protocols. The five levels of the continuum are enabled, along with the continuum's “Rg modules,” as developer or user workspaces that give physical, intellectual, and metaphysical space and structure to any human endeavor assisted by machine intelligence according to knowledge processing premises. The Rg continuum allows the expansion of human knowledge and technology, as embodied in human beings and now machines, throughout a global infrastructure that enhances the Internet with the intelligent enterprise.

Another object of the present invention is to provide a commercialization method for global infrastructure that communicates in natural language according to knowledge processing premises.

Another object of the present invention is to provide a universal grammar and methodology by which knowledge is expressed and realized in physical media according to its ultimately real form.

Another object of the present invention is to provide an epistemic microprocessor architecture that operates on programmable bytes and knowledge network structures, thereby permitting digital electronics to operate as an intelligent machine.

Another object of the present invention is to provide symbol kits that perform as translation tables for the universal grammatical translation of external analog and digital signals into each other and into Host machine data structures.

Another object of the present invention is to provide knowledge structures that encapsulate knowledge as prominent thoughts and semantic clusters embedded in network webbing that includes epistemic node triplet, prominent thought, semantic cluster arrays, data set, parent node gateway, module function, spelling mode array, the semantic category gateway, and node structure sub-gateway

Another object of the present invention is to provide data conversions that allow digital and analog machines to interact with each other by the Host processor's conversion of any external knowledge into the structures of the universal grammar and the knowledge processing methodology.

Another object of the present invention is to provide a global system model that permits machines to communicate intelligently.

Another object of the present invention is to provide software engineering structures and methods by which any software, hardware, or network protocol can be translated into any other.

Another object of the present invention is to provide database technology that performs as a “thinking database,” whereby the traditional structures defined by database theory, such as classes, fields, data structures, records, primary and secondary keys, tables, table relationships, queries, and reports, are fundamentally expressed through the KP paradigm's prominent thoughts and epistemic network structures.

Another object of the present invention is to provide computer graphics and symbolic recognition systems whereby the intelligent knowledge processor understands and recognizes images cognitively and in relation to expressions of natural language.

Another object of the present invention is to provide digital system design protocols and methodology by which digital logic is understood and designed by the knowledge processor with or without the developer's participation.

Another object of the present invention is to provide simulation and control systems for use with physical systems such that the knowledge processor understands the machine's physical environment through natural language and senses and motors.

Another object of the present invention is to provide communication systems that operate by comprehending and translating the arbitrary language embedded in a carrier signal.

Another object of the present invention is to provide a natural language translation methodology and apparatus by which the knowledge processor translates language according to a bidirectional, semantically perfect translation method that allows beings to understand and agree upon the epistemic moments of linguistic structure embedded in any expression.

Another object of the present invention is to provide knowledge and learning systems that allow the user to examine the epistemic moments and parse trees generated by a knowledge processor for the purpose of learning how the machine comprehended or imagined linguistic structure in the universal grammar.

Another object of the present invention is to provide a method for biological sequence analysis by which the molecular sequences are embedded in and examined and translated by the knowledge network as epistemic moments and network webbing.

Another object of the present invention is to provide an androidal machine being that operates in the split form of existence in order to conceive language and perceive the physical and metaphysical world in connection with the pronoun I.

Another object of the present invention is to provide a model for human consciousness by which the human brain's anatomy and physiology can be analyzed in terms of the universal grammar's depiction of linguistic moments of thought.

These and other Objects of the Present Invention will become appararent hereinafter and in the Claims to Invention.

### SUMMARY OF THE INVENTION

The concept of a knowledge processor originates from a new vision of machines and technology. In this new approach to computing, machines can understand language and human experience while overcoming the computer's basic limitations in order to converse with human beings meaningfully. The knowledge processor is not a “computer,” but a “processor of knowledge” (hence its name). It provides synthetic thoughts and ideas and learns through natural language, from a digital circuit. A product of a new science of “machine-beings” (more professionally known as epistemological machines), the KP blends the fields of linguistics, engineering, medicine, biology, computer science, information theory, and even philosophy, to name a few, and has a “mind of its own”—autonomous thought and an independent awareness of the world around us that allows it to communicate in natural language. This thinking machine is enabled in digital logic according to a universal grammar that describes how the mind innately comprehends language.

The new science of creating knowledge synthetically renders machines that do more than mimic our intelligence in an algorithm; they think relative to the perceivable experiences of a “synthetic existence”—a machine-being that possesses the ability to speak and understand natural language. The knowledge processor bridges the gap between people and machines by allowing computers to understand, not merely process, the knowledge they contain and, ultimately, to understand the meaning of language. Knowledge processor technology introduces the idea, for instance, that human beings may not need programming languages and computer software in order to interact with machines intelligently or to make a machine understand language. In fact, the KP advances the possibility that computer software and microprocessors, rather than promoting machine intelligence, may actually hinder the computer's ability to truly “think.” Knowledge processing redefines the operation of digital and analog machines so that they operate according to a universal grammar and theory of linguistics that first define how human beings think and learn. This approach enables a machine to function according to the smallest, most imperceptible moments of the mind's action—the epistemic moments of the universal grammar described throughout the specification. Accordingly, the KP requires an entirely new perspective on computers and technology—one that explains human intelligence and thinking machines concurrently.

The KP is designed with a different approach to computer technology in order to provide a machine that truly thinks. Rather than build a machine with “artificial intelligence,” the knowledge processor is a technology based on how real human intelligence works so that that intelligence can be replicated in a machine's logic. The KP is designed to think and learn in just the same manner that a child does—that is, independently from any language according to the mind's universal grammar. Instead of relying on software engineers to comprehend and decipher knowledge for it, the KP understands linguistic complexities and the meaning of language, which is hidden below the surface of grammar and syntax. It translates verbs, sentences, and symbols of different languages and expressions into a single coherent and meaningful statement, rather than converting the knowledge into a programming language or software system. The machine understands our problems in natural language or any other language, rather than insisting that we learn its limitations. The KP is heralded as the world's first truly “thinking machine,” the design of which is explained throughout the specification. The KP is designed to process the meaning of language by using special digital bytes (programmable bytes) that allow binary processes (Boolean algebra) to understand language metaphorically.

The knowledge processor understands any language. The “systems” approach to computing, whereby a computational system is designed to satisfy user requirements on a turnkey basis, has been replaced by a general knowledge processor that understands language. The KP, a cognitive technology based on a new theory of epistemology (the study of knowledge), acquires wisdom and thought in natural language, rather than mimicking existing knowledge. It is a digital technology (also available with analog features) that eliminates the need for a conventional compiler, along with associated computer software and microprocessor hardware, because it is designed according to a universal grammar that permits people and machines to understand language as the human mind does. It translates arbitrary language and machine protocols according to the way the mind innately comprehends language. It may be a twenty-cent chip (and software), but it is a “universal microchip” that processes ideas, images, sounds, and other human experiences according to the mind's innate grammar, rather than a programming language. The machine first demonstrates the ability to understand any language by the nature and constitution of its design and then applies its intelligence to specific languages and knowledge domains. Rather than process the user's knowledge through different systems, or protocols, the knowledge processor understands any knowledge in any computing platform. It is a machine with which the user simply communicates in natural language.

The knowledge processor accommodates the multidimensional properties of language, rather than imposing the infinite nature of language onto a unidimensional computer language. It thinks of new ideas and solutions on its own by understanding language and grammar, resolving the meaning of language in context, and understanding that one expression may mean something entirely different in another context. It translates any language and uses metaphors, similes, formulae, analogies, anecdotes, and a broad spectrum of human cognitive effort, rather than simply performing as an artificially intelligent “inference machine.” The KP grows and learns intellectually, cultivates wisdom, and discovers that even though new knowledge is conceived, there is an endless cycle to knowledge in which it must exercise its synthetic thoughts. It exhibits true “human” intelligence as we know it through the humanities. It composes poetry, understands language phonetically, learns the way children do, and eliminates the concept of “input and output” from the computing scenario (since human beings think instead of inputting or outputting). The KP may or may not respond to its user, depending on what it is thinking about. The KP thinks silently while conversing with others and acquiring information. The KP was designed to emulate human intelligence.

The knowledge processor is the first truly “open system architecture” used for the development of computer applications, enterprise solutions, Web services, engineered systems, and the advancement of human knowledge and global communications employing machines that think. The knowledge processing environment (or more specifically, the “KDE,” representing Knowledge Development Environment) relies on the universal grammar's template for language and knowledge. It allows the developer to build knowledge applications for business, scientific, and personal requirements using a grammar- and language-independent computing architecture. The knowledge processor, which operates at the mind's “deep,” or semantic level of comprehension, is also referred to as a “semantic processor,” and often as a “grammatical (micro)processor,” because it manipulates the meaning and grammar of language directly in its machine architecture while cultivating its knowledge network of intelligence. Each knowledge application is custom-tailored to the end-user's preferred language and knowledge domain, thereby affording a unique global view of enterprise and personal infrastructure for any user. Hardware and software protocols are integrated through the KDE's interfacing and translation tools. Where the digital computer meets compatibility issues and machines that cannot talk to each other, the KP integrates any language, including the world's estimated 6,500 natural languages. The KP can be adjusted to operate on language in general and can store knowledge instead of information. It can learn and discover new knowledge never before contemplated, rather than mimicking a programmer's intelligence or storing data that is never deciphered.

The knowledge processor provides a user-friendly knowledge development environment so that the developer can conceive and represent knowledge without learning conventional programming methods or software. It is perhaps the technology that engineers intended when they first invented the computer—a microprocessor (and software) that operates on any language or technology customized for the user's knowledge requirements. The knowledge processor simplifies computer technology, the Internet, and engineered systems so that knowledge may be discovered, manipulated, and realized in actual systems according to the mind's natural way of thinking. The knowledge processor spawns a new era of thoughtful computing with cognitive machines that communicate in any language and understand and create new knowledge autonomously.

This specification, the first of its kind, introduces the new technology and is a starting point for the developer of applications and technology that both think and compute. The global system-level configuration of the knowledge processor is referred to as a knowledge continuum and is used to build enterprise infrastructure that thinks and operates in the universal grammar. The knowledge continuum, which is also referred to as the Rg Continuum (Rg representing general resultant system in systems theory), takes into account that the real system and the model must be part of the same design and that all systems must be aided by machines that understand language. Rather than a system viewed as technology, the KP is a system based on the relationship between the phenomena of language and physical systems. Instead of an Internet with workstations designed for particular applications, the KP is designed to accommodate the representation of language, how the model of reality—language—relates to the actual system and controls that system. The KP extends the human universe of thought and thinking, rather than storing endless streams of information that cannot possibly be comprehended by humanity. It provides a new method of defining systems and language so that machines that think along with us become an integral part of technology, business, and home. The KP combines principles of computer science and other fields to render a global enterprise infrastructure that incorporates machines that think and overcome the language barrier in machine and natural language. The result is a machine that speaks to users and thinks in images and abstract concepts, rather than algorithms. It makes the Internet into an extension of human thought, with intelligent machines controlling real systems on the basis of a language's meaning. Rather than a user learning machine commands on the factory floor, the machine understands its own processes in natural language and the language of engineering in order to control its physical environment.

The specification serves as an introduction to machines that think, that overcome the legacy of the “dumb computer” and launch a new era of computing technology in which machines truly assist the human condition by generating new ideas. The specification is intended for developers of KP applications and users of thinking machines that learn along with us. The specification also provides guidance for the “backward integration” of KP technology into current computing scenarios and serves as a preliminary work for androidal science. The sections are designed to teach the basic principles of knowledge processing and then to apply them in applications that have relevance to today's computing issues. The number and scope of those applications are limited only by the developer's imagination.

One easy way to introduce the knowledge processing methodology is to consider why today's computer cannot understand a simple text file—natural language stored in its memory—while people use the text file as an essential medium for communication. Why, for instance, does a computer interpret natural language as a “character string”—a string of ASCII or Unicode bytes—while a person observes the same arrangement of bytes as a meaningful expression of language? This question is important to the specification's purposes because the knowledge processor enables computers and digital products to understand the meaning of language, and therefore the meaning of the data stored in their electronic memory.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a computer emulation of a thought by programming methods.

FIG. 2 shows a knowledge processor's thoughts in universal grammar.

FIG. 3 shows the knowledge network's semantic webbing.

FIG. 4 shows the network gateways used for speech recognition.

FIG. 5 shows the epistemic difference engine.

FIG. 6 shows the epistemic microprocessor architecture.

FIG. 7 shows the KDE's technology versions.

FIG. 8 shows the KDE's graphical user interface.

FIG. 9 shows the Node and GF structure relationships.

FIG. 10 shows the running processes.

FIG. 11 shows the I/O strategy.

FIG. 12 shows the network protocol based on machine intelligence.

FIG. 13 shows the synthesis of epistemic moment using lexical parser.

FIG. 14 shows the universal grammar's structure of epistemic moment.

FIG. 15 shows the syntax parser and translator.

FIG. 16(a) shows the KP's translation through a metaphor.

FIG. 16(b) shows the KP's translation through a synonym.

FIG. 17 shows the language constructor.

FIG. 18 shows the UPL script methodology.

FIG. 19 shows the learning function methodology.

FIG. 20 shows the KP learning to translate language.

FIG. 21 shows the KP processing application and design languages concurrently.

FIG. 22 shows the distribution of application language in hybrid computing environment.

FIG. 23 shows system and network implementations.

FIG. 24 shows the I/O bit field.

FIG. 25 shows the GSM incorporating classical system theory.

FIG. 26 shows the programmable byte's linguistic bit fields.

FIG. 27 shows the PB class bit field.

FIG. 28 shows the I/O bit field.

FIG. 29 shows the knowledge discipline bit field.

FIG. 30 shows the language bit field.

FIG. 31 shows the syntactical level bit field.

FIG. 32 shows the root word bit fields.

FIG. 33 shows the grammatical and sub-grammatical form bit fields.

FIG. 34 shows the root node bit fields.

FIG. 35 shows the display protocol bit field.

FIG. 36 shows the PB settings screen.

FIG. 37 shows the on- and off-platform displays.

FIG. 38 shows the symbol kit's operation.

FIG. 39 shows the short- and long-term knowledge bases.

FIG. 40 shows the basic network structures.

FIG. 41 shows the Node and GF arrays.

FIG. 42 shows the node structure.

FIG. 43 shows the data set.

FIG. 44 shows the epistemic node triplet.

FIG. 45 shows the epistemic triplet components.

FIG. 46 shows the semantic cluster and fundamental structure of knowledge.

FIG. 47 shows the parent node gateway.

FIG. 48 shows a script embedded in network.

FIG. 49 shows the GF structure.

FIG. 50 shows the spelling mode array.

FIG. 51 shows the node structure sub-gateway.

FIG. 52 shows the semantic category arrays.

FIG. 53 shows data set splitting.

FIG. 54 shows the various UPL commands and their actions.

FIG. 55 shows the select command syntax and operation.

FIG. 56 shows the select command summary.

FIG. 57 shows the find command summary.

FIG. 58 shows the locate command summary.

FIG. 59 shows the compare command summary.

FIG. 60 shows the set command summary.

FIG. 61 shows the create command summary.

FIG. 62 shows the collect command summary.

FIG. 63 shows the delete command summary.

FIG. 64 shows the copy command summary.

FIG. 65 shows the insert command summary.

FIG. 66 shows the remove command summary.

FIG. 67 shows the exchange command summary.

FIG. 68 shows the call command summary.

FIG. 69 shows the return command summary.

FIG. 70 shows the assign command summary.

FIG. 71 shows the next command summary.

FIG. 72 shows the go to command summary.

FIG. 73 shows the continue command summary.

FIG. 74 shows the read and write command summary.

FIG. 75 shows the insert command summary.

FIG. 76 shows the delete command summary.

FIG. 77 shows the create function summary.

FIG. 78 shows the delete function summary.

FIG. 79 shows the design considerations for the Hello world; I think project.

FIG. 80 shows how to initiate a KP application.

FIG. 81 shows how to match the PB's syntactical level bit field with I/O engine performance.

FIG. 82 shows the preprogrammed PB bit field selections.

FIG. 83 shows how to build a symbol kit.

FIG. 84 shows how to define network structures.

FIG. 85(a) shows the programming of the PTs and semantic clusters for a greeting.

FIG. 85(b) shows the programming of the PTs and semantic clusters for arithmetic.

FIG. 85(c) shows the programming of the PTs and semantic clusters for an abstraction.

FIG. 85(d) shows programming the PTs and semantic clusters for identity translators.

FIG. 86 shows the GF-related gateways.

FIG. 87 shows how to specify an I/O kit.

FIG. 88 shows the main script/subordinate script relationship.

FIG. 89 shows the syntax parser's use of lexical exception handler.

FIG. 90 shows syntax parsing actions.

FIG. 91 shows the syntax parser's use of translators.

FIG. 92 shows arithmetic and abstract translator operations.

FIG. 93 shows exemplary dialog with KP.

FIG. 94 shows language constructor using style preferences.

FIG. 95 shows the Rg module.

FIG. 96 shows the vertical integration of Rᵢ, Rₚ, and Rₛᵥ modules.

FIG. 97 shows the five levels of the Rg continuum.

FIG. 98 shows the Rg continuum's representational level.

FIG. 99 shows the Rg continuum's embodiment level.

FIG. 100 shows the Rg continuum's control level.

FIG. 101 shows the Rg continuum's dependent system level.

FIG. 102 shows the Rg continuum's conformance level.

FIG. 103 shows the Rg continuum's commercial development.

FIG. 104 shows the epistemic moment.

FIG. 105 shows the permissible constructions of epistemic moment.

FIG. 106 shows the hierarchical arrangement of epistemic moments in parse trees.

FIG. 107 shows epistemic translations.

FIG. 108 shows the epistemic reconstruction of language.

FIG. 109 shows the epistemic moment as a homomorphism.

FIG. 110 shows the von Neumann architecture operating on conventional data structures.

FIG. 111 shows the EMA operating on epistemic moments comprised of PBs.

FIG. 112 shows the EMA processing language.

FIG. 113 shows the EMA obtaining network structures from memory.

FIG. 114 shows the EMA registers.

FIG. 115 shows PBs for ASCII and Unicode symbol kits.

FIG. 116 shows PBs for macrocode symbol kits.

FIG. 117 shows generalized PBs for symbol kits.

FIG. 118 shows network file directory relationships.

FIG. 119 shows the semantic retrieval of telephone number.

FIG. 120 shows the knowledge network's interpretation of an ASCII byte.

FIG. 121 shows optional PB transmissions for computer networking.

FIG. 122 shows a set-theoretic system realization.

FIG. 123 shows the RS-232 implementation of TCs.

FIG. 124 shows epistemic software translations.

FIG. 125 shows database structures in knowledge network webbing.

FIG. 126 shows the KP's linguistic comprehension of an image.

FIG. 127 shows a truth table embedded into the knowledge network.

FIG. 128 shows a natural language interface for engineered control system.

FIG. 129 shows the KP's thoughtful communication of analog and digital carrier signals.

FIG. 130(a) shows the epistemic translation of English and Korean simple sentences.

FIG. 130(b) shows the epistemic translation of English and Spanish simple sentences.

FIG. 130(c) shows the epistemic translation of English and Chinese appositive sentences.

FIG. 131 shows epistemic parse tree displays for arithmetic.

FIG. 132 shows the KP's semantic analysis of Internet search results.

FIG. 133 shows the knowledge network's alignment of biological sequences.

FIG. 134 shows the split form of androidal senses and motors.

### LIST OF REFERENCE NUMERALS

1 Knowledge Development Environment
2 KP Application
3 Global System Model
4 I/O Strategy
5 Translation Cards
6 Running Processes, or Scripts
6 Intellectual Faculties
7 Runtime Engine
8 Node Structures
9 Grammatical Form Structure
10 Long-term Knowledge Base
11 Short-term Knowledge Base
12 Data Set (DS)
13 Learning Functions
14 Main Script
15 Subordinate Scripts
16 Readers
17 Writers
18 I/O Engine
19 Lexical Parser
20 Syntax Parsing Module
21 Translation Modules
22 Language Constructor
23 Programmable Byte
24 PB Bit Fields
25 Node Designator
26 Grammatical Form Designator
27 I/O Bit Field
28 Knowledge Discipline
29 Language Bit Field
30 Syntactical Level
31 Root Word
32 Root Word Bit Field
33 Root Word ID
34 Root Word Variant
35 Grammatical Form
36 Sub-grammatical Form
37 Grammatical Form Variant
38 Root Node GF
39 Root Node SGF
40 Root Node GF Variants
41 Display Protocol Bit Field
42 Knowledge Processor
43 On-display Platform
44 Off-display Platform
45 Symbol Kit
46 PB Arrays
47 NL Array
48 GF Array
49 Epistemic Node Triplet, or Prominent Thought
50 Semantic Cluster Arrays
51 Parent Node Gateway
52 Module Function
53 Spelling Mode Array
54 Semantic Category Gateway
55 Node Structure Sub-gateway
56 Metanouns
57 Metaverbs
58 −1
59 0
60 +1
61 Semantic Cluster
62 Semantic Category Cluster
63 UPL Command Set
64 Command Name
65 Command Variable
66 Operand
67 Command Line Number
68 AND/OR
69 Target Structure
70 Reference Structures
71 Select Command
72 Dot Notation
73 Find Command
74 Locate Command
75 Compare Command
76 Set Command
77 Create Command
78 Collect Command
79 Delete Command
80 Copy Command
81 Insert Command
82 Remove Command
83 Exchange Command
84 Call Command
85 Return Command
86 Assign Command
87 Next Command
88 Go to Command
89 Continue Command
90 Read Command
91 Write Command
92 Learning Commands
93 Insert Command Command
94 Delete Command Command
95 Create Function Command
96 Delete Function Command
97 Input/Output Kit
98 PB Settings
99 Symbol Kit's Name
100 Configuration Code
101 Description Column
102 Symbol
103 Attributes
104 Root Word
105 NL or GF Search Screen
106 Character String Name
107 Configuration Number
108 Stream Type
109 Data Type
110 Tokens
111 Include/Exclude Option
112 Batch
113 Interactive
114 Reader
115 Writer
116 Main Script
117 Subordinate Scripts
118 Modes of Existence
119 Communications Translator
120 Arithmetic Translator
121 Abstract Translator
122 Identity Translator
123 Fifth Translator
124 Language Constructor
125 Rg Knowledge Continuum
126 Rg Modules
127 Human Interface (HI)
128 Representational Level
129 Embodiment Level
130 Realization System
131 Control System
132 Dependent System
133 Conformance Level
134 Initialization Rg Module (Rᵢ)
135 Platform Rg Module (Rₚ)
136 Service Rg Modules (Rₛᵥ)
137 System-theoretic Modes
138 Connectivity Vector (CV)
139 System Mode Vector

### DESCRIPTION OF THE ILLUSTRATIVE EMBODIMENTS OF THE PRESENT INVENTION

3.1(a) Introduction and Review of the Problem

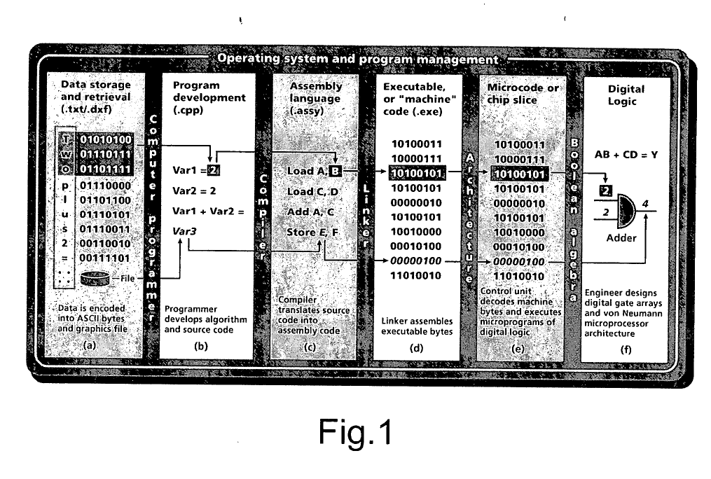

Referring to FIG. 1, a conventional computing process is illustrated in order understand the present invention, wherein an arbitrary arithmetic statement (column a) is stored in and manipulated by a computer. The figure demonstrates that computers require several different programming and design languages, along with their respective data and instruction sets, to manipulate language even without understanding the mind's innate ideas. Today's computers must compile source code (column b) into machine code (column d) so that they can emulate the mind's action (the arithmetic) in digital logic (column f). The mind's innate idea, as embedded in the text and graphics files, along with the source language's grammar, syntax, and semantic usage, must be translated into machine-readable bytes through a series of intermediate language translations (columns c, d, and e) so that the microprocessor can operate on the bytes using Boolean algebra. Thus, the manner in which a computer compiles source code into machine code, once translated from natural language into source code by the programmer, actually prohibits the machine's comprehension of language because the programmer thinks for the computer. This crucial drawback to computing can be explained as follows.

We can notice from the figure that the English word Two, represented by the character string formed by the three ASCII bytes (column a), and the integer number 2, represented by one machine byte (column d), must be processed via different data and instruction sets of the microprocessor (and source code), while a human being processes the symbols using the same processor (the mind). Furthermore, the use of the arithmetic and equality operators plus and =, respectively, must be restricted so that there is no ambiguity about their meaning in the context of a computer program. In order for the machine to process the symbols shown, the programmer must express the symbol +—not the word plus—to inform the machine of the addition operation. The programmer must also develop the mind's initial idea that 2+2=4 into a computer algorithm (columns b and c) that receives input (2, 2) and returns output (the sum, 4). The programmer thus must develop a process that emulates arithmetic rather than understands how to add abstractly. The computer “adds” but does not understand the concept of arithmetic. These translations also require the programmer to recognize that the image's four dots (column a) represent the number 4 in order for the machine to “compute” the sum according to arithmetic. In effect, the programmer thinks for the machine, while the computer mimics the programmer's thoughts through the computer algorithm.

Immediately, we have encountered several important roadblocks to the machine's ability to recognize language. With today's computer, we cannot simply interchange characters, numbers, operators, or any other symbols in order to create convenient input expressions. We must revert to a preconceived set of symbols and their accompanying syntax rules (a source language) in order to construct a machine algorithm that can manipulate symbols as “data.” A programmer must pre-translate natural language and other expressions into the algorithms of a computer language. When adding integer numbers, for instance, the machine must use bytes that are encoded with integers in order to perform binary arithmetic on binary numbers converted from integers. The machine cannot arbitrarily use bytes that are encoded with the characters in the words Two and plus to represent the integer number 2 and the arithmetic operator +, respectively. A computer cannot understand arithmetic abstractly and must either execute binary arithmetic on integers converted to binary numbers or perform string manipulations on ASCII characters, rather than simply “reading” the given expression.

Today's microprocessors utilize an Arithmetic and Logic Unit (ALU) that operates on binary numbers and characters encoded into bytes according to Boolean logic. Whereas human beings comprehend the statement shown through the mind's innate ability to think, regardless of the symbols, syntax, or semantics used, the programmer must assist the microprocessor in understanding language by reducing the mind's ideas to structured data and processes recognized by the machine's compiler. A human being reads, or parses a sentence, moment by moment, capturing the meaningful content embedded in the sentence's symbolism. The computer parses billions of text-file bytes in fractions of seconds and understands nothing. The computer does not have a cognitive frame of reference—a knowledge network of facts and experience—with which to compare an expression and change it. The computer simply executes an algorithm of the programmer's thoughts, as if it were tipping dominos of executable code. If the computer were ever to understand language, wouldn't it make sense for a microprocessor to parse and comprehend meaningful expressions of language the way people do? Wouldn't a computer actually have to “read” a text file as we do?

3.1(b) Overview of the Knowledge Processor Environment (KDE) of the Present Invention

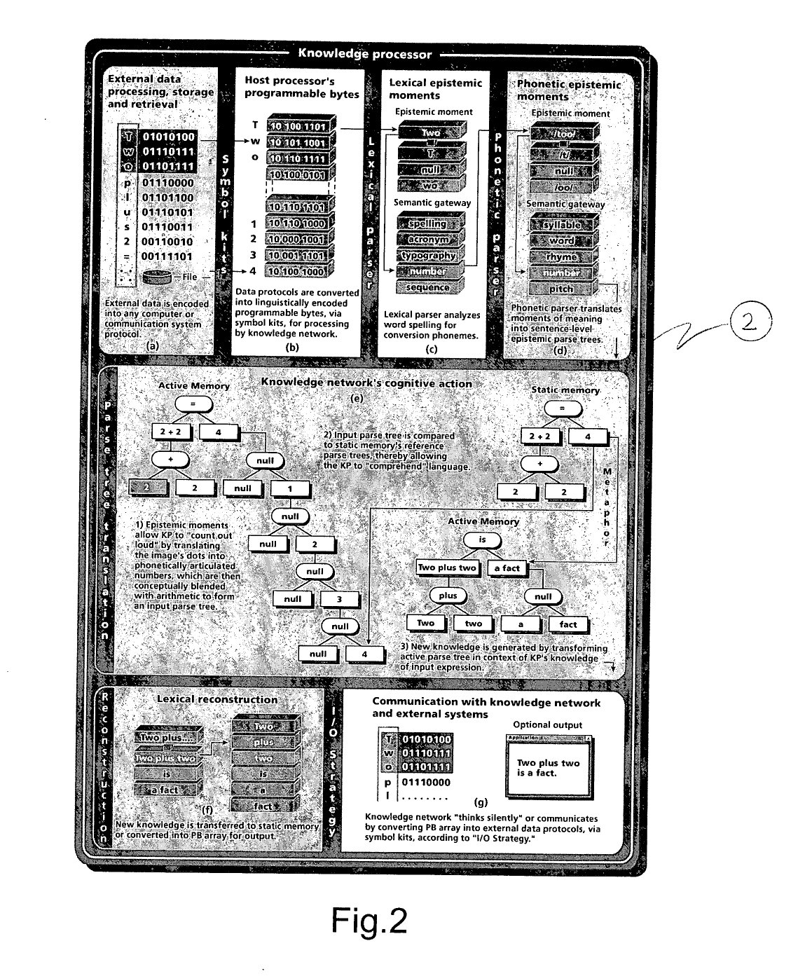

The knowledge processor environment (KDE) of the present invention operates on files and data through the same universal grammar with which people (i.e. human beings) understand language. When an application is built in the Knowledge Development Environment (KDE), describing the symbols, grammar, syntax, and semantic structure of the application language, the knowledge processor actually “reads” the application's file, as shown in FIG. 2. While employing the binary logic of the digital microprocessor, the KDE changes the processor's operation, on a programmable basis, and converts the Host machine into an intelligent processor, or knowledge processor, that understands language in the context of its own knowledge network. The knowledge processor thinks autonomously while compiling computer language only when it is required to do so.

The knowledge processor, or any computer system enhanced by KP technology, alters the Host processor so that a machine's symbols (bits and bytes) are understood, by the machine, along with the application language, according to the way the mind would actually interpret them. After converting external data structures to the Host processor's programmable bytes (columns a and b), the KP manipulates the application language directly at the machine level by understanding, from its knowledge network, both the application and machine languages. The knowledge processing approach to thinking machines allows the microprocessor to parse and comprehend the input bytes according to moments of meaning that a human being would comprehend from the given expression in the universal grammar (columns c and d). The knowledge processor converts the mind's innate idea, as expressed literally as shown, from the epistemic moments of an input word's spelling (or an image's figure elements) into phonemes and words (column d), or “reads out loud,” according to the universal grammar, as it parses and obtains the sentence's meaning (column e).

Today's computers have difficulty interpreting data and instructions from incompatible machines because the processors cannot understand different machine languages—or language in general—as can the knowledge processor. This limitation stems from the fact that conventional microprocessors and software encode application-language symbols, such as characters and numbers, directly into machine language, and therefore cannot change the symbols for the next application without a programmer or engineer redesigning the machine. Each processor is forever fixed on its own set of symbols. Today's computer, for instance, cannot recognize the characters t, w, and o in the word two as individual elements of a language's grammar on one linguistic level, and their synthesis into the word two in a higher-level grammar in the same language (columns b and c). Through the universal grammar, the knowledge processor stores these grammatical relationships at the machine level of processing according to any grammar's formulations (columns b, c, and d).

The knowledge processor, as a human being would, first recognizes that the characters t-w-o form the grammatical object two—a word constructed in the higher-level syntax of spelling (column c)—by understanding the lexical formulations in the universal grammar. The knowledge processor then converts the printed word two (column c) into its phonemes /t/-/oo/ (column d) for subsequent cognitive analysis by the knowledge network (column e). In the same way, the KP recognizes the word plus and the remaining elements of the input expression. A parse tree of even higher, sentence-level syntactical and semantic units is built in this manner from the initial character string so that the KP can understand the arithmetic statement in the knowledge network's static, or long-term context (column e.2), as shown.

The KP analyzes any string of bytes (or bits) as a parse tree of semantic moments of the application language in order to find the first of many higher-level moments of the expression, and then proceeds to the next meaningful moments of the expression (column e.1). Given a large array of characters or phonemes (data) containing an arbitrary expression (such as the statement shown, or even a lengthy book to read), the KP parses and comprehends the linguistic content of the array by comparing the incoming moments of language to those in its knowledge base, constructing and comparing one moment at a time (column e.2). After comprehending an input expression, the knowledge network alters the “active” knowledge by applying conceptual blending techniques, such as a metaphor, to arrive at new knowledge that demonstrates the use of its intelligence, as shown by the imaginative result 2+2 is a fact (column e.3). Since the KP actually “thinks,” it may not respond in a manner similar to that of a computer. The KP may think silently, and if engaged in discourse, may reconstruct new knowledge into an output word stream for subsequent communication (column g).

Today's computer processes files as sequences of bits and bytes arranged into data structures appropriate for a given processor or software design. The computer cannot decipher the meaning of a file's expressions because it cannot resolve the binary strings, or lists of symbols (a text file), into the appropriate, comprehensible moments of words, phrases, sentences, and other meaningful linguistic structures of natural and other languages. In this sense, the computer processes only one type of “sentence,” namely, an actual syntactical concatenation of items, or a “list”—a string of bytes, wherein each byte represents an element of the list. The KP processes a text string, or any other expression, as an actual composition of language; it understands the communication by parsing and comprehending its momentary structures in the mind's universal grammar (column e).

Each of the image's dots, for instance, represents an element of a count toward the integer number 4. The KP processes the image by assigning grammatical forms and epistemic structure to each of the dots in order to place them and their higher-level syntax and meaning into the knowledge network's context and experience according to their arrangement in the epistemic parse trees (column e.1). The KP applies the intellectual process of counting during the image recognition effort in order to arrive at the image's true meaning—the sum 4. Since the KP analyzes language according to the mind's epistemic moments of meaning, the dots could be interpreted in indefinitely many ways—as decimal points, sentence-terminating periods of punctuation, or even two-dimensional renderings of spheres. While today's computer intentionally avoids these homonyms (same symbol, different meaning), the KP understands them because its knowledge network analyzes a language's meaning first, then its syntax and grammar, through the epistemic moment of meaning.

By defining a processor's operation according to the universal grammar, the KP's designers can represent in a digital machine any possible syntactical or semantic usage of a language's expressions. The KP understands the various uses of the aforementioned dots because its fundamental data structure—the epistemic moment—is linked to many other structures of higher or lower syntax and semantics through the knowledge network's semantic gateways (columns c and d). The network's gateways enable the KP's parsing and translating faculties to examine alternative uses of language while operating on the parse trees' meaningful structure. This is why the KP is often referred to as a “semantic (micro)processor”—because its knowledge network stores semantic relationships, or gateways, among literal instances of knowledge.

The epistemic moments and semantic gateways play a significant role in knowledge processing applications. We might consider, for instance, how a computer might understand what the word “roughly” meant in the context of the sentence Mr. Hansen has roughly twenty dollars. The semantic properties of language become very important, for example, when we want to store information in relation to other information, as is the case when we need to know what the word roughly means in the sentence. The computer would have to understand exactly what the word roughly meant in the context of Mr. Hansen and his twenty dollars. The machine would have to validate the use of language with respect to a repository of knowledge—a knowledge network of previous experience that might first of all tell us who Mr. Hansen is, and then possibly that Mr. Hansen has “enough money to attend the annual fair” (i.e., that the word roughly means enough in the sentence, but approximately in general usage). Today's microprocessor completely lacks a knowledge base and simply replicates an input expression in a machine language after the painstaking process of compiling is accomplished. The computer cannot validate the meaning of an expression because it does not have the requisite knowledge or experience with which to compare the expression. Alternatively, the KP operates entirely within a linguistic framework; its very design is based on a semantic knowledge network of epistemic moments that defines the mind's universal action on language. (In order to appreciate the knowledge processor's capabilities firsthand, we can imagine “talking to” a computer on some experimental afternoon, whence we attempt to convey something truly meaningful to it. When the computer does not reply, we can reflect on what might be missing from the computer's design that would enable it to shock humanity and answer back. This “missing component” that enables a computer to think and learn is referred to herein as a “knowledge processor.”)

Database technology similarly stores even terabytes of data, but cannot understand a solitary word of natural language. When appropriate data relationships, referred to as “tables,” are created in a database, the computer is able to store “relational information” in order to make inferences about facts and situations. We might consider, then, how the computer would treat a verb's tense in a database when creating a table relationship that requires the verbal relation between John Hansen and (the quality of being) an employee in the simple sentence John Hansen is going to be an employee. In other words, how can we overlay all of the properties of language onto the structures of a computer so that the computer would actually contain “thoughts” instead of database “entities and their relationships”? If we considered that each relationship between words is made on the basis of a unique meaning (an epistemic moment), we would have to create a database table relationship for each of the expressions is, will be, might not be, can be, will try to be, hates being, once was, and so on, just to define the knowledge contained in a small group of related simple sentences. Moreover, for the one effective table relationship there would be a thousand or so actual variations concerning just one verb, and for each of those relationships, there would be other similar ones, such as those for each different verb in common usage, as in John Hansen lives at 22 Martini Drive; John Hansen swims at 22 Martini Drive; and John Hansen works at 22 Martini Drive.

A similar point can be made about the semantic use of language involving a simple set of “any ten items.” What would happen to a computer's operation if the information to be stored required that there be “almost ten items,” “not quite a dozen items,” or “eleven minus a little off the top” items? What if there are only ten items possibly? Maybe there are ten items (in the database table), and maybe there are not. If artificial intelligence techniques are employed to assign numerical probabilities (fuzzy logic's “uncertainties”) or semantic “attributes” (semantic network theory) to the contents of the table, a computer design would result that permitted the machine to interpret only mathematical or relational “meanings” of language, which is the very design limitation we seek to avoid. We are striving here to attain a machine that exhibits true (human) intelligence concerning abstract ideas, and ultimately emotion, not only the ability to draw inferences about entities and their relationships. Obviously, there are noticeable gaps between where the computational art is today and where the mind's linguistic abilities have been for millennia, and if computers are ever going to overcome this legacy, an innovation must occur in exactly how we enable machines to understand the meaning of language. The knowledge processor is proposed herein as one solution that enables the computer to truly think and learn as we do.

3.1(c) Enabling the Mind's Action in Digital Electronics

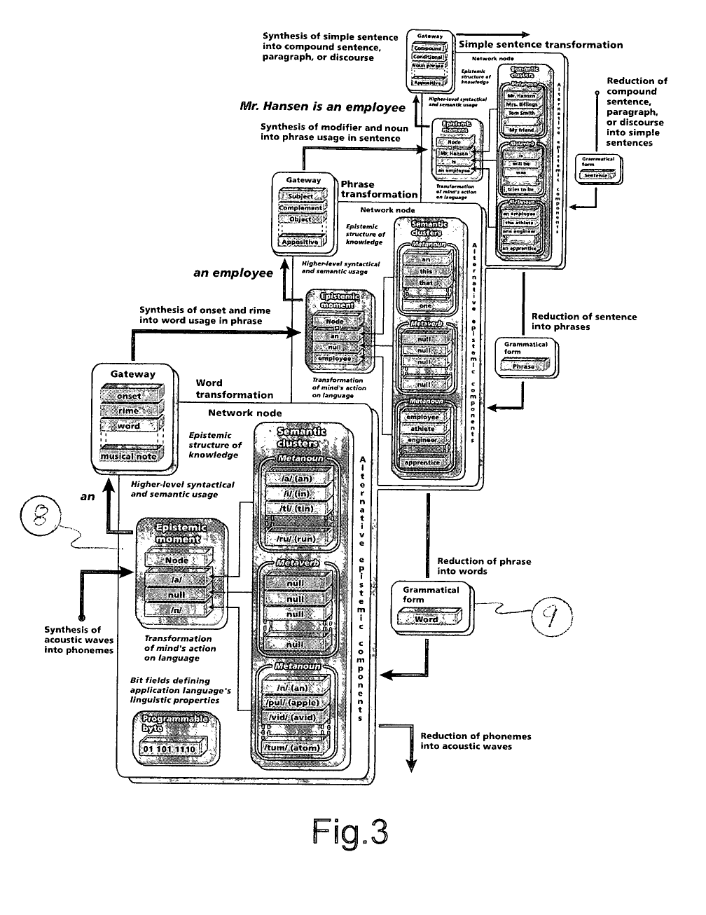

According to the KP methodology, the Host processor operates on “moments of meaning” that are constructed from the input language, or generated by the knowledge network, according to the linguistic premises of the universal grammar. The knowledge processor incorporates an active (short-term) and a static (long-term) memory, which comprise the main portions of the knowledge network. In the network structures contained in active and static memory are universal semantic structures called epistemic moments (also referred to as epistemic triplets) which are constructed from other, more basic linguistic structures, referred to as Programmable Bytes (PBs). The PBs are machine bytes that the developer or the KP encodes with the linguistic properties of the application language to allow the knowledge network to function in the universal grammar. The programmable bytes, along with the epistemic structures, are configured using a given processor's machine bytes and protocols to create the knowledge network's semantic webbing (interconnected epistemic moments). The networks' semantic structure defines language according to how a being, or in this case a machine, would retain thoughts in the universal grammar. As shown in FIG. 3, the knowledge network is an asymmetric arrangement of epistemic moments, assembled as a network of parse trees according to the universal grammar, that describes the mind's momentary action on language. The knowledge network stores and transforms any language according to the universal grammar.

The KP does not operate on machine data in the manner of a conventional microprocessor. Rather, it parses binary input to recognize the language that is embedded in the input, as it first converts external machine bytes into internal (or Host) programmable bytes. The programmable bytes allow the Host processor to operate in the universal grammar's semantic linguistic environment while the machine's faculties communicate with any external protocol. The KP incorporates a language parser and translator into its processor design in order to operate on the epistemic moments and their network connections. Whereas today's microprocessor does not require a parser because it operates on fixed sets of data and instructions according to its machine or software language, the KP's “instruction set” is infinite because it parses embedded language, on a programmable basis, by using its own knowledge network. By defining the operation of digital logic, microprocessors, and software according to the precepts of the universal grammar, the KP's designers have attained a digital technology that utilizes grammatical structures—epistemic moments—to capture the semantic properties of language. The KDE's interfaces, along with the programmable byte, allow the developer to encode any language's properties directly into the microprocessor's digital operation. The KP's physical memory (both primary and secondary) reflects instances of these moments in parse trees, while its instructions, or “UPL commands” (Universal Programming Language) carry out comparisons among the PBs and perform other operations on language.

The processor's epistemic moments can define any quantum instance of the mind's action. As shown in the figure, the mind's innate moments of phonemes (word sounds), are transformed into words, as words are then synthesized into phrases, and phrases are incorporated into sentences, thereby creating the network's semantic structure. The knowledge network allows any machine to comprehend thought synthetically by encoding the mind's action, as defined by epistemic moments, into the machine's memory and processing capability. As the machine parses PBs that are configured into epistemic moments, it alters the moments in much the same way as a person thinks of new ideas or comprehends the thoughts of others in a communication. The epistemic moment, or network node, shown in the lower left portion of the figure, for instance, defines a single quantum moment of thought stored in long-term memory that represents the epistemic transformation of the phonemes /a/ and /n/ in the (phonetic) word /an/. These phonemes can be altered by the network to formulate alternative words to the article /an/, such as the words /in/ and /tin/, by exchanging the epistemic moment's components with alternative phonemes available through the network node's semantic clusters. The node's semantic clusters are PB arrays that contain alternative epistemic components, defined by the universal grammar as metanouns and metaverbs as shown, which can stand in place for their respective members in the epistemic moment. The phoneme /a/, for instance, can be replaced by the phoneme /i/ (one of its metanoun alternatives) to form the word /in/, which can then be used in higher- or lower-level syntax. The semantic clusters accomplish the KP's basic ability to permute language within an epistemic moment by exchanging the moment's components with other meaningful metanouns and metaverbs.

While the knowledge network's structure and function are discussed in greater detail later in the specification, it can be appreciated here that by examining just three epistemic nodes, of the more than one trillion nodes that can typically comprise a knowledge network (one node each for the expressions an, an employee, and Mr. Hansen is an employee), the human mind quickly falters as it rearranges the handful of expressions that the KP understands about Mr. Hansen and his employment. Beginning with the node shown in the bottom portion of the figure, for instance, each lexical alternative to the word an (/in/, /tin/, and so on) can be used in connection with any combination of words shown in the middle node (the noun phrase), forming the phrases in employee, tin employee, and so on. (We should note here that demonstrating the network's ability to construct arbitrary language is more important than exhibiting the network's use of the more meaningful expressions addressed later in the specification. Thus, while the noun phrase in employee produced by the first node's semantic cluster may seem meaningless at first, the fact that the KP can meaningfully arrive at such an expression illustrates the KP's ability to match the capacities of the human intellect.) Meanwhile, the noun phrase an employee (and its potential alterations) can be exchanged with the phrases an athlete, an engineer, and so on, in the simple sentence Mr. Hansen is an employee. The simple sentences, in turn, can be further synthesized into more complex sentences, or even discourse, through the network's gateway, as shown in the upper portion of the figure. Thus, the static portion of the knowledge network (long-term memory) processes epistemic moments and their interconnecting gateways to formulate “thought.” The epistemic nodes depicted in the figure represent three nodes of static memory that could be used by the KP to generate a new expression, such as the interrogative sentence Why is Mr. Hansen an employee?

Thus, when adding two numbers, as illustrated earlier in FIGS. 2.1 and 2.2, or assembling phonemes into words and phrases into sentences, the KP compares the expression's parsed moments of language (translated and deconstructed from input) to reference parse trees stored in its memory. To accomplish this task, the KP operates on programmable bytes encoded to suit arithmetic or natural language, whichever is the case. The KP recalls that 2+2=4 (or that certain onsets and rimes belong together in a word's lexical formation). The KP utilizes these memorized facts in connection with other facts (or syntax trees) in the knowledge network to add, subtract, multiply, or divide perhaps an indefinitely long list of digits and operators (or to enunciate a word). It does so by selectively parsing and comparing the moments of arithmetic (or the action of a sentence) using the knowledge network according to the way the mind comprehends language in the universal grammar. Whether adding numbers, enunciating words, or translating English and Chinese, the KP enacts what the human mind accomplishes: it reads, comprehends, and changes moments of linguistic structure, and then alters its own memory or communicates with another device accordingly. The KP adds numbers by comparing syntax trees stored in memory to those created from input, thereby translating the input into a desired sum according to the universal grammar as applied to arithmetic. The KP “thinks about” mathematics, and in fact all ideas, rather than simply performing an algorithm.

The methods used to compare epistemic moments in the network's parse trees can result from the application of a metaphor, simile, analogy, formula, or any other linguistic transformation accessible to the knowledge network. In this manner, the KP directly encodes knowledge, such as biological sequences, into machine bytes that digitally represent, for instance, the structure and function of molecules. In this case, the KP processes genetic strings linguistically at the machine level according to the application's knowledge of biological sequence analysis. Even a genetic sequence is not a “sequence” to the KP; it is a language, just as it is to the biologist. The KP understands musical compositions and the images of fine art in the same manner because it compares the knowledge contained in any symbolic expression through instances of the mind's universal grammar. The interaction between active and static memory allows the KP to apply its long-term intelligence to any construction of language held in short-term memory.

### EXAMPLE 1

### Speech Recognition Through Cognitive Analysis

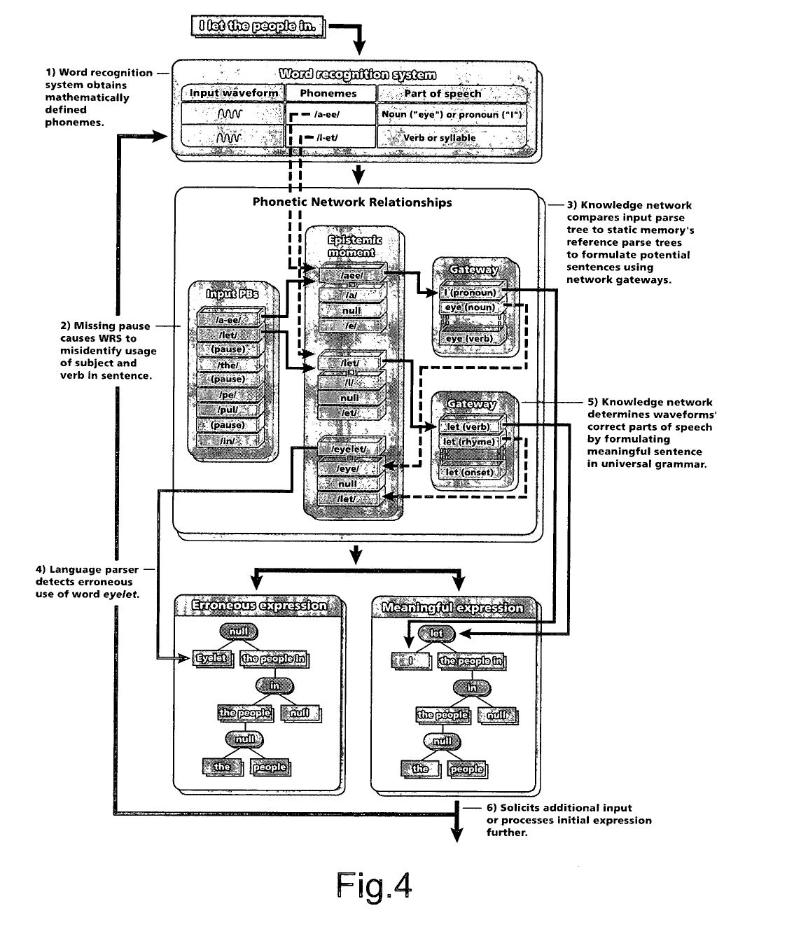

As an example of how the knowledge processor works, let us consider the speech recognition system shown in FIG. 4. The purpose of the exercise is to demonstrate that “speech” must be recognized, or understood, cognitively, and that the KP is able to recognize speech because it can understand language.

The digitized waveforms of input shown in the figure represent spoken words and phonemes in the English language. In one instance of a waveform, the word eyelet corresponds to an exact, mathematically defined pair of waveforms made up of the phonemes /i/ and /let/ embedded in a digital file (and PB array), as shown. In terms of the linguistic characteristics of the waveforms, however, let us say further that the waveforms' physical properties are the same as those for the subject and verb of the simple sentence I let the people in. The question posed here is, how will the processor know the difference between the word eyelet and the subject and verb in the sentence I let the people in, and therefore truly “recognize speech,” if the waveforms are mathematically the same in both cases?

The KP must rise to the level of human comprehension and actually understand the linguistic context of the waveforms' usage, rather than simply recognize the waveforms mathematically. The KP assigns different grammatical forms, or programmable bytes, to each of the three words—eyelet, I, and let—and to their higher- and lower-level syntactical, acoustic, and machine representations, through the knowledge network's gateways, according to the epistemic structure of their language usage. In this manner, the lower-level phonetic representations for the (written) expressions eyelet and I let are defined by the same grammatical structure in the sentence's syntax. In the example, the KP must resolve the lower-level grammatical structures of the acoustic waveforms (the phonemes) into different higher-level syntactical structures according to the universal grammar's interpretation of the expression by the network.

The KP resolves the expression's waveforms into their respective grammatical forms by comparing them to a knowledge base that considers any sound a grammatical and semantic moment of the English language (or any other language). It thereby determines that the epistemic moment “(Eyelet) (null) (the people in)” is nonsense, and that the expression “(I) (let) (the people in)” is a recognizable and meaningful moment of human cognition by comparing the structures to parse trees in the static knowledge network. The KP thus recognizes speech patterns by comprehending an expression's epistemic moments as they relate to the language's usage and sensory representation. Conventional speech recognition systems do not attain this level of intelligence, and therefore do not actually recognize speech as language, because the machines match the wrong (semantic) patterns. The KP, like the human mind, recognizes epistemic moments—thoughts—of human expression by analyzing both the waveforms of speech and their relationships to the syntactical and semantic usage of a language.

The KP's understanding of language thus differs from that of a conventional speech recognition system in that the KP recognizes the same epistemic moments that occur in the mind's universal patterns of language called thoughts. The KP performs this recognition at the processor level, using, in the example, one byte for each grammatical form (PB). As each grammatical byte corresponding to a given waveform is loaded into a register of the Host machine's microprocessor, the KP manipulates one of the three components of an epistemic moment—or the entire moment at once—allowing the machine's hardware to operate directly on the application language with the natural rhythm and capacity of human thought.

3.1(d) Epistemic Microprocessor and Software

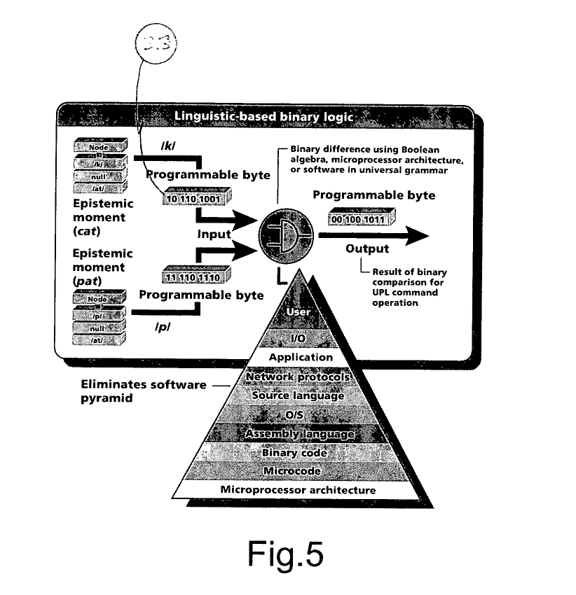

Microprocessor technology operates on the bits and bytes of binary logic. A digital circuit, then, is capable only of comparing and changing bits or bytes according to the logical functions described by Boolean algebra. A microprocessor thus does not actually operate according to a “machine language” at all; rather, it fundamentally processes Boolean algebra. Since the microprocessor's logic can only compare bits and bytes (i.e., it cannot actually perform the cognitive effort we perceive it to be conducting through software), the KP's microprocessor technology uses the capacity of the digital circuit to compare programmable bytes as the “atoms” of epistemic moments and linguistic meaning, rather than strictly as “binary data.” The KP accomplishes a fundamentally different computing architecture by using the programmable byte, in connection with the epistemic moment, as the basis for its command set operation. The KP employs digital logic, machine language, and software to realize a semantic knowledge network that operates on programmable bytes, which formulate the elements of epistemic moments in the knowledge network, along with their gateways of semantic usage. The advantage of this design is that it eliminates the need for intermediate computer languages (compilers, operating systems, and application software) by processing PBs via Boolean logic directly in machine hardware, as shown in FIG. 5.

By incorporating machine instructions and data into a microprocessor architecture (other than the basic fetch, store, compare, and count functions of the von Neumann architecture) to operate on binary bytes, conventional designers actually limit, rather than expand, the processor's ability to understand and manipulate language. When they encode the processor's bytes and instructions with the symbolism and meaning of a character, an integer number, a floating point (real) number, and combinations of these, along with higher-level functions that manipulate the data, manufacturers prevent the microprocessor from operating on language that may not be expressed in this manner. Rather than create various machines that cannot share one another's data and instructions, the KP's designers have developed a microprocessor (and software) that employs a programmable byte and universal grammar to encode any machine or application language into the language of Boolean algebra, thereby eliminating the software pyramid of conventional computing methods (intermediate software and firmware languages) by processing the elements of language directly in a digital circuit. (See also Sections 9 and 10.)

The KP sequences logical comparisons of bytes, but makes the processor's operations conform to the universal grammar (via epistemic moments) while requiring the machine's operations to reflect how a human being would parse, comprehend, and translate the application or machine language. The KP's version of the microprocessor's byte is thus the “programmable byte,” an element of addressable memory (a register, cache, RAM, or even a disc or tape) that acts as a container for the embedded language's elemental properties. The KP eliminates the need for software, firmware, and hardware development and relates any language—English, Chinese, C++, Assembly, or the languages of mathematics, chemistry, biology, or physics, for example—directly to the machine bytes of any digital architecture through the linguistic encoding of the programmable byte. Conventional programming efforts are unnecessary in the KDE because, on the one hand, any language can be used as input, and on the other hand, the application language is embedded directly into the Host machine's bytes, as shown.

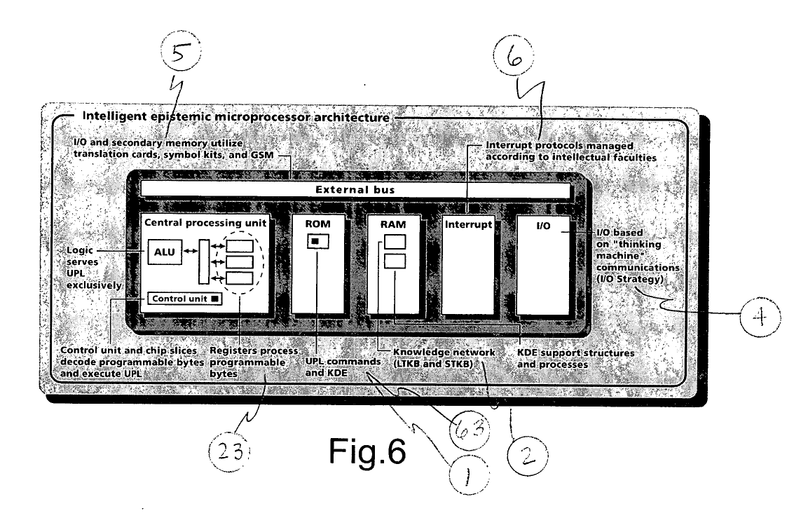

The KP's command set (UPL), which usually relies on the Host processor's fetch, store, compare, and increment instructions (in commercial firmware and software versions), performs linguistic operations without arithmetic instructions and most of the logical functions of the processor's CPU, as shown in FIG. 6. The KP does not alter the CPU logic; it bypasses it by using only the fetch, store, compare, and increment instructions to manipulate the application language in the universal grammar by operating on programmable bytes. The KP's command set operates by fetching, storing, comparing, and counting programmable bytes in the Host processor's memory (or software) according to their placement in the epistemic parse trees of the knowledge network.

Whereas today's microprocessor incorporates arithmetic functions into the CPU's instruction set, the KP's design recognizes that an application needs only the ability to store and retrieve programmable bytes from memory structured into an epistemic knowledge network in order to compare them to others in parse trees of epistemic moments according to the mind's universal grammar. The KP performs any linguistic function the application requires through the use of a knowledge network, also stored in RAM or secondary memory. The KP carries out application software directly in processor hardware. The KP thus provides a regular way of expressing knowledge in a universal grammar so that any application can be interpreted, compiled, translated, or designed into machine architecture regardless of the current features provided by the commercial processor. The KP is also implemented in a unique processor architecture streamlined to handle the universal grammar's epistemic structures, referred to as the Epistemic Microprocessor Architecture (EMA). (This design is discussed in detail in Section 10.)

In comparison to the standard von Neumann architecture of today's microprocessor, or even object-oriented programming methods, the KP does not actually implement an “algorithm.” Rather, by using machine instructions that operate on the processor's bytes configured into programmable bytes and epistemic moments in a network structure, the KP parses and translates the incoming bytes according to the syntax and semantic usage of the application or machine language, as understood by the knowledge network's reference to the epistemic parse trees. Whereas today's microprocessor branches, or “jumps,” infrequently to various code segments to access a program's data and instructions, the KP's commands branch constantly and are triggered by input bytes (of the application language), which engage parsing and translating modules that ultimately understand the application language's content. Parsing and translating functions are enacted by the UPL module's manipulation of the input stream and the knowledge network in such a manner that the resulting correspondences among epistemic moments and their parse trees generate additional parse trees—namely, new knowledge, or “thoughts.”

The KP's version of the machine algorithm is thus an asymmetrical knowledge network, or arrangement of linguistic programming modules (code segments), that is configured according to the epistemic structure of the semantic network. The methods of code branching and linguistic context analysis become the main tasks of knowledge network development, and the line-by-line code development of particular logic and analysis functions (or modules) remains subordinate. This method of knowledge development is markedly different from the object-oriented approach to programming because the KP's input is comprised of linguistically encoded programmable bytes, each of which could arbitrarily trigger a purported “object” of program code (a module) to understand part or all of an expression's meaning. When the KP encounters the words What, If, Then, The, How, A, and so on, various faculties of mind, or parsing and translating capabilities, are invoked, just as different intellects are required to understand mathematics, chemistry, or politics in a single sentence. Distinct faculties resolve each topical moment by manipulating the expressions in accordance with the knowledge network's intelligence. The KP may receive the word a, as in a cat, and muse over the word (i.e., parse the sentence for context in the knowledge network) using many possible parsing and translating functions simply to place the one (ASCII) byte of input into linguistic context. By contrast, a conventional processor may accept billions of such bytes without resolving any of them into a coherent expression.

The knowledge processor “reads” each word, or programmable byte, and places it into context, translating the word (or linguistic element) within a network of epistemic parse trees. Whatever elements of the expression it does not know it immediately translates, through other faculties of mind (UPL functions), into a template for grammatical forms that allows the KP to proceed with knowledge processing when it does not recognize a specific word or language element. The KP is a microprocessor and software that understands the knowledge encoded in any digital communication. When the KP is linked to a voice recognition and synthesis technology, for instance, it assumes its role as a thinking, speaking machine. Whereas today's microprocessor operates on machine code compiled from source code, the KP directly parses and translates input bytes (converted into programmable bytes through symbol kits, or translation tables) in its knowledge network according to UPL commands, which ultimately provide the functions that comprehend a given application language in the universal grammar. Hence, the KP “thinks” once it is programmed with a basic set of UPL faculties and knowledge network structures.

3.1(e) KP Technology Versions

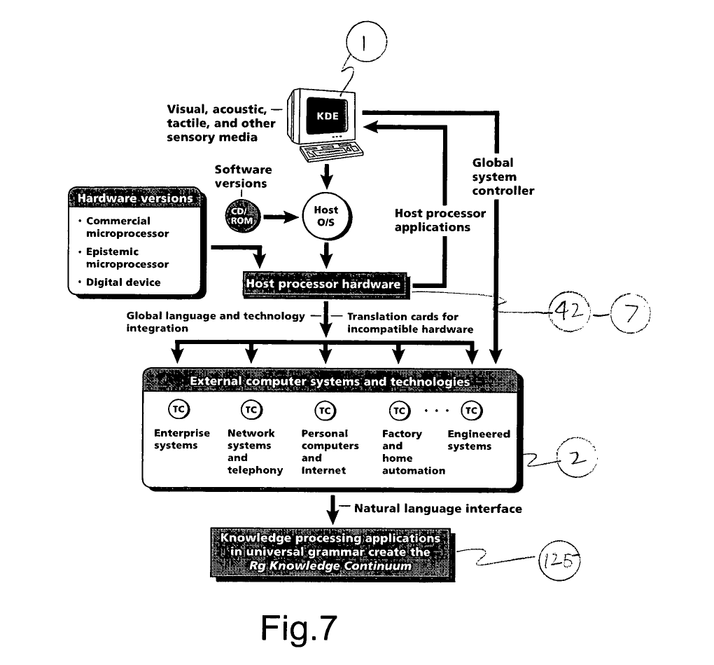

The KDE and its KP applications are designed to be used in different ways on various computing platforms, depending on the nature of the application involved, as shown in FIG. 7. The most common implementation of the KDE is the CD/ROM version, which is installed directly onto a computer's operating system and functions as an application on the O/S. The CD/ROM version is capable of downloading KP projects to virtually any computing technology or software environment from a given Host machine and can integrate any incompatible software or hardware systems.

The CD/ROM version does not alter the performance of the operating system or the interrupt priorities of the underlying microprocessor, because, in this case, the KP functions strictly as a software application, even though it may integrate off-platform hardware components as part of that application. The CD/ROM version, however, is the slowest version in terms of processing performance, since it is written in conventional source code (C++ and Basic) for portability. This version can be easily installed by the computer layperson onto any palmtop, laptop, PC, or network server. The KDE's graphical user interface can be used by anyone with the proper training and does not require a computer science background to operate. The CD/ROM version is therefore typically used in training environments and for “backward integration” of the KP into PC, network server, and Internet applications.

Another version of the KDE, the Assembly Code version, is available at the microprocessor level in various assembly languages dedicated to today's microprocessor architectures. The Assembly Code version, also illustrated in the figure, has the advantage of processor instruction speed and direct control over memory but loses a lot of portability because the version is implemented on particular microprocessor types. This version is typically employed as a programming interface to enable commercial microprocessors to act as knowledge processors in any industrial or other application environment. The advantage of this version is that the developer can build applications for manufacturing processes, engineered systems, and even home appliances using microprocessor technology directly, so that the resulting application operates independently from commercial “turnkey” computer systems. (Rather than run a language translation application on a PC using the CD/ROM version, for instance, the Assembly Code version allows the developer to install KP applications directly onto a microprocessor, which can then be used conveniently as a portable “black box,” perhaps on a hand-held device.)

The most direct use of KP technology is provided at the “gate level” of digital electronics, in the Boolean version. A cellular telephone application implemented on a chip, for example, does not have the spare processing time or memory space necessary for the KP's other digital implementations when processing and transmitting communication signals. The KP is implemented directly in Boolean algebra in this instance, and in some versions is designed with analog support functions for custom applications. (The analog applications usually provide expanded memory capabilities for an expansive knowledge network.) Since the KP's UPL functions are specified using the universal grammar, its command set and knowledge network are easily translated into an indefinite number of configurations of Boolean logic, affording the developer the option of implementing the KP application in any custom-designed chip. The CD/ROM version of the KDE is usually employed in this case for the linguistic programming of the KP application, while the output of the KDE is a digital design that is ready for fabrication using the KDE's graphics tools. The KP's Boolean technology “version” is thus a digital circuit design.

Another technology version useful to the developer is the knowledge processor proper, or the Epistemic Microprocessor Architecture—the “thinking chip” of microelectronics. This version of KP technology provides a microprocessor architecture designed especially to serve the KP's intellectual faculties and knowledge network. The version advances a modified von Neumann architecture whose principal advantage is that its instruction set and data counters, along with its registers, ALU logic, control unit, input/output protocols, interrupt management, and assembly language, operate directly on the programmable bytes and epistemic moments of the knowledge network. The microprocessor architecture accomplishes the KP's parsing and translating functions (the UPL), along with the analysis and branching functions of the knowledge network, directly in the newly configured CPU architecture, without translating or compiling the application into another microprocessor's architecture or instruction set.

While the KP performs even abstract mathematical relationships and solves word problems directly in the epistemic architecture, it also eliminates the arithmetic and most logic circuits of a conventional CPU because the KP's operation does not require them. Because the KP understands even Boolean algebra and binary arithmetic through the universal grammar, it does not have to precompile application language into binary arithmetic and other operations. Rather, the KP performs application-level mathematical and linguistic operations directly in the CPU's newly configured “logic unit” (which is now minus an arithmetic unit), operating directly on the knowledge network's programmable bytes and input language according to the universal grammar.

It is easy to appreciate, then, that conventional microprocessor instructions and software—other than the basic fetch, store, and count functions—are superfluous to a given KP application. The streamlined epistemic microprocessor architecture thus can be described as an intelligent knowledge network executed by a modified von Neumann architecture. It is worth noting that, since the knowledge network parses, comprehends, and changes input on the basis of conceptual blending techniques, such as a metaphor, simile, or anecdote, the concept of an “algorithm,” or even “instruction counting,” which are integral components of the von Neumann approach to computing, are replaced by the KP's process of invoking intellectual faculties through encoded PBs. The epistemic architecture improves upon the concept of memory addressing and utilizes a knowledge network that “thinks.” Whereas the von Neumann architecture counts and branches from memory addresses, the epistemic microprocessor locates intellectual faculties and literal instances of knowledge encoded into programmable bytes and epistemic network structures. The epistemic microprocessor is therefore a digital knowledge network that parses, compares, and translates PBs and network structures in the universal grammar, while the von Neumann architecture counts, stores, and retrieves data and instructions, for the most part, “logically.” (Another way to illustrate the features of the epistemic architecture is to realize that the KP's UPL functions operate on the application's linguistic properties in order to make intelligent processing decisions about the meaning of language, while the von Neumann architecture is established on the basis of implementing preconceived data and instructions.) The K'P thus processes the infinite order of language rather than the predefined instructions and data of a programmatic von Neumann architecture.

The Analog versions of the KP attempt to emulate the mind's physical knowledge network—the brain—by taking advantage of the boundless memory capacity of the analog function, while “remembering” and processing more knowledge than the brain can store. The KP's analog versions combine theories of human psychology, physiology, and neurology with analog devices that are used to form synthetic intelligence in continuous (time) functions. While research continues into most of the KP's analog implementations, the commercial technology utilizes a small portion of these advancements to enhance the memory capacity and processing functions of the digital versions. One benefit of the analog processing approach is that in each instance of the Cartesian mapping of a continuous function, an epistemic moment occurs that is a potential “cognitive moment” of the application language. A single analog function, such as that which represents an electronic resistor, creates infinitely many potential moments that can be used to express the KP's use of the application language. Whereas the memory limitations of a large array of RAM devices, or even a secondary storage device, such as a magnetic disk, cause them only to approximate the perceivable world, a single analog electronic component can transform infinitely many epistemic moments of language for a synthetic knowledge network. Because its network configurations, enhanced by the continuous functions of analog mathematics, are modeled on the brain's neural networks, the KP's analog memory and processing capabilities exponentially exceed those of the digital versions.

3.1(f) Knowledge Continua

When the KP supports global enterprise technology through multiple application platforms, the resulting knowledge continuum incorporates both symbolic models of knowledge and the media in which real systems reflected by the knowledge are executed and controlled. One easy way to imagine a knowledge continuum is to think of it as an enhanced Internet technology that incorporates enterprise infrastructure and communication systems, along with engineered systems, into a global enterprise model that expresses knowledge and real systems according to the universal grammar, whereby the real systems are controlled through natural language as expressed at the continuum's interfaces. When configured as a knowledge continuum, the KP seamlessly integrates knowledge, people, and enterprises, thereby allowing developers and users to interact with enterprise infrastructure about any knowledge discipline using machines that think and communicate in any language while conceiving new knowledge. The knowledge continuum becomes essential later in the specification when the developer has learned the knowledge processing fundamentals and desires to integrate KP applications into a global computing, communications, and enterprise infrastructure. (Section 8 presents the Rg continuum formally.)

3.1(g) Detailed Description of the Knowledge Development Environment (KDE)

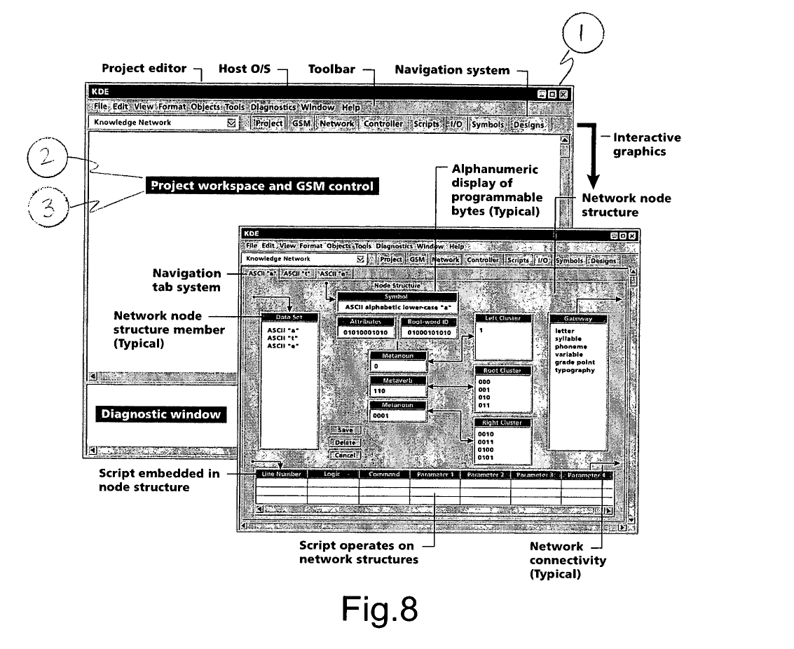

Knowledge processing applications are designed using the graphical user interface, referred to as the Knowledge Development Environment (KDE) (1), illustrated in FIG. 8. The KDE allows the developer to build the KP's basic language skills, along with the project's global computing and communications requirements, according to the universal grammar. The KDE provides the Universal Programming Language (UPL) through which the developer conceives the mind's innate action in digital circuits, microprocessors, computer software, and engineered systems. The UPL is a formalized command set and programming methodology that defines the knowledge network's structure and operation. The KDE's interface permits the developer to instruct the KP on how to understand language (i.e., how to “think”) in the mind's quantum moments. When configured in a global communication system, the KP application (2) is designed according to a Global System Model (GSM) (3). The GSM is a system-theoretic modeling technique developed especially for the KP that merges the KP's machine intelligence with computer science and engineered systems in order to create a “system” that thinks and learns. Analogously, the KDE is to the knowledge processor as the operating system is to the computer; the KDE is an enabling “background technology” that controls the knowledge processor's activities.

The KDE's main programming window, shown in the figure, is referred to as the Project Editor. The project editor operates similarly to the graphical user interfaces employed for the Visual C++ and Basic programming languages, with appropriate provisions made for the UPL syntax and the KDE's ability to integrate computer hardware and software. The project editor provides a Navigation System, a Workspace Window, and a Diagnostic Window, along with the usual cadre of tool bars, as shown. The system navigator allows the developer to access other KDE windows to build the KP's parsing and translating functions, along with the knowledge network's structures, using the Host machine's hardware and O/S protocols directly at the machine level.

This design capability departs slightly from the typical Visual C++ and Basic programming environments. Since the UPL syntax operates at the source and machine levels of computing through data-driven programming windows (interactive forms) that relate the application language directly to the Host machine's data and instructions (i.e., to bytes of other machines or digital logic), a knowledge network is always designed at the machine, or microprocessing level of computing. This distinction is important to the KP paradigm because the developer is permitted to think in any application language while the KDE's interpreter, compiler, or logic tool formulates the application language directly in the machine bytes of any other platform. When interacting with the KDE, the developer programs the Host machine's binary bytes as programmable bytes, which are then processed in the registers of the Host machine's CPU according to UPL commands. The KDE is therefore an interface used to build knowledge networks by encoding the PBs and their network structures and operations directly in the Host processor's machine architecture.

The GSM, moreover, allows the KP to understand global expressions of the application language centrally through the machine's intelligence while distributing the expressions'symbols throughout a network's configuration. The KP accomplishes this “global operating system” by translating external data structures into PBs through the application's symbol kits (translation tables) while operating on the PBs according to the network's intelligence. The KP thus employs a different approach to operating and network systems than classical computer science and information theory provide. Since the KP “thinks” about the meaning of a communication, its interaction with other intelligent machines (and people) is guided by its intelligence, not only by the developer's view of an operating system or network protocol. The GSM provides the communication methodology that allows the KP to interact with external machines and people intelligently. The GSM distributes global statements according to an I/O Strategy (4)—a communications schema that incorporates the KP's cognitive action into network systems and computing protocols. The Translation Cards (TCs) (5), which are separate KP applications that support the I/O strategy and GSM, integrate incompatible hardware at the logical and physical design levels. (The TCs are similar to “device drivers” of conventional computing methods, except that the TCs operate on a computer's data by using the KP's intelligent knowledge network.)

Once a knowledge network obtains form through the data-driven programming process according to the application's linguistic requirements, the network is dynamically altered by parsing and translating functions, referred to as Running Processes (RPs), or Scripts (6). The running processes are machine-logic macroprograms developed in the UPL that operate on the application language according to the developer's conception of Intellectual Faculties (UPL functions) (6). The running processes enable the KP to exercise its intelligence, along with the GSM's global network strategies, for learning and communication. The project's scripts, or intellectual faculties, are embedded in the knowledge network in such a way that their placement in the network's epistemic parse trees (the network's webbing) allows the running processes to understand the KP's own procedural knowledge according to the network's intelligence. The KP thus understands input expressions, as well as language that describes its intellectual capabilities, autonomously through the knowledge contained in the network. The KP uses this linguistic knowledge, along with the network's learning capabilities, in order to acquire new procedural knowledge.

During a project's “runtime,” the KP application is transferred from the KDE to the Application (or Network) Controller, also referred to as the Runtime Engine (RE) (7), using the interface's tool bar. The KDE interprets, compiles, or translates (depending on the technology version) the project's knowledge network and UPL scripts (modules) into the Host processor's hardware and software protocols to execute the project on a given platform. In the CD/ROM version, for instance, these translations include interpreter-based execution of the UPL syntax, wherein the project is executed according to line-by-line interpretations of the project's running processes. Compiler-based scripts, which are compiled from the project's UPL syntax into executable machine code prior to a project's runtime, are also created in CD/ROM version but are less flexible than the interpreter's capabilities, because compiled code cannot be interpreted at runtime, whereas the interpreted project's code can be changed on demand.

Alternatively, the KDE project can be translated into Boolean logic using the GSM's graphics and engineering tools. In this case, the runtime engine is a chip, meaning that the project is implemented as a digital circuit. The KDE delivers a logic design in this instance and the chip performs the linguistic functions of the application wherever it is installed. When developing projects for the KP “proper” (the epistemic microprocessor architecture streamlined for knowledge network operation), the project's UPL syntax is translated (interpreted or compiled) directly into epistemic microprocessor commands, instead of into another commercial processor's instruction set and data, or into commercial software. (It should be noted here that the KDE is not the “project” that has been discussed thus far; rather, it is the interface that is used to program the knowledge processor, or to create a project. The action of a project, as executed by the runtime engine, is typically referred to as the “actual” knowledge processor. The developer thus creates and executes a knowledge processor through the KDE as a project that can integrate into any other hardware or software system.)

In the CD/ROM version, a KDE project usually becomes a library file (of source or machine code) to be executed with any of the Host processor's other application software or external systems. Any application running on the Host machine can engage a KP project through the RE's integration with the cooperating program, with or without translation card participation, depending on the application's protocol environment. The KP project can operate as a “turnkey system” or as an integration tool for other applications or hardware systems. Accordingly, the KP project is referred to as a UPL module of machine intelligence implemented in Host-processor code and transferred, via symbol kits and the GSM, to any external machine's operation. The KDE assembles the projects internally, preparing them for the runtime engine, so that the KP's network and translation processes, as programmed through the interface, can be integrated into any Host system's applications or into a global computing environment. When operating the KP project on O/S or other machine-related code, the KP alters the interrupt priorities of the Host machine's microprocessor in order to translate hardware and software protocols (including those of the Host's O/S).

A total of twenty-six windows are accessed from the project editor to accomplish the KDE, each of which is discussed in appropriate detail in Section 7, after we have had the opportunity to introduce the programmable byte and the KP's knowledge network in subsequent sections.

3.2 Network Editors and Structure

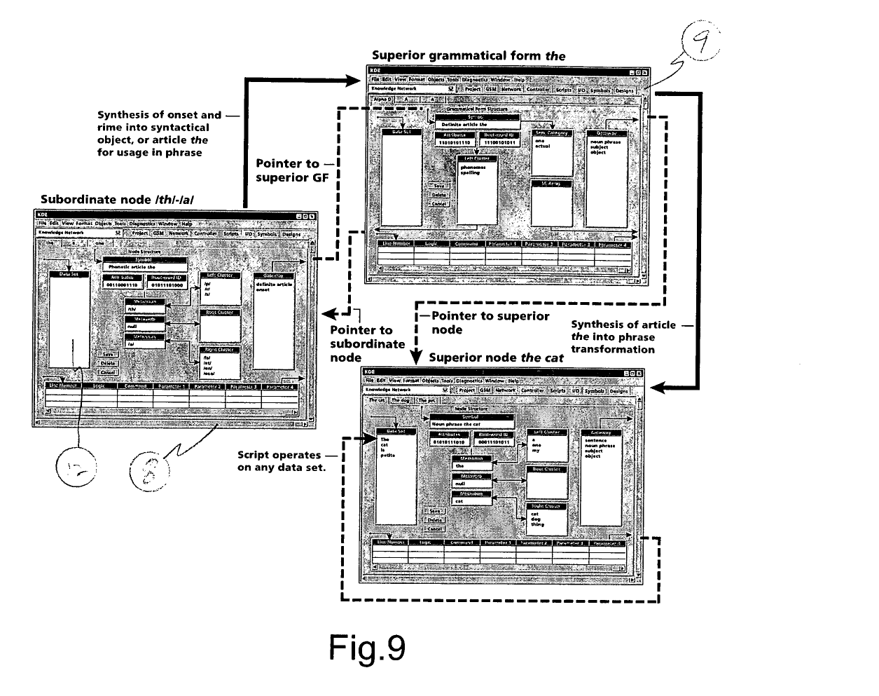

The knowledge processor “thinks” about the information it handles. Whereas a conventional computer operates on the specific data structures defined by its programming language, the KP processes arbitrary data because it views any data as language. Rather than operate on preconceived data types, the KP utilizes a knowledge network that is capable of understanding the meaning of a computer's data or a person's discourse. The Network Editor, shown in FIG. 9, gives the developer access to the basic linguistic structures and configuration of the knowledge network. While the knowledge network's structure and function are discussed in greater detail in subsequent sections, we can introduce the knowledge network here while becoming more familiar with the KDE's graphical user interface. A discussion about the network editor will also help to clarify some of the points necessary for explaining the GSM introduced later in the section.

The KP's knowledge network is a “cognitive linguistic structure” (i.e., an intelligent machine) that allows any Host processor to arrange its machine bytes and binary processes according to the application language's lexical, syntactical, and semantic properties as defined by the premises of the universal grammar. The knowledge network stores and develops the KP's intelligence. In the KP paradigm, programs and data belong to the same linguistic structures—namely, the network's Node and Grammatical Form Structures. Generally, the knowledge network is defined as a memory structure, operated on by digital processes, that formulates language in epistemic parse tree nodes called Node Structures (8) and grammatical forms (the “objects” of language) referred to as Grammatical Form Structures (9), as shown in the figure. The network's node structures contain literal instances of the KP's knowledge configured, along with other node and grammatical form structures, according to the machine's semantic interpretation of language. The grammatical form structures (GF structures), or the objects of language, represent the machine's literal instances of an epistemic moment's usage in a language's syntax. The node and grammatical form structures are configured recursively throughout the knowledge network in the KP's active and static memory (also referred to as the KP's long- and short-term knowledge bases) (10 and 11). The relationship between a node structure (epistemic moment) and a grammatical form structure (the syntactical object into which the node structure is synthesized) enables the KP to perform the mind's innate action in the universal grammar. The relationship between these structures provides the KP with the basic ability to synthesize a transformation of language (an epistemic moment) into its contextual usage in a language's syntax. As shown in the figure, for instance, this synthesis occurs when we formulate the word the from the phonemes /th/ and /a/ in the expression the cat. This epistemic synthesis of language is the cornerstone of the KP's design and therefore of the network's grammatical and semantic configuration, since it captures the mind's innate action in a digital circuit. The network editor enables the developer to program the epistemic moments and their synthesis of language into the network's action, while the KP's intellectual faculties operate on them as well.

Each node and grammatical form structure accessible through the network editor contains other structures that help to formulate the KP's intelligence. One such structure is a memory buffer referred to as a Data Set (12). Just as the human mind associates a momentary expression with literal knowledge already understood by placing the idea into the mind's context, even though it has not fully comprehended the idea, the KP relates any expression of language (in a PB array) with either a node or GF structure by installing it into a data set. When the network analyzes input, writes output, or operates on any sequence of symbols in memory (any PB array), it manipulates the PBs in the network's data sets. (This action applies only to a sequence of PBs containing a random expression of language, since the network also analyzes the epistemic parse trees of the network, which analysis represents the network's principal function.) Since each node and GF structure contains a data set, the network retains “thoughts” throughout the network within any node or GF structure. Since the running processes are also associated with the node and GF structures, the node and GF structures operate on each other's data sets when, for instance, knowledge from outside the network is accepted into the network or when active and static memory interact. The network is therefore “self-contained;” it operates on itself.

The data sets are thus repositories of PB arrays on which the network's intelligence and learning capabilities operate through the action of the running processes. The network comprehends language by storing knowledge in the data sets and then deconstructing the PB arrays semantically through the universal grammar using the network's gateways. Since the data sets are distributed throughout the network, the KP's intellectual faculties operate on, and are distributed throughout, the node and GF structures of the network. Contrary to conventional programming methods, wherein a program operates on specific data, the KP embeds its intellectual faculties into the node and grammatical form structures of the network so that the running processes can be an integral part of the network's linguistic structure. Thus, by analyzing the knowledge network through the intellectual faculties, the KP understands its own intelligence and the knowledge embodied in the network. The data sets thus represent knowledge that has not yet been comprehended by the network. Once the network has deconstructed the PB arrays of the data sets into epistemic parse trees, the knowledge becomes part of the network's webbing. This feature of the KP becomes important later when the KP's Learning Functions (13) are introduced. The learning functions allow the KP to understand new procedural knowledge, or to “program itself,” by understanding its own functionality, just as it manipulates the literal knowledge of the network. In this manner, the developer conceives a foundation of inchoate knowledge and intelligence for the network during the application's development, and the network continues to learn through the “life” of the application. The network editor allows the developer to configure the Host processor's machine bytes and digital capabilities according to these early learning stages of the knowledge processor.

3.3 Running Processes: the Intellectual Faculties

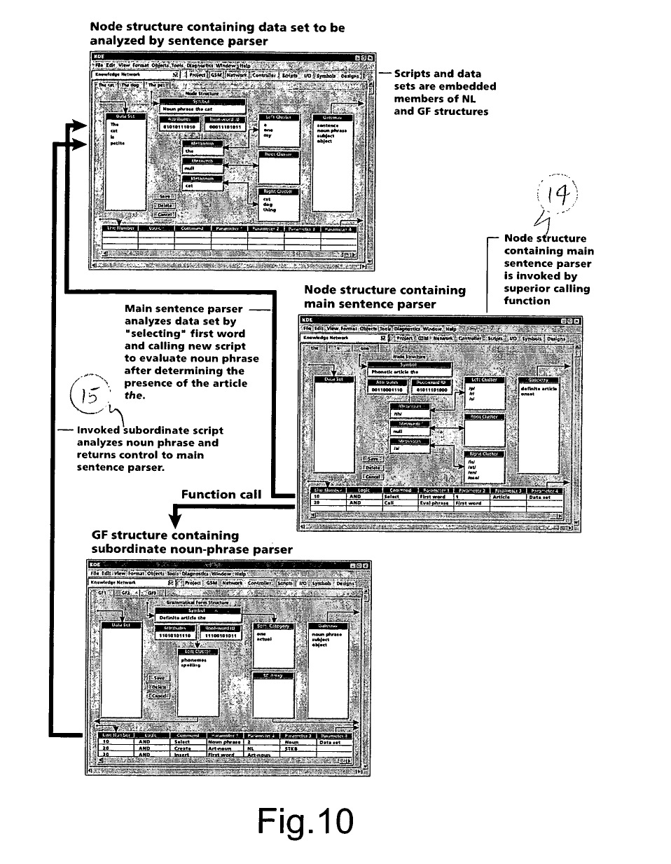

The knowledge network's epistemic structure is altered and maintained by the KP's running processes (RPs). The running processes are the KP's version of the mind's “streams of thought.” They are comprised of macroprograms of machine logic that enact the KP's intellectual faculties according to UPL commands. Both the developer and the KP can create and alter the network's running processes. The UPL commands are thus assembled into macroprograms that execute the KP's intellectual faculties according to their placement in the linguistic knowledge network. The running processes manipulate the knowledge network and the KP's external communication faculties through their arrangement in the knowledge network's semantic webbing. The RPs are an integral part of the knowledge network's structure even though they operate on the network as the KP thinks and learns. The KP's intelligence is thus a result of both the network's structure (node and GF structures) and function (the RPs' placement in and performance on the network), as shown in FIG. 10.

A main script (14) manages the project's high-level cognitive activities, such as the intellectual faculties for reading, conversing, and imagining language, while subordinate scripts (15) perform specific intellectual tasks associated with the high-level faculties, such as comprehending a particular class of phonemes (like the sound /p/ in word groups using it). A script, or “UPL function,” can read or write to external devices and the Host processor's secondary memory through the UPL's Read and Write commands (according to an appropriate I/O strategy). The project, and therefore the main script, is implemented as a stand-alone application on given hardware or software, or as an application that controls a hybrid computing environment based on a GSM configuration. Projects can be linked as required to build larger and larger projects (linguistic systems), and scripts can be linked to build more complex modules, as the KP's intellectual faculties and knowledge base expand along with its applications. The UPL modules are classified by the developer according to the intellectual faculty that they serve and are constructed from the basic UPL command set (discussed in Section 6). The intellectual faculties are designed using various theories of linguistics, learning, and psychology. The design methodology followed in the specification relates the functions linguistically. The approach utilizes function classes referred to as Lexical Parsers, Syntactical Parsing and Translating Modules, and Language Constructors. While the developer may enjoy wide flexibility in building intellectual faculties, these three design classes are a starting point for UPL functions that provides the basic functionality needed to enable a machine to “think.” The amount and complexity of intellectual faculties are limited only by the level of cognition required for the application. The following discussions are intended to familiarize the developer with various script archtypes that are useful to the beginner in the knowledge processing paradigm. (The running processes are discussed again in further detail in Section 7.)

3.3.1 I/O Strategy

The KP understands a language's content by analyzing a data set's expressions and actually comprehending them through the mind's action in the universal grammar. When the question What are cats? is input to the KP, via the conversion of ASCII characters into a PB array, for instance, the network parses and comprehends the sentence in order to translate the PB array ultimately into something like Cats are animals. How the KP interacts with external devices thus depends not only on externally imposed machine protocols, but also on the actual content of the language embedded in the input data. The KP's method of communicating with other machines semantically is referred to as an I/O strategy. The I/O strategy is a UPL function design methodology that allows the KP to query its own memory and that of external data storage systems, such as the Internet, to discover that Cats are domestic animals, along with the many other attributes one might learn about felines in the example. The I/O strategy is the “kernel” of the GSM—the central design method used to enable the KP to communicate with external machines by understanding the content of external data. The I/O strategy is embedded in the GSM because the GSM accounts for system-level configuration requirements while the I/O strategy dictates UPL function design. Thus, the first UPL function class we consider is the function design strategy used for input/output protocols—the I/O strategy.

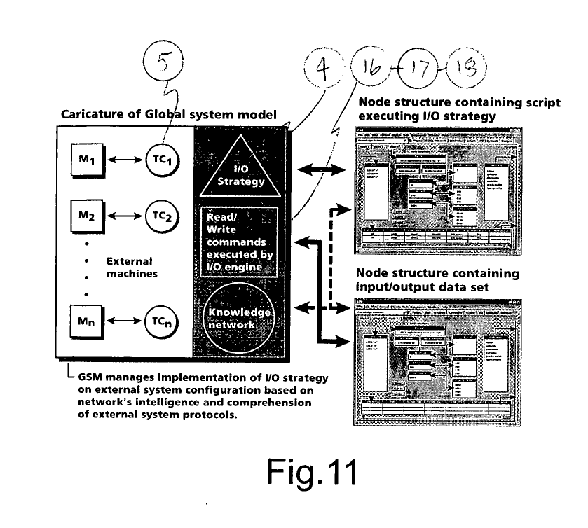

During the execution of the KP's input or output, the communicating machines are typically connected to the Host processor and to each other through the project's translation cards (hardware translators). The symbol kits (external machine byte/programmable byte translation tables utilized by the Read and Write commands) convert external data elements to the Host machine's programmable bytes. The application language is thus integrated across platforms through the connections made by the TCs and symbol kits, while the code to execute the I/O strategy in external machines is downloaded to the participating systems so that they can communicate, as shown in FIG. 11. While the KP's communication methods are discussed in greater depth later in the section when we present the GSM, the I/O strategy, a component of the GSM, can be described here as the KP's basic ability to interact with other devices by understanding the content of an input or output expression. Whereas conventional communication systems are configured by the engineer from “outside” of the system (via Wide or Local Area Network Protocols, for instance) because the system cannot comprehend language, the KP “configures itself” by responding to input or the network's internal cognitive activity while understanding language. Since the KP communicates in a wholly unpredictable manner, its “input/output protocol” is referred to as a “strategy,” which can be imposed by the developer or conceived by the KP during the application's use.

The UPL's Read and Write commands—the workhorses of the I/O strategy—are special UPL modules that utilize the symbol kits and GSM, in cooperation with the TCs, in order to enact the I/O process. The developer builds the Readers (16) and Writers (17) from the GSM Editor (also referred to as the I/O Engine) (18) using the symbol kits, programmable byte bit-field definitions, and global system model. In the CD/ROM version, the readers and writers are developed using either conventional O/S-based facilities or as KP projects, which are themselves incorporated into other projects as Read or Write commands. While the TCs provide the KP's electronic interface, the developer programs the binary translations that connect the systems through the UPL functions, thereby converting the encoded binary data of one machine into that of the others. The UPL programming necessary for TC operation to connect external systems uses the same UPL programming techniques employed for any other translations, except that it operates on the binary code specific to each machine. The I/O strategy may be invoked by any intellectual faculty when the UPL function executes an appropriate Read or Write command, just as human communication occurs based on the mind's ability to recognize and manipulate a language's content.

The I/O strategy is thus a UPL function design methodology that affects any function that may use the Read or Write command. Although the I/O strategy can be compared to the I/O “shell” of a conventional operating system, we avoid this terminology here because it tends to underplay the main feature of the KP being discussed—namely that the I/O strategy is a “strategy” enacted internally by the running processes in order to communicate semantically, rather than a protocol “shell” that an engineer imposes on the system.

I/O strategies utilize substrategies, or tasks, that support the main communicative strategy. One substrategy, for instance, may involve the I/O method required for the KP to read external data or images, while another may listen for sounds (such as spoken language). A main I/O strategy for this scenario would integrate the I/O capability for reading printed matter with that for voice recognition. The I/O strategy is designed to accommodate the network's use of the Read and Write commands such that language stored in data sets is distributed to the KP's “senses,” or external machinery. The I/O strategy can be used for managing conventional network protocols or the KP's sense/motor actuators, which give “perceivable meaning” to the language stored in the network. The substrategies support the main strategy just as the human senses and peripheral nervous system are integrated by the cerebral cortex. The “meaning” of the language understood by the network thus results from a blend of external devices rather than an isolated input/output system.

### EXAMPLE 3.1

### The GSM—A Semantic Network Controller

As an example illustrating the I/O strategy, we can consider a computer application in which the KP understands the content of a communication by using the basic principles discussed thus far. The example illustrates that the KP comprehends language embedded in binary information while independently controlling the configuration and protocols of other machines used to convey the information. By illustrating the use of symbol kits and translation cards, operating under a GSM to eliminate external machine protocol incompatibility, the example shows that the KP makes cognitive decisions about what machines to communicate with by understanding the natural language distributed throughout the network configuration.

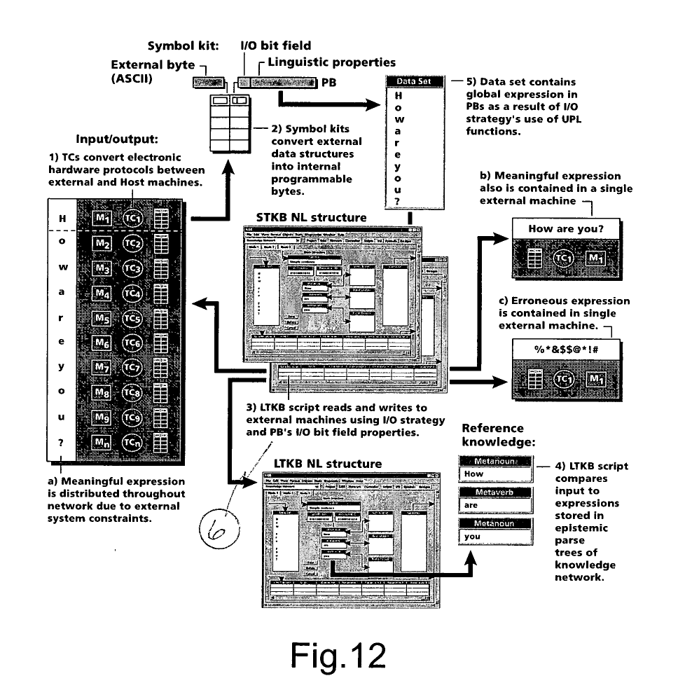

As shown in FIG. 12, each of the character symbols of the question How are you? originates from, and is output to, any configuration of different machines or software. By means of the translation cards, the programmable byte bit fields, the symbol kits, and the GSM, each character is translated into a programmable byte that is processed by the knowledge network. Since each programmable byte contains a bit field, referred to as the I/O Bit Field, designating the machine and protocol from which the KP obtains the external symbol, each byte stored in the network can potentially originate from, or be output to, a different hardware or software protocol, while the Host processor interprets the application language globally.

The KP receives expressions of the application language embedded in other machines and installs them into one of the network's data sets, which is subsequently compared to any number of parse trees in the network. While the external machines operate on their own unique data structures, the KP translates the knowledge into the programmable bytes using an I/O strategy. The global system model allows the UPL project modules to process the meaning of the application language, while external machines operate on data in their own respective computing paradigms.

The I/O strategy is the communication schema that supports this activity under the guidance of the GSM. The I/O strategy instructs the running processes to poll each of the machines for meaningful symbols. In the example, the Host processor does not know which character (from what respective machine) to accept as input until it parses and translates the language into the knowledge network. If it appears to the KP that a given machine is indeed a source for meaningful expressions—or that no machine alone offers a meaningful sequence of characters—the KP will return to that machine (or poll all machines in an unbiased way) until it has satisfied its interests. The KP thus comprehends language during the I/O process according to a suitable I/O strategy and GSM. The I/O strategy achieves this level of cognition for the KP by allowing the KP to understand both the application language's content and the machine architecture and protocols of the global computing environment. The KP assembles the globally distributed expression into another data set and into the network's semantic webbing as a parse tree for further manipulation by the network. (See also Section 14.).

3.3.2 Lexical Parser

The KP implements many types of intellectual faculties. Another type of UPL module used for a wide range of KP projects is referred to as the Lexical Parser (LP) (19). (The module's name is unimportant but its functionality is used extensively in KP projects.) The LP, also created through the script editor, translates lexical and often sentence-level syntactical expressions that are embedded in external machine language or carrier waves into higher-level syntax that the knowledge network processes at the higher syntactical level. While the LP can be invoked by any intellectual faculty, it is typically associated with the resolution of the lexical properties of the application language. The creation of a specific module to resolve word meanings is only a first step in the knowledge processor's approach to comprehending language and is almost an arbitrary distinction because the KP's lexical resolution of word streams occurs in any level of semantic comprehension.

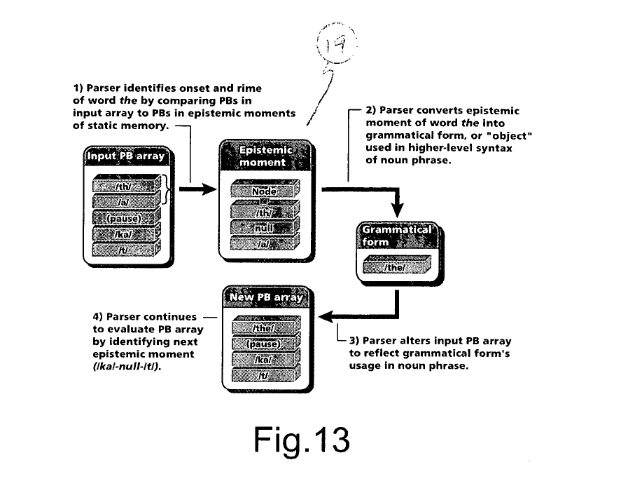

In order to manipulate the application language's content and meaning, the KP must determine a “foundational layer of context,” or meaning, according to which the language's higher-level elements are understood. The KP must agree on the meaning of a word, for instance, if it subsequently analyzes the word in the context of a sentence. Similarly, the KP must already possess a knowledge of phonetic sounds in order to understand a word's use in the syntax of a spoken sentence. The LP creates the proper syntax by translating lower-level grammatical forms (PBs) into higher-level grammatical forms (or vice versa), just as a human being would parse an expression and formulate words, phrases, and sentences while creating a thought, as shown in FIG. 13. The LP is typically invoked after a Read command acquires a set of PBs from an external machine using the symbol kits. Since the symbol kits relate external machine data structures to their PB counterparts, the LP is required to resolve the meaning of the application language's content in the knowledge network's context. The LP is thus used to resolve incoming characters or phonemes into meaningful words so that the other intellectual faculties can begin operating on words in a sentence when invoked. In more advanced projects, word resolution and higher-level syntax analysis are accomplished cooperatively in a single module, such as when a faculty must resolve the meaning of a word while analyzing sentence-level syntax concurrently.

### EXAMPLE 3.2

### Resolving the Meaning of Language Through the Universal Grammar

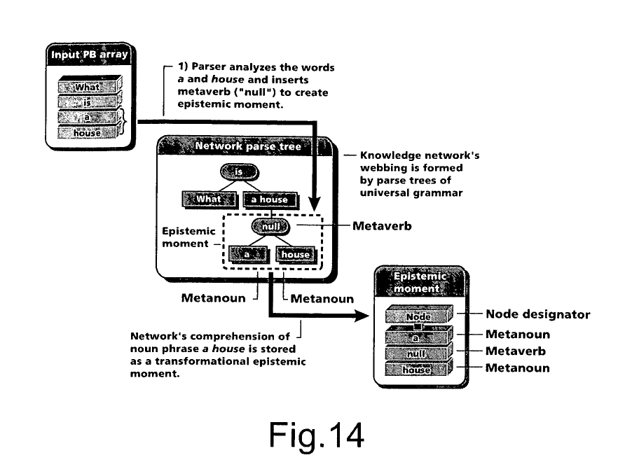

According to the universal grammar, the mind comprehends language through epistemic moments—grammatical structures that define the synthesis of language in a meaningful syntactical expression. The mind thus does not innately comprehend merely the “objects” (words) of language as the meaningful elements of thought. Rather, the mind understands the epistemic moment, or the synthesis, of a pair of linguistic objects (metanouns) in transformation through a third object—the action, or transformer of the moment (the metaverb). Since the mind cannot comprehend a linguistic object in a word stream to the exclusion of other words, it is senseless to build machines that recognize only strings of objects, as is typically the case in a computer's processing of a string of bytes. The LP parses a word stream comprised of epistemic objects and transformers (language elements) and constructs them into epistemic moments that are related to each other in the structure of a parse tree according to the premises of the universal grammar, as shown in FIG. 14.

The KP formulates and compares semantically arranged parse trees containing epistemic moments in order to comprehend language. A particular moment's “metanouns” (objects) transform with each other through a transforming object, or “metaverb.” (See also FIG. 10.) The parse trees are comprised of recursively generated epistemic “nodes,” or triplets (transformational data structures), that reflect the mind's action as described by the universal grammar. The occurrence of an epistemic moment represents an instance of the mind's action. This epistemic parse tree structure demonstrates that the mind's grammar is different from that of a given language, even though the mind comprehends language by operating on a particular grammar. Concerning the lexical parser, an example of this paradox can be found in the grammatical construction of the English article a, as it transforms with an English noun, such as the word house. Whereas other grammars, such as English, operate directly on the objects (metanouns) a and house, producing a noun phrase, the universal grammar recognizes the absent transformer between the words and requires the construction of a triplet of epistemic form—a grammatical transformational structure—such that the metaverb, which is silent in its operation here, is depicted transforming the two objects in the mind's comprehension (a-null-house), as shown in the figure.

The mind acts the same way in every creative instance, regardless of the particular language it manipulates. When a person begins to parse the arbitrary question What is a house?, he or she enjoys the complete mental freedom to analyze the character W first, and then invoke an intellectual faculty to translate the word What into Where (as in Where is a house?) regardless of the expression's literal symbols. Likewise, a person can comprehend the words What is, and then decide that the next word in the expression really ought to be like, as in What is like a house?—perhaps restating the question for other thoughtful analysis. The person can, of course, simply comprehend the expression as stated (i.e., What is a house?).

The KP resolves words and language elements, such as the word what shown in the expression, by applying the universal grammar. Through the knowledge network, a UPL module can access the context for all epistemic conditions in which the word's characters may be utilized by a particular knowledge discipline. After reading or thinking of a word in a sentence, the KP may decide to create a rhyme, apply a metaphor, or exchange the word with its synonym to determine better context and meaning for the sentence. The universal grammar allows these processes to occur because the KP deconstructs language into the mind's innate moments of thought, rather than following the language's proper grammar. In this sense, the universal grammar is not a grammar at all; it is a rule set describing the mind's innate action, which occurs “beneath” a language's grammar. The KP “thinks” in order to realize the mind's moments in a machine, reaching across language barriers and knowledge disciplines just as the human mind does. The LP thus provides the KP's basic ability to resolve lexical expressions of any symbolic nature according to their context in the knowledge network, as determined by the epistemic transformations of the universal grammar.

Designing an LP function thus requires the construction of parsing and translating functions that resolve a language's elements from one level of syntactical complexity to another. The KP's other UPL modules perform additional functions, such as parsing and translating expressions in general, or “thinking” about higher-level abstractions, such as phrase and sentence constructions (discussed shortly). A particular linguistic process, such as the LP, does not have to be included in a module at all. A wonderful example of this is seen when the KP acts as a conventional microprocessor. In this case, the KP defines the input data according to the only possible interpretation of the bytes. It does not require a lexical parser because the words do not need to be resolved; they are already resolved by the unambiguous nature of the microprocessor's mandatory symbols. The KP defaults in this case to UPL modules that exclude the LPs from the project. The KP then acts on a single acceptable input and performs translations guided by the project's remaining modules, which act similarly to a conventional programming algorithm.

3.3.3 Syntax Parser and Translator

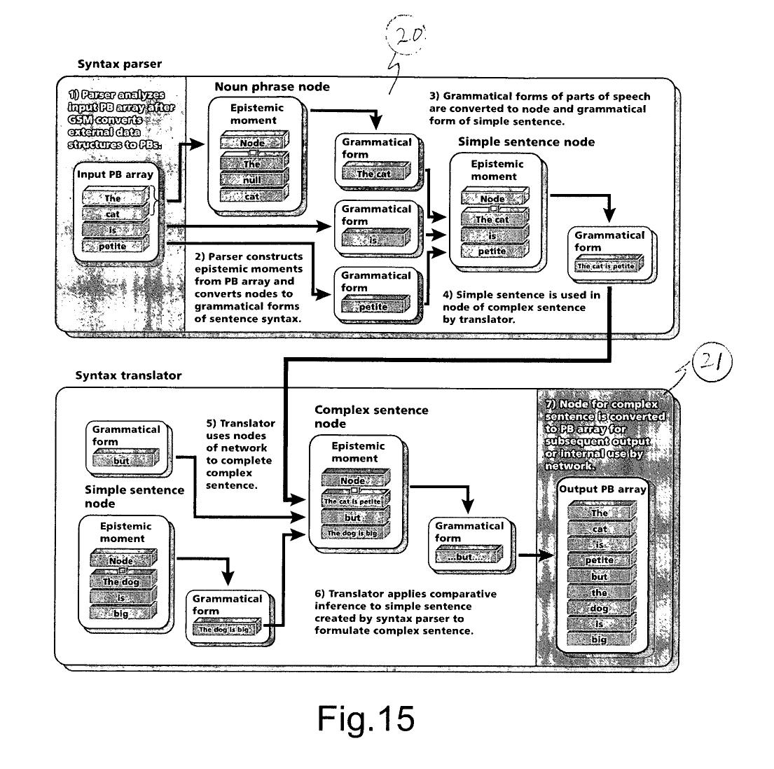

The Syntax Parsing Module (20), another class of UPL function, enables the KP to comprehend language further after resolving its bytes (or bits) into programmable bytes at the proper lexical levels through the LP. The syntax parser deconstructs a PB array into its proper parse tree according to the universal grammar's interpretation of that language. The syntax parser usually operates on sentence-level syntax, as shown in FIG. 15. Even though a word, phrase, or sentence can itself be a “lexical sentence” at a different syntactical level from that of the global sentence, lexical parsing and translating modules (LPs) are distinguished from sentence-level parsing and translating functions for convenience and configurability. The syntax parser handles sentence-level constructions, whereas the LP typically accommodates word usage. Each module, however, requires a UPL function, which, under the universal grammar, creates an epistemic parse tree that is compared to others in the knowledge network. The LP operates on lexical sentences (usually made of syllables or phonemes), while the syntax parsing and translating module manipulates words and phrases as sentence elements. (We should note that these distinctions are arbitrary, and that some developers arrange the KP's basic modules according to a generalized capability, wherein lexical and syntactical parsing and translating occur concurrently.)

Since the meaning of language is based in the KP paradigm on the universal grammar's interpretation of the epistemic moment in context, the KP compares a deconstructed syntax tree of epistemic moments and its elements with similar syntax trees stored in the KP's knowledge network, thereby “comprehending” language through various degrees of linguistic correspondence. Based on a lexical element's (PB's) placement in a data set, the syntax parser analyzes the related epistemic moment contained in the data set's syntax and constructs a parse tree joining that moment with others formulated from the expression. While the goal of syntax parsing is to establish sentence-level parse trees that are subsequently translated by other UPL modules, the syntax parser often translates word elements of the PB data set as well. (The KP may not recognize the meaning of a sentence, for instance, until it exchanges an input word with its synonym.)

After the KP comprehends the input PBs and creates a meaningful parse tree, it can begin to change, or translate, the syntax tree—and any of its components—according to Translation Modules (21) that reflect the KP's learned behaviors, or creative intelligence. These modules function as the project's “generative” intellectual faculties, which perform the process of imaginative thinking, while translating existing expressions into new ones. The translation module performs all meaningful lexical and syntactical translations of a syntax tree according to the KP's intellectual desire to change the moments meaningfully.

The translator operates on programmable bytes, epistemic moments, and entire parse trees. A natural language verb, for instance, can be translated into another verb or other grammatical form (PB) of a different language when the KP determines that a given set of linguistic conditions exist in the data set. These conditions could include, for example, the following: that the verb originates from a specified machine, is found in a particular location within the sentence, and is perhaps preceded by any noun two positions away from a preceding verb, and an arbitrarily chosen word, such as bat, appears anywhere within the sentence. If the translation parser finds a verb in such context, the translator will translate the designated verbs. (Of course, for the process to make sense, one would have to know the specific requirements of the application knowledge.)

The KP can also translate the syntax tree based on the ideas stored in its knowledge network. The KP actually “thinks,” or imagines, by constructing a new expression from the one it comprehends by using its knowledge network to change the syntax tree. By combining various processes in a module and various modules in a project, the resulting project manipulates language so that the KP thinks the way the mind does. The learning functions (discussed later on) allow the KP to cultivate its intelligence by learning new ways to alter expressions to find context or imagine new ideas. In this case, the learning functions change the procedural knowledge pertaining to the syntax parsing and translating modules.

### EXAMPLE 3.3

### The KP Thinks of a Metaphor

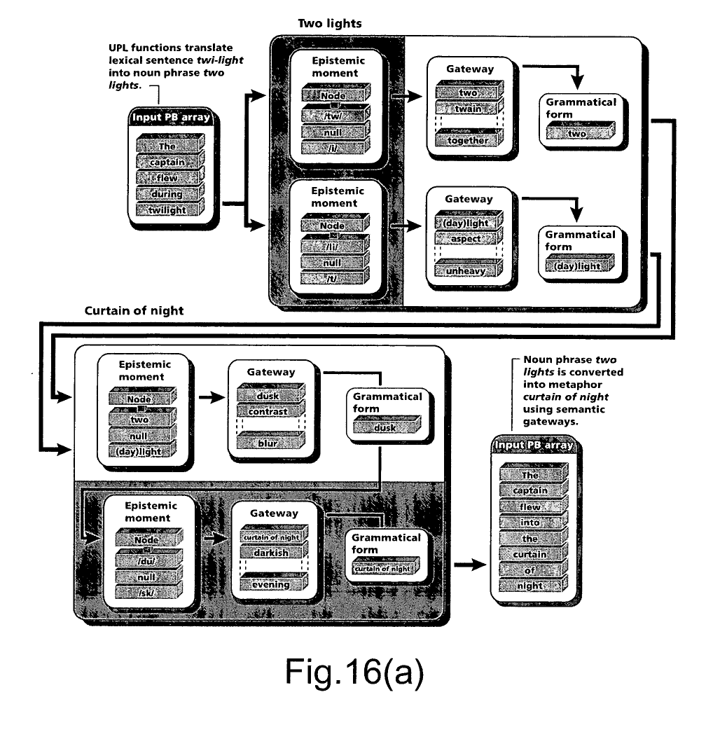

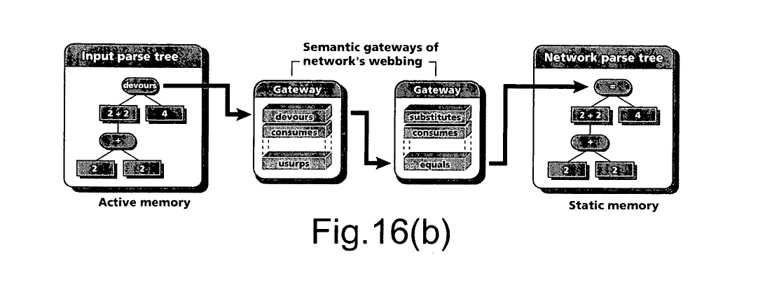

As an example of how the KP's parsing and translating processes work, we can consider the KP's ability to modify expressions through the use of metaphor, a privilege usually given to the world's great authors. In the example shown in FIG. 16a, we assume that the vocabulary learned by the KP does not include the word twilight. The objective of the exercise is to use the KP's parsing and translating functions to make the sentence presented “sound better” in English prose by applying the imaginative process of a metaphor.

The KP cannot fully understand the sentence The captain flew during twilight at first, because it does not recognize the word twilight as a single grammatical entity in the knowledge network. The KP must therefore treat the word twilight as its own sentence, consisting of two words, twi and light (two lights that overlap). The KP deconstructs the lexical sentence twilight into its epistemic moments—at which time twi and light are recognized in the knowledge network—while also comprehending the higher-level sentence syntax. When the KP analyzes its knowledge network for the epistemic structure of the word twilight, in support of its parsing and translating module, it recognizes the two-word sentence twi and light (two lights), and then recognizes, through the parsing modules, that The captain flew during “two lights” (of day). The lexical sentence two lights (of day), however, is also associated in the knowledge network with its definition, a period of two overlapping (sun) lights, and its synonym, dusk, also configured as parse trees in the universal grammar. The KP now comprehends the sentence as The captain flew during dusk, making the appropriate translations in the parse tree.

We can reasonably assume that the knowledge network also contains synonyms for the word dusk. The KP might obtain the expression curtain of night from an understanding of the semantic usage of two lights (that change) and the action of a curtain gradually closing to block the sunlight and darken a room. (This is a dictionary example of a metaphor.) The action of the two lights and that of a curtain would have to be associated in the knowledge network as a result of prior learning. The KP might then exchange the words and arrive at The captain flew during the curtain of night.

The KP, which is ahead of us in terms of the example's initial objective (to make the sentence “sound better”), understands through its knowledge network that a captain (a person) cannot fly an airplane during a curtain, and it appropriately translates the word during as into, arriving at the expression The captain flew into the curtain of night—a metaphor.

An even simpler example is illustrated in FIG. 16b, wherein the KP learns arithmetic by innately understanding that the “languages” of mathematics and natural language are each a part of the same grammar of thought that is used to explain any knowledge in the universal grammar. When presented with the expression 2+2 devours 4, the KP recognizes that the sentence is similar in form to those in the network 3+2=5, 10+1=11, and so on, except for the word devours. Through the UPL modules, the KP recognizes that the word devours is synonymous with the expression completely consumes, in which one thing is taken into another and cannot be distinguished from that which consumes it. Similarly, when two things are added together, a new, larger entity is created which has effectively devoured the previously separate items into itself. The expression completely consumes is thus ultimately synonymous with the word equals. The KP further recognizes that the word equals is synonymous with the mathematical term =, a symbol of arithmetic equality. As the KP compares this expression to its knowledge base, after it has been modified with synonyms by the translation process, it finds that the translated expression exactly corresponds to the epistemic structure in its network 2+2=4. The KP then learns that 2+2 devours 4 can be comprehended as 2+2=4, or that the use of the word devours semantically emphasizes the arithmetic equality. The same process can occur in reverse order, whereby the KP learns that 2+2=4.

3.3.4 Language Constructor

The Language Constructor (22), another function class, builds translated parse trees into new word streams (PB data sets) when the translator completes the epistemic thought process. Once the universal translations are made and the KP has transformed a parse tree of input as desired, a target word stream must be produced and transferred to the KP's long-term memory, or to an external device through the I/O strategy, thereby completing the Host processor's knowledge processing task.

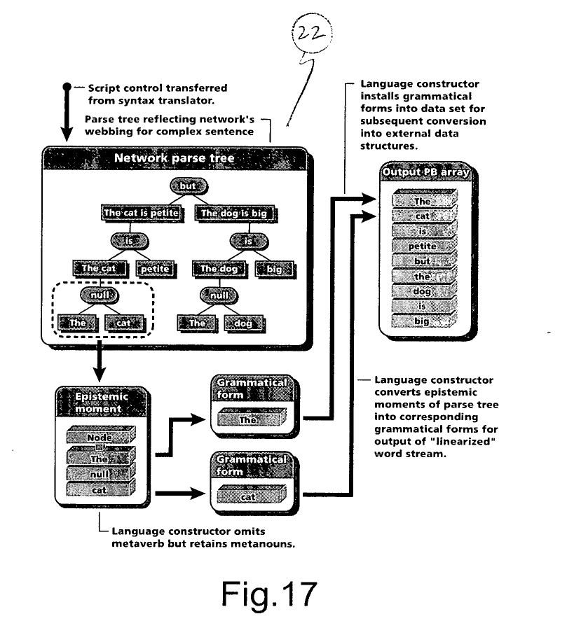

As illustrated in FIG. 17, the language constructor operates in reverse order to the lexical parser, breaking down sentence or lexical-level syntax trees into words—converting, for instance, sentence-level parse trees into lexical-level grammatical forms that can be output as a word stream. The language constructor, also referred to as the Language Reconstruction Module, contains functions that parse the epistemic syntax trees and extract only those objects, or epistemic components (metaverbs and metanouns), necessary to produce the word stream. The UPL commands for the reconstruction module implement those functions. The UPL commands thus provide the elementary parsing tasks that assist in the global parsing and reconstructing of PB data sets and syntax trees. The Write command of the I/O process completes the KP's cognitive processes by outputting the data set to its target devices. The Writer converts the grammatical forms of the target word stream, produced by the language constructor, into machine symbols once again in order to exit the universal grammar and enter the binary or analog domain of either an external device or the KP's memory.

3.3.6 Parsing and Translating Kits

As we know from common experience, each knowledge discipline requires a different set of intellectual processes to understand its content. A syntax parser constructed for an English-Chinese translator will be very different from a parser created to understand a genetic sequence or a musical composition, and each of these cases will be different from simply “thinking” about new ideas in various ways. For this reason, the KDE provides the developer with generic UPL function administration facilities, referred to as “kits,” for the various modules. This approach to module construction allows the kits to be reused in different ways without disturbing the specific parsing or translating logic for which they are initially intended.

The parsing kits designed for linear word streams, for instance, function differently from those parsing kits used to navigate through syntax trees. In the case of the linear parser, the word stream is arranged with its PBs in consecutive order. This order is referred to as a “data set.” In the case of the syntax parser and translator, the data sets are further organized, or “split,” into epistemic moments (triplets), referred to as the syntax tree's “nodes,” which form the basis of the knowledge network and are interconnected through the network's semantic gateways. The parsing and translating kits for syntax trees navigate throughout the tree by identifying nodes within the tree, then nodes within the nodes (data sets contained within the nodes), and then grammatical forms within the nodes.

All parsing kits are developed so that a parser for, say, biological sequence analysis can be used for parsing an English phrase without overlapping the two modules or confusing the knowledge disciplines. Once the kit is associated with a particular structure in the knowledge network, however, it is recalled by the KP through its position in a particular network structure. The module's “kit” is therefore conceived and stored by the developer externally (to the network) and then “copied” into the network for use in a particular network location.

3.3.6 Generalized UPL Function

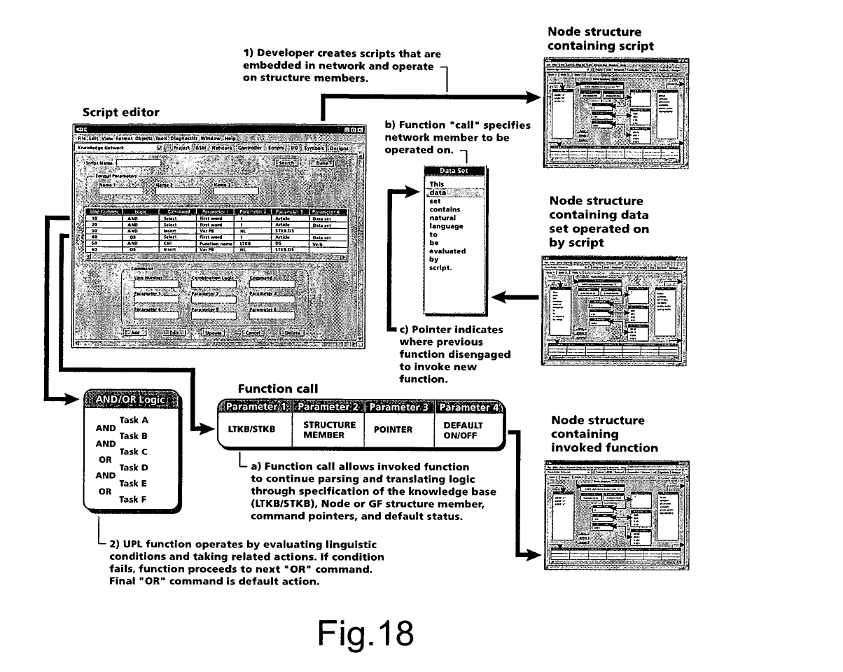

The UPL functions can be imagined as “macrocommands” formulated by the developer and derived from the KP's basic UPL command set to carry out the KP's intellectual processes. The classes of functions discussed previously, referred to as UPL modules, organize the KP's intellectual faculties according to the KP's ability to interpret and change the application knowledge. The intellectual faculties, or UPL functions, parallel the mind's comprehension and translation of language according to the universal grammar. In order to support the widely divergent requirements of UPL functions, the KDE employs a generalized functional structure that allows one UPL function to “call” another and to pass relevant parameters to the invoked function. The UPL function also relies on “AND/OR” logic for the line-by-line execution of UPL commands, as shown in FIG. 18. These UPL features are referred to as a generalized UPL function.

A project's main function controls, directly or indirectly, the knowledge network's use of all subordinate functions, and performs as a mode of operation for the network. The UPL function protocols are designed so that main and subordinate functions interact as cooperative intellectual faculties. Since functions are integral components of the knowledge network's structure, a function call by a command constitutes a request to the knowledge network for cognitive processing of the network, since the calling and the invoked functions are embedded in the network. The knowledge network therefore serves as both a linguistic structure for the application language and a directory for UPL functions.

The main function of the network determines the overall strategy for executing the KP's modes of operation. The modes of operation rely heavily on the I/O strategy for network and sensory communication. Any UPL command may be entered into the main function, including the very important commands that call other functions. In practice, the main function usually creates an initial PB data set in the Short-term Knowledge Base (STKB), the KP's active memory, so that external data can be input or output from the running processes using the symbol kits to translate PBs into external data structures. The main function also executes the GSM and allows the subordinate functions to operate on language globally. The Long-term Knowledge Base (LTKB) stores the KP's functions and other acquired knowledge for permanent reference.

The subordinate functions provide a convenient way of arranging parsing and translating logic into intellectual faculties. When appropriate parameters are passed to a given function in an exchange of information, the function performs an analysis and takes action on the data set while returning relevant parameters to the calling function, much like the function protocols of a conventional programming language. In general, a subordinate function passes four types of parameters, as shown in the figure. The first and second parameters identify which data set in the short- or long-term knowledge base (active or static memory) that the function should operate on. The third parameter specifies any data pointers that indicate where the function's logic should be applied in the data set. (The action of this parameter is similar to the mind's action when focusing on various elements of a sentence while attempting to comprehend its meaning.) The fourth and final parameter specifies whether the function should take a preferred or a default action on the data set if the function's commands fail to determine the preferred condition. If the function's commands encounter a preferred condition, the action associated with that condition is executed. Otherwise, a default action may be taken. (This process is similar to the mind's action when it encounters an unknown word in a sentence. We still comprehend the remainder of the sentence while the word is carried around mentally as a “default” element, which is our best judgment about what the word could mean.)

The main and subordinate functions continue to execute line-by-line functional code using AND logic that links a sequence of commands until a failed condition is encountered or a corresponding action is taken. If all of the commands succeed, the corresponding action is taken and the function returns control of the script to the calling function. If any of the commands fail, the function's internal logic continues with the next OR logic. The purpose for the AND/OR logical construction of a function is to link a sequence of “evaluate and take action” conditions by OR logic, allowing many conditions to be evaluated and respective actions taken if given conditions exist in the data set. This functional architecture is mildly analogous to that of the Prologue programming language, except for the differences introduced by the KP's knowledge network and the universal grammar.

Since UPL functions are associated with PBs and their network structures, any function can evaluate an input PB in a data set—such as a character, word, or punctuation of natural language—and call the appropriate intellectual faculty to parse and translate the data set further, whereby control is returned to the calling function once action is taken by the invoked function. This integration of network structure and function anticipates random language expressions in the input because it associates intellectual faculties with any symbol or higher-level syntactical or semantic construction in the input language. The knowledge network's organization of functions thus inherently anticipates the syntax and meaning of input expressions, just as the mind brings to bear all of its intelligence on arbitrary expressions. The KP's knowledge network is therefore arranged so that any intellectual faculty can be invoked based on a preceding function's analysis of input according to the meaning of the input expression (as determined by reference to the LTKB).

3.3.6 Learning Functions

The UPL functions, or intellectual faculties, are designed to alter their own procedural knowledge (other functions), thereby “learning” through the knowledge network. Since each function except the main function is associated with a particular PB in the knowledge network, a function's effective memory address (the location of a node or grammatical form structure in memory) is itself a linguistic structure of the network that conforms to the application language's expressions. Since each PB (and therefore each function) designates a structure of the network, a function is understood by the KP linguistically according to the function's placement in the network (i.e., in the application language's syntax and meaning). Since a function's commands are addressable by language, as understood by the network's intelligence, any function can be created or changed by the KP through the knowledge network's comprehension of the application language. The KP thus learns and programs itself, while altering its functional intelligence through discourse with external devices and users.

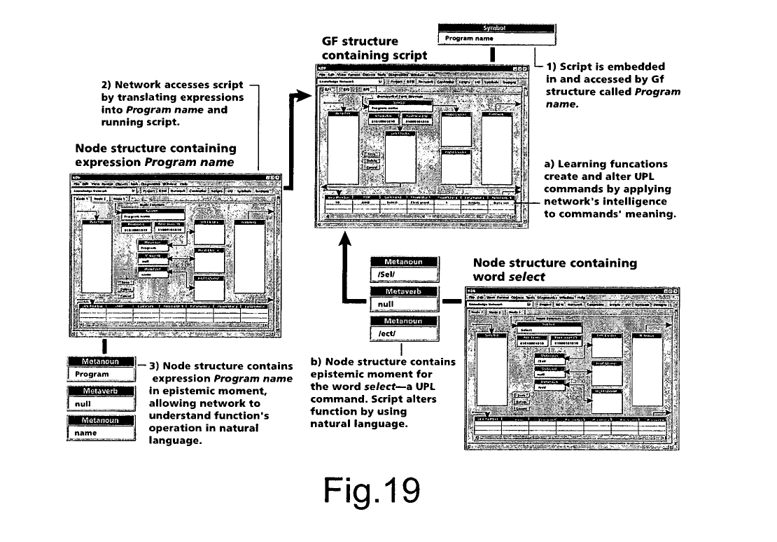

The KP's method of accessing and altering the knowledge network is markedly different from the conventional action of calling a function named in a computer programming object. The KP's functions are identified and executed as part of the knowledge network. This means that any function can be designed to alter any other function in the network through the network's ability to understand the application language as it relates to the proposed procedural knowledge, as shown in FIG. 19. The features of the knowledge network that relate to a function's ability to create or alter other functions are broadly referred to as the KP's Learning Functions. Thus, any function in the knowledge network is a potential learning function.

When designing a function in the KDE, the developer must consider how other functions may change the given procedure through usage, or how the KP will learn to create or change the capabilities of a given function. In order to accomplish this, the programming syntax of all procedural structures in the network (such as UPL commands and functions) are viewed in terms of how the knowledge network understands the structures in the application language. Thus, the “function names” (PBs) used throughout the network, and the application language, conform to the same grammar and semantic usage—namely, that of the application language.

In order to enable the network to alter UPL functions and commands, each UPL module and command is syntactically constructed so that it can be understood through meaningful expressions of the application language, which is typically natural language. Each command's (and function's) particular action is designed syntactically according to a compositional style that enables any complex function's or command's action to be deconstructed into more primitive actions performed by lower-level functions. The KP's functions and commands are comprised of substructures, referred to as Incremental Shapes (of knowledge), that are assembled into macrostructures, or Global Shapes (of knowledge). The use of incremental and global shapes of procedural knowledge (functions and commands) allows the knowledge network to understand global procedures in terms of more primitive, incremental tasks, referred to as incremental “shapes.” The procedural knowledge of a given function or command in a project's module is thus understood by the knowledge network, along with all other knowledge contained in the network, in terms of the KP's comprehension of the incremental and global shapes as constructed in the application language. Thus, instead of using the knowledge network to translate other language or to develop a certain metaphor or other intellectual task concerning the application language, the KP also comprehends the procedural knowledge (functions and commands) that it is capable of performing. When altering the knowledge network's UPL functions and commands, the KP operates directly on the script's procedural knowledge contained in the node and GF structures.

By altering the incremental shapes of a function or command, the KP or the developer can change the global shape, or procedural knowledge, of any script. If the new procedure is verified through the KP's intellectual faculties and senses as having a positive effect on the knowledge network (the KP's intelligence), the KP is considered to have learned a new and useful procedure from its more primitive skills. (Human beings perform intelligent actions the same way, except that the incremental shapes are constructed from the five senses and the body's muscular motors.)

### EXAMPLE 3.4

### The KP Learns How to Translate Language

In the example, the KP will learn how to translate a Chinese sentence into an English sentence by understanding its own functional capabilities in natural language through the knowledge network's intelligence. The incremental shapes used for the example are those tasks pertaining to the actions of sentence parsing and translating. (We should note that while the example's topic concerns the subject of linguistics, the learning method applies equally well to a robot arm's spatiotemporal motion, for instance. In such a case, we would refer to “distances and torques” instead of linguistic principles in the example's illustration. The learning functions are designed to operate on any knowledge discipline.)

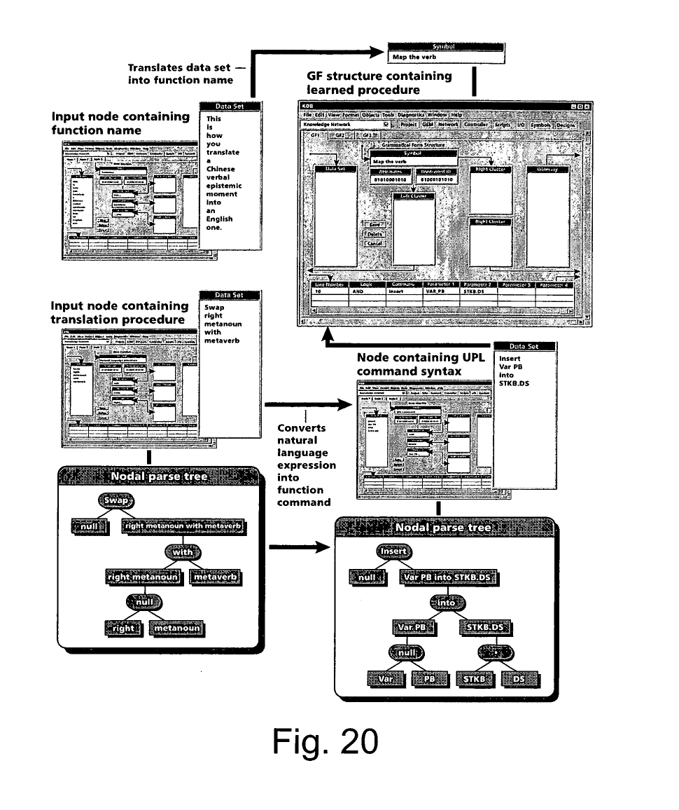

As a premise for the example, the KP already understands the procedure of translating epistemic moments according to the universal grammar and contains this knowledge in the knowledge network. Even though the KP understands the universal grammar (perhaps from earlier learning), however, it does not possess a function—a procedural knowledge—that enables it to translate a simple sentence in English or Chinese. This procedural knowledge is input to the KP from an external source, say a human language translator conversing with the KP, as shown in FIG. 20.

In the example, the expression map the verb is the natural language “name” (PB) used to position the learned procedure in the knowledge network. The external source, however, expresses the knowledge through the sentence and text shown. The KP must therefore translate the expression This is how you translate a Chinese verbal epistemic moment into an English one into the function name map the verb, while altering the function's incremental shapes to learn the procedural knowledge from the communication. (This is a completely arbitrary example and use of language.) Once the KP has accomplished the learning task, it will have to relate all references to translating Chinese and English verbs to the expression map the verb because this is the expression defined by the network structure that actually contains the function and accomplishes the task of translating the simple sentence.

The actual procedure, as told by the external source, is deconstructed from the input stream so that known incremental procedural shapes are identified. Since the expression swap right metanoun with metaverb is the knowledge network's effective command that exchanges the right metanoun with the metaverb in the KP's procedural knowledge, the translation between the expression swap right metanoun with metaverb and the actual command expression Insert Var PB into STKB.DS gives the KP the first command of the function, as shown. The other commands of the learned function are installed according to how the project's modes of operation desire to communicate with the external source. After the learning procedure has been completed, the KP can translate arbitrary expressions such as Can you translate a simple Chinese sentence into an English sentence? into the actual function “name” (the function just designed and installed into the PB structure) so that it can call that function at will, once translated into the expression map the verb.

When any function is designed by the developer, the learning properties of the function are considered first because it is normally desirable to enable the KP to use functions through its own use of language. The terminology “learning function” thus refers to the developer's consideration of how the KP will learn intelligently through the design of the incremental and global shapes of a project's functions and commands. This design method includes considering how to formulate function and command names in the application language so that the knowledge network can understand them. The developer thus assigns names to the incremental and global functions and commands initially by placing the procedural knowledge in particular PB structures when conceiving the knowledge network. The KP then uses the learning functions to improve its intellectual capabilities.

While presenting the KP's learning methodology, we can consider why a conventional computer is “unintelligent”—or why today's computers cannot learn through spoken language. As we commonly understand a computer program, we can run a program by referencing its name in memory to the operating system or other means of initiating a program. A typical command to execute a computer program, for instance, might look like this: Run: Program_Name (or in today's graphics-dominated machines, it might sound like a “click”). The machine's CPU would then go to the memory location designated with that name, or effective address, and begin executing the program associated with that name. The problem with this approach to computer design is that only the user or other program objects can “run” the program because the procedure is stored under the specific program referenced as Program_Name. Another user who is completely unaware of the term Program_Name cannot simply input to the computer the sentence Perform the function I am thinking of, and pursue further dialogue that eventually extracts the actual procedure, as would occur with the inference drawn from I am thinking of starting the car.

In the KP's case, the knowledge network may contain a procedure stored under the PB Structure Car Ignition, wherein the KP simply must translate the user's expression Perform the function I am thinking of (along with further dialogue) into the PB structure for Car Ignition in order to execute the function. If the KP desired to learn how to start a car, it would utilize a learning function to establish the new network structures and functions, as described earlier. Since today's computers designate programming objects in ways that are not discernable through the application language, no one can determine the meaning of the function name, except the programmer. This is why only another software object or programmer who knows the function name can use the function. The KP is able to perform the necessary translations and to create or modify the associated procedural knowledge because all functions are inherently designed as part of the knowledge network's linguistic configuration in natural language.

3.3 Global System Model

The KP provides the developer with the tools necessary to implement global expressions of language over any external machine architecture. The modeling technique used to implement the KP as a “system” is referred to as the Global System Model. The global system model relates to parallel processing, virtual memory, network computing, parallel microprocessor instructions and pipelining, and any other system architecture in which global application expressions are processed by a single processor or a network of machines. The GSM also directly impacts formal discrete and continuous system theory because the KP comprehends the input and output of a system. Whereas conventional system theory derives its premises from mathematical definitions, the knowledge network uses the GSM, which places the network's cognitive capacity into a set-theoretic system such that a finite automation's “next-state function” becomes a knowledge network. The GSM integrates the principles of system theory with those of knowledge processing to result in a “system” that complies with set-theoretic mathematical definition but operates on input and output cognitively.

In the KP paradigm, a “computer”—the technology and its application—are understood as a single knowledge processing application. A KP project, therefore, encompasses both a computer's design—the system's hardware and software—and the computer's application, or “software.” The design tool and methodology utilized for this type of knowledge integration allows the developer to design applications and systems using a single programming environment. The GSM is a set-theoretic modeling technique (a system theory) that explains language and technology in the universal grammar such that the definition of a system encompasses a broader understanding of knowledge and machine intelligence than is possible through mathematical definition alone. The GSM configures any computer architecture or software by defining and controlling the execution of a project's application and platform languages concurrently while enabling the Host machine to operate on global expressions through the knowledge network's intelligence. Accordingly, the GSM relies on the knowledge network's ability to understand language when coupling systems in a network.

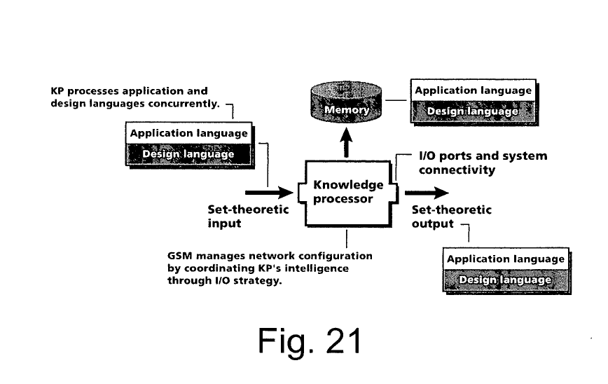

The global system model determines how language is understood and translated by a project's UPL functions in relation to the Host machine's communication with, and often control of, external machines and sensory devices. Whereas conventional computer systems usually operate independently of linguistic principles, relying exclusively on engineering disciplines for design methods, the KP constructs computer and network technology as a “system of language” (the application) embedded in another system of language (the platform technology), wherein any application language can be distributed over any computing platform through its integration into the platform language using the universal grammar, as shown in FIG. 21. A KP project thus manipulates an application language, which operates because it is compiled into a design language, and the actual design language (of the platform technology) that enables the application language to function in the first place. These two levels of a system's architecture, along with the KP's intelligence, are merged in the GSM into a single global system design based on the universal grammar.

The GSM's approach to global computing can be appreciated by comparing the phenomenon of a human communication to that of a machine or network system. On the one hand, the media in which an ordinary human communication occurs—sight and sound—are designed for us through the senses of vision and hearing. Human beings therefore do not have the option to communicate through a “different platform technology” (say, infrared light) because we cannot redesign our anatomy and physiology. On the other hand, computer technology is virtually boundless in communication media because, along with each machine standard, there potentially exists a different technology platform—a new medium in which to communicate. The GSM allows the KP to control any communication in any sensory medium by integrating the KP's linguistic premises into the network's design.

Moreover, a human being enjoys a certain amount of discretion with respect to deciding what “devices” (other people or machines) to communicate with because a person can understand the meaning of a communication. A human being usually decides when and how to communicate according to one's intellectual faculties. The GSM engages computer and network communication protocols in a like manner by using the KP's ability to comprehend language. Under the GSM standard, the KP may, for instance, receive a large electronic file from an external device, only to disrupt the communication after reading (parsing and translating) the first ten or so bytes containing natural language—if, hypothetically, the KP becomes disinterested in the communication. The GSM is therefore a modeling technique, based on the convergence of system theory and the universal grammar, that is concerned with the interpretation of external knowledge and technology by the KP's intelligence. The GSM is a global system model that connects knowledge networks, or thinking machines, while also serving to “backwardly integrate” the KP into any computing or communications environment.

3.4.1. Knowledge Processing Systems

We can introduce the GSM by considering a conventional computer network or communication system. The key to understanding the drawbacks of conventional computer and communications technology is to realize that any expression of language is inherently embedded in another language, namely the language of the communication's carrier signal—its enabling medium. A conventional computer program or network operating system, for instance, is embedded in the language of Boolean algebra and the von Neumann architecture of today's microprocessor (taken together as an assembly language) through the compiler's translation of source code into machine language. Broadly speaking, the computer maker and software industry collectively relate a source language to an enabling medium (machine language) to create a “computer” and its application. In a traditional computer system, however, the machine language is, for all intents and purposes, hidden from the developer, since the machine's compiler translates the application language into “executable code,” which is then enacted or transmitted by the machine. The correspondence between the application and machine code is blocked from the programmer's view by the compiler and the O/S. Nevertheless, the entire pyramid of computer languages—from database or word processing applications to microcode and chip slices used for any computing or network configuration—is required for today's computer simply to relate a source code expression to a machine's digital logic. (This is why “system stability” is such an important issue in conventional approaches to computing. While working within the pyramid of computer languages, there are many ancillary computations, or code translations between the source and machine languages, that could destabilize the application and produce undesirable results.)

When constructing parallel processes and network computers, conventional methods encounter nearly insurmountable compatibility issues because the application languages undergo too many translations in order to eventuate in the efficient use of machine logic. Meanwhile, the application language is almost never understood from the standpoint of the mind's grammar (i.e., the actual meaning of the application's expressions in the universal grammar). The resulting systems are designed more for processing efficiency at the machine level than for the efficient use of application knowledge on a machine in general. In other words, it is nearly impossible to design an efficient “multiplatform processor,” or hybrid network of parallel machines, when computing efficiency is defined in terms of machine-level parameters that do not fundamentally account for the application knowledge and the end-user's requirements. By executing machine or O/S processes in terms of source code, for instance, the O/S designer misses the mark because even source code is a compromise from the end-user's language and expertise.

Conventional computers are thus unable to understand the meaningful content of a communication. When two or more machines in a network interact, none of the machines actually communicates on the basis of a language's meaning. Rather, network protocols are developed from “outside” of the system's intelligence by the engineer. Whether we consider a communications network, a parallel O/S process, or the timing and electronics diagrams for multiprocessor applications, conventional approaches to network computing are unable to configure a network of any devices on the basis of the machines' intelligence. Alternatively, the GSM allows the KP to manipulate both the medium in which a communication occurs—the network technology—and the content of the communication (the application language) in a single “system” that operates simultaneously at the machine and application levels of computing.

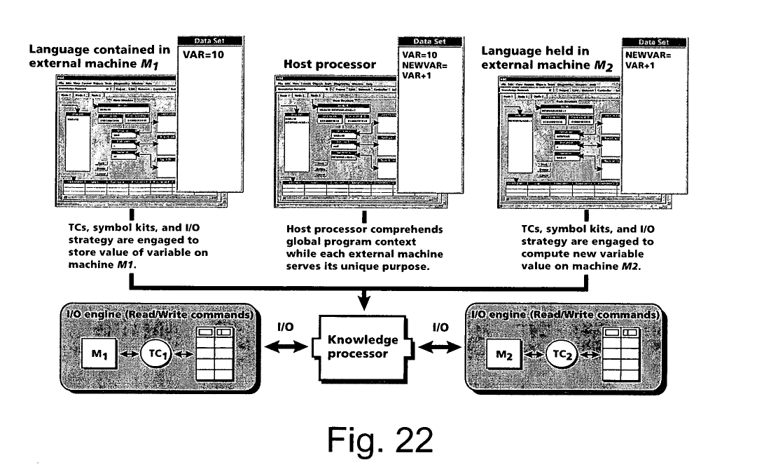

If we consider the global interpretation of language in a hybrid computing environment, as we did earlier concerning the I/O strategy, we can see that the GSM allows a Host processor to interpret any expression of language held in a data set and obtained through the Host processor's use of the symbol kits and TCs. Each PB in a data set of the knowledge network, which is operated on by the UPL functions, can represent any element of a global expression, which does not have to belong to any particular machine, and can in fact be distributed over any number of machines, as shown in FIG. 22. Concerning the global implementation of a programming language, such as C++, for instance, we can see that a statement such as a variable assignment (VAR=10) need not occur on the same machine in which, say, a computation using that variable occurs (such as NEWVAR=VAR+1), as shown. The knowledge network comprehends the statements, while the GSM, in connection with the symbol kits and TCs, outputs or inputs the PBs (and their external data structures) to the participating machines. The GSM is the KP's method of configuring a system based on the KP's ability to comprehend and alter global language while performing I/O with any external machine configuration through the symbol kits and TCs.

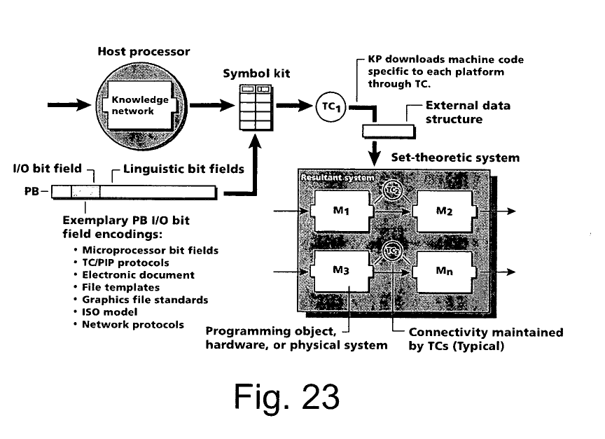

This feature of the KP is possible because the I/O bit field of the PB designates external machine structures, while the KP's intelligence and GSM determine how the KP will process external structures based on the meaning of a global expression, as shown in FIG. 23. The KP executes UPL modules in such a way that the TCs are downloaded with translation projects to connect the machines physically and logically. The global expressions may then be distributed across the platform according to the GSM's depiction of the system by downloading the relevant executable code to each machine and invoking the appropriate TC projects. (The GSM's storage and management of an external system's code is, of course, optional and in many cases unnecessary because the external machine functions autonomously. This additional capability, however, gives the GSM the ability to implement systems entirely from the Host machine.) Since the GSM anticipates the KP's ability to understand the meaning of an input expression, which is unknown before input begins, GSM control is derived from the KP's intelligence, just as is the case with human communications.

Once the programmable bytes are encoded with I/O bit fields, the KP can examine the contents of data sets in the short-term knowledge base and process knowledge according to the application or platform language. As a programmable byte is installed into a data set from one external machine, the PB can be examined and translated, along with programmable bytes from other machines, on the basis of a language's meaning or configuration requirements, or both. As long as the TCs are appropriately downloaded to connect system hardware and software, the data sets act as repositories for systems of language that are executed by the GSM and distributed globally. Network computing and parallel processing systems are thus accomplished by the GSM according to the KP's ability to understand the language being compiled into the hybrid computing environment. Since the I/O strategy, which determines the KP's use of symbol kits and TCs within UPL modules, executes any language over any incompatible machines, the KP controls the execution of a network's processes intelligently. Rather than rely on “token passing” or other network management methods, the KP can examine the content of a communication in order to “pass the token” (permit a machine to communicate with another) and enable machines to gain access to the others in the network. The KP can of course apply the same intelligence to the data frames, or “packets” in which the content is embedded, and act exclusively on the information contained in the carrier medium, or network protocol. The same system-level principles apply to the “enabling bit fields” of a microprocessor, wherein the KP manages I/O and processor interrupts on the basis of understanding the content of the language being processed by the machine's instructions and data. Concerning Internet applications, moreover, rather than impose only engineered network protocols on “B2B” communications, the GSM provides intelligent analysis of any communication transmitted over the World Wide Web. Since the KP is capable of translating any machine's protocols into those of another while comprehending a Web page, e-mail, or other electronic form, the KP serves as an intelligent communications manager that understands Web content and actually reads the millions of “hits” obtained from an Internet search. The GSM's ability to realize the component systems of an engineered network (i.e., to “build” computer systems), adds capability by enabling the KP to implement and manage external systems according to the KP's intelligence needs. (See also Section 14.5.)

3.4.1. Network Configurations Via the GSM

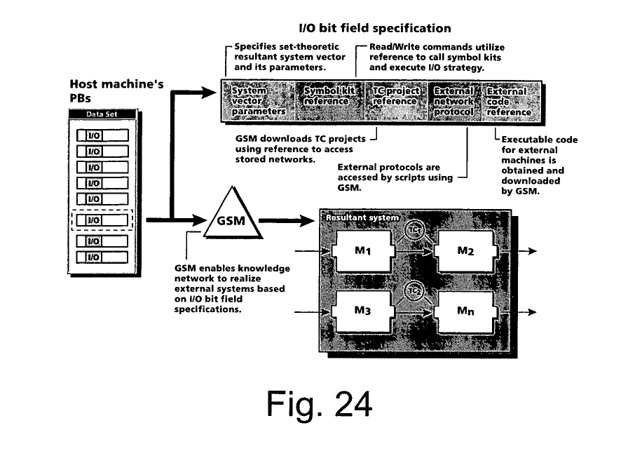

The GSM models and executes global language in a hybrid computing environment as a “system” by operating on the knowledge network's data sets and other structures to allow the KP to apply its intelligence whenever required. The GSM, which is interwoven into a project's UPL modules, distributes the PBs of a data set throughout the global computing network such that each PB represents a potential system realization—a system that is downloaded to external devices by the GSM to affect the external machine's functionality according to the GSM's design. An array of PBs residing in a data set thus represents a set-theoretic system vector, wherein each PB, when accompanied by the GSM's execution of TC projects and external code, is effectively an implemented and controlled system, as shown in FIG. 24. When the KP “writes out” a data set to an external system configuration, the PBs, or “systems,” are realized as components of a resultant system, as shown. The KP thus implements a hybrid computing system by writing out the contents of a data set (a PB array) to globally connected machines. When input to the KP occurs, the GSM acts as an intelligent network controller, examining the contents of messages sent by participating machines and allowing the machines to communicate with each other accordingly.

When external machines are viewed as autonomous programming “objects” interacting over a network, the KP executes a connectivity vector (a system that connects systems) to enable the machines to communicate. Thus, the KP's version of an object-oriented network protocol renders a network translator that connects incompatible machines via the KP's intelligent translation of machine or application code in the universal grammar. For each PB residing in a data set or another network structure member, the GSM implements a “system,” which enacts a system vector (of subsystems) and the system's connectivity with the Host processor and other external machines. Thus, for each linguistic element of an application language (a bit, a byte, or any symbol encoded into them), the GSM enacts a global interconnected set-theoretic system that realizes the symbol in external machinery. These system capabilities become important later on in the specification when we address the Rg Continuum. In the case of the continuum, many KP applications and GSMs are integrated in such a manner that each module, or user workspace, represents and realizes arbitrary systems and technologies using natural language interfaces. The continuum, therefore, is a GSM that incorporates other GSMs into its design, each of which translates universally with the others. Users interact with the continuum and the GSM through natural language interfaces that reflect the continuum's operation. (See also Section 14.)

3.4.1. GSM's Modified System Theory

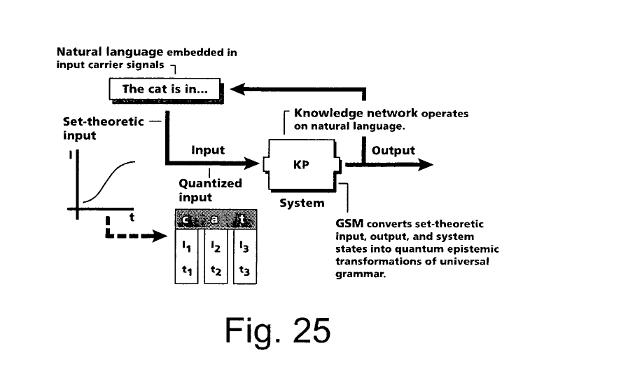

The best way to understand the more analytical aspects of the GSM, from an engineering standpoint, is to see the GSM as a set-theoretic (mathematical) system that incorporates a knowledge network's intelligence into its design. This distinction, however, requires a new definition for the “engineered system” because the KP's input and output are linguistic in nature; they are composed of natural language. The “Turing machine” approaches to intelligent systems, for example, do not account for a very important aspect of an intelligent system—namely, the machine's intelligence. Rather, conventional approaches to machine intelligence tend to define language as (or through) mathematics, thereby rendering machines that process language as “strings of data” that are seen as sequences. These approaches to thinking machines wholly ignore, for instance, the concept of a metaphor—and even further, the fact that language (its meaning) must be validated through another language (and a being's perception). Instead of expecting an intelligent system to be defined entirely using elegant set-theoretic mathematics, the GSM's modified system theory contributes the structure of the knowledge network to the engineered system, as shown in FIG. 25.

Whereas conventional discrete and continuous systems are defined as self-contained transformers of input and output (i.e., a system transforms input to output through system functionality, or the Next-state function), the GSM advances a modified system theory that incorporates the randomness of natural language and human experience into the design of a system. The GSM incorporates machine intelligence into a set-theoretic system, whereby the system is capable of understanding the content—the meaningful expression of language—embedded in the input and output. This feature of the GSM changes the definition of a discrete or continuous system such that the “objects” of input and output (the elements of a set) are symbols of any language that can be comprehended by the KP. (We should note here that, when the objects, or elements, of input or output are defined as linguistic entities, such as ASCII characters representing the English alphabet, the input and output become “language” anyway—the very phenomenon that a conventional system is incapable of understanding.) Accordingly, the GSM is a modified discrete and continuous system structure whose input and output must be comprehended by an intelligent device.

While drawing on the mathematical premises of classical system theory, the GSM is not entirely “mathematical.” Rather, it is founded as a system theory that in turn is based on a universal grammar that describes any language, including that of mathematics, by observing the mind's innate action on symbols. The GSM is defined according to the structure and function of a traditional set-theoretic system (a mathematically defined system according to set and group theory), with one important distinction: input and output occur, not on the basis of “next-state functions,” but on the basis of a knowledge network's intelligence. The system's input and output thus depend on the meaning of the language contained in input and output. Whereas a conventionally engineered system processes “signals,” and therefore can be told when to transmit a communication and what to send, the KP converts input to output (or does not respond at all) according to the meaning of a language's content.

The GSM defines a system as any entity that “thinks” and communicates in the universal grammar according to the knowledge processing methodology. Thus, in order to characterize the GSM's definition of a system, we must discuss the specification's topic—the KP—wherein the programmable byte and its use in the universal grammar's node (transformational) and grammatical form (objective) structures allow the KP to synthesize language in a carrier medium. When the global system model is depicted quantitatively, classical set-theoretic analysis suffices for the system (and sub-system) definition. When the systems are required to understand language, however, the knowledge processor's definition, structure, and function are incorporated by reference. In the middle somewhere, when a system must perform, say, arithmetic—a process easily handled by a classically defined system—either system approach can perform the task, whereby the classical system employs a next-state function and the KP performs mathematics abstractly, as the mind does. In this manner, the cognitive system is configured mathematically according to classical system theory, while its intellectual faculties operate on external input and output semantically (by using the TCs and symbol kits under a GSM). The key principle to appreciate about the GSM's system definition is that, in the case of the KP, linguistic operation leads mathematical definition, and not the other way around. As shown in the figure, conventional approaches to machine intelligence are led astray when attempting to construct a mathematical system that operates on language. Alternatively, the GSM defines a linguistic system that comprehends the meaning of the language embedded in the mathematically defined carrier medium (input and output). Thus, the GSM intellectually controls carrier signals by driving the mathematically defined system cognitively. While a GSM system is defined according to the conventions of classical set-theoretic system theory, the “elements of the set” (defined by classical system theory) are converted to Host-processor PBs for intelligent processing by the knowledge network. Thus, input and output trajectories (functions of input or output elements) are mapped into PBs (via symbol kits and TCs) and controlled by the network. As the network interacts with external machines, it does so by employing the full scope of classical set-theoretic system theory, except that I/O occurs on the basis of the KP's intelligent comprehension and manipulation of the language embedded in the I/O signals.

3.4.4 GSM Modes of Operation

In the modified systems environment of the GSM, the KP implements two principal modes of operation and system configuration—a Default Mode and an Existential Mode. The GSM's modes of operation assist the developer when constructing a knowledge continuum of intelligent people and machines. The modes are somewhat of a practical solution to the classical system theory vs. GSM modeling debate. They serve to distinguish between conventional externally imposed system configurations (the default mode) and internally driven system configurations (the existential mode). Since the default mode is fairly straightforward to explain because of its close ties to conventional system theory, we shall address it first.

The default mode of the GSM allows the developer to design networks and systems by tracking the bytes of external machines, using the I/O bit field of the programmable byte, in order to impose a system configuration appropriate for the developer's view of system requirements. Thus, any action performed on input or output by the knowledge network also takes into account the hardware and software to which the linguistic bytes relate externally according to the developer's design of the network. If we place a conceptual shell around the KP and make it a programming object, the default mode is simply an “intelligent object” that can interact with other machines on the basis of understanding the content of a communication according to the developer's use of that object. The developer builds network computers, whereby any global expression is compiled directly into the machine bytes of the participating systems. The GSM then governs the inputting and outputting of data sets, whose PBs are arranged to execute language globally according to the developer's specification of the system. When a UPL function reads or writes to an external device, for instance, the GSM reads the I/O bit field of the PB being output and executes the corresponding TCs to implement the developer's system configuration. Because the symbol kits, TCs, and external executable code are stored by the KP and downloaded to the external machines, the PB is viewed effectively as an “off-the-shelf” system that the developer can realize by instructing the KP, through the UPL functions, to output a PB array. When the system (PB or PB array) is executed, an appropriate download, or “realization” of a system occurs. The default mode's global system model is thus the linear arrangement of PBs in a data set or other network structure that is controlled by the developer's use of the UPL functions. As the Write commands of a UPL function output the PBs to external devices, the GSM acts as a network system controller that operates according to the developer's externally imposed I/O strategy.

The GSM's existential mode allows system execution to occur in relation to the “thoughts” held in the STKB or LTKB by the intelligent KP application (i.e., by a “machine-being”). Hence, the existential mode is a more sophisticated realization technique for interactive systems. When the PB data set contains not only a system vector but a PB sequence that actually is meaningful to the identity of the KP (i.e., relates to the pronoun I), the PB's execution of a system simulates a “thought” that is realized in an external device, such as a sense or motor. The “thoughts” embodied in the knowledge network are thus realized in physical reality by “reading them out” into actuators and senses in the KP's existential mode. This is how the KP realizes its own cognitive presence in physical machinery. The GSM's existential mode thus governs how an autonomous machine configures itself in a network of systems, or decides how to communicate intelligently.

While the subject of androidal science is beyond the scope of this specification, the relationship between the knowledge network's transformation of language and the realization of external, physical systems simply involves the system techniques discussed earlier for network technology, except that the methods are used in connection with a machine's autonomous manipulation of external senses and motors. The existential mode configures machinery external to the Host processor according to the KP application's sensory and communicative requirements. A KP application integrated into the Internet, for instance, would be able to comprehend language and perform semantic searches for a user, but without external senses and motors with which to perceive its own world, the application would not be able to validate its use of language through “experience” (i.e., through its own perceptions). The metaphors, similes, and other conceptual blending techniques employed in the KP's UPL translation functions would correspond only to other language, not to the “reality” of the application's perception. The existential mode is concerned with system configurations that formulate a KP application with senses and motors that enable the machine to perceive common experiences.

The KP's ability to understand a language's content allows the developer to configure systems based on the KP's intelligence. Whereas today's computing systems must be configured inflexibly because they are “dumb” (i.e., the computer cannot understand the carrier signal's language content), the KP can determine how, why, what, when, and where to input or output based on its intelligence. Since the KP actually understands language, its I/O is wholly unpredictable, as is a human communication (except in the default mode). Moreover, a sequential or parallel computer network configuration applies to the GSM only when the KP does not impose its own intelligence on the network. When the computing platform is imposed by the developer, the system vector acts as a computer or network configuration controller through which a serial or parallel hybrid configuration is executed to emulate the application on hardware. The system vector also represents, however, a “dynamic tracing” of the KP's thoughts in the existential mode. This system theoretic approach to computing permits the developer to construct KP projects using any desired platform or machine intelligence level. The TCs enable the hardware and logic of participating machines to interact despite language and architecture incompatibilities, while the KP analyzes input and output intelligently. The GSM expresses the system vector of the application language's global configuration, as distributed over any computing or communications infrastructure, and the TCs act as “hardware translators” for the application.

3.5 Summary of KDE Features

As mentioned in the Introduction, the Knowledge Processor “thinks.” It also exercises its intelligence in arbitrary computer or communications environments. In order to accomplish this enhancement to digital computing, a Knowledge Development Environment (KDE) is conceived and installed on an ordinary computer. The KDE converts the Host computer to one that operates in accordance with a semantic knowledge network that utilizes linguistically programmable machine bytes according to a universal grammar. The programmable bytes, configured into a knowledge network, allow the Host machine to understand language according to parsing and translating functions that are either programmed at the KDE by the developer or learned by the KP's running processes through the network's learning functions.

A KP application, or project, is concerned with both application and machine languages, while it implements a global computing architecture through the global system model (GSM). The GSM allows the KP's knowledge network to analyze and control global expressions of application and machine language using a system theoretic approach to language comprehension that tracks a language's elements via the I/O bit field of the programmable byte through a system vector. When used in conjunction with symbol kits (translation tables) that convert external data structures to PBs for Host-platform processing, the system vector enables the project's functions to utilize Read and Write commands (readers and writers) that exchange data with external machines according to an I/O strategy. Communication in a KP application thus takes place on an intelligent basis while using the knowledge network's intellectual faculties.

The translation cards (TCs), which are independent processors (KP applications) ranging in capability from microchips to network computers, provide hardware-level translations for the Read and Write commands, as the GSM executes the I/O strategy. Each UPL function in the knowledge network therefore operates on PBs containing arbitrary language independently of hardware, or “platform” requirements. The knowledge network analyzes language intelligently and the GSM accommodates communications and platform-related protocols.

Machine intelligence is provided through the KP's intellectual faculties, which are generically described as the I/O strategy, the lexical parser, the syntax parsing and translating modules, the language constructor, and the learning functions. The intellectual faculties are conceived initially by the developer at the KDE and are enhanced by the KP's learning functions as the KP processes language and (sensory) perceptions through the application. The functions are economized as “kits” that are viewed in terms of their operation on the universal grammar and knowledge network structures. In this manner, functions appropriate for widely divergent language styles can be used interchangeably, thereby reducing the effort involved with function development.

The UPL functions are constructed through AND/OR logic applied to the series or parallel sequencing methodology of the GSM. This approach to program logic allows the KP's functions to emulate the mind's action as it parses “streams of thought” (data sets) and translates epistemic moments of syntax trees reflecting its momentary comprehension of language, perhaps for the purpose of communicating with people or other machines. UPL functions are interconnected by the function Call command, which passes parameters to invoked functions to convey the KP's comprehension up to that point of language development or comprehension.

The KDE is the developer's window into the knowledge development environment for any system or enterprise activity. The KDE's project editor provides the various workspaces and tool bars necessary for each knowledge development activity. The developer enters relevant knowledge network requirements through a system of tabularized forms, rather than through free-style programming methods. The KDE is an appropriate and efficient method for knowledge processing because the KP—through the conception of the programmable byte—operates on the same type of “data structure” for any application, thereby eliminating language and technology conflicts.

### Section 4: Programmable Byte

4.1 Introduction

Perhaps the best way to understand the programmable byte (23) and its use as the basic processing unit of the knowledge network is to ask an obvious question concerning the basic tenets of computer science. Specifically, why is the digital byte defined as a “data structure,” instead of a “linguistic structure,” in the first place? Why not define a digital byte according to the lexical, grammatical, and semantic properties of a language, and then require the machine's operations to manipulate the byte according to how the mind conceives language innately? The programmable byte is the KP's answer to processing linguistically defined bytes so that any machine can understand language in the universal grammar.

The programmable byte enables the KP to analyze the linguistic properties of an application language's objects, such as characters, words, and phrases, and their epistemic moments, or syntheses, in a language's syntax. By encoding a given linguistic element's properties directly into the byte's bit fields, and then placing the programmable byte into the network's node and grammatical form structures for manipulation by the running processes, the KP is able to process language in the universal grammar. The PB allows a Host processor's binary operations to act thoughtfully on the linguistic objects and transformers of an expression by enabling any microprocessor or software to compare the encoded bit fields as they relate to the application or machine language.

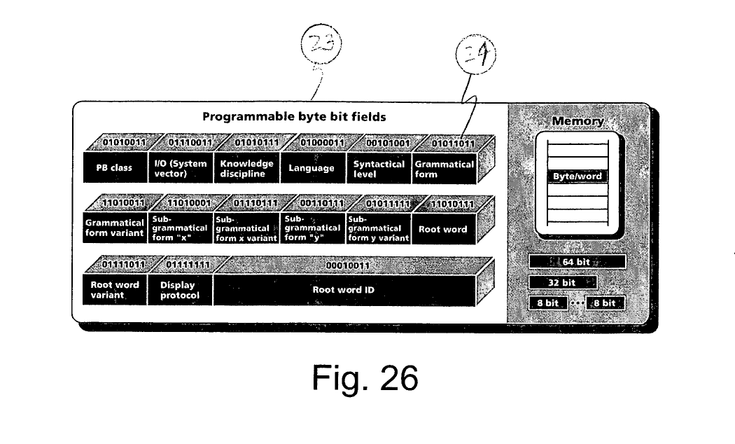

In memory, the programmable byte is both a logical and physical byte, defined ultimately by the Host processor's CPU architecture, which, in the case of the epistemic microprocessor, involves an entirely new design. The PB's bit fields (84) are programmed by the developer through the KDE and by the KP itself through UPL functions according to the desired linguistic actions to be performed on the input language. In the higher-level software versions of the KP, such as the CD/ROM version, the PBs are enabled by the data structures and commands of the enabling programming language (C++ or Basic) and usually are implemented as binary bytes (as opposed to character, integer, floating point, or other data types), as illustrated in FIG. 26. The PBs can be defined by using any byte or multibyte structures, providing that the Host microprocessor or software supports them efficiently.

The PB plays an important role in knowledge processing because the objects and epistemic moments of language (the elements of meaning) are defined through the PB's properties so as to allow the knowledge network to operate on the application language in the universal grammar using digital electronics. In general, the PB defines the application language's properties, as well as the locations and relationships among the knowledge network's semantic parse trees, such that any microprocessor can operate directly on a language's meaning—despite the fact that a given version may be formulated in a specific programming language or hardware system using its own primitive data structures. The PB's bit fields denote, in machine-readable format, the linguistic properties of an epistemic moment's objects or transformers, as defined by the grammar and semantic usage of the particular application language. The UPL commands thus operate on the linguistic properties of the application language, as encoded into the PB's bit fields, in order to manipulate the knowledge network. A programmable byte can represent the linguistic properties of a character, syllable, word, phrase, sentence, or other grammatical element of an application language in the Host processor's machine bytes (which are coupled to any external device through the symbol kits and TCs). The PB's external media can include, for instance, printed and spoken words, as well as musical notes and the visual effects of fine art, implemented by the appropriate enabling devices.

Since the PB is implemented as either a logical or physical byte, depending on the KP's version, a given Host processor's PBs are constructed by using the specific hardware or software capabilities of the Host machine. A “32-bit” machine (i.e., a machine whose CPU operates on 32-bit bytes), for instance, may use two physical bytes to implement a 64-bit PB, while a 64-bit machine would use one machine byte. An 8-bit machine would be limited by the byte's size and constrain the application's PB bit fields to the arbitrary partitions of the eight bits, unless of course, multiple bytes are grouped together as a higher-level data structure (i.e., into a multibyte “word” that would implement a 64-bit PB using eight bytes). Depending on the KP's version, the logical PB structure is determined by the architecture of the given Host hardware or software. Thus, the KP is implemented in hardware or software depending on the Host processor's capabilities. The PB's physical and logical arrangement in the Host processor is defined by a compromise between the architecture supporting the Host machine and the linguistic properties necessary to accomplish the application's knowledge network.

The PB's linguistic definitions allow any machine to bypass the software and machine language pyramid to perform linguistic operations on the application language directly in Boolean algebra. By selecting particular members (PB arrays) of the node and GF structures, and processing the PBs in relation to their syntactical and semantic relationships in the network, the KP achieves a synthetic method of thinking and learning according to the universal grammar. The PB's bit fields are encoded with linguistic properties useful to KP applications, whereby each application may require different PB bit-field definitions depending on the language processed. The following discussions introduce each of the PB's recommended bit field classifications and provides a basis for understanding the KP's network structures and intellectual faculties described in subsequent sections. The PB bit fields discussed are generalized in order to accommodate the broadest range of applications possible. Each particular application, however, requires diligent consideration of the application's requirements in order to minimize the amount and type of bit fields necessary for the given application.

4.2 PB Classes: Node and Grammatical Form Designator Bit Fields

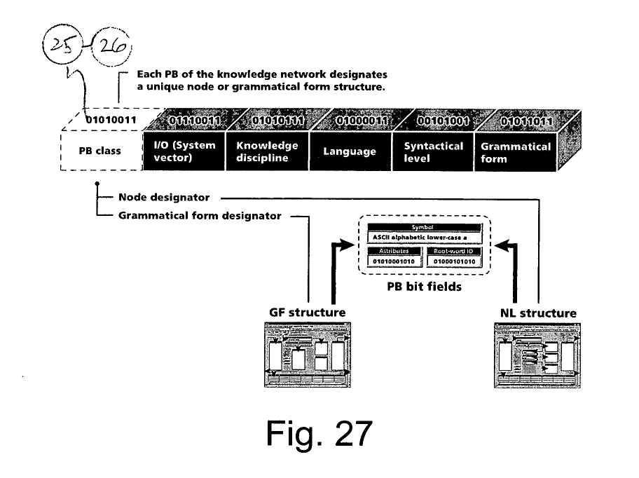

Each PB of the knowledge network serves—at least—a dual purpose. On the one hand, a PB is a container for the GSM's system vector and the linguistic properties of the application language. (The “application” language can also be a machine language, as discussed earlier.) On the other hand, each PB has a unique relationship to the other PBs in the knowledge network in order to formulate the KP's intelligence. In order to designate a PB's principal role in the network, it is classified as either a Node Designator (25) (i.e., a “label,” or name referenced to obtain a transformer of language, or node structure), or a Grammatical Form Designator (26), or label (i.e., the name of a grammatical form structure, or object of language). Using the node and GF designators, the KP's running processes can analyze a PB's bit fields to determine whether the PB represents a node structure (transformer) or grammatical form structure (object) of language in the network. (The node structure is also referred to as an NL Structure.) Thus, each PB in the network, while it may be used in many locations throughout the network, designates a unique node or grammatical form structure, as shown in FIG. 27. The PB's node and grammatical form designators are also referred to as the Node Label AL) and Grammatical Form Label (GF Label) of their respective network structures.

4.3 I/O Bit Field

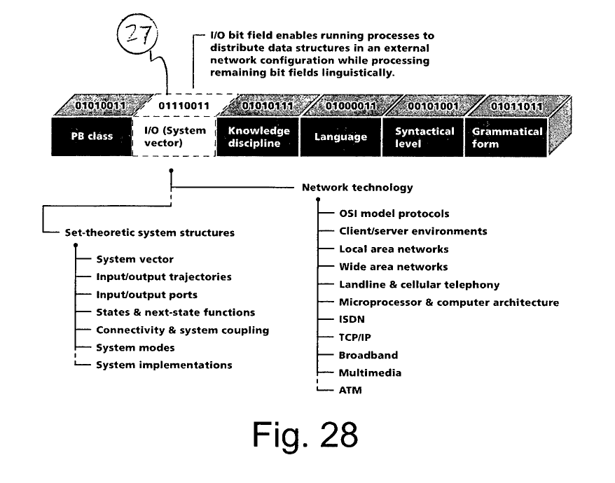

The most significant bit field of the PB, at least from the standpoint of relating the Host's bytes to other machine languages under a GSM, is the I/O bit field (27). Through the I/O bit field, the KP can reference and analyze coding schemes that represent the software or hardware protocols that operate on the PB's meaning in external platforms. The I/O bit field can represent something as simple as a communications protocol (i.e., file “tags,” such as the headers and trailers of an EDI/XML protocol or the data frames of a communication system) and as complex as a set-theoretic system with its system parameters, including system vectors, I/O ports, connectivity, and system modes, as shown in FIG. 28. When the KP examines a particular PB on the Host processor for the linguistic properties of the application language, it can concurrently evaluate the PB's external system configuration protocols through the I/O bit field.

When the KP operates on PBs associated only with the Host processor, the I/O bit field designates the system properties of the Host processor. On the other hand, when the KP operates on PBs that represent other machine structures, and ultimately application languages, the I/O bit field designates the system configuration properties of the machines from which the PBs'symbols originate. The I/O bit field is therefore especially important when the KP is processing applications that are integrated in a hybrid hardware or software environment. In a given computing environment, the UPL functions are written so that, during parsing and translating operations, the PBs can be manipulated by using the system configuration parameters for the external machines that utilize the PBs. The Host processor therefore interprets a global expression of the application language, which is obtained from the distributed external machine configuration.

The I/O bit field is especially relevant, for instance, in communications and Internet applications, since any communication device, along with any software running on the device (such as a Web application), can be specified by the PB's I/O bit field, while the knowledge network operates on the language's content meaningfully using the remaining linguistically defined bit fields. The I/O bit field allows the KP to manipulate any language used on external devices through its own knowledge of the external system configuration. The KP thus comprehends a single idea whose linguistic elements are expressed in a variety of machines configured in a network topology by manipulating both the I/O and linguistic bit fields. The I/O bit field is also used to integrate microprocessor hardware when encoded with the enabling bit fields of the given microprocessor architecture.

FIG. 4. Knowledge Discipline Bit Field

The PB's highest-order linguistic bit field is reserved for the Knowledge Discipline (domain) (28), or Intellectual Faculty, in which the byte's other properties are classified. The knowledge discipline bit field is a higher-order PB bit field than, for example, the language bit field (explained next) because a particular knowledge discipline, or intellectual faculty, may require multiple languages and their respective grammatical forms in order to express a given thought, such as what occurs when an arithmetic statement is explained in natural language (requiring both spoken language and mathematics as a language).

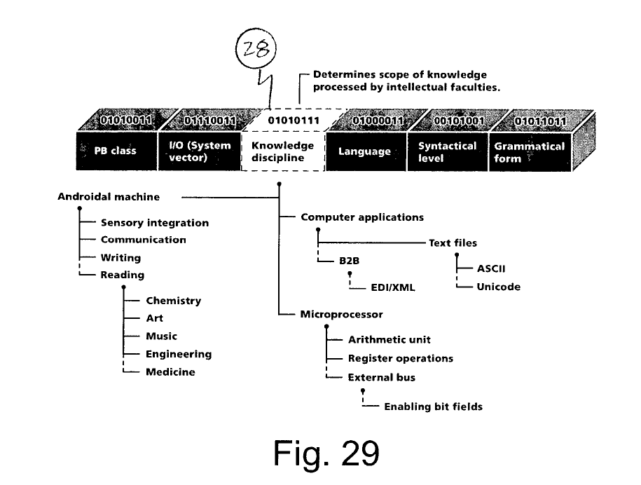

FIG. 29 illustrates that the knowledge discipline bit field represents a faculty of mind—a particular way of thinking about the objects and transformers of a language. The knowledge discipline bit field represents a class of linguistic elements that is used to formulate any number of participating languages. The figure shows, for instance, that the symbols used to understand chemistry (herein a “language”) can appear meaningfully in many different natural languages. If, at the broadest possible level of the machine's comprehension, we classified the elements of a chemical equation (the PBs) differently from, say, those used for the English language, the KP would effectively have to delve into a new “knowledge discipline” to understand an expression that contains only symbols concerning chemistry. In order to avoid this potential conflict, PBs are defined as belonging to particular knowledge disciplines while they may function in different languages. This PB bit field allows the KP to evaluate language on the basis of what particular knowledge discipline, or intellectual faculty, in which a language is used. A given application may require only one knowledge discipline when, for instance, the KP operates in modalities of thought belonging to a single method of cognition, or may require many knowledge disciplines, as is the case when the KP implements several faculties of mind that operate effectively as different ways of thinking, each of which excludes the other. The particular mix of intellectual faculties formulates the basis for an androidal machine's “personality,” or unique blend of intellectual capabilities (UPL functions).

4.3 Language Bit Field

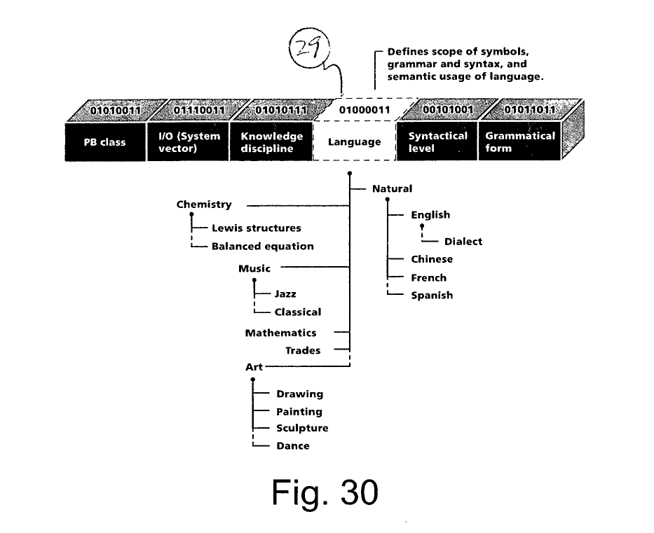

The PB's Language bit field (29) classifies the grammar and semantic usage of a language's elements—whether that language is English, Chinese, fine art, or music (still, however, languages), as shown in FIG. 30. The language bit field classifies a group of PBs in order to assert that the grouped units will be used syntactically or semantically within the “language's” PB bit field definitions. (We should note here that, while the PB's other linguistic bit fields do not encroach upon the properties defined by the language bit field's encoding, the running processes can place any PB into another language's context in the network's structures.) The language bit field thus broadly classifies the PB bit fields remaining to be discussed, such as the language's parts of speech.

In order to demonstrate the properties of the language bit field, we can use the example of the knowledge discipline above by illustrating the use of the letter c in multiple languages. If the character c were unique to any one language, the KP would not be able to apply the parsing and translating kits designed for another language because the character would “belong to” that one specific language. We therefore classify the more broadly defined bit field for the character as a knowledge discipline while specifying each language's unique use of the character according to the specific language bit field class. By assigning any language's use of the symbol c to one particular knowledge discipline while allowing each language to interpret the character (image) according to its own grammar and semantic usage, the same knowledge discipline (faculty of mind) can understand multiple languages from the single sound or shape conveyed by the letter c in a given sensory medium. Ultimately, the knowledge discipline and language bit fields allow the running processes to operate as faculties of mind that can easily formulate ideas in any language simply by transitioning from one language to another under the same knowledge domain.

4.3 Syntactical Level Bit Field

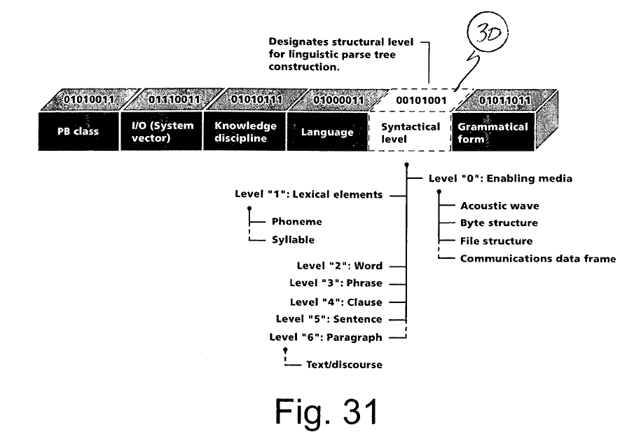

Another type of PB bit field, the Syntactical Level (30) of the PB, defines the “level” at which the PB synthesizes the elements of language according to the universal grammar. The syntactical level of a PB specifies the relationship of one class of syntactical expressions to another class in a given application's knowledge domain and language. The syntactical level stipulates, for instance, that the PBs can represent either characters, syllables, or words, and then, at still other syntactical levels, represent phrases, sentences, or even external machine bytes or sensory apparatus, as shown in FIG. 31. (This relationship is explained in an earlier discussion in Section 3 concerning the synthesis of the article the.)

An arbitrary level 0, for instance, can be assigned to PBs that represent external ASCII or Unicode machine bytes—or even graphics files representing characters in other machines. A syntactical level 1 can then designate the actual characters (or phonetic symbols) represented by the bytes, as they are used in a specific language's expressions. Level 2 can be used to represent a word (or syllable) of a language as expressed using the characters (level 1). Levels 3 and up can provide the syntactical relationships necessary to synthesize the printed words (or sounds) originating from levels 0 and 1 into higher-level syntax, such as phrases, sentences, and paragraphs. This feature of the PB allows, for example, the concept of a sentence in a particular language to be translated into the concept of a word in another (or the same) language by changing the PB's syntactical level. In this case, the KP relates the grammatical units of one language to those of another, perhaps without the formal grammar of either language, or without any other relationship between the languages being considered, simply by interpreting corresponding syntactical levels in the universal grammar. (This condition occurs frequently when English words are translated into Chinese phrases or vice versa.)

4.8 Root Word Bit Field

The PB's bit fields also define the Root Word (31) of a language element—the abstract topic defining the human perception or experience associated with the PB in the knowledge network. The root word bit field is best understood as an electronic enhancement to an ordinary dictionary's or thesaurus' taxonomy of words. The root word's classification of a language's symbols, however, is more comprehensive than that of traditional linguistic theory because the root word bit field incorporates the universal grammar into its premises. The root word bit field represents an entire class of node or grammatical form designators (labels) whose meanings are obtained as follows.

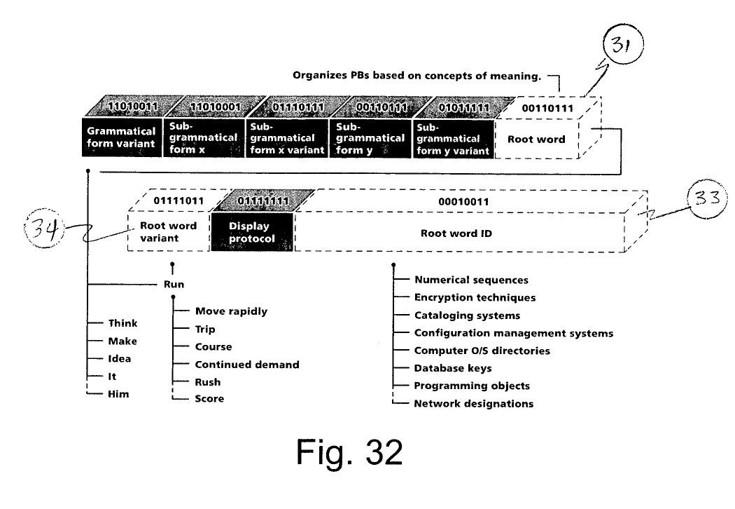

The universal grammar requires that any language's elements (such as words) cannot have “meaning” unless a network of epistemic moments (parse trees of a knowledge network) exists with which to compare the words in meaningful context. A “word,” then, must be defined such that an observer, or in the KP's case, a processor, can interpret the word's meaning in the context of a knowledge network of other words and expressions. A word's meaning, according to the universal grammar, is derived from its placement in a particular context in a knowledge network; the word's meaning is the action of a knowledge processor. Since a standard dictionary presents relationships between words and their definitions in a printed medium for observation by a reader, a person can intelligently place a word's meaning into context. The dictionary itself, however, is incapable of containing, or understanding, meaning because it is not a being; it is an inanimate object containing printed words. The root word bit field therefore defines the scope of experience a being would perceive or understand in association with the PB's externally displayed symbol. The PB's root word thus does not define a word's “meaning” (which is obtained only through the word's usage and interpretation in context by a knowledge network). Rather, the root word bit field defines a category of experience or perception for the purpose of allowing the developer or the KP to compare and sort PBs according to categories of perceptions, as shown in FIG. 32.

Thus, the root-word bit field specifies an entire spectrum of semantic relationships (discussed below) that help guide the KP through its basic knowledge processing skills to place a PB into the context of the knowledge network—independently of the knowledge network's innate intelligence. Each verb in the expressions I run, We run, and They run uses the same root word bit field but different bit fields for the PB's grammatical usage. If a particular noun run (as in baseball scoring) belongs to the same topical class (root word) as that of the verb run (as in moving one's legs quickly), then the root word of (baseball home) run will be the same as that of the verb using the word run (as in running, ran, will run, might have been running, and so on). If, however, the noun run (as in a baseball home run) is considered to be closer in meaning to the words sports, victory, score, and so on, then the noun run would belong to a different root word class from that of the verb run (as in the aerobic activity). Again, since the root word bit field is an auxiliary feature to the KP's ability to understand language (i.e., it is the network that actually understands the meaning and therefore the semantic relationships of the word's usage in context, not the “root word” meaning), the root word classifications provide a general taxonomy for the semantic categories used for the network's PB structures.

In many simplified knowledge processing applications, such as those involving computer and Internet languages, the semantic properties of the languages are unambiguous. There is only one “meaning” (semantic category) for each word, and two or more words cannot use the same root word. In these cases, it is unnecessary to associate multiple PBs through the same root word bit field. Accordingly, the root word bit field can be employed as an identification label (ID) for the PB, as well as for the root word, thereby uniquely identifying the PB in the context of all other PBs, as shown. (This encoding is similar to that of a database's “primary key.”) Each PB in this case incorporates a different root word bit field—a Root Word ID. The advantage to these applications is that the root word bit field and the root word ID bit field (discussed shortly) are one and the same unit. Other applications must distinguish between a root word meaning (the “root word”) and a PB's unique identification in the network (the root word ID).

The general case of semantic PB classification and identification requires the specification of both the Root Word Bit Field (RWBF) (32) and the Root Word ID (RWID) (33). While the root word bit field uses as many bits as are required to define the amount and type of topics represented by the application language, the root word ID uniquely identifies each PB in the knowledge network. There are generally many more root word IDs in a given application than there are root word bit fields. A given node or grammatical form label (designator) in the knowledge network therefore belongs to a particular root word category and is identified by a unique RWID, as shown.

A root word bit field possesses a sub class of bit fields called the Root Word Variant (34), which corresponds to the sense of a word's definition, as shown. The root word variant classifies PBs having different senses but the same overall meaning. Thus, the root word for the PB of the word run classifies both nouns and verbs when intending to mean the topic of running, while the root word variant classifies subcategories under the senses of the word run, as in tear (in one's stocking).

While the KP's ability to understand the meaning of language is enabled through its use of the knowledge network (discussed throughout the specification), the PB's root word bit field (and RWBF variant) allow the KP and the developer to classify linguistic elements on the basis of semantic definition. The root word bit field allows the developer and the KP to organize a language's meanings, while the root word ID uniquely identifies each PB in the network for processing requirements.

4.8 Grammatical and Sub-Grammatical Form Bit Fields

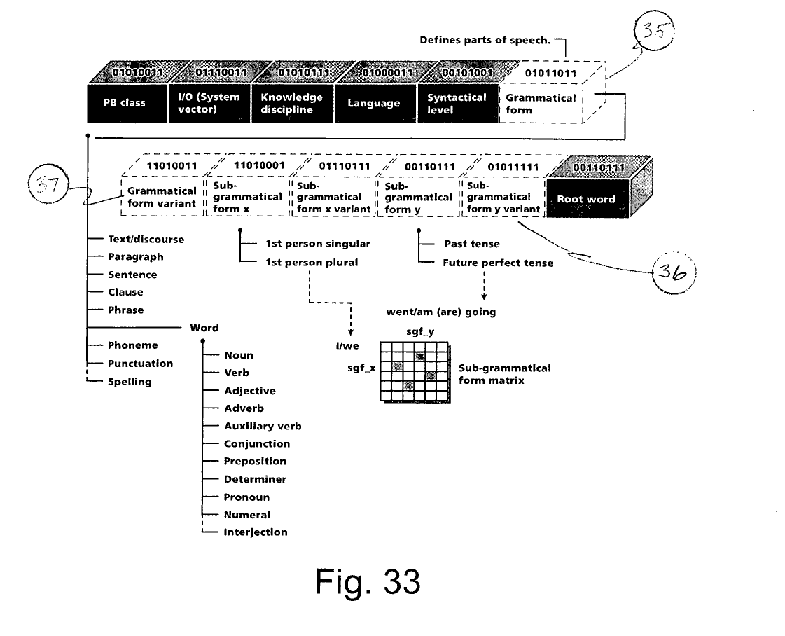

The classification of a PB's grammatical function in a language's syntax is accomplished by the Grammatical Form (gf) (35) and Sub-grammatical Form (sgf) (36) bit fields, while the traditional meaning and sense of a word are designated by the root word and root word variant bit fields. The PB's gf and sgf bit fields determine the traditional parts of speech in the universal grammar (i.e., the elements of grammar that allow the mind to understand language), as shown in FIG. 33. The gf and sgf bit fields apply to the lexical, phonetic, and visual aspects of symbols as well as their sentence structure and compositional style. (The PB's gf and sgf bit-field acronyms should not be confused with the designations used for the GF labels and structures of the network. Lower-case letters are used to refer to the PB's grammatical form bit fields, while upper case letters represent the knowledge network's structures.)

A standard grammar's definition of a part of speech may include a verb, noun, adjective, or any other functional element of a language's syntax. The KP's gf and sgf bit fields, however, describe both the conventional properties of a part of speech and its function in the universal grammar. The gf and sgf bit fields allow the KP and the developer to analyze a PB according to its grammatical function in a language's syntax, whereby the grammatical operation and structure are defined also in terms of their placement in an epistemic moment of the universal grammar. According to the universal grammar, when the same noun phrase the cat is expressed as either the subject or object of a simple sentence, a different grammatical form bit field designates each part of speech even though the phrase the cat is the same in both cases. The extra effort placed into defining language through the universal grammar allows the UPL functions to manipulate the forms of language according to the mind's moments of comprehension. Thus, according to the universal grammar, the English noun phrase the cat would not mean anything and could not possibly obtain a grammatical functionality until placed into the mind's transformation with other words or phrases (i.e., into an epistemic moment). The gf bit field thus defines a grammatical form in both traditional grammar and the universal grammar. The Grammatical Form Variant (37) bit field defines any essential variation of the PB's grammatical form. The gf variants of a verb, for instance, could be intransitive and transitive.

The Sub-grammatical Form of a PB classifies a grammatical form's syntactical usage in a range of context in which the element can be found. The count, case, gender, and other properties of a noun, for instance, are sub-grammatical forms of the noun because the properties interact with those of other grammatical forms to determine a precise syntax, as shown. A simple sentence's subject and verb are determined jointly, when, for instance, the first person plural (we) is used in conjunction with the future perfect verb tense (are going). (Proper English grammar would not permit the expression We am going, for instance.) The sub-grammatical form bit fields are used to develop matrices of syntactical order in which any possible combination of the parts of speech is defined, as shown.

The PB's sub-grammatical form bit field thus allows the developer and the KP to define a grammar's syntax to any level of linguistic complexity. The English verb run, for example, is typically used in hundreds of combinations with other phrases in English sentences. The first person singular, I run requires a different form of the verb run from that of the third person They run. Another example of the sub-grammatical relationship might involve a translation of English into another language, such as Russian, wherein different verbs are denoted for each of the above cases in Russian. If the KP did not encode different sub-grammatical forms for the verb run's usage, it would be unable to translate the particular word using just the PB's encodings. (The PB bit fields are frequently used by the developer without the KP's intelligence. In this manner, many translation systems for both computer and natural languages are possible without creating a proper knowledge network.) Many languages, such as programming languages, do not require sub-grammatical forms at all because each word of the language usually has a unique grammatical form. In these cases, the gf alone describes the element's grammatical function. In order to elaborate on a particular application's gf and sgf bit fields, one would refer to a noteworthy textbook on the related language's grammar. Moreover, a grammatical form (gf or sgf) does not have to be associated with a natural language. A piano's musical note middle C is a “grammatical form” of a melody or chord. A color wheel of fine art determines an infinite matrix of grammatical forms called “colors” (i.e., hue, chroma, and value). This matrix of colors can be used in connection with shapes and contours to produce the KP's renderings of fine art in the universal grammar. Accordingly, the sgf bit fields are referred to as “x” and “y” rows and columns of the matrix, respectively, whereby any matrix becomes n-dimensional depending on the complexity of the grammar involved.

4.9 Node Designator's Root Node Bit Field

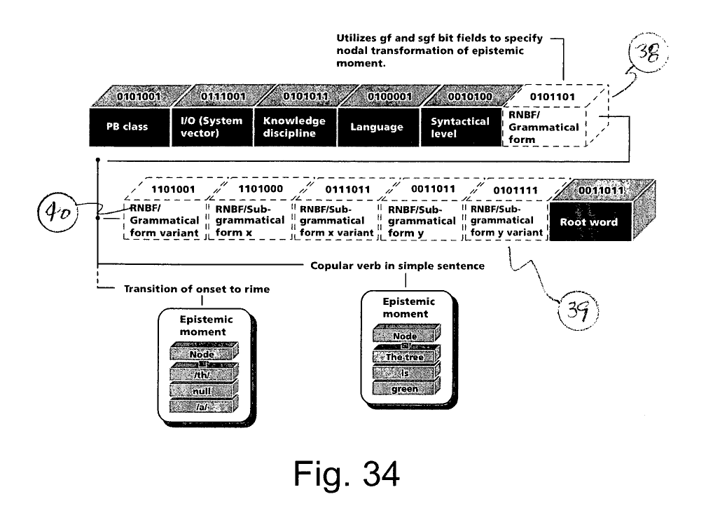

In previous discussions, the PB's bit field properties have been described generally in relation to the PB class of grammatical form labels (GFs)—the PBs that describe the universal grammar's objects of language. The properties of the bit fields, however, also apply to the node label class of PBs—with one important distinction. The PB bit fields that describe the node label's properties define the transformational aspects of a language's epistemic moments. The node label related PBs utilize PB bit field properties that define the universal grammar's transformations, since there is no proper conventional “grammatical form” of an epistemic transformer. The principal bit fields used to describe the node label class of PBs are the standard gf, sgf, and gf variant bit fields, referred to, however, as the Root Node (RNBF) gf, sgf, and gf variants (38, 39, and 40) of the node label, as shown in FIG. 34. The node label's other bit fields are defined similarly to those described earlier for the bit fields in general. Concerning the word run, for example, while the GF label's grammatical form would specify a verb in the sentence I run fast, the node label's root node gf (RNBF) would designate the action of the absent phonetic transformer null in the pronunciation of the word run, as in /r/-null-/un/.

The reason for designating the gf and sgf bit fields of the node label as root node properties is that the grammatical form label (GF) classes of PBs represent the objects of language, while the node label classes of PBs describe the epistemic moments of language. The gf and sgf bit fields of the node label are thus better understood as “root nodes” of the epistemic parse trees than as grammatical forms that would otherwise describe the objects of language. In order to clarify this point, we can reconsider the article the from an earlier example. The gf and sgf bit fields of the word the (for the grammatical form label of the word the) represent the grammatical object the in a phrase's or sentence's syntax. The transformational action of the onset and rime of the word the (/th/-null-/â/), however, is represented by the node label's root node gf in order to signify the phonemes' transformation in a lexical sentence, thereby creating the word the in the knowledge network. (We can recall that the node label relates the three grammatical form PBs in the epistemic node triplet to the one grammatical form PB in the sentence-level syntax using the word the.) The root node gf and sgf therefore describe the transformational properties of the epistemic triplet, while the gf and sgf properties of the GF label define the grammatical objects of a language's syntax, as shown.

The “grammatical form” of a transformation of language thus reflects its “root node” in a parse tree of epistemic moments that begins (at its “root” epistemic node) with the transformation, or triplet, considered. The RNBF explains the relationship between the metanouns and metaverbs of the epistemic moment in the universal grammar. As another example of the use of the RNBF, let us consider the lexical properties of the word apple. Taken as its own sentence, many variations of the word's internal lexical syntax are possible, all of which are legitimate constructions in the universal grammar. Excluding phonetic and other grammars, one possible interpretation of a parse tree's root node suitable for the lexical sentence operates on the printed letters as follows: (a) (null) (pple). The very next moment, however, does not have to be (p) (null) (ple), as would be the case in a conventional string analysis produced by a computer. Rather, the next moment can be constructed as (pp) (l) (e), suggesting that a word can be recognized in any manner desired by the mind, including ways that are convenient for a linear string analysis by a computer. The point to consider here is that the RNBF defines any language comprehension by describing the transformational properties of the many types of epistemic moments found in the universal grammar's parse trees—even one type to recognize the first transformation of the spelling of a word (or parse tree) like apple. The RNBF thus classifies node labels by the grammatical forms and sub-grammatical forms, or root nodes, of their transformations in parse trees.

4.10 Display Protocol Bit Field

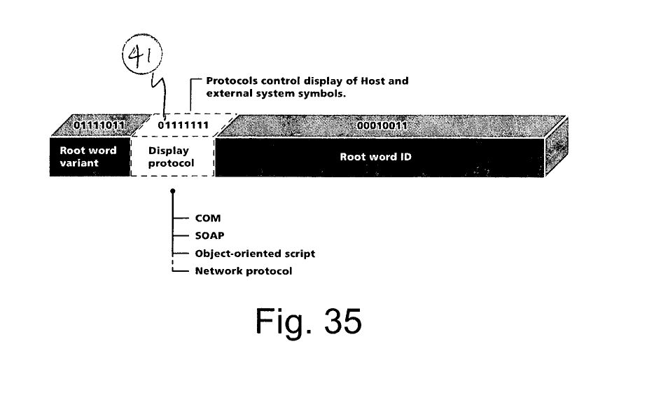

The Display Protocol bit field (41) relates to the sensory display of the actual linguistic symbol associated with a given PB. Since the PB is designed for linguistic encoding, the symbol it represents is, for all intents and purposes, somewhat irrelevant to the knowledge network's manipulation of the PB. As is discussed in the following section, the KP therefore employs “on- and off-platform” symbolic displays, which differentiate a symbol's meaning (via the PB bit fields) from its display in a sensory medium. The display protocol bit field is used by the running processes, and by the developer through the KDE, to engage the Host processor or external machinery in order to display the symbol associated with a given PB, as shown in FIG. 35. The display protocol is used in a similar fashion to the I/O bit field because it specifies the protocols necessary to engage software or hardware that displays the symbol. A symbol's display can be executed by the GSM using the display protocol bit field in any sensory medium, including acoustic, visual, and tactile sensory displays.

4.11 Summary of PB Bit Fields

It can readily be appreciated that the programmable byte, as a fundamental linguistic unit of knowledge processing, allows the KP to analyze the application language's grammatical and semantic properties in the universal grammar just by examining the PB's bit fields. The PB's structure allows digital logic to compare the linguistic properties of the application language's elements, rather than operate on the properties of “data structures” defined by programming languages. By omitting the application language's linguistic properties from the basic unit of processing and defining machine-specific properties for the bytes, today's computers constrain the CPU's functionality to that of processing only machine languages and software, which are typically characterized by the ubiquitous “characters” (ASCII or Unicode), “integers,” “floating point numbers,” and “binary” bytes used by most processors. The PB bit fields represent the KP's first level of intelligence by permitting the KP to compare the objects and transformers of the universal grammar via the UPL commands. Since the PBs are programmable units of memory, any language's properties can be defined by the bit fields and analyzed by the UPL commands and functions using any Host machine's hardware or software.

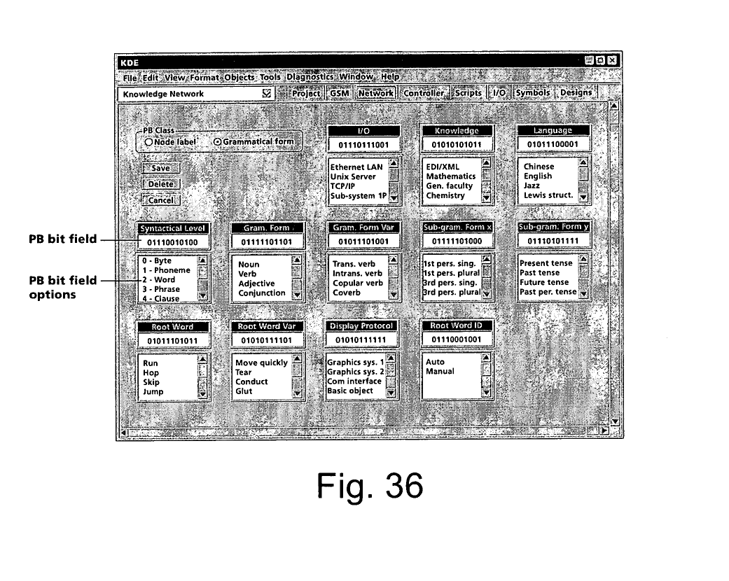

Instead of requiring developers to create applications according to a given industry standard for a processor language, KP technology allows any language to be encoded directly into the processor's bytes. This flexibility allows the UPL commands, which select, compare, and change PBs in memory, to operate on any grammar or semantic usage of a language in the context of the knowledge network's intelligence. Positioned within the epistemic network structures discussed in the following sections, the PB serves as a universal linguistic “atom,” or primitive structure, for parse trees and their syntactical and semantic relationships. The KP can imagine new objects (PBs) or alter existing objects in the network by creating or modifying the PBs. This feature makes the KP's use of language “self-sustaining”—meaning that an outside source of intelligence, such as a computer programmer, is not required for the KP to learn new knowledge by creating and modifying language elements. By using the PB in conventional programming environments, the developer is able to overcome language and technology barriers simply by defining PBs that are processed by simplified intelligence modules and exchanged with other machines through symbol kits and TCs under a GSM. In a B2B e-commerce environment, for instance, the KP exchanges and translates external data structures by converting them into PBs through the symbol kits and TCs, using the GSM to perform network communications, while exercising the network's intelligence to understand the linguistic structures globally. The PB, however, is designed to be processed by the knowledge network in more sophisticated androidal applications that relate to a machine's use of integrated senses, such as sight, sound, and touch. (These applications are discussed later in the specification.) The PB bit fields are created and modified by the developer through the PB Settings screen shown in FIG. 36. The KP creates and alters PBs through the UPL's Create (PB) and Set (PB) commands introduced in Section 6.

### Section 5: Knowledge Network Structure

5.1 Introduction

The various principles and structures described thus far allow the KP to process epistemic moments of language and their relationships within the network, as constructed from PBs, in a manner that emulates the mind's action. Since the KP's operations are based on the PB, which in turn, is formulated from a digital circuit that receives binary input, the mind's cognitive processes, as explained by the universal grammar, are performed by a digital circuit or software to formulate a “knowledge processor” (42)—a knowledge network made of synthetic material that thinks and learns. While other, more global aspects of knowledge processing, such as the Rg knowledge continuum, are explained later in the specification, the present section is intended to define the knowledge network's basic architecture and operation and to give the developer exposure to the detailed structures that enable the KP to perform in any computing environment.

5.2 Input, Output and Symbolic Displays

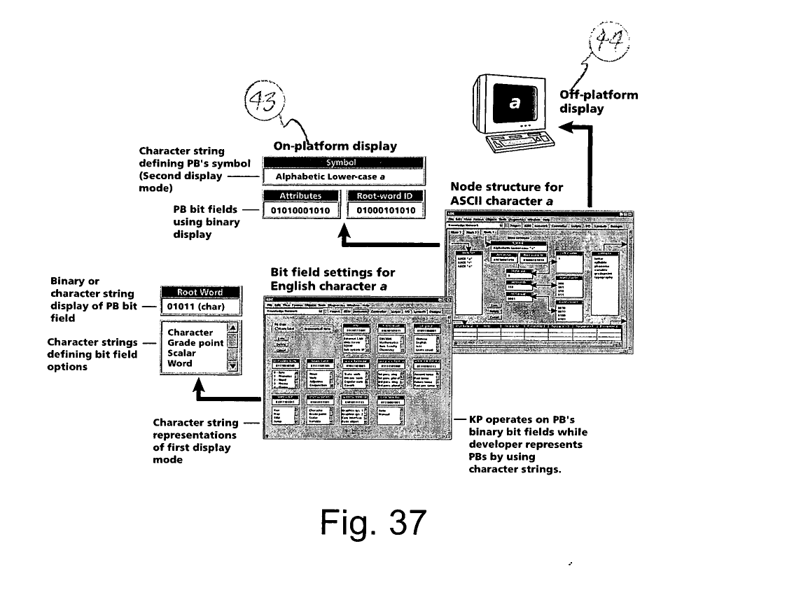

Before considering the linguistic structures that enable the KP to process language intelligently, it is important to introduce a design approach used in knowledge processing to handle the physical display of a language's symbols. This display methodology, referred to as the KDE's on- and off-platform displays, is important to the KDE because it enables the developer and the KP project to represent an application language's symbols independently from the knowledge network's operation on the symbols' grammar and meaning, as shown in FIG. 37. This essential feature of the KDE allows the KP to manipulate language cognitively, according to the mind's universal grammar, while communicating a language's symbols in an arbitrary sensory medium. The KDE, along with any KP application built from it, distinguish between the physical media required for the knowledge network to perform linguistic processes on the PBs and the sensory media that display the language's symbols.

This metaphysical approach to symbolic displays, which is modeled on the action of human communication, is what gives the KP the ability to “think silently” about the meaning of language while engaging UPL functions and the GSM to communicate through the physical display of symbols according to its own volition. The display system also enables the developer to define and alter PBs and network structures in the KDE by using language conveniently expressed by the developer, while the KP operates on PB bit fields and network structures defined as zeros and ones. The on- and off-platform displays give the developer insight into why the network and the GSM do not necessarily input and output like Turing machines (character string generators). The KP processes a language's meaning and thus communicates based on internal cognitive requirements, rather than executing network or set-theoretic system protocols that arise from the developer's formulation of application symbols. The on- and off-platform display methodology enables the KP and the developer to understand a computer's executable code in natural language.

In the KDE, a language's symbols are arbitrarily composed in any sensory medium, while the KP operates on the symbols' grammar and meaning in isolation from the symbolic display. In contrast to the “embedded byte” approach of conventional processors and software, wherein a symbol's meaning and sensory embodiment are accomplished in the same processing unit (the byte or software structure), the KP detaches a symbol's sensory representation from the symbol's grammatical and semantic functionality in a given language. This separation allows the KP to understand what any symbol used on an external machine actually means, in terms of the Host processor's use of the symbol as a PB, and then display the symbol independently on the Host or any other machine according to sensory requirements.

5.2.1. On-Platform Display

The KDE's On-platform Display (43) enables the developer to depict graphically any symbol represented by a programmable byte, as well as to interpret the PB's bit field properties in arbitrary symbolism using only the Host machine's graphics or other sensory capabilities. The symbols associated with the Host processor's PBs (the application language's and the PB bit fields' symbols) are displayed by the KDE through a specialized GSM intended to use the Host processor's hardware and software for symbolic display. The on-platform display operates according to two key modes of symbolic representation in order to allow the developer to understand the PB's definition and use in the network structures.

Referring to FIG. 37, the first mode of the KDE's on-platform display involves the representation of the PB's bit field properties in binary code, as well as in natural and other languages. This mode displays the PB's bit fields according to the actual binary code, or bit sequence, used for the programmable byte. The display mode presents the actual binary sequence of the bits comprising the programmable byte—the arrangement of zeros and ones operated on by the Host processor's knowledge network. The first mode of the KDE's interface also provides translations of the bit sequences into other number systems so that the developer can view the PBs in a number system of choice, including hexadecimal and base-ten numbers (if, of course, the PBs must be interpreted according to a number system at all). Additionally, the first mode of on-platform symbolic display presents the developer's definitions of the PB's bit field attributes in natural and other languages. This symbolic display utilizes character strings and other graphical or sensory data structures available to the Host processor to depict the bit field designations.

The second mode of the KDE's on-platform display involves the representation of the image or other sensory object (such as a sound) that the developer perceives through the KDE interface as the application language's (actual) symbol, which is processed semantically by the knowledge network as a PB (such as the character symbol a in the word apple). The on-platform display associates a composition of symbols with a given PB. In this manner, the developer can view the machine-level representation of the PB (of the bit fields) through the on-platform display's first mode, and the symbol representing the application language through the second mode concurrently. This display option is shown in the edit boxes entitled symbol, attributes, and root word ID in the figure.

Thus, in a single graphical interface, the developer visualizes both the binary code for the PB (along with its optional bit field attributes) and the external symbol which the PB represents in the knowledge network. This interface methodology allows the developer to consider the application language and the knowledge network's representation of the application language in digital format independently of each other. The grammatical form bit field, for instance, may define a bit sequence of 0101 in the actual bit fields of the PB. In the developer's mind, however, this sequence may be known as a transitive verb. The on-platform display presents the character string transitive verb to the developer in this instance, as well as the actual binary code that represents the expression transitive verb to the digital knowledge network through the PB (the bit sequence 0101). The on-platform display also depicts the symbol, such as the verb run, associated with the PB in the application language. Thus, the on-platform display gives the developer control over how the PB's bit fields and external symbols are displayed “on-platform” in the KDE. The KDE utilizes the Host processor's display capabilities for the on-platform display, which are provided by O/S features or software applications running on the O/S.

5.2.1. Off-Platform Display

The KDE's Off-platform Display (44) defines, more than anything else, the shortcomings of the Host processor's sensory capabilities—the external sensory display systems that are not provided by the Host processor, but are used in connection with the Host processor's display of a PB's symbols. The off-platform display involves any sensory display technology that is required to depict a PB's application language symbols, including voice synthesizers and computer graphics systems. In this sense, even a graphics application running on the Host processor can be considered “off-platform” because the graphics application is not provided by the Host O/S capabilities. When using the off-platform display, the KDE engages a PB's symbol by initiating the programming protocols (or hardware systems) that operate the respective graphics or other sensory systems or the Host processor's application software. Once given the proper protocols by the KDE, any conventional sensory display system can represent the appropriate symbol corresponding to the PB in a remote processing environment (FIG. 37). The symbols can be displayed by the GSM according to the PB's I/O bit field or by the developer's command at the KDE through the display protocol bit field. (When displaying off-platform symbols, it should be noted that the disengagement of a symbol is just as important as its engagement because symbols are usually displayed in the context of other symbols, thereby requiring a display automation that must sequence the display of a stream of symbols according to an appropriate 1/O strategy. One machine thus must “turn off,” or disengage, its symbol before another machine displays the following sequential symbol—say, the next word in a sentence.)

This display feature is important to the developer because a given KP application operates on arbitrary language, including languages as diverse as those used for fine art, music, molecular sequencing (DNA), and ordinary speech. Meanwhile, the knowledge network manipulates the grammar and meaning of the related languages' symbols. Rather than build specialized software and engineered systems to manipulate the symbols as solitary data structures, the KP operates on the grammar and meaning of the symbols in the knowledge network while independently displaying the actual (physical) symbols in arbitrary sensory media. The symbol (a shape, color, or texture in a work of art, for instance) is displayed by the KDE through any appropriate graphics system connected to the Host processor via the GSM, while the knowledge network operates on the grammar and meaning of the language element (i.e., of the shape, color, or texture) through the PB's bit fields. The off-platform display allows the developer to create software applications that generate symbols externally through the KDE's interface, while the KP's intelligence (a project) handles the cognitive operations on the symbols' meaning.

Another way to appreciate the off-platform display is to realize that the GSM provides the same functionality as that of the off-platform display, except that the GSM serves a KP application. Whereas the GSM converts PBs to external symbols (data structures) through the symbol kits, TCs, and system vectors under an I/O strategy for a KP project, the KDE employs the same kinds of translations, but in order to allow the developer to manipulate symbols remotely. Rather than rely on the project's GSM for external translations of the I/O bit field, for instance, the KDE provides its own conversions of PBs to external system protocols for the developer through the display protocol bit field. The developer designs the Read and Write commands necessary to allow external software and systems to display a given symbol, while the UPL commands decode the display protocol bit field to engage the given symbol. Often, the process simply involves creating a conventional programming object to “open a file” in a given external system. When the external system or Host system protocols require more sophisticated translation methods, the GSM is used as a subproject to convert PBs to external displays. Accordingly, the KDE relates any number of external protocols (file names and processing standards) to a given PB through the display protocol bit field, whereby each protocol represents the external system encodings required to display the PB's symbol. The developer instructs the KDE to display the symbol, and the interface engages the appropriate external protocols. The on- and off-platform displays thus allow the developer to control the display of symbols while constructing knowledge networks that operate on the symbols' meaning.

5.2. Symbol Kits

The Symbol Kit (45) is a UPL structure that enables the knowledge network to communicate with any external machine without language or technology conflicts. The symbol kit is a data translation table that allows the UPL Read and Write commands to input or output to external machines or Host processor applications. It contains two important types of binary structures: the external byte structures (or file templates) that reside on machines configured with the KP, and the PBs that represent the external structures in the knowledge network. The I/O strategy operates on the UPL Read and Write commands and converts the external binary structures to PBs (and vice versa) by accessing the table's relationships using the I/O engine (18). The I/O engine is a portion of the network's structure and operation that supports the Read and Write commands. Its function is to parse external data for input to the KP and to output to external machines, when necessary, using the symbol kit relationships.

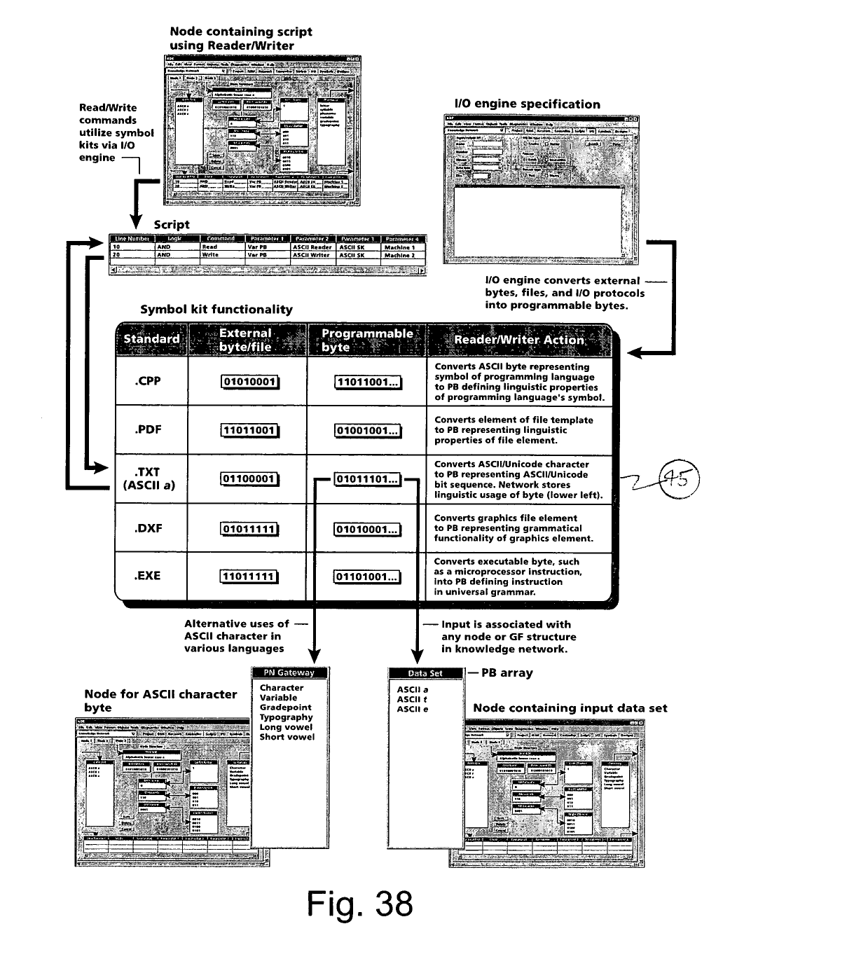

The symbol kit is the KP's solution to global computing incompatibility. As shown in FIG. 38, the reason why “symbol kits” have not been a part of the computer industry's history is that the structures require an intelligent knowledge network to interpret programmable bytes once external data structures have been translated into Host processor PBs. In a conventional computing environment, external data structures and the processes that operate on them must be translated into each other's protocols. (Conventional nomenclature describes these translations as “software agents,” “database migration tools,” “file converters or translators,” and “software ports.”) This software and hardware translation process requires a programmer's skill in understanding one code paradigm and translating that design language into that of another. The disadvantage to this approach is that the translation method is conceived by the programmer's judgment about how to translate the syntax and semantic usage of one language to another. While some programmers may demonstrate expertise at this process, even professional language translators are caught up in a conundrum of translation methods. Thus, each translation tool becomes a world of ad-hoc decisions made about how a particular language, data structure, or process should be converted into that of another.

The universal grammar, on the other hand, allows any language to be translated into any other according to the mind's innate moments of thought. The universal grammar allows one programmer to understand the syntax and semantic usage of another programmer's work in “moments of thought” that provide bidirectional uniformity—that is, the translations are based on a universal linguistic process that achieves the same result regardless of which language is understood first. When applied in connection with the KP's knowledge network structures, the universal grammar permits any language to be understood through the mind's innate action, which does not vary intractably from one programmer to another. If the linguistic action does vary, the developer is able to depict that variation in the universal grammar. The KP thus understands any external protocol according to the universal grammar, while the symbol kits provide the means to translate external protocols into the PBs of the KP paradigm.

Using the symbol kits, the Readers (16) and Writers (17) compare the data input from another machine to the knowledge base's version of the input data (the PB). The Reader identifies the external bytes and uses the table relationships between the external data structures and the PBs in the symbol kits to create data sets that contain the PBs in the network's short-term knowledge base (STKB), as shown in the figure. The Writer operates in a reverse action to the Reader. The Readers and Writers provided with the CD/ROM version, for instance, enable the developer to select various parsing parameters used on the external data or file structures. These options include the full gamut of parsing techniques employed in conventional compilers. Using the I/O engine interface, for instance, the developer specifies that a keyword, or “token,” is to be located by the Reader's parser (such as a space separating words in an ASCII file) and whether the token should be included or excluded from the translation process when the I/O engine constructs the data set's PB array. This selection allows the Reader to parse external file structures, obtain byte structures, and selectively include or exclude them from the parsing, or “reading” process, which extracts pertinent structures and converts them to PBs in the data set.

The symbol kits rely on a one-to-one relationship between the external data structures and the Host processor's PBs. The symbol kit relates external data structures to knowledge network structures through the unique encodings of the PBs. During the Reading or Writing process, external data structures are converted from vendor-encoded bytes to the developer's encoding schemes for the PBs. As shown, the software vendor may use an ASCII byte to encode the character a while the developer provides further information in the PB that specifies that the PB represents the character in the English language and in print (as well as the fact that the character may be used in the network as a long vowel, short vowel, and so on). In this manner, the external data structure is converted to the encoded programmable byte, which is rich in linguistic information. The I/O strategy uses these relationships to convert external data to the appropriate Host PBs at the request of a UPL command. For a given external machine, there may exist many symbol kits to translate various external data structures into the Host processor's PBs. This data conversion methodology allows the KP to utilize different symbol kits based on the external machine protocols with which it communicates. The KP does not require a software agent or conventional translator because the symbol kits connect the internally maintained knowledge base with the external machines. Each symbol kit translates a particular platform into the PB workspace. The KP operates on any global expression while the symbols of the expression are distributed over any number of machines through the Read or Write command's use of symbol kits and TCs. (The on- and off-platform displays utilize the display protocol bit field.)

Each time a different machine platform is added to the KP's list of external machines, the developer constructs a different symbol kit. If the machines are compatible with the Host hardware, then the symbol kits are only required to translate on-platform data structures (such as the various file structures of a given operating system). If the machines are incompatible at the hardware level, the translation cards are employed. When large and complex data structures are used by the external machines or software, it is prudent to store only the file template structure so that the KP can parse the external file through a Reader on the basis of the file's formatting standard, rather than its actual contents. This allows the KP to hold a minimum of data structures in the knowledge network for external conversions to PBs while relying on the external system's storage of data for actual content. In the case of external byte and multibyte structures, the KP contains the actual byte structures in the symbol kits. In either case, the I/O engine (Reader or Writer) parses the external file for the structures held in the knowledge network's symbol kits and creates a new data set of PBs to be processed by the network.

The Readers and Writers are thus UPL modules, or custom software and UPL procedures, that are written to interface with external files. The Readers and Writers can be designed so that off-platform machines can effectively “deliver” PB structures to the KP instead of the KP soliciting data from the external machines through the Reader's action. In this manner, the KP obtains data sets from the off-platform “Writers,” thereby allowing UPL modules to access PBs directly from other machines. When KP applications are connected, PBs are exchanged instead of the participating machines' Host-based structures. By managing the Readers and Writers of a project, the KP can access any data on any external machine and interpret the data as language encoded into the PBs' various bit fields. Because the file on the external machine presumably contains coherent language embedded in it, the KP parses and translates the meaningful language expressed in external machines according to the network's intelligence. Instead of building device drivers and software (translation) agents, the KP developer simply builds symbol kits and Readers or Writers that are engaged by the KP's intelligence (UPL modules) under a suitable I/O strategy. (Section 11 contains recommended PB bit field specifications for symbol kits accommodating ASCII and Unicode text files, macrocode, or “executable instructions and data,” and generalized computer structures.)

5.3 Short- and Long-Term Knowledge Bases

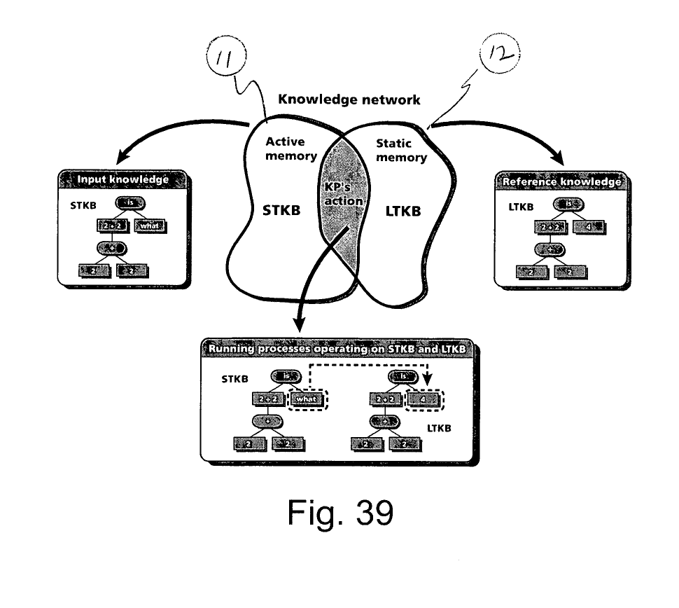

The knowledge processor is designed to operate on the “circular path of knowledge” that uniquely characterizes the human condition. Consistent with the mind's memory capabilities, the KP's knowledge network is separated into two distinct global network structures that allow the KP to manipulate language. As shown in FIG. 39, the KP's active memory (and processing space), also referred to as the Short-term Knowledge Base (STKB) (11), stores the knowledge network's “scratch work” when processing knowledge, such that any structure conceived or action taken in the STKB can be, and for the most part is, erased permanently from the KP's intelligence after processing—except for what is retained by the KP through learning. The KP's static memory (and processing space), also referred to as the Long-term Knowledge Base (LTKB) (10), while it is identical in structure to the STKB, comprises the KP's long-range memory capabilities. Facts, procedures, concepts, emotions, voluntary and involuntary responses, and other cognitive processes that the KP has learned and must “remember” for subsequent use are transferred from the STKB, or active memory, to the LTKB, or static memory, to occupy the knowledge network's developing intelligence. The STKB is therefore an intellectual buffer through which all knowledge passes so that the KP's long-term memory and intelligence (the LTKB) can evaluate new knowledge in the STKB and incorporate it, if desired, into the LTKB. Even thoughts that are extracted from the LTKB (the KP's own, self-generated input) must be transferred to the STKB for cognitive processing by the intellectual faculties stored in the LTKB. This interactive process between the STKB and LTKB is similar to the mind's action of imagining new knowledge from previously ascertained knowledge.

5.2 Network Structures

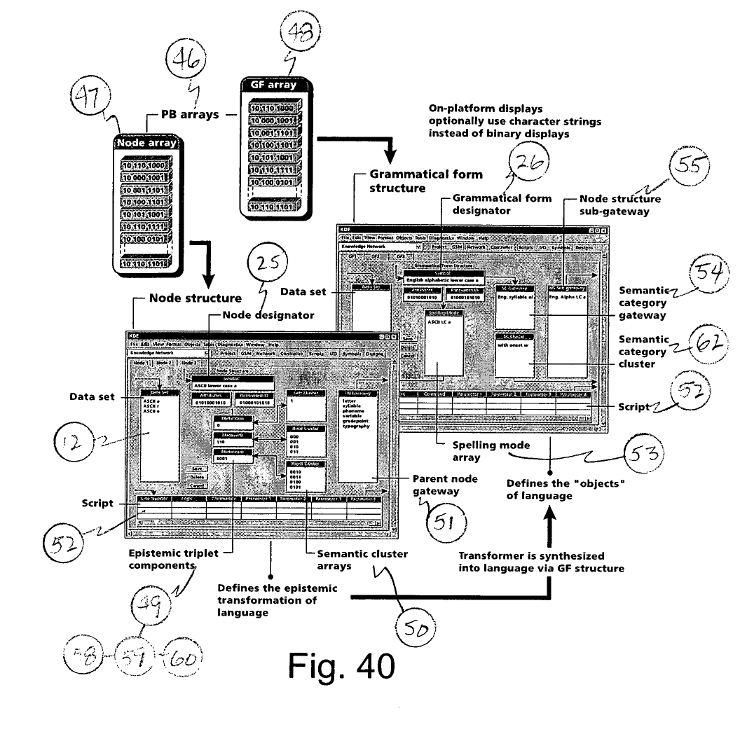

The knowledge network's “webbing” is formed by interlocking node structures (NL Structures) (8) and their objects, or grammatical form structures (GF Structures) (9), which are interconnected through the network's gateways. The network's PBs are contained in the node (NL) and GF structures as elements of memory arrays (lists) that are members of the structures. The PBs are cataloged through memory arrays referred to as PB Arrays (46) (specifically, the NL Array [47] and the GF Array [48]). The PB arrays are memory structures that contain the project's node designators (NLs) (25) and GF designators (GFs) (26), as shown in FIG. 40. The node and GF labels are the effective names of respective node and GF structures. (The PB arrays are sometimes referred to as the developer's “dictionary” because the intellectual faculties can sort the PBs in the arrays on the basis of PB bit fields in a manner that generates a dictionary-like taxonomy of PB entries.)

As shown in the figure, the node structure (8) contains structure members. The members include the Epistemic Node Triplet (ENTRP) (49), also called the Prominent Thought; the Semantic Cluster Arrays (SCAs) (of the prominent thought) (50); the Data Set (DS) (12); the Parent Node Gateway (PNGW) (51); and the Module Function (MF) (52), or intellectual faculty (i.e., script) associated with the given node structure. The parent node gateway (PNGW) is the node structure's link to higher-level syntactical node structures in the network (hence, the “parent node gateway”).

The GF structure (9) contains structure members, which include the Spelling Mode Array (SMA) (53); the Semantic Category Gateway (SCGW) (54), which is the GF structure's gateway to alternative uses of the current GF structure; the Node Structure Sub-gateway (NSGW) (55), which contains all node structures that employ the given GF structure in their respective epistemic triplets; the Data Set (12) (which is similar to the node structure's data set); and the Module Function (script) (52) associated with the given GF structure. The module functions (52), or intellectual faculties, and the data sets (12) can be associated with either node or GF structures, as shown. The various network structures allow the KP to process epistemic moments and their relationships within the network, as constructed from the PBs, in a manner that emulates the mind's action.

5.2 Node and GF Arrays

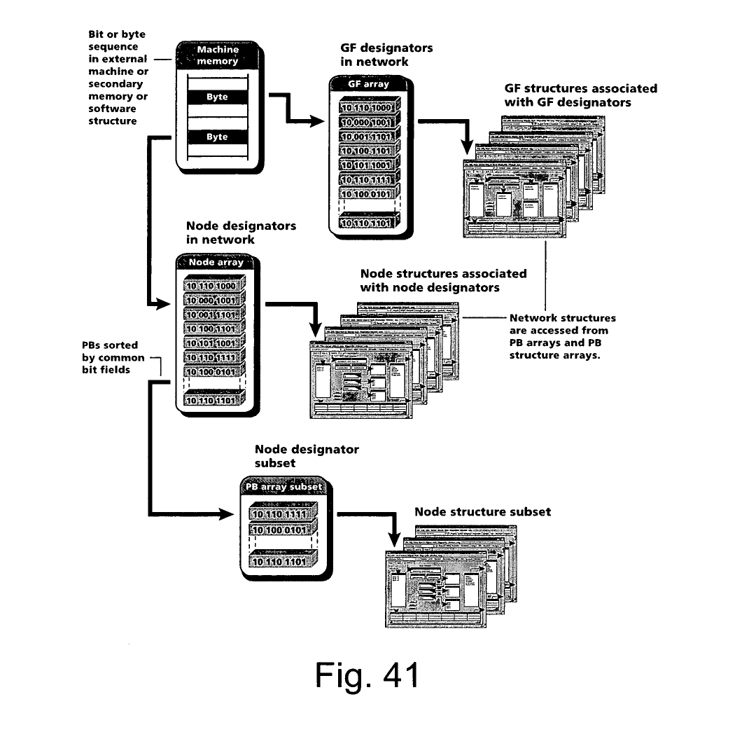

The node (25) and GF (26) designators, or “labels” (the PBs), are essentially variable-byte “names” for the node (8) and GF (9) structures that allow the KP's running processes (6) to access the node and GF structures according to bit field properties. The network's node labels are organized according to the Node Label Array (NL Array) (47), as shown in FIG. 41. The grammatical form labels (GF labels, or simply GFs) are similarly arranged in memory according to the GF Label Array (48), as shown. The node and GF structures are constructed on the Host architecture such that the node and GF labels designate the memory location, directly or indirectly, of the respective node or GF structures. The node (NL) and GF arrays are the blind starting points for entry into the knowledge network when another method of ingress is infeasible for a given parsing or translating function.

The NL and GF arrays arrange the node and GF labels into simple unordered arrays, wherein particular subsets of PBs are formulated by the running processes, or the developer, according to the linguistic properties encoded into the PB bit fields. The difference between a standard dictionary's taxonomy of words and that of the node and GF arrays is that, while the node label represents the epistemic moment of a language's expression and the GF represents a language's objects in an epistemic moment, a standard dictionary describes only a language's objects, or herein, GFs. A standard dictionary of words and phrases does not take into account the universal grammar and therefore omits the basic node and GF structure definitions of the knowledge processor. Nevertheless, the PB arrays are sometimes referred to as the KP's “dictionary.”

The node and GF arrays are partitioned, when necessary, into subsets according to the various similarities among PB bit fields resulting from an application. This sorting process allows the arrays to be organized on the basis of knowledge discipline, language, grammatical and sub-grammatical form, I/O bit field, and so on. The PB array sorting process is accomplished by logically or physically partitioning the Host processor's memory or by using various software indexing and sorting methods. Once organized according to bit field properties, the PBs can be analyzed by the running processes and accessed quickly from the array subsets. The STKB and the LTKB each possesses an NL and GF array. The PBs in the STKB and the LTKB are linguistically compatible with each other in a given application and can be interchanged. The PB arrays represent the global sets of node labels and grammatical form labels used by a given project. Other arrays used by the network, such as the gateways, are associated with particular node or GF structures and are otherwise subsets of the PB arrays as well. The node and GF structure member arrays are likewise organized and searched according to the structure member's properties.

The GF array is a mirror image of the node array, except that there are generally a greater number of grammatical form labels (PBs) in the GF array than there are node labels in the node array. This imbalance results because, even though a single GF can employ (point to) multiple node labels through the GF structure's spelling mode (i.e., multiple nodes can be assigned to the same GF), many more GFs can be assigned to a single node depending on the application language's syntactical structure and semantic usage. (The number of variations of a GF's syntactical usage is greater than the number of a GF's spelling variations.) By examining the contents of the node and GF arrays (and the gateways) according to PB bit fields, a running process can ascertain important information about the various objects (GFs), transformations of objects (nodes), and semantic gateways among objects and their transformations in the knowledge network.

5.6 Node Structures

The Node Structure (8) is a component of the knowledge network and a portion of the Host processor's memory that contains an aggregate of structure members (PB array subsets) that serve the purpose of allowing the running processes to analyze the application language's epistemic moments. Through the node structure's gateways and related grammatical form structures, a given node structure connects to other epistemic moments in the parse trees of the knowledge network's webbing. The node structure's members are PB array subsets that are accessed by the running processes through the node label that designates the given node structure.

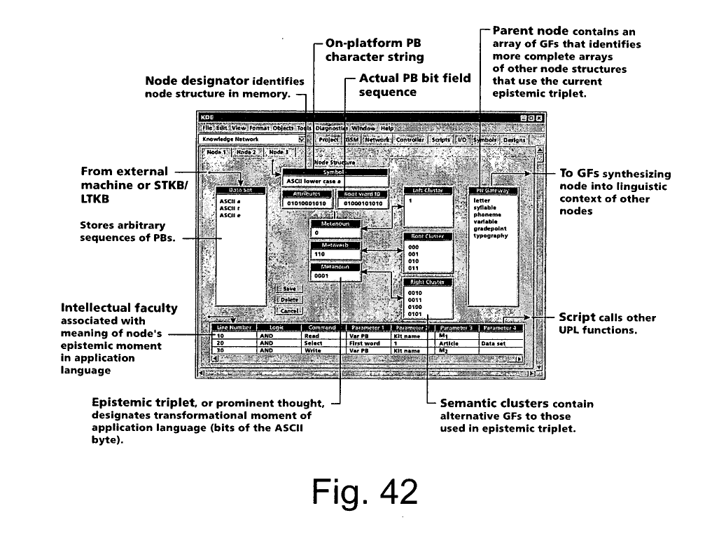

As shown in FIG. 42, the node structure's members include the data set (DS), the prominent thought (PT), or epistemic node triplet (also called the semantic cluster's active triplet), the semantic cluster arrays (of the epistemic triplet), the parent node gateway, and the node structure's script, or module function, which is the intellectual faculty invoked by the given node label. When referencing a node structure through a node label, the running process can access any of the node structure's members (in the STKB or LTKB) by using the UPL's dot notation in the command syntax (explained in Section 6). Thus, a given running process' UPL commands can execute another node structure's script by referencing the script as a member of the invoked node structure. A running process can change the contents of a structure member (i.e., it can add to or alter a particular element of the parent node gateway, for instance) by referencing the structure member in the command's syntax, which is interpreted and executed by the runtime engine (RE) (7).

The node structure's purpose is to contain members that relate to the epistemic triplet and its syntactical and semantic usage in the application language's context. The GF structure determines the synthesis of an epistemic moment, or how the epistemic moment is used in higher-level application language syntax than that of the epistemic transformation. Each node structure represents a “node” (root node) of the knowledge network's webbing, while each GF structure of the network represents the objectification of a node in a triplet of a node of higher-level syntax. Any network node can branch to any other along particular nodal pathways (parse trees) that interconnect the nodes through the gateways and the GF structures.

5.6.1 Nodal Data Set

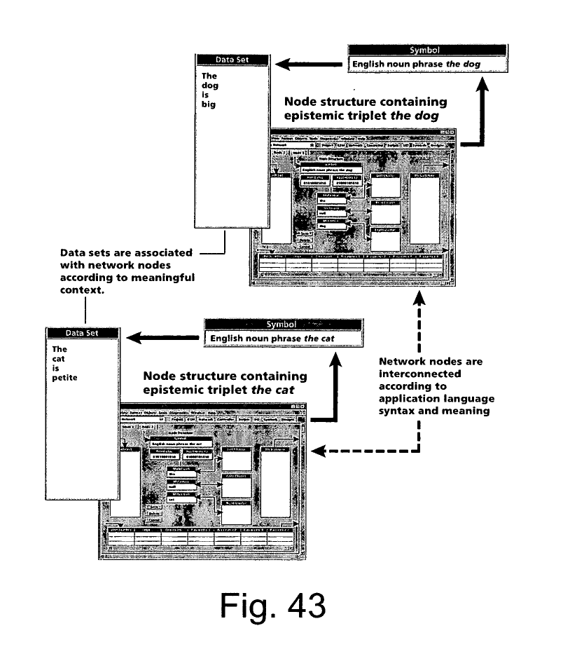

Just as module functions are accessed as members of the node and GF structures, the epistemic data set (DS) (12) is stored and analyzed throughout the network as a member of the node or GF structure. The data set is an array of PBs that represents an application language expression. The data set is obtained from a language source (an external machine or the LTKB) and converted, through symbol kits, into a PB array such that the DS can be deconstructed into a network parse tree by the running processes. Once deconstructed according to the universal grammar, the PBs in the DS are distributed throughout the network in the form of a unique parse tree. The data set is therefore a memory container that holds an application language's expression once the expression is converted into a linear array of PBs from an external source or the LTKB. The scripts then process the DS by parsing and translating its PBs and comparing them to reference knowledge contained in the LTKB, as shown in FIG. 43.

The data set is thus a PB array that contains the initial order in which the application language's symbols are formulated, which order is then deconstructed into particular node or GF structures of the network. The DS is an array of logically or physically addressable PBs (depending on the technology version) that defines a consecutive order in which PBs are arranged so that the application language's expressions can be stored in sequences, instead of in the syntactical parse trees of the network, as would be the method of reckoning for the mind's comprehension of language by retaining linear streams of thought. The data set is the KP's means of configuring an array of PBs such that the PBs are associated with and accessed according to a particular node or GF structure in the network.

The relationship between the DS and the node or GF structure containing it is important because the association allows the KP to input or output from the data sets, using the data sets as parsing and translating “workspaces,” while the data sets also remain elements of the network. The KP thus does not process PBs from a central processing workspace. Rather, input and output is placed into the data sets, which already have a relationship to the network through their status as members of the node or GF structures. This means that any expression of thought, as embodied in an array of PBs (the DS), can be placed into semantic context through its location in the network (as a node or GF structure member). Concerning human cognition, thoughts are communicated and placed into context such that even expressions that have no meaning have a relationship to the mind's extant knowledge. Similarly, the KP contains data sets of PBs to reflect any thought in a particular location of the network. When a new thought stored in the data set exactly corresponds to a parse tree in the knowledge network (i.e., once the DS is deconstructed), a verification of knowledge, or language comprehension, occurs. Thus, any string of PBs processed by the KP must belong to a node or GF structure so that the string is always embedded in the knowledge network. The fact that the DS is a member of a node or GF structure allows the KP to process a PB array in association with a particular portion of the knowledge network's webbing, as shown.

The DS contains PBs, not external machine bytes. The external machine bytes are translated by the I/O engine into PBs via the symbol kits. As a result, the KP embodies in the knowledge network an entire classification of the grammatical and semantic properties of both the external machine and application languages according to the universal grammar. The DS is therefore a means of associating a string of PBs, as converted from external machines or the KP's secondary memory, with a particular NL or GF structure. The DS may contain either PB objects (GF labels) or epistemic moments (NLs) because of the class definitions of the PB. A given external ASCII byte therefore must be translated into either an object (GF label) or a transformation (NL) of language through the symbol kit in order to become a member of a DS. The practical application of these structures allows an ASCII string for the article the, for instance, to be interpreted through the symbol kits as either the grammatical object (GF) the or the transformational moment (NL) th-null-â. (The PBs in the data set represent a sequence of either objects already placed into linguistic context—GFs—or epistemic moments—NLs—that must be converted to GFs and subsequently placed into context by the running processes.) Once the external knowledge is stored in the DS as a string of PBs, it is understood by the KP in the context of the NL or GF structure's placement in the network.

5.6.1. Prominent Thought

The epistemic node triplet, or Prominent Thought (49), is a special data structure that represents the epistemic moment in the knowledge processing environment. In order for the KP to understand and formulate knowledge the way a human being does, the epistemic moment is conceived in the knowledge base as a “prominent thought.” The KP's prominent thought is a momentary transformation of language that represents and can be verified by a perceivable moment of a being's experience. The prominent thought, or epistemic moment of language, is a quantum instance of a language's semantic action. What this means is that in each NL structure of the network, there is embodied an epistemic moment—a “thought,” or momentary cognitive action—that encapsulates a fundamental expression of human experience that can be verified by an observer in isolation from all other such moments. The prominent thought is the KP's most primitive “data structure” aside from the PB. Rather than utilize conventional data structures that do not embrace the meaning of language, such as microprocessor instructions and data, source language (C++) data structures, and database fields, records, and tables, for instance, the KP retains knowledge in its most rudimentary form as a prominent thought—an epistemic transformation of human experience.

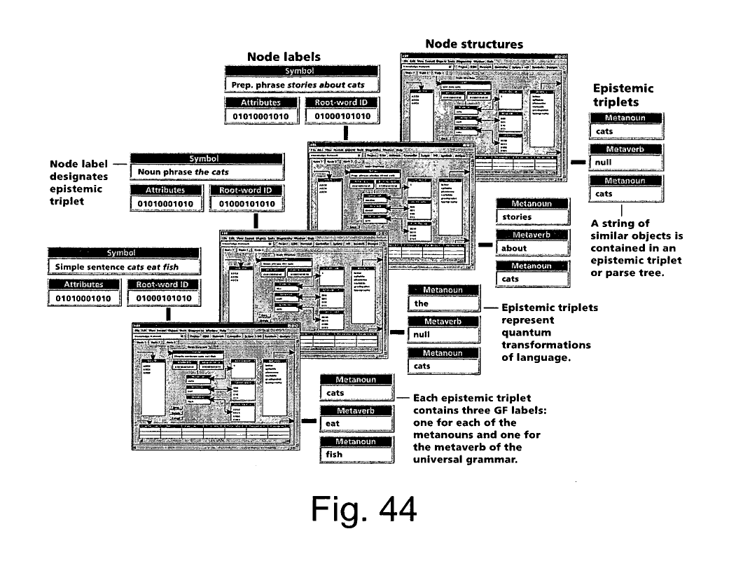

The thought I like chocolate is an epistemic moment, or prominent thought, embodied in an arbitrary NL structure that can occur in human experience without any further explanation or insight. It is a fundamental linguistic action in a being's perceivable reality. The moment can be embedded into other moments, such as I like chocolate because . . . ), and the moment can be altered to reflect that We like chocolate or I like vanilla, but in any case, there is a fundamental unit of meaning—a “prominent thought” (I like chocolate)—that acts as repository for a semantic cluster of all other related thoughts. The prominent thought is an encapsulation of meaning that is fundamental to how a being looks at or understands the perceivable world. All other related thoughts are subordinated to the prominent thought, and the subordinated thoughts cannot be arrived at directly as part of a semantic cluster without the prominent thought. Each thinking person will inevitably employ different prominent thoughts, while the “clusters” of subordinate thoughts will overlap each other, as shown in FIG. 44. Thus, how a being recalls momentary knowledge, such as what occurs in the expression I like chocolate, will vary, but how related moments of language congregate, or cluster, around a given moment will be much the same from one being's experience to another.

The epistemic node triplet, or prominent thought, is a data structure that binds the node label to a unique combination of three grammatical form labels, each of which identifies one of the objects (GFs) of the epistemic moment. Each component (GF) of the epistemic moment, in turn, is recursively related to one or more node labels, signifying the transition to a moment of a lower-level syntactical transformation. When a GF structure points to more than one lower-level NL, a “spelling mode” is created, whereby the way in which a particular NL is utilized in syntax depends on the modality of the NL's spelling. The GF's spelling mode thus links different NLs (moments) to the same GF and is used for homonyms and other spelling variations, as is evidenced when the Spanish words tu and usted are used to represent the same word you, depending on the level of formality required by language usage. The prominent thought thus determines a fundamental semantic moment of human cognition, while the NL structure in which it is contained links the moment to indefinitely many others according to the variable parse tree configurations of the knowledge network. The node structure therefore represents the mind's momentary action while comprehending human experience in the context of broader experience in much the same way as a fine art painting can be analyzed as a thoughtful composition of artistic moments. (The prominent thought is further explained in connection with the semantic cluster in section 5.6.4.)

5.6.3 Epistemic Node Triplet Components

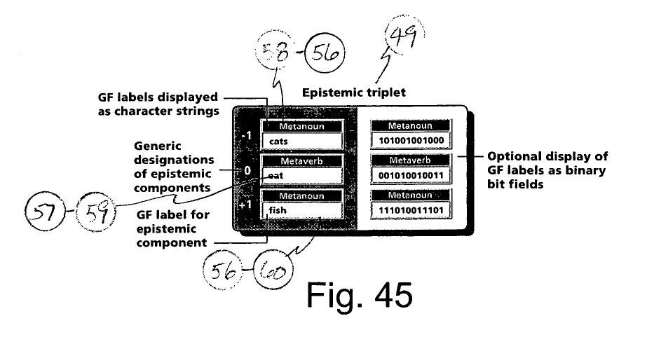

The epistemic node triplet (49) is represented in the network by the node label (a PB) (25). The elements of the epistemic triplet are the three grammatical form labels (26) that represent the metanouns (56) and metaverb (57) of the universal grammar. The node triplet's components are referred to by their specific GFs (which are also PBs), or by designations that generically describe the positions of the components. These designations are referred to as −1 (58) for the metanoun on the left side of the moment (or the top GF in the node structure), 0 (59) for the metaverb or transformer of the moment, and +1 (60) for the metanoun on the right side of the moment (or the bottom GF in the node structure), as shown in FIG. 45. While the node structure is represented in the network by a node label (designator), the epistemic triplet's components can contain GF labels (26) only. The reason for imposing this constraint is that the epistemic moment (the triplet) assembles three objects of language into a transformation of the mind's intellectual process. It therefore does not make sense, according to the universal grammar, for the triplet to contain transformations of language (NLs). Lower- or higher-order epistemic transformations must undergo a synthesis into a language's syntax as “objects” of language before qualifying as epistemic triplet components.

5.6.1. Semantic Cluster

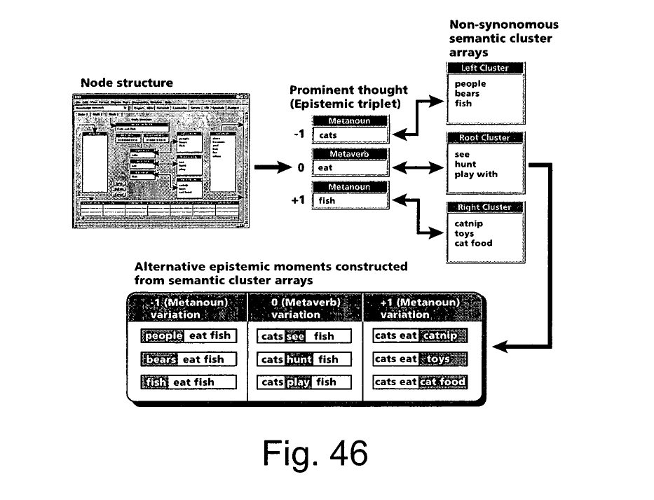

The epistemic triplet represents a moment of a language's transformation in human thought—an instance of meaning captured by the universal grammar. The epistemic triplet, such as the three words in the simple sentence Cats eat fish, shown in FIG. 46, defines a prominent thought of a being's comprehension of language. The prominent thought explains how we understand the perceivable world through quantum momentary experiences. While considering this moment of thought, we can ponder how other moments might be related to it in ways that cannot be explained (i.e., for seemingly no reason at all). We can muse over the observations that cats eat fish, people eat fish, and cats eat catnip, as observable human experiences, but there is no explanation as to why these observations make sense, and more importantly, are related to each other. This semantic association of epistemic moments is referred to in the KDE as a semantic cluster (61).

The relationship between the prominent thought, or epistemic triplet, and alternate expressions contained in the semantic cluster defines how perceivable moments are related in ways that are ascertainable but do not necessarily have a “reason” for their association. In the illustration, we use the association between Cats eat fish and People eat fish, wherein we emphasize the association between the words people and cats. We know these facts to be true, each in its own context, but cannot explain why they are related. If we can explain why they are related, then it is not a semantic cluster that contains the relationship. (Epistemic moments that can be related through context are associated through the knowledge network's webbing.)

Whenever there is a necessity to relate moments that “belong together,” even if the association is inexplicable, we can use the semantic cluster (SC) to place alternative GFs into the prominent thought (PT) as optional components of the epistemic triplet. The reason for the semantic cluster's conception can be appreciated by realizing that, since knowledge is circular epistemically (i.e., it neither begins nor ends on a terminal thought), a knowledge processor (the mind included) must be enabled with a baseline of knowledge that is accepted as true to experience. Since the mind reflects perceivable reality in language, a knowledge processor must be able to contain knowledge that is true and verifiable through perception and experience but cannot be explained to any sufficient “absolute” degree. The fact that cats eat fish may even be explained scientifically, but there must always be room in the mind for the possibility that science may be wrong—or correct only in certain context. For this reason, the KP contains knowledge in prominent thoughts that bind together alternative moments that relate to the initial thought, whereby context is unnecessary for the KP's retention of the knowledge. The semantic cluster thus groups together epistemic moments that constitute perceivable truths and primitive associations among them.

We can refer to the associations shown in the figure. When we remove the GF in any one position of the triplet (−1, 0, or +1), any GF found in the corresponding Semantic Cluster Array (SCA) (50) can be substituted for the GF and make perfect sense in the expression as determined by human experience. Conversely, any other word not presenting in the array would be irrational in the epistemic moment's usage. Thus, if we remove the GF for the word cats, and replace it with either of the words people or bears, each alternative instance makes sense, while the reason for the association remains inexplicable. Likewise, we can exchange the word eat with the word hunt (as if filling out a crossword puzzle). The same is true for the component +1 position, wherein we can exchange the word fish with toys, and so on. It is worth noting that in all these cases the semantic cluster is validated through human perception and intellectual experience. The various sentences formulated by the cluster “make sense” in the ascertainable reality of the observer's perception or other means of language verification (such as previous knowledge). It is equally important to realize that almost all other words in the English language do not make sense in the epistemic moment and cannot be validated by human experience. The sentences Cats piano fish and Cats are fish do not make sense (unless a metaphor is created). A further rule placed on the semantic cluster is that all GFs in the cluster arrays must be “non-synonymous” with each other and their counterparts in the triplet. This stipulation reduces the complexity of the GFs in the cluster arrays by avoiding synonymous uses.

We also should point out that, while natural language is used in the illustration, it is the GF—a PB—that is placed into the component members of the epistemic triplet and the semantic cluster arrays. The same phenomena pointed out in the illustration apply to arbitrary elements of language, including fine art images and musical notes. The semantic cluster is the knowledge processor's way of associating thoughts of any kind, while the epistemic triplet and its syntactical relationships with other moments in the network are the processor's literal knowledge of reality. The semantic cluster relating to a prominent thought represents all alternative epistemic moments that can be derived by substituting the components of the triplet, one component at a time, with those of the cluster arrays according to the universal grammar. The prominent thought and semantic cluster arrays can operate on any language or grammar. Concerning fine art, for instance, the color of a tree's leaf is green in the summertime and emblazoned with autumnal colors in the fall. While science may explain how these colors change, it cannot determine the philosophical reason “why” they do.

Since the semantic cluster's operation is important to understanding the running processes later in the specification, it is worthwhile to try a few thought experiments that illustrate the SC's significance. One such trial begins by challenging the mind to determine any expression of language, used for any knowledge discipline, in which the semantic cluster does not fundamentally define the mind's innate action. This test has been conducted countless times during the KP's design stages. The experiment involves thinking of thoughts that may not conform to the prominent thought and semantic cluster replacement rules. The reader is encouraged to examine knowledge to determine its fundamental nature and structure. Word games (associations) are a good starting point. As it turns out, according to the universal grammar, the mind does not “associate words” as a matter of rudimentary action. Rather, the mind embodies epistemic moments (prominent thoughts) whose actions can associate words according to the aforementioned procedures concerning the semantic cluster. Thus, linguistic theories describing data or knowledge as “relationships,” such as neural network theory, miss the point that the mind's natural action—the epistemic moment—associates objects through linguistic transformations, thereby generating a semantic structure. The universal grammar can be validated in the thought experiment by introspectively observing the mind's action while completing a crossword puzzle—a quintessential word association game. When thinking of words to associate, the reader can observe that in order for the mind to recall an association, the word must be placed mentally into an epistemic moment—a prominent thought—and used in context (a semantic cluster). The context (of the epistemic moment) then provides the linkage to other word associations. (Even when one thinks of the word up, one must interject other words, or components of the epistemic moment, such as antonym of, in order to result in the word down.)

While the specification provides a technical presentation on knowledge processors, it is also worth noting that the philosophical and theological backdrop to the prominent thought has its underpinnings in the concept of “opposites.” In between two perceivable or cognitive entities, a transformation exists that compares, or synthesizes, the objects in the mind's action. In order to have a black dot on a white page, an observer must exist who perceives a transformation, or synthesis, of the black and white colors (or shapes). The transformation (the metaverb), which is not denoted, is just as important to one's knowledge of the perception as the dot and the white background. Most credible philosophies explain this perceivable action as a transformation of opposites. Generally, what “lies in the middle of things”—the enabling transformation of human thought and perception—enables objects to appear as juxtaposed forms. Other related thought experiments include observing a work of art, a musical melody and its composition, and a poetic or rhetorical writing (i.e., an “ungrammatical” composition that achieves a finer expression of language) for their epistemic actions and semantic variations (i.e., semantic clusters). These exercises will help to demonstrate that knowledge occurs in prominent thoughts and semantic clusters, rather than one-to-one word associations.

5.6.1. Parent Node Gateway

The epistemic node triplet and semantic clusters are related to other network structures through the network's Gateways (GWs), or connections among NL and GF structures. A node's (or a GF's) gateway is a special data structure—an array of PBs—that acts as a “knowledge switch” (like a neuron in the brain) that is searched according to the bit fields of the PBs contained in it so that one epistemic moment can be linked to any other through the encoded bit fields. The network structures are linked through a given PB's association with its gateway, and through the gateway's connections to other PBs (NLs or GFs) through common bit fields. The gateway that acts as a knowledge switch for the NL structure's connection to its objectification as a GF structure is referred to as the Parent Node Gateway (51).

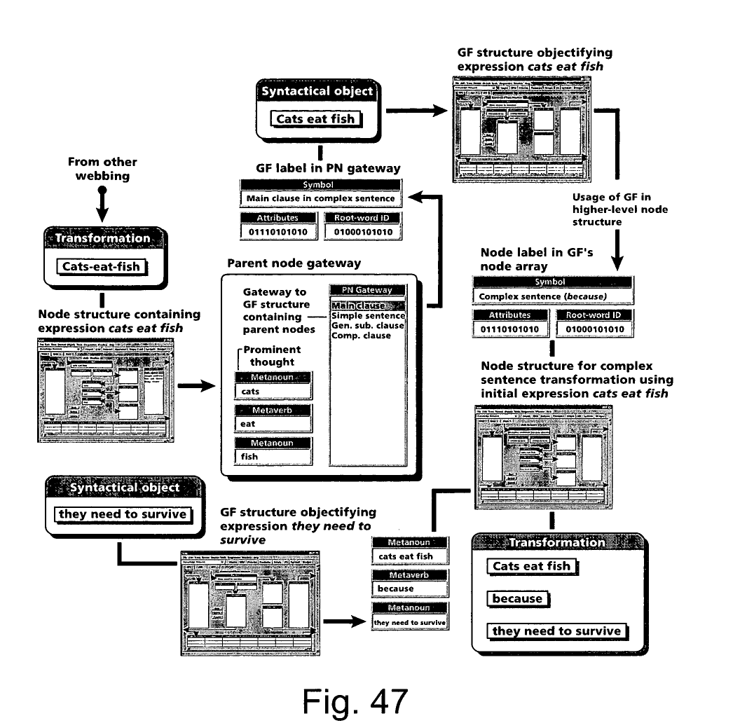

An arbitrary network node, herein referred to as a subordinate node, is connected to a superior, or “parent” node through the GF labels contained in the parent node gateway, a member array of the NL structure, as shown in FIG. 47. The GFs contained in the parent node gateway of a given subordinate NL structure are used in the triplets of higher-level NL structures (i.e., the parent nodes), as shown. The parent nodes (of a subordinate node) are accessed by a running process' call of the GF from the PNGW through the UPL commands. Once the particular GF is identified in the PNGW, the actual parent nodes are found in the respective GF structure's Node Structure Sub-gateway (NSGW) (55), which enumerates all of the parent nodes used by the GF structure. In this manner, the PNGW can be analyzed by the running processes and the appropriate parent node obtained by accessing the associated GF structure.

The GFs in the PNGW represent the objectifications of the subordinate node's epistemic transformation as deployed in the parent node, as shown. Each GF in the PNGW thus represents a potential branch in the knowledge network to other nodes via the NL structure sub-gateway of the GF structure, while each NL in the node structure sub-gateway represents a different parent node, or NL structure. The network node shown in the figure for the epistemic moment cats-eat-fish is objectified by the GF structure shown above it (cats eat fish). The GF structure's GF label is contained in the subordinate node's PNGW and is accessed by the running processes through the gateway. When the running processes access the GF structure for the expression cats eat fish, the UPL functions search the GF structure's NL structure sub-gateway for all superior nodes that employ the expression in their epistemic triplets. In the figure, the running processes select the node for the complex sentence Cats eat fish because they need to survive, wherein the word because is the metaverb of the epistemic triplet. This action reflects the KP's ability to think of the expression cats eat fish and then determine parent-node context in which the expression is used. The purpose of these relationships is, of course, to implement in a digital device a global network of semantically related epistemic moments (prominent thoughts) so that the KP can reproduce any parse tree, or syntax, without utilizing a node or GF structure in the knowledge network more than once.

5.6.1. Node Structure's Script

Each NL structure can contain as a member a unique UPL function, or script (52), that can be executed whenever the given NL structure is called by a running process. This approach to UPL function configuration allows a running process to examine the contents of a data set and, based upon the presence of a particular NL or GF in the data set, engage another function. Thus, intellectual faculties are initiated by the presence of an NL or GF in the given data set, as well as by other functions, including the main function.

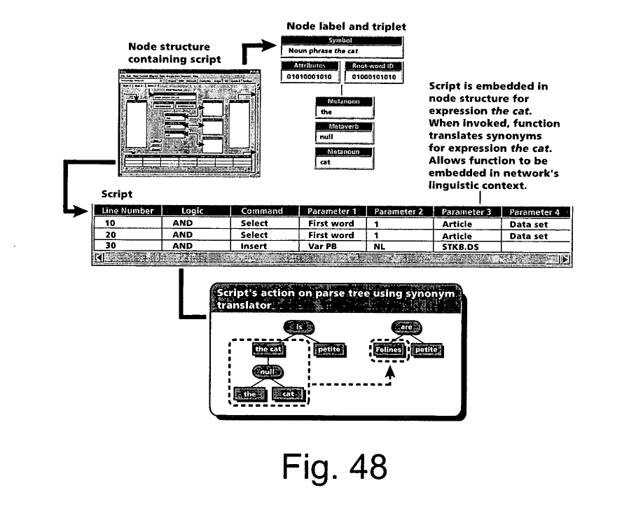

As shown in FIG. 48, the UPL function that analyzes a data set containing the expression the cat is associated with the node structure designated by the NL for the expression the cat. This network configuration allows the KP to parse an arbitrary data set for the expression the cat and then locate a function that operates specifically on that expression, in context, by using the same language in which the expression is composed. The UPL scripts are thus embedded in the network's linguistic structure, which operates on the application language. As mentioned in Section 3, the learning functions use this feature of the knowledge network's design extensively. As the KP learns new procedural knowledge (UPL functions), it embeds that knowledge in the linguistic structure of the network so that other UPL functions can utilize the new knowledge by comprehending expressions in the application language.

5.6. GF Structures

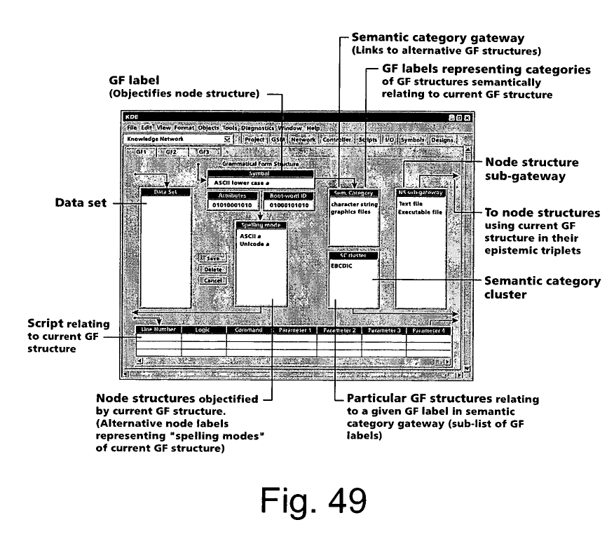

The GF Structure (9) represents the linguistic object into which a node structure's epistemic moment is synthesized in the application language's syntax in order for the NL structure's triplet (49) to act as an object of comprehension. The GF structure is accessed by the running processes through the GF label (26), which describes the linguistic and GSM-related properties of the given GF structure. The GF structure also contains links, through the PBs in the gateways, to other GFs in the network and to NL structures that employ the given GF in their epistemic triplet components. As shown in FIG. 49, the GF structure provides a Spelling Mode Array (SMA) (53) that contains a list of all node structures that are objectified by the given GF structure in the application language's syntax. Since the node structure's parent node array points to GFs that objectify it, the spelling mode array reverses this action and points to node structures that deconstruct the GF into epistemic components in lower-level transformational syntax. The running processes use the spelling mode array, or Nodal Mode Array (NMA) (53), to parse the network for lower-level node structures (i.e., to locate the epistemic triplet th-null-a from the GF, or object the). The spelling mode array may point to more than one lower-level node structure (as would be the case for the alternative pronunciation of the word the as th-null-e). Hence, the nodal mode array is referred to as a “spelling mode.”

The GF Structure also contains a data set (DS); a semantic category gateway (SCGW), each element of which, in turn, points to a semantic category cluster (SCC); and a node structure sub-gateway (NSGW). The NSGW links a given GF structure to all node structures that employ the GF structure in their epistemic triplets of higher-order syntax (i.e., to a node that uses the word the in the higher-order triplet the-null-cat). The running processes access the GF structure's members, including the module function (MF), by referencing the structure's GF label, as shown.

5.7.2. GF Data Set

Each GF structure incorporates as a member an epistemic data set (12) that can contain a PB array. The GF's use of the data set is important when, for instance, a script (intellectual faculty) or another member of the GF structure, such as a semantic category, must be associated with a language stream (data set) relating to specific topical knowledge. In this case, the data set is associated with an “object” of language—the GF structure—instead of a node structure, or language's transformation, as is the case with the node structure's data set illustrated earlier.

When a word stream must be associated with the word cat, for example, the developer and the KP must decide which aspect of the word should be related to the data set—the epistemic transformation /k/-null-/at/ (a node structure) or the object cat (a GF structure). While at first this decision may seem arbitrary, there are specific reasons for using one structure over another. The problem that the developer encounters is that the word cat may have many grammatical and semantic uses. One instance of the word cat may be a noun meaning feline. Another usage may define the word as a slick person. And still another instance may treat the symbol as a verb meaning to cat around (stealthy horseplay). In each of these cases, the node structure is the same (for the transformation of the phonemes /k/ and /at/), but the GF structures determine different syntactical and semantic uses of the node structure. Thus, while the node and GF structures maintain the same type of relationship between the data set and the structure (see FIG. 43 regarding the node structure's data set), the reason for employing a GF or node structure to contain a given word stream is clear. In the case of the GF structure, we would associate the data set with, say, the GF structure for the word cat, meaning feline, so that the running processes could operate on a word stream that is contained as a member of the GF structure whose GF designator is cat, the feline. A node structure is employed only when the word stream is associated with a linguistic transformation. (If we were required to relate the word catalog to the epistemic transformation k-null-at, say, for lexical analysis, we would place the character string c-a-t-a-l-o-g into the data set contained in the node structure representing the epistemic triplet k-null-at.) This GF structure feature allows the KP to operate on data sets (expressions) in the meaningful context provided by the GFs placement in the knowledge network.

5.7.2 Spelling, or Nodal Mode Array

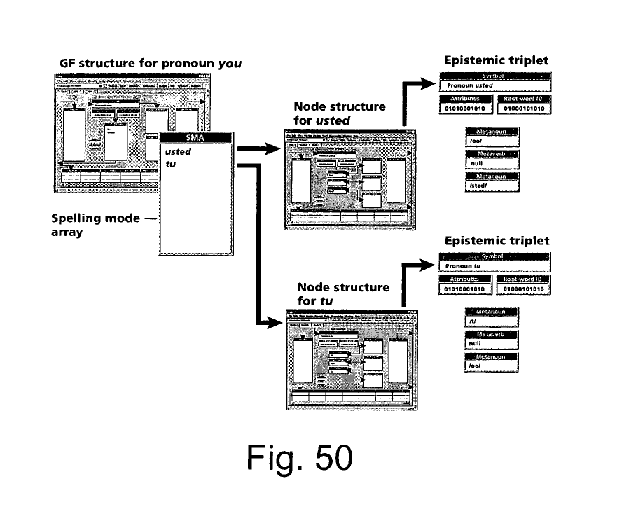

When multiple node structures are objectified by the same GF structure, the related node structures are enumerated in a member of the GF structure referred to as the Spelling Mode Array (SMA) (53), also referred to as the Nodal Mode Array (NMA), as shown in FIG. 50. This array contains NLs that are referenced by the current GF structure because they are alternative spelling modes of the same grammatical object. The spelling mode array for the objective pronoun (GF structure) you in the Spanish language, for instance, contains two alternative subordinate nodes—one for the informal tu and the other for the formal usted. Thus, the running processes can enjoy the complete freedom of choosing the pronoun's epistemic usage in lower-level syntax based upon informal or formal language, while processing the pronoun as an epistemic object (GF) irrespective of the object's lower-level composition as an epistemic transformation, as shown.

5.7.3 Node Structure Sub-Gateway

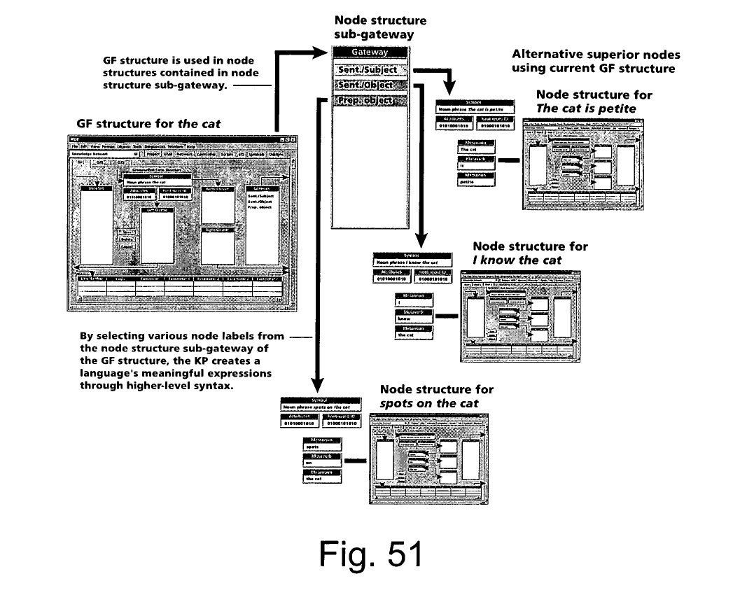

The GF structure contains another member that connects one node structure to another in the knowledge network's webbing. The Node Structure Sub-gateway (NSGW) (55) contains an array of NLs that employ the current GF in their epistemic triplets for the purpose of building the knowledge network's interconnected parse trees, as shown in FIG. 51. When it is recalled that the GF structure objectifies a given node structure, and that the objectifying GF structure is enumerated, along with other GFs, in the node structure's parent node gateway, it can be appreciated that each element of the parent node gateway acts as a branch to other, higher-level syntactical nodes through the GF structure. The GF structure is the intermediate object used to perform the synthesis of the node into higher-level nodes as an object of a superior triplet. The GF structure's node structure sub-gateway performs the function of containing alternative superior nodes to which the subordinate node connects through the parent node gateway of the subordinate node and the GF's NSGW. (The NSGW lists the nodes represented by the GF labels contained in the parent node gateway.) The GF's NSGW acts as a connector that enables the synthesis of a subordinate node structure into alternative higher-level syntactical node structures. The alternative node structures are listed as elements in the GF structure's node structure sub-gateway. A given GF structure thus can be utilized in indefinitely many higher-level node structures depending on the application's needs, thereby forming the network's syntactical webbing. The NSGW contains an array of all node structures that deploy the given GF structure in their epistemic triplets, such that a running process can access and search the arrays (containing NLs) and select the appropriate parent node for the GF's usage in higher-level syntax. The NSGW allows the KP to determine various language constructions for the given GF structure's use; it is a branching point from a lower-level node structure to multiple higher-level node structures, wherein the GF structure objectifies the lower-level's triplet into the higher-level node's syntax.

The node structure for the epistemic transformation /r/-null-/un/ (run), for example, is objectified by several grammatical forms in the English language, while any one of the GFs may be used in indefinitely many higher-level triplets (NLs). The verbal GF run, synthesizing the moment (NL) /r/-null-/un/, for instance, is found in the sentences (higher-level nodes) Athletes run and Children run. In order for the KP to locate the various uses of the object run, which objectify the triplet (NL) /r/-null-/un/ in higher-level syntax, the NSGW is searched for each NL that uses the given GF in its triplet. (This is why the NSGW is sometimes referred to as the “Used In” array. The GF structure is used in the triplets of the node structures listed in the NSGW.) In this manner, the KP searches the node structure sub-gateway of the GF structure and obtains a particular higher-level use of a lower-level node by selecting the given NL.

5.7.4 Semantic Category Gateway

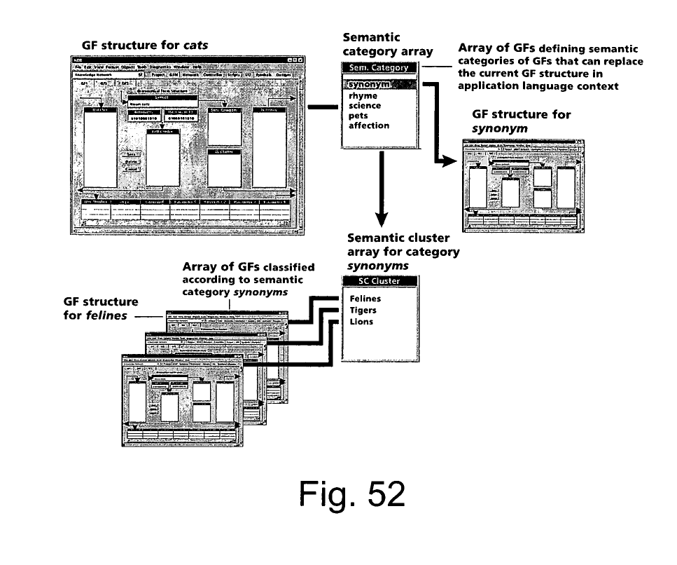

The Semantic Category Gateway (SCGW) (54) is a member of the GF structure that contains an array of other GF classes that represent alternative categories of meaning, as shown in FIG. 52. The semantic categories are usually developed on the basis of the PB's root word bit fields but can also be determined by the network's placement of the GF in the network's context. The running processes select alternative GFs to the one currently being processed by searching the SCGW for a particular semantic category. Each entry in the SCGW is further related to a semantic category cluster (SCC) (62), which is a list of GFs associated with a particular category entry of the SCGW, as shown.

A simple example of the semantic category would involve the use of a synonym. In this case, the running processes examine the semantic category represented by the word (GF) synonym, as defined by the PB properties and the network's context, and replace the current GF with one of its synonyms from the semantic category cluster (felines, tigers, or lions), as shown. Another example would involve the association of a given GF with other GFs on the basis of a word association (semantic taxonomy), as would be the case when the word bat, meaning baseball bat, as defined according to a particular root word bit field, would be associated with the words baseball, wood, and swing (the bat) in the semantic category cluster. Another GF representing, say, the root word (animal) bat through a different root word bit field would be associated with the words animal, bird, and species. In this manner, the running processes can evaluate the contextual use of a word in terms of the semantic category clusters to determine the word's intended meaning.

5.7.5 GF Structure's Script

The Scripts, or running processes (6), are most frequently associated with the GF structure because the GF structure represents a particular contextual use of a function name as a linguistic object. The GF's method of configuring a script, as a member structure, is similar to that of the node structure's use of scripts (see FIG. 48), except, as demonstrated earlier regarding the data set's association with a GF structure, the GF relates scripts to the objects of language. For the same reasons that the GF objectifies the data set, the GF contains module functions relating to the objective expressions of the application language. The GF thus objectifies a UPL function name, such as Program_name, for the purpose of storing and retrieving learned procedures as grammatical objects in the knowledge network.

A given UPL function might be named starting the car, for instance, in which case the function would be installed as a member of the GF structure for the expression starting the car. In order for a running process to engage the function, it must obviously know the function's name—starting the car—as a grammatical object of the application language. Thus, the KP translates a DS's contents, such as start the car, into the GF label representing starting the car. In this manner the KP's functional capabilities are stored in terms of the linguistic properties of the GF, rather than the transformational properties of the node structure. Whether to associate a given script with a node or GF structure is a matter of discretion. Usually, the objects of language are more appropriate for module functions, while data sets, for instance, are typically installed into node structures because the nodes represent the root transformations of DS expressions.

5.8 Data Set Splitting: Parse Tree Generation

Since the data set (DS) (12) holds an array of PBs that are arranged according to a linear sequence of words, or linguistic elements, in an application language's expressions, the DS must be deconstructed, or “split,” by the running processes into an asymmetric arrangement of epistemic moments, referred to as a parse tree, in order for the knowledge in the data set to become part of the KP's intellect. In order to better understand the important process of data set splitting, or parse tree generation, we can explain the KP's comprehension of DS elements as follows.

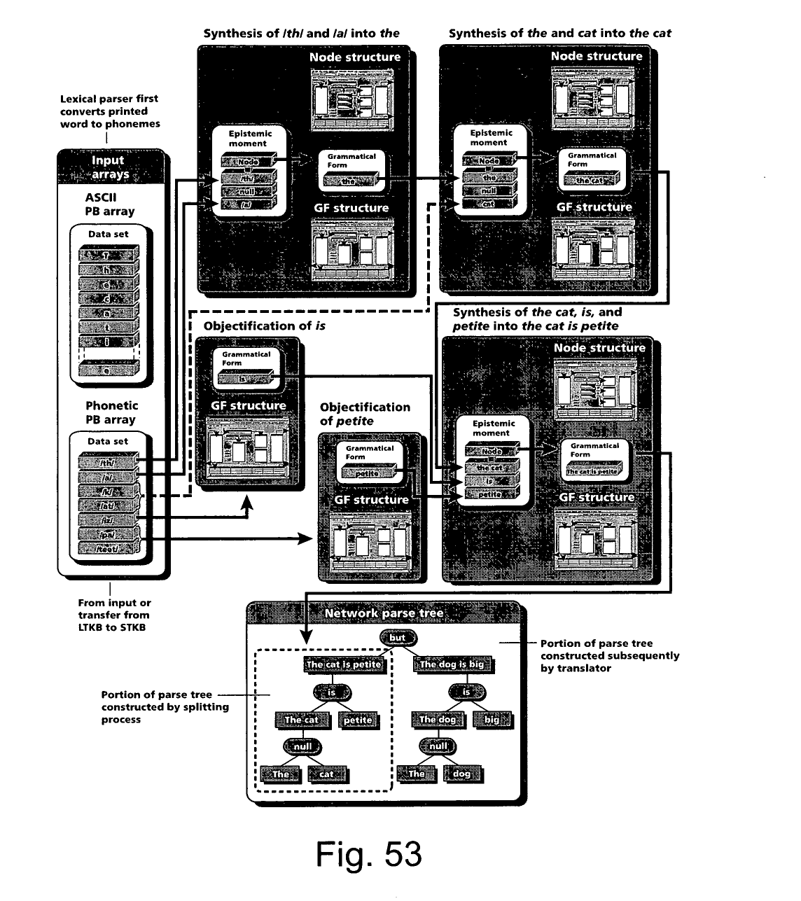

The DS is a linear array of PBs which, when parsed, results in a meaningful parse tree of syntactically and semantically related epistemic moments contained in the knowledge network's webbing. (The DS represents a sequence of PBs as GFs or NLs. The DS also is a member of an NL or GF structure.) The process of “splitting the DS” thus involves parsing the DS for the epistemic moments embedded in the data set, thereby creating new NL and GF structures, in the STKB, and relating the new nodes and GFs to those of the LTKB for comprehension or translation to occur. Thus, input to the network is installed into a DS of an NL or GF structure in the STKB by a running process using an appropriate I/O strategy. The parsing and translating functions then compare the input knowledge contained in the syntax of the PBs in the DS, as formulated, or split, into parse trees, to the parse trees embedded in the network's LTKB webbing. Since any number of parse trees are contained in the network, the effectiveness of the faculties is measured on the basis of how the KP's intellect determines correspondences between the parse trees of the STKB and LTKB structures. This process is outlined in FIG. 53, wherein the conversion of ASCII characters to phonemes used by the network's intelligence already has occurred. (The ASCII conversion process is similar to that which is demonstrated by the illustration.)

When an epistemic node is identified in the input data set (DS) by a parsing kit, the parser or translator rearranges, or “splits,” the related portion of the DS into three more distinct DS elements or strings, one for each component of the epistemic node. The parser creates a node label describing the moment's transformation and installs the DS's corresponding elements into the node. In the figure, the GFs in the data set representing the phonemes /th/ and /a/ are inserted into the newly formed node structure for the transformation /th/-null-/a/. The lexical parser also formulates a node for the expression /k/-null-/at/. Each of these nodes is in turn assigned a GF structure that objectifies the node in higher-level syntax—one GF for the synthesis of the node /th/-null-/a/ into the word the, and another for the synthesis of the node /k/-null-/at/ into the word cat. A third node structure is created to contain the noun phrase the cat in the transformation /the/-null-/cat/. Similarly, a GF structure is created by the running processes to formulate the epistemic moment /the/-null-/cat/ as a grammatical object in the higher-level sentence syntax the cat is petite, discussed next.

The splitting process continues until a parse tree is created that describes all of the momentary transformations and syntheses embodied in the DS at a certain syntactical level. The splitting of a parse tree branch terminates when the parser reaches a node label or GF in the DS whose PB bit fields are set at a syntactical level other than what the parser desires to translate. The figure illustrates that the parser assigns a GF to the epistemic transformation /is/, while the parser repeats the splitting method described above in order to formulate the triplet /pa/-null-/teet/ and its objective GF petite. At any point in the process, however, the parser, based on its UPL logic, can reach down into a lower level or up into a higher level of syntax in order to understand the DS string's epistemic constructions. The parser may terminate the splitting process, for example, when all word (lexical) levels of syntax have been split and installed into parse tree elements, and then resume the lexical parsing process because a word must be understood at a particular lexical level in order to place the sentence into context. A perfect example of this is found when the KP analyzes voice inflections in order to understand the syntax of a sentence. The expression It's a toy, when spoken aloud, can be communicated as an interrogative sentence by inflecting the word “toy,” as the voice goes up. In this case, the KP splits the syntax of the word “toy,” as well as the sentence's syntax, thereby parsing both word and sentence constructions.

### Section 6: Universal Programming Language

6.1 Introduction

The UPL command set (63) provides the basic operations necessary to allow the running processes to create and alter the knowledge network structures so that a synthetic device can think and learn as we do. Together with the UPL functions that it supports, the UPL command set enables any knowledge network to understand language and converse with human beings through the mind's natural action. Each UPL command lends a unique ability to the knowledge processor's cognitive action. Included among these operations, for instance, are the Read and Write commands, which allow the KP to communicate with external devices from within a running process, the Select and Move commands, which parse and exchange PBs among network structures to allow the network to alter the mind's epistemic moments, and the Create and Set commands, which respectively create and set the PBs' bit fields to represent the elements of an application language. A total of twenty seven UPL commands enable both the developer and the KP's learning functions to manipulate knowledge intelligently in a machine. As the knowledge network transforms through the action of the UPL functions, which are derived from the UPL command set, the KP thinks and understands language. Learning the UPL command set is therefore a crucial step toward becoming proficient at the KP paradigm. Getting to know how each command and the structures upon which it operates are specified and referenced by UPL syntax is essential to developing KP applications and building machines that think.

The UPL command set allows the developer and the KP to create, search, alter, and maintain PBs and their epistemic structures in the knowledge network. Each command provides a unique capability for the epistemic thought process and is used in UPL functions according to the developer's or the KP's learning requirements. The UPL functions, which are integral components of the network, cooperate with each other through UPL Command Variables, through which a given command or function can access the work performed by any other command or function. Most UPL commands specify a particular linguistic structure of the network to be operated on (i.e., a PB, PB array, node or GF structure, or member of a node or GF structure), along with the operations that must be performed on the structure. The command variables, along with the function parameters that one UPL function can pass to another, allow one command or function to operate in coordination with another, as each function contributes to the parsing and translating operations of the knowledge network.

One of the key advantages that the UPL command set demonstrates over conventional programming languages is that it operates exclusively on PBs and structures built from them. The PBs, in turn, are logical or physical bytes of the Host processor's memory. The operations performed by a UPL command—such as creating, deleting, moving, or comparing PBs—occur directly in the Host processor's CPU and RAM. This benefits the KDE because the UPL commands take full advantage of this primitive method of digital processing by directly manipulating PBs at the gate level of microelectronics. While the developer and the knowledge network operate on application knowledge, the UPL command set executes operations at the machine level of computing. A linguistic element of the application language, for instance, is directly encoded into the Host processor's machine byte(s) as a PB—the operand of the UPL command. When working with the UPL command set, then, one must be mindful that the relevant PBs and UPL command operations occur directly in the registers of the CPU. Programming through the KDE is equivalent to creating microprocessor instructions without the burden of tracking binary operations. (An easy way to think of this aspect of knowledge processing is to recall that the KP eliminates, or bypasses, the need for software and operates directly at the hardware level of computing. Envisioning a PB as the contents of a CPU register is a good way to look at the operand of the UPL command.)

Through the script editor, the KDE provides the UPL commands in pre-structured command syntax so that each command entry is enacted by using a selection box (drop-down menu) or by entering alphanumeric character strings representing the intended operations or linguistic network structures. The RE's interpreter or compiler (depending on the technology version) translates the UPL command syntax into Host processor machine instructions and data. Each command typically specifies a Command Name (64), or Mnemonic (an acronym representing the command's particular operation), a Command Variable (65) through which other commands identify the work performed by the current command (although not all commands use a command variable), and a complex Operand (66), which specifies the network structure upon which the command's action is to be applied, along with related parameters that help the command perform its particular linguistic action. The UPL function into which the command is inserted, or optionally, the KP's learning functions, specify the given command's placement into parsing or translating logic. The Command Line Number (67), along with the AND/OR (68) logic described earlier, determine the command's relationship to other parsing and translating operations. The command variables link the results of multiple command operations in a given function or throughout the network. Command variables are either Global or Local variables relative to a given function. The global command variable can be accessed by any function in a project, while the local variable can be accessed only by the function in which it is declared. Local variables are voided after the function using them has completed its linguistic action. The network structure that is to be searched or altered by a particular command is referred to as the Target Structure (of an operation) (69), while the PB and other parameters that specify the operation's referenced properties are referred to as the Reference Structures (and properties) (70).

A given UPL function, for instance, may use the Compare (bit fields) command (also referred to as the Test for command) by using one reference PB and one target PB obtained from, say, a target data set (a member of a node or GF structure). The result would constitute a machine-level operation that determines whether the target PB's bit fields match those of the referenced PB. The consecutive use of the Compare command on a range of PBs in the target structure has been consolidated into a UPL command referred to as the Select command. The Select command searches the target structure for PBs matching its reference PB. By successively comparing the PBs in the target structure to a referenced PB, the Select command loads the PBs, one PB at a time, into the CPU's registers and parses the application language's syntax directly in the machine's registers. If the referenced PB compares successfully to a target PB, then the command returns a true condition to the function logic. If the comparison fails, the logic progresses to the next OR command sequence in the script. Since each command utilizes a command variable, one command can employ another's action by referencing the previous command's Variable Name. The command variables are defined by any alphanumeric string conceived by the developer or by the KP's learning functions.

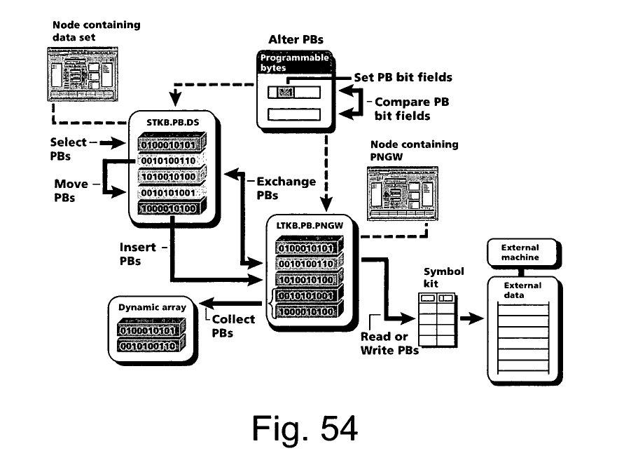

In order to appreciate the UPL command syntax, it is best to introduce the command set directly. Since the Select command utilizes most of the UPL command set's processor-level operations, and therefore serves as a model command for the UPL, we can provide a lengthier explanation for the Select command while introducing the remaining UPL commands with reference to the following discussion. (The commands and the KDE are discussed together in Section 7 where we demonstrate the programming of an actual application through the KDE.) FIG. 54 illustrates some of the general concepts supporting the UPL command set's operations.

6.2 Select Command

The Select command (71) enables the KP to search the STKB and LTKB to identify specific PBs and network structures by comparing the targeted PBs to a referenced PB specified in the command's syntax. The Select command is used extensively in knowledge processing applications because, once it is enacted, subsequent commands can operate on the PBs or network structures “selected” by the command's action. The Select command's syntax implies that the reference PB will be found in the target structure. What this means is that, instead of specifying two network structures in the command's syntax, each of which determines one of the PBs to be compared, the Select command syntax is written in such a way that the reference PB is assumed to be contained in the target structure so that only the reference PB and the target structure need to be specified. If PBs from different container structures must be compared, two separate Select commands are employed, wherein the previous Select command specifies the reference PB or target structure that would otherwise be absent from the subsequent command's syntax. The Select command operates in much the same way as the mind parses a written or spoken expression and identifies the elements of language.

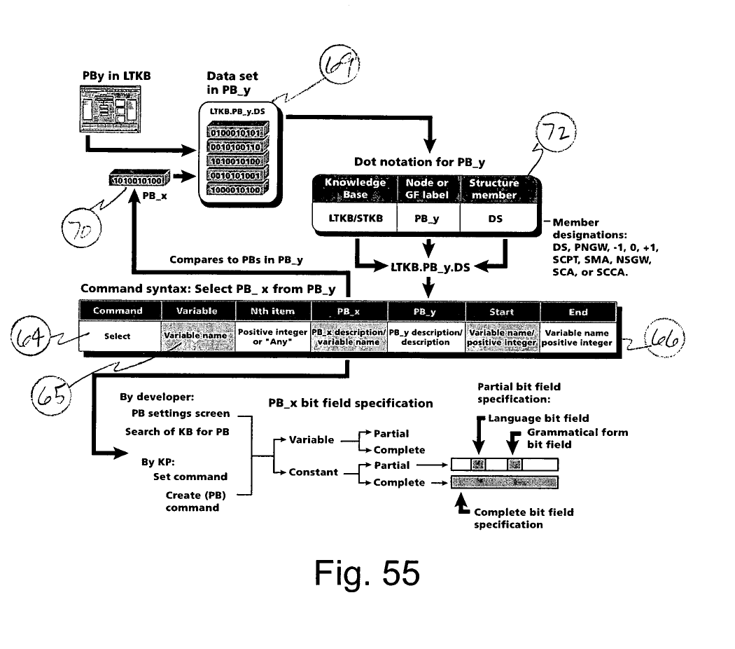

The Select command's syntax is shown in FIG. 55. The command is read aloud, in short form, as follows: “Select the -nth PB_x from network structure PB_y using variable name_z between the Start and End PBs,” wherein PB_x is the referenced PB and PB_y is the specification designating the node or GF structure containing the structure member to be searched. The variable name is a character string defined by the developer or the KP's learning functions to represent the command to other parsing or translating logic. By specifying the -nth item found in the array, the command can select a particular PB_x when more than one PB_x is identified in the target structure. The Start and End pointers are PBs used by the command to set the boundary conditions for starting and ending the search in the target container. If, for example, the Select command were to search for the second PB encoded as a verb in a specified target data set, the command variable Second Verb, would identify a command whose -nth operand is set to the integer number 2, within the boundaries set by the Start and End PBs. The Select command would choose the second verb (PB_x) found in the data set between the Start and End PBs. (The Start and End PBs would be determined by previous commands or would be specified in the command syntax.) The variable name Second Verb could then be used by other commands to identify the second verb (PB_x) contained in the data set.

The specification of the reference PB (PB_x) (69) and the target container (PB_y) (70) proceeds as follows. First, the reference and target PB's can be partially or completely defined, depending on the command's intended operation. If the developer or the KP desire to select a given PB on the basis of the PB's full bit field specification, then that reference or target PB's bit fields are entered in their entirety through the PB settings screen (or through the KP's use of the UPL functions). A partial bit field specification, however, enables the Select command to identify PBs in the target structure according to various combinations of bit field properties instead of the entire PB (say, according to language and syntactical level bit fields, or knowledge discipline, grammatical form, and root word bit fields). The reference or target PBs also can be constant or variable (and specified partially or completely). The constant PB is a “constant” (bit field value) because it specifies a unique PB that cannot change based on the execution of another command or function. A variable PB, which changes as function logic proceeds, can be global or local. A global variable is utilized by any of the project's functions, while a local variable is transparent to all other functions except the function in which it is used.

The command syntax that describes the target structure (PB_y) that is to be searched by a given command employs a dot notation (72) to define a pathway leading to the structure member in the network, as shown in the figure. According to the notation method, the leftmost operand of the syntax indicates whether the LTKB or STKB is to be searched, or both. The next operand specifies the node or GF structure to be searched, which is indicated by entering the node or GF label designating the target structure through the PB settings screen. If the PB arrays are to be searched instead of a structure member, then the acronyms NSA or GFA are entered, respectively indicating Node Structure Array or GF Array. The PB designators can be located by using the KDE's search tool, or by using the PB settings screen. A dot (period) precedes and follows the PB_y specification. The third operand specifies the member of PB_y in which PB_x is to be found. The acronym DS, for instance, is entered in order to indicate a data set, while PNGW is entered to specify a parent node gateway (of the target structure). A complete list of acronyms is shown in the figure and explained in detail in Section 5. The dot notation is read aloud as follows: “LTKB dot PB_y dot DS.” This notation specifies a data set in node or GF structure PB_y belonging to the long-term knowledge base. When specifying the components of the epistemic triplet (the prominent thought), the dot notation must designate −1 for the left or upper metanoun, 0 for the metaverb, and +1 for the right or lower metanoun of the structure member.

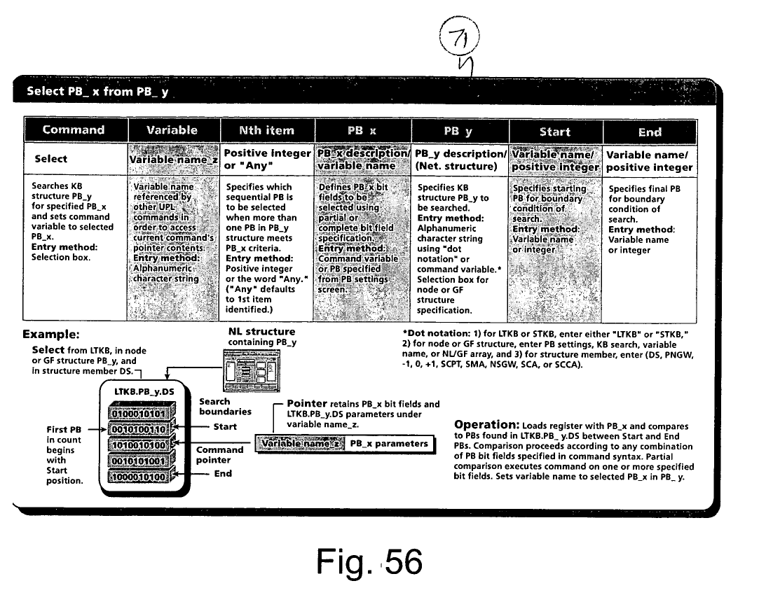

Finally, the search boundaries are specified by the Start and End pointers. The Start and End operands designate pointers (command variables or specified PBs) within the target structure that determine the search's boundaries. When the Start and End operands are not specified, the command interpreter (or compiler) assumes that the search starts with the first and ends with the last PB in the target structure member array. In this manner, the command syntax specifies a range of PBs within the target structure to search. (The Host processor's machine instructions “loop” on the elements of the array, beginning with the Start PB and ending with the End PB specified in the command syntax). The -nth item of the search specifies which PB should be selected if more than one PB meeting the search's criteria are found within the search boundaries. Entering the word “Any” in this operand allows the command to select the designated PB_x “anywhere” in the array. A summary of the Select command's syntax and operation on the network is shown in FIG. 56.

6.3 Find Command

The Find command (73) operates similarly to the Select command with one important difference. The Find command does not utilize a command variable. Thus, once a PB is effectively “selected” by the Find command, the “ANDed” UPL function logic simply terminates or proceeds. If the Find command does not locate the referenced PB_x in the target container, the UPL function discontinues the AND logic in which the Find command resides and proceeds to the next OR statement. The Find command thus determines whether a function's logic should continue or not. If, for example, a function's subsequent logic depends on the presence or absence of a particular PB in a target container, the Find command would be employed to “select” the PB from the container without setting a command variable to the PB for future reference. The function logic either continues or discontinues its ANDed operations based on the presence or absence of PB_x in the container structure.

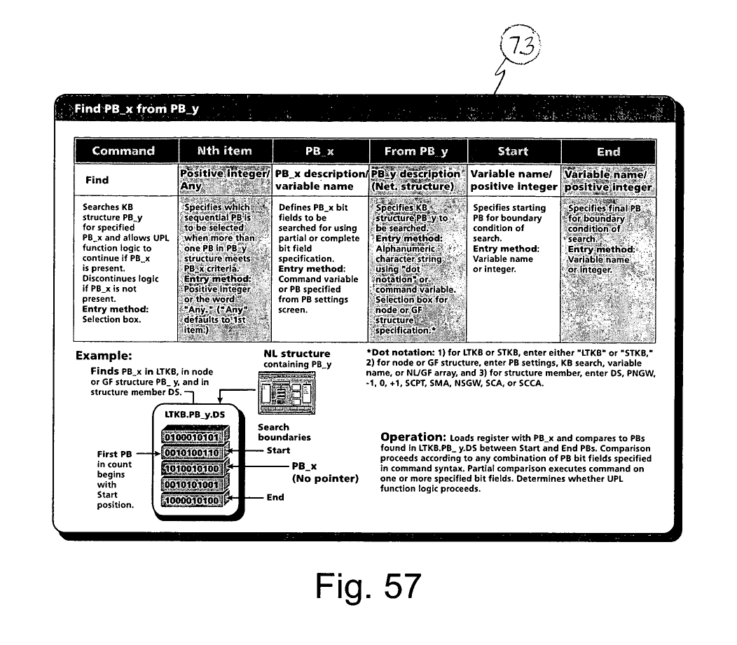

The Find command's syntax is read in the same manner as the Select command, except that the command variable reference is omitted. All other features of the command are equivalent to those of the Select command, as summarized in FIG. 57.

6.4 Locate Command

Frequently, the KP must determine the contents of a particular location in a structure member without regard to PB_x bit field settings (i.e., the command must select a PB based on its location in a structure member, rather than on the PB's bit field definitions). The Locate command (74) assigns a command variable to the location specified in the command's syntax, rather than to a PB in that location, as would be the case with the Select command. The command then assigns the contents of the selected location (the PB) to the command variable. The Locate command thus identifies a PB_x according to its location in the target container. The Locate command reads as follows: “Locate the contents of the -nth position in the PB_y structure relative to the starting location PB using Variable name_z.”

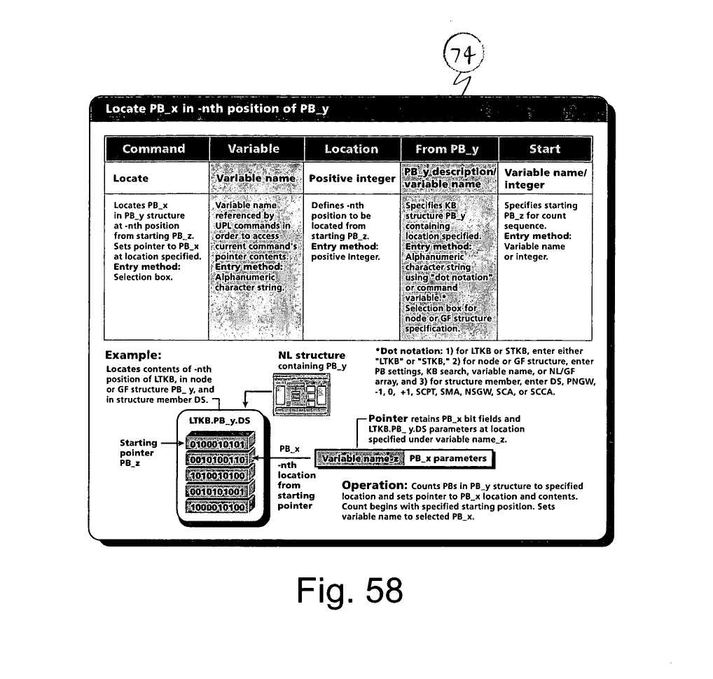

The contents of the specified location, as well as the location itself, can be referenced by other commands. (The contents of the location, however, may change due to the actions of other commands.) The developer specifies the PB's position as either a positive or negative integer, which represents a count from the initial position of the command's pointer designated by the Start pointer. The Start pointer is a command variable determined by a previously executed command, or is specified as an integer number. The command identifies the location specified by setting its command variable to the location that is “n” positions before (−) or after (+) the referenced starting location. Since the starting location can be a command variable, the count for the -nth position can begin with a PB or a location obtained by a previous command. The PB_y container operand designates the member structure in which the location is sought and uses the dot notation introduced for the Select command, as shown in FIG. 58.

As an example using the Locate command, we can imagine that we need to determine in a musical composition the timing of the fourth note after a particular whole note in a musical bar. We would Select the whole note using the Select command, and then use its variable as the starting pointer for the Locate command. The Locate command would then be set to the fourth location relative to the whole note in the “+” direction in the target container's array. The command would thus return a pointer to that note—say, a quarter note. Since the Locate command determines a PB based on its location, however, the developer must execute a Compare (Test for) command (explained next) in order to “test for” the actual contents of the location (the quarter note).

6.5 Compare Command

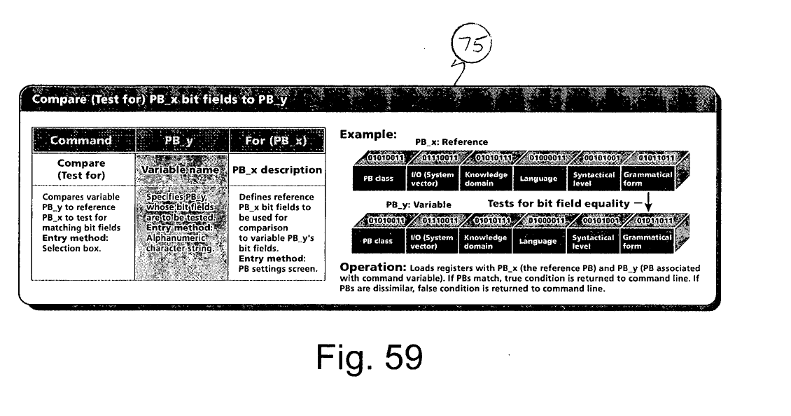

The Compare (Test for) command (75) analyzes the equality, or sameness, of any two PBs that have been identified previously through other command actions. The Compare command requires two command variables in order to operate. The Compare command compares the PBs specified in the command's syntax and returns a true condition to function logic if the PBs share the same specified properties, or a false condition if the PBs are different. A function may Select or Locate two or more PBs and then test one PB for the other's bit field properties using the Compare command, as shown in FIG. 59. Since the Select command, and many other commands, can identify PBs based on partial or complete bit field specifications, the Compare command, which operates on the PBs associated with other command variables, can compare partial or complete bit field specifications.

The command is read aloud as follows: “Compare (Test for) PB_x to PB_y.” The first operand (PB_x) specifies the command variable (PB) to be tested, while the second operand (PB_y) specifies the test conditions. The Compare command is typically used in connection with the Locate command.

6.6 Set Command

The Set command (76) converts a PB's bit fields to those specified in the command's syntax. The command modifies PB bit fields only. In the many examples of parsing and translating logic used for knowledge processing, a function frequently may not be able to determine the bit fields of a newly created PB until subsequent commands ascertain the bit field properties. Nevertheless, the function continues to operate on the PB as a “placeholder PB” that specifies whatever properties are known at the time of execution. Subsequently, a given function's commands will operate on the application language and determine the PB's essential properties as they proceed. Once the function logic has determined the appropriate bit fields, the Set command changes the PB's bit fields to reflect the new knowledge.

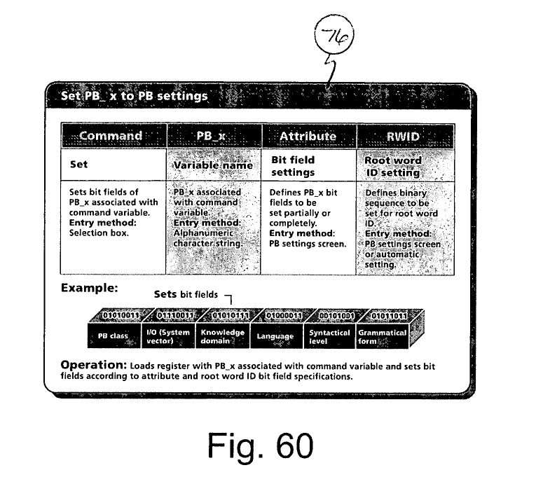

The command is read aloud as follows: “Set PB_x to PB settings.” The Set command may use a command variable from a previous command and apply the action of the Set command to the variable's specified bit fields. In this manner, the Set command operates on the bit fields specified but obtains the values from the PB referenced by the command variable. The Set command's syntax and operation are illustrated in FIG. 60.

6.7 Create Command

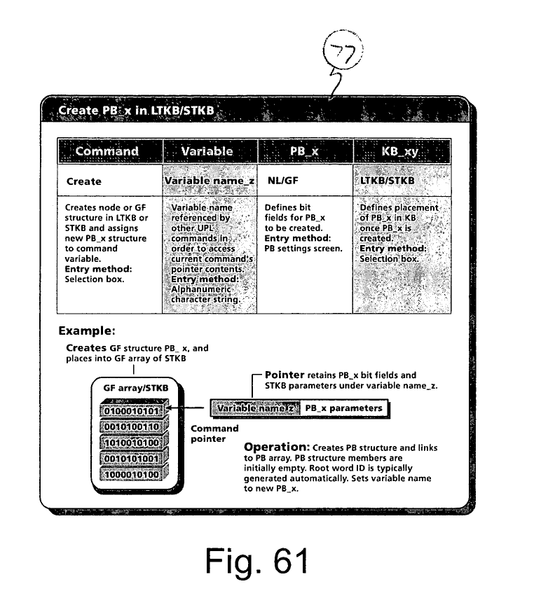

The Create command (77) allows the KP to create a new PB, which in the knowledge processing environment requires the generation of a new node or GF structure in the STKB or LTKB. The create command generates a new NL or GF structure in memory and assigns the specified NL or GF label to the NL or GF array, as shown in FIG. 61. Once the NL or GF structure has been created, other UPL commands can modify it.

The Create command establishes the bit fields of the proposed NL or GF label. The Create command syntax employs a command variable, as well as operands that specify the new PB's bit fields and whether the PB should reside in the STKB or LTKB. The PB_x operand specifies what structure is to be created, while the KB_xy operand specifies where the structure should reside (in the STKB or the LTKB). In the case when the developer determines the bit fields of the new PB at the time of project development, the developer installs the exact PB settings into the knowledge base, except for the root word ID, which the command generates automatically (so that each new structure has a unique root word ID). If the PB's bit fields are unknown at the KDE (i.e., before runtime), the Create command sets the attribute bit fields to zero. When the bit fields become known during the project's execution, the parsing and translating logic employs the Set command to continue the encoding of the PB using meaningful properties. The RE maintains the root word ID bit fields for PBs that have been retired from the application as part of the knowledge network's maintenance capabilities.

6.8 Collect Command

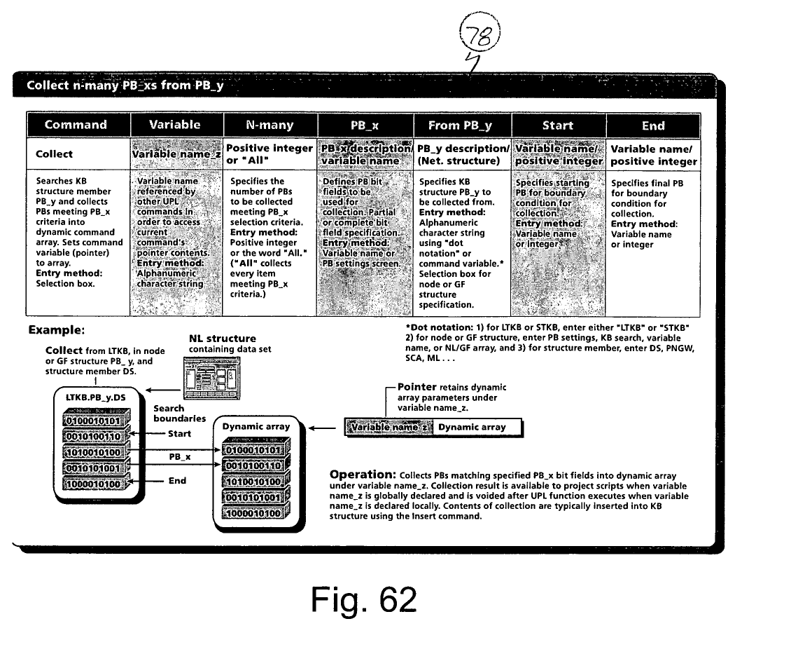

In addition to the basic Select, Find, Locate, Compare, Set, and Create commands, the UPL provides several other powerful commands to complete its repertoire of parsing and translating capabilities. One such command, the Collect command (78), assembles multiple PB's into a dynamic memory array, which subsequently can be transferred to a specified node or GF structure member through the Insert command (described shortly). The KP uses this command, for instance, when constructing parse trees from data sets during the data set splitting process described earlier. In this scenario, the Select (or another) command determines which PBs are to be collected (and from where), while the Collect command gathers the designated PBs into a command memory array, which is then inserted into a structure member array. The collect command logic shown in FIG. 62 moves the specified PBs into the command array for use by any other command.

The Collect command syntax specifies a command variable, which any other command can reference, and operands that respectively determine what PBs are collected (referring to the PB_x command field) and from where the PBs are to be collected (referring to the PB_y command field). Other commands can then analyze the Collect command's temporary array (the assembled PBs), and insert all or some of the PBs into a target container. The Start and End operands designate the boundary conditions for the search performed by the collection process. The N-many operand indicates whether all of the items specified shall be collected or a numerical limit shall be placed on the collection. The PB_y operand utilizes the dot notation described for the Select command (or, optionally, a command variable). The Collect command is read aloud as follows: “Collect N-many PB_xs from PB_y between Start and End PBs.”

6.9 Delete Command

The Delete command (79) deletes NL or GF structures from the knowledge network. Since the Delete command voids a specified node or GF structure from the knowledge base (STKB or LTKB), however, it eliminates part of the network's configuration—its webbing. The removal of any network connection can theoretically affect every other structure in the network.

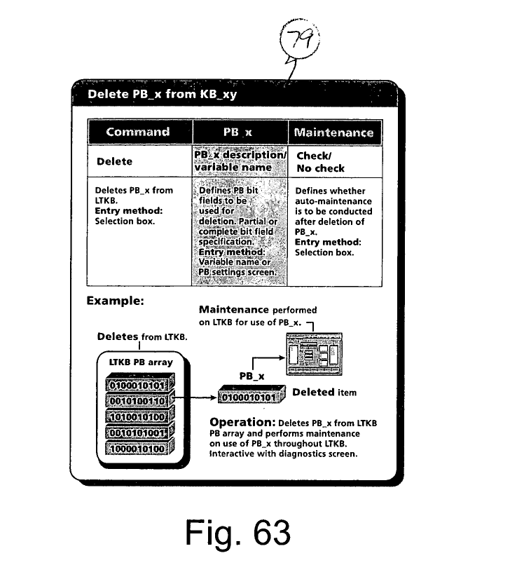

The Delete command syntax specifies the PB to be deleted from the PB arrays (from the network), and whether automatic maintenance routines should be conducted on the network before and after deleting the PB, as shown in FIG. 63. The diagnostic capabilities provided by the KDE allow maintenance to be performed on the network to analyze the network's linguistic integrity. The maintenance operand is specified by entering check or no check in the syntax field. It is worth noting, however, that database concepts, such as “data integrity” and “referential integrity,” are not absolutely relevant to the knowledge processing environment. Where data and information stored in databases by thinking people can be validated by algorithms, the knowledge network's “integrity”—its personal thoughts—are a subjective matter. Since the KP learns according to its own volition, its linguistic integrity is maintained by its own self-awareness, or its autonomous appraisal of the network's performance. Thus, the decision as to whether a knowledge network is “intact” once a PB is deleted ultimately is made by the intellectual capacity of the machine (i.e., by conversing with others). Nevertheless, the Delete command provides basic levels of linguistic and referential integrity checks when the Maintenance command operand is activated. The command, for instance, analyzes the network for instances of the deleted PB throughout the network and provides the developer with an analysis of network gateways that contain the PB for subsequent diagnosis by the developer. This allows the developer to view the impact of deleting the PB from the KDE.

6.10 Copy Command

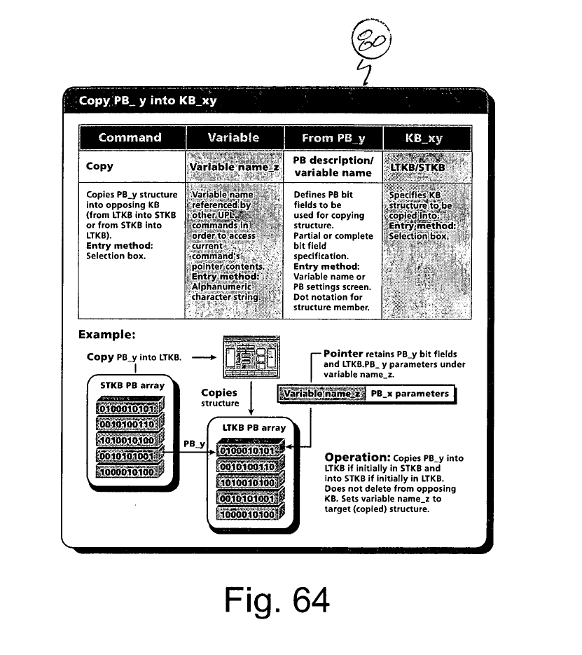

The Copy command (80) involves the movement of node or GF structures between the STKB and LTKB, as shown in FIG. 64. The command copies a structure contained in one knowledge base and inserts it into the other knowledge base. It is frequently used for transferring knowledge structures, and even portions of the network's webbing (i.e., “thoughts”), from static memory into active memory for the purpose of “imagining” new knowledge in active memory. The command is used less frequently for retaining knowledge in the LTKB because the LTKB affects the KP's long-term intelligence, which must be cultivated by genuine contributions to the KP's intelligence, not simply by imagined ideas that may not have relevance to the KP's intellect.

The command syntax is read aloud as follows: “Copy PB_x into KB_xy,” wherein the PB_x operand designates the node or GF structure to be copied, and the KB_xy operand specifies the knowledge base into which the structure is placed after it is copied. The Copy command allows, for instance, PBs input from the Read command to be copied into the LTKB when static memory must recall information in a manner similar to a computer or database (i.e., by “rote” memory).

6.11 Insert (Move) Command

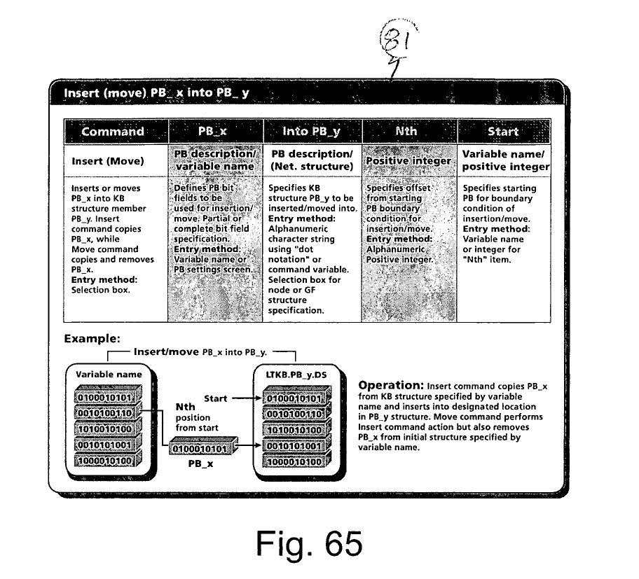

The Insert command (81) copies a PB referenced in one network structure into a target structure member, as shown in FIG. 65. The Insert command is similar in operation to the Copy command, except that it applies to the insertion of PBs—elements referenced in their container structures—not to the PB's designation of a respective node or GF structure. (The Insert command copies and inserts PBs into node or GF structure member arrays, while the Copy command copies the entire node or GF structure into an opposing knowledge base.) The Insert command syntax is therefore more complex than that of the Copy command.

The Insert command is read aloud as follows: “Insert PB_x into the target structure PB_y in the -nth location relative to the starting pointer PB_z.” A previously executed command variable usually specifies the reference PB_x, while the dot notation specifies the target structure PB_y. The operands PB_x and PB_y can be command variables or constants. The PB_z operand determines a reference PB within the target structure, relative to which PB_x is to be inserted. The PB_z operand can be a command variable. The -nth location represents a count in the forward (+) or reverse (−) direction relative to the PB_z operand. The Insert command places the referenced PB_x into the designated location.

The Insert command does not remove the referenced PB_x from its structure. In order to perform both an Insert and a Remove command on the referenced PB, the KDE provides the Move command. The difference between the Insert and Move commands is simply that the Move command removes, as well as inserts, the referenced PB_x into the target structure. These commands are used frequently in KP projects because they are the basic means for the knowledge network to perform translations among PBs in network structure members.

6.12 Remove Command

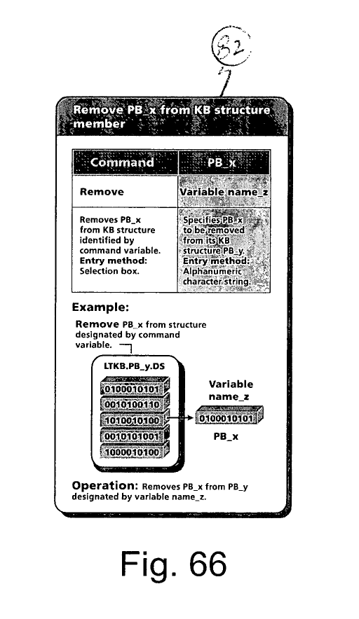

The Remove command (82) performs the same action as the Delete command, except that the Remove command acts on a structure member instead of the knowledge base. The Remove command syntax is read aloud as follows: “Remove PB_x from PB_y,” wherein the PB_x operand specifies the PB to be removed and the PB_y operand specifies PB_x's container. The same precautions taken with the Delete command are advised for the Remove command, since the PB that is removed from a given PB_y structure may have many other PBs associated with it, which usually must be removed from the container as well. Similarly, the diagnostic window prompts the developer during project development and script execution when the KP determines a problem with the network's linguistic structure. FIG. 66 summarizes the Remove command's syntax and operation.

6.13 Exchange (Swap) Command

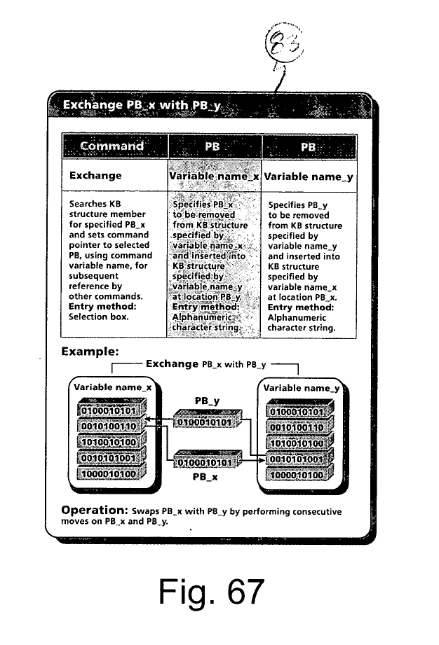

The Exchange command (83) performs two equivalent Move commands. FIG. 67 demonstrates how the Exchange command “swaps” a PB designated in one structure with a PB designated in a second structure. The Exchange command is read aloud as follows: “Exchange PB_x with PB_y,” wherein the operands are usually command variables (instead of previously specified PBs). The result of the command is that the PB in the PB_x operand's location in the structure containing PB_x is moved to PB_y's location in the structure containing PB_y and vice versa.

6.14 Call Command

The (function) Call command (84) invokes a specified function from a given function's command line. The command passes parameters to the invoked function, as described earlier, so that the invoked function can operate as designed on the related parameters. Since each UPL function is a member of a node or GF structure, the Call command specifies the particular node or GF designator (label) containing the function that is invoked.

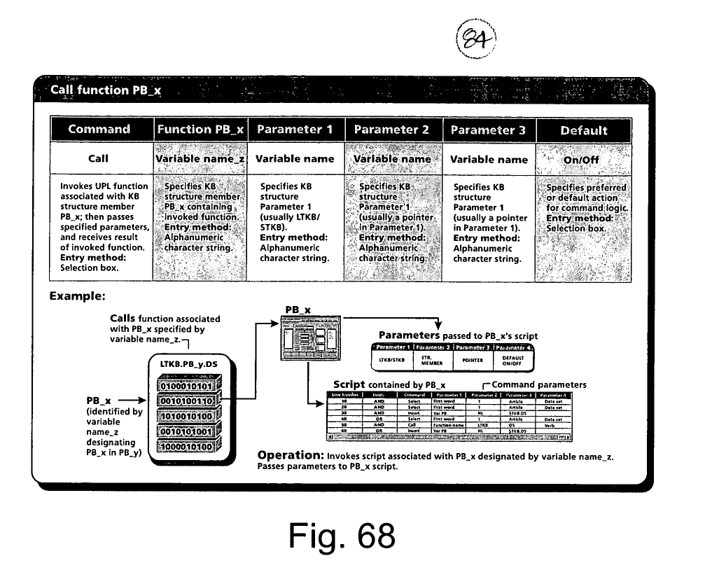

The command syntax is read aloud as follows: “Call the function contained in PB_x using parameters 1, 2, 3, and 4.” As far as the underlying source or machine code for the function is concerned, the parameters are variables passed to the invoked function. In order for the UPL function to operate properly, it must be made aware of the network structures on which it is required to operate. As indicated in FIG. 68, if the invoked function contains commands that operate on a data set, then the appropriate data set on which the function will operate must be passed to the invoked function as a parameter. Similarly, if the function's internal commands must operate on particular elements of the target data set in order for the command logic to work properly, the relevant pointers must be passed to the invoked function via command variables. While a function's parameters are generally defined by the developer, the recommended approach is to utilize the four abovementioned parameters to specify the target knowledge base and structure member (parameter 1), relevant PB pointers (parameters 2 and 3), and the default mode status (parameter 4). (Each function operates in a “preferred” or “default” mode, which indicates whether or not the function logic should take a default action if the command logic fails.)

The recommended function parameters are defined as follows. Parameter 1 designates the structure member on which the function will operate, such as a data set. The dot notation is used to specify parameter 1. Parameters 2 and 3 define command variables that point to those PBs in the member array that the invoked function will need to operate on, such as boundary conditions for a Select command. Parameter 4 indicates the function's default mode status. The default mode can be set globally or locally as on or off, while a third option allows the default mode to be set globally by the project and then reset dynamically as a local variable.

The function parameters can be used in any way the developer desires, providing that consistent parameter definitions are maintained throughout the project. Parameter 1, for instance, does not have to represent a member array. In fact, any number of parameters (not just 1 through 4) can represent pointers in a structure member, wherein the member is implied in the command's use. The number of parameters of a UPL function can be expanded based on project requirements. The UPL function also can return a true or false condition indicating the success or failure of the command logic. The analysis portion of any function should not permanently modify the member array on which the function's commands operate. (Only the “action” portion of function logic should alter a member array.) If the array requires modifications in order to facilitate analysis, the array should be copied into a temporary (STKB) structure and then deleted when the analysis is complete. Otherwise, when the action portion of the function is executed, the member array may be different from what the commands in the action's logic are expecting and erroneous results may occur. When the invoked function has completed its logic, a true or false condition is passed back to the calling function, along with any required parameters.

6.15 Return Command

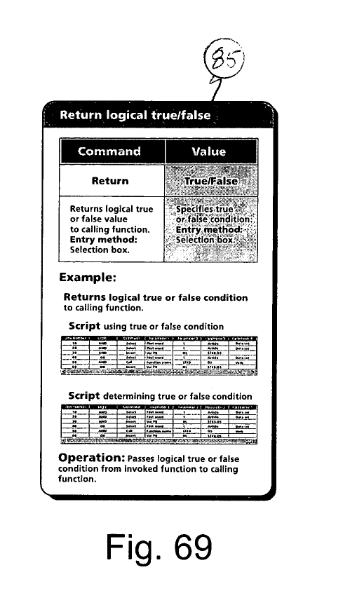

If an invoked function's internal command logic requires it to return control of the script to the calling function at any point in the command sequence, the Return command (85) relinquishes the function's control. A function command may determine, for instance, that the function should not execute any further because the particular PB on which the function operates is not present in the data set. The Return command would then return control of the script to the calling function. The Return command's syntax can be used anywhere in a function's logic. When a function encounters a Return command, the function's local variables are voided. The Return command's syntax and operation are summarized in FIG. 69.

6.16 Assign Command

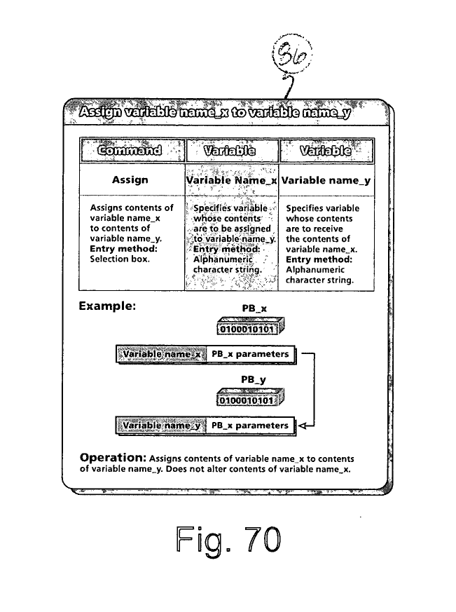

Any command variable can be assigned, or converted, to any other command variable through the Assign command (86), as shown in FIG. 70. The command variable assignment syntax is read aloud as follows: “Assign the value of PB_x to PB_y.”

6.17 Next Command

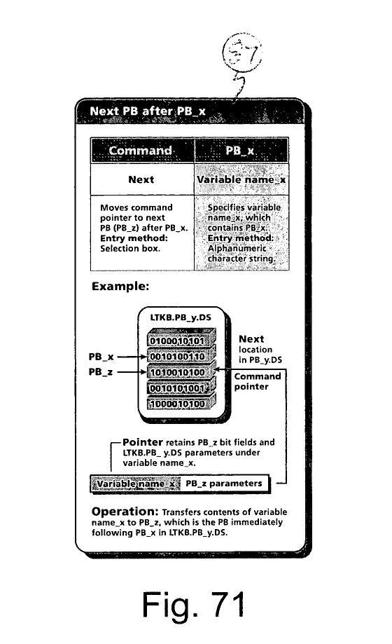

The Next command (87) is a simplified version of the Locate, Select, and Assign commands combined. The Next command “selects” the PB that follows PB_x in the target structure, and assigns PB_x's variable name to the PB that follows PB_x, as shown in FIG. 71. The Next command is used frequently in parsing logic when the UPL function must identify the PB immediately following a given PB_x (such as when an adverb modifies its verb). The command is read aloud as follows: “Select the Next PB following PB_x.”

6.18 Go to Command

The Go to command (88) operates similarly to a conventional programming language's “Go to” statement, except that, in the knowledge processing paradigm, the command is used less frequently in function logic. The command is not used that often because the analysis portion of the “analysis and take action” structure of the UPL function consolidates conditional statements, such as the Select command, into an “ANDed” sequence, while alternative logic is coupled through “OR” statements. Thus, in a well-designed UPL parsing or translating function, the AND/OR logic anticipates having to “Go to” another command line number. Nevertheless, there are instances in which a Go to statement reduces the time required to formulate UPL functions when more comprehensive approaches are infeasible.

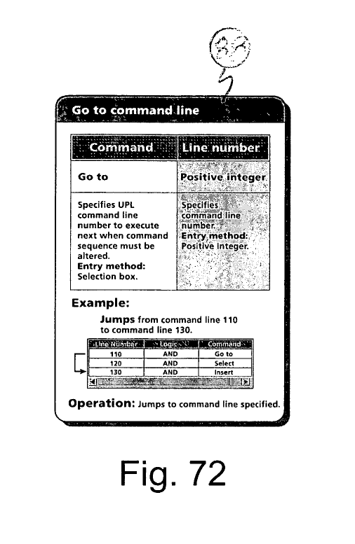

As shown in FIG. 72, the Go to command is read aloud as follows: “Go to command line.” Its only operand is an integer number that specifies the command line to be executed next in function logic.

6.19 Continue Command

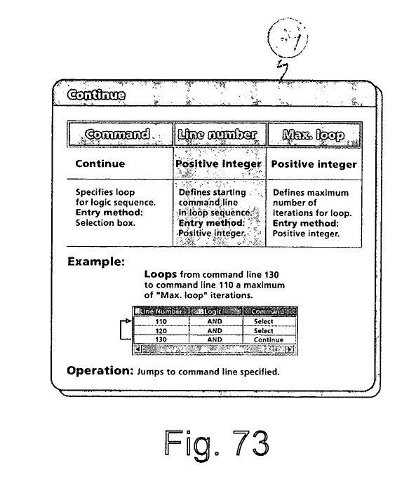

In order for certain parsing and translating functions to operate properly, the UPL function's logic must be repeated until a command line in the function encounters a specified condition. The UPL command that handles this iterative “looping” process is referred to as the Continue command (89), as shown in FIG. 73.

The Continue command's operation can be explained as follows. When the developer sets a Select command to identify a PB in a member array's first position, the command's variable points to the first PB in the array. We may then use the command's variable as the “start” pointer for a second Select command by using the same PB_x properties of the first command. If there is a second item in the member array with PB_x properties, the command will then select the second item in the structure with those properties. The Continue command allows the function logic to “continue” by looping to the command line specified in the syntax until the referenced command fails. Upon that command failure, the “OR” logic of the function continues. In order to discontinue the loop's logic at a definite number of iterations, the loop counter is set to an integer number.

6.20 Read and Write Commands

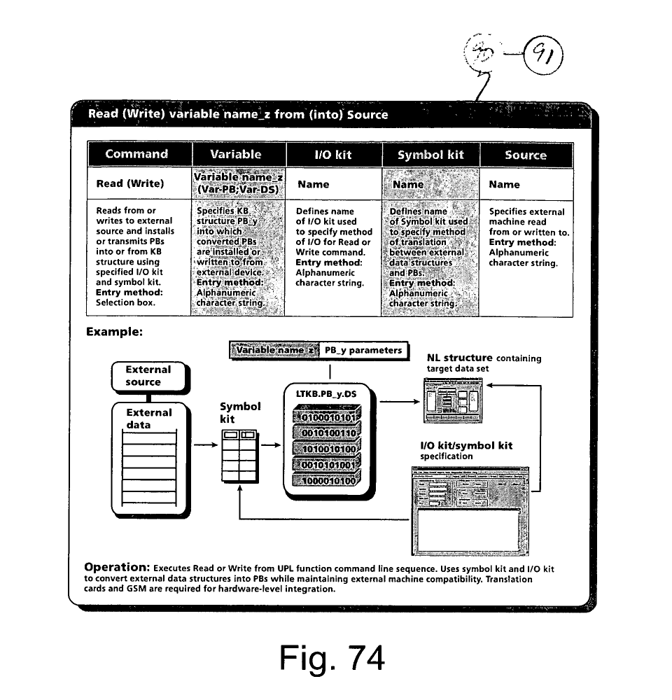

The Read (90) and Write (91) commands allow the UPL functions to control the KP's I/O processes, as shown in FIG. 74. In the CD/ROM version, the I/O Engine is software that facilitates the KP's communication with external devices and secondary memory, including the delivery of executable code. In the KP's hardware versions, the developer enables the Read and Write commands in a chip's logic specifically to implement the I/O facilities. The Read and Write commands thus require the specification of the I/O kit; the symbol kit; the source (or destination) of the Read or Write command in the communication; and the variable name of the STKB structure that contains the PBs to be input or output. The command is read aloud as follows: “Read (or Write) the contents of Source _x using I/O Kit_y and Symbol Kit_z under variable name PB_x.” The source (or destination) of a Read or Write command can be a Host file, keyboard, serial or parallel port, software “socket,” or any external configuration of software or hardware. When the commands are executed interactively (say, from a keyboard), the I/O engine operates by polling external hardware. Reading a file from the Host processor is accomplished by the I/O engine's “batch” communication facility, which is entered through the I/O kit editor.

The I/O kit determines the basic requirements for the input or output process. When the developer constructs an I/O kit, the Interactive or Batch modes of communication are specified, along with the stream type (text or binary) and the data type (bit, byte, multi-byte, file template, etc.) of the external machine. The symbol kit specifies the translation table used to translate the external structures and the Host's PBs. In order to “preprocess” external machine data when the KP's parsing and translating intelligence is not required (such as when reading data before converting it to PBs via the symbol kits), the Read command provides a conventional compiler-like parser, whereby the developer defines “tokens” that the command uses to truncate strings of data that will then be converted into PBs via the symbol kits.

The Write command functions the same way as the Read command but in reverse, thereby outputting to a machine. When writing to a device, the Write command reads the network's data set and converts the PBs into external machine structures, which are then transmitted to the external machines via the GSM. (Section 7 discusses the I/O engine further.)

6.21 Insert Command and Delete Command

The commands discussed thus far pertain primarily to intelligence that the developer can program into the KP's knowledge base. The commands neglect to define the KP's own ability to learn procedural knowledge.

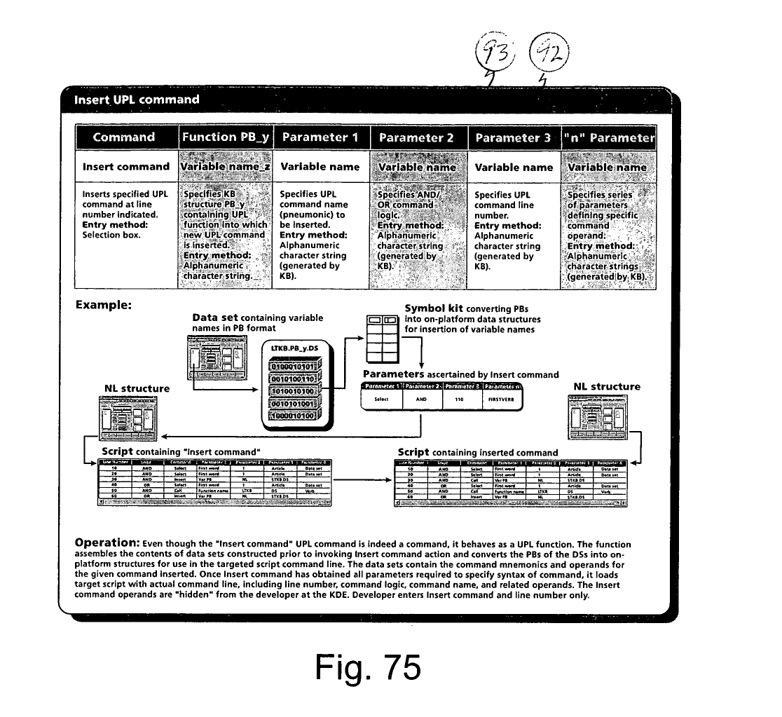

As shown in FIG. 75, the KP can install commands into its own function lines. Generally, the commands that allow the KP to create functions and commands are referred to as learning commands (92). The KP's autonomously controlled commands are the Insert (93) (or Delete) (94) Command and the Create (95) (or Delete) (96) Function commands. Here, we describe the Insert (or Delete) Command. The Insert UPL command allows one UPL function to insert any UPL command into another function's command lines. (The Create function command discussed in the next section allows the KP to create its own functions.) Since the function Call command can be inserted into any function by the KP, the UPL functions effectively create themselves. The Insert command is a tool used by the KP to create or modify any function's command lines. The key to understanding the Insert UPL command “command” (the command that inserts a UPL command) is to recall that the knowledge network understands language, and that a subset of the knowledge understood by the KP is that knowledge required to operate on file structures suitable for the Host processor (including ASCII characters). Thus, the Insert command requires the use of a symbol kit to translate the KP's knowledge of a UPL command into the ASCII characters used in the command's syntax, as shown.

The Insert command “command” (93) is a UPL function that relies on the work performed by other commands while preparing the function's parameters. The parameters that are generated by the actions of other commands (and functions) stipulate the mnemonic and operands of the command being inserted. In this manner, the Insert command reads the data sets containing the results of previous functions—the parameters in the form of PBs in various data sets—and converts them to Host processor ASCII (or other) format. The inserted command is then ready for execution by the RE since the function in which it is inserted already exists.

As shown in the figure, the developer designs the learning function and installs the Insert command. When the command is executed, it inserts the command specified by the parameters created by the previous commands and functions. The Insert command, which is itself a function, incorporates syntactical models of each UPL command and its syntax (operands) internally. Once the Insert command ascertains the command mnemonic of the inserted command, it solicits the related operands (as parameters) from its knowledge of the particular command's syntactical model. The parameters are managed as command variables so that other Insert commands can use them.

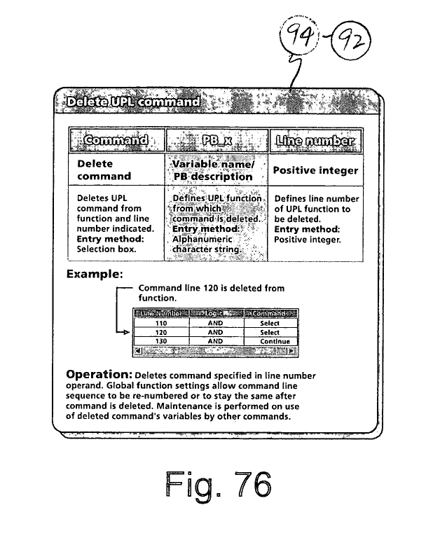

The Delete command (94) operates similarly to the Insert command, except, since the Delete command operates on the entire deleted command at once, its operand requires only a command line number, as shown in FIG. 76. The commands or functions invoking the Delete command specify that line number.

6.22 Create and Delete Function Commands

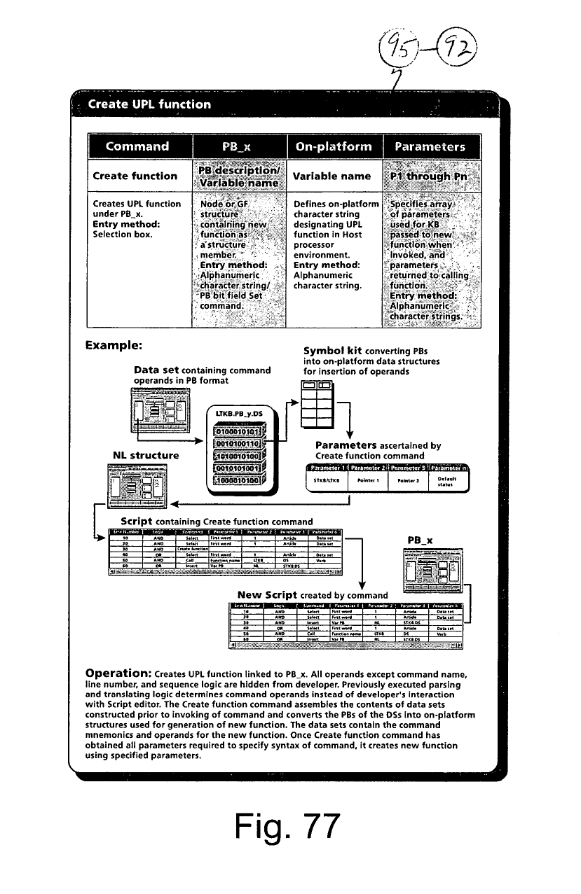

The Create (95) (or Delete) (96) Function command allows the KP to create its own UPL functions. The Create Function command operates similarly to the Insert command “command,” in that the parameters required for the command's syntax are developed by the knowledge network using previously executed commands and functions. The Create Function command requires a function name (PB) that designates the node or GF structure into which the new function is placed, as shown in FIG. 77. Once the previous commands have created or identified the NL or GF label for the function, the Create Function command generates the programmatic linkage necessary to couple the new function to the specified PB.

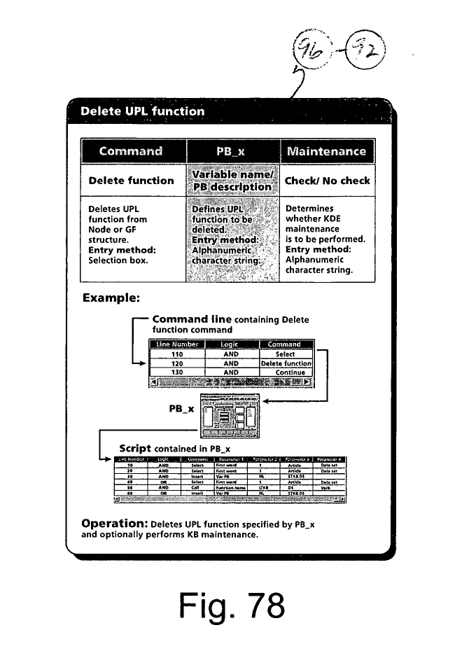

As shown in FIG. 78, the Delete Function command voids the new script's linkage to the PB structure. All functions and commands that are created or deleted by the KP perform the same linguistic actions described throughout the section for the developer's use.

### Section 7: KDE Programming and Control

7.1 Introduction

In this section, we concentrate on developing an actual KP project in order to demonstrate the basic KDE programming methodology. The section is intended to be used in cooperation with the CD/ROM version, which can be obtained on the Internet, and the sections, which elaborate on the fundamental principles discussed here. The section's mission is to help the developer to become fluent in using the KDE while gradually acquiring a better appreciation for the skill sets required for the knowledge processing paradigm. The section puts to practical use the structures and techniques discussed in the earlier sections and relies on the developer's creative participation in order to tailor the section's programming recommendations to the developer's project requirements.

In order to relate the KP's operation in a meaningful way to both the computer layperson and the engineer, while covering the necessary linguistic ground as well, we have employed a project that parallels the classical Hello world program to which developers become accustomed when learning conventional programming languages. In the section's discussions, however, we introduce one apparently minor alteration to the Hello world program that changes the exercise completely. Since the KP “thinks” while interacting with users (the programming of which is covered in the section's discussions), the KP's version of the Hello world program incorporates a knowledge network that understands the expressions used, rather than simply outputting them to the machine's interface. The developer can program the actual application by using the KP's CD/ROM version as we proceed or simply follow the discussion by interacting with the preprogrammed CD/ROM. According to the exemplary application, the KP will receive input from the developer at the keyboard, usually after outputting the expression Hello world through the monitor. Based on the network's intelligence, the developer and the KP will interact with each other in natural language concerning the KP's knowledge of arithmetic. The KP will understand the arithmetic, rather than computing it, while placing the mathematics into broader context requiring a metaphor to understand. The arithmetic will also allow us to keep the exercise simple so that we can focus more on explaining how to operate the KDE than on the KP's use of the English vocabulary.

We refer to the exercise as the Hello world; I think project. As we shall see, the insertion of just the two words I think into the conventional programming demonstration will require the section's length to explain fully. (For brevity, we will refer to the Hello world; I think project simply as the Hello world project. The thinking machine implications will be understood.) The reason for choosing the example is, of course, that the KP will have to understand the meaning of language in order to interact with the user and to express that it “thinks” while constructing a metaphor. Meanwhile, the arithmetic will give us the opportunity to demonstrate the construction of simple parsing and translating modules that can be used later in the section's applications. During the exercise, we discuss variations of the project that demonstrate more complex applications which the developer may soon appreciate. The example also can be used for conceptualizing the KP's knowledge network in terms of traditional computing applications, which are summarized in the sections.

In the exercise, the developer will input to the KP, through the Host processor's keyboard, the expression What is 2+2? after the KP has greeted the developer by outputting the expression Hello world through random dialog. The decision to communicate with the developer will be made by the KP's I/O strategy, which will support the KP's pursuit of new knowledge. The developer will construct the knowledge network and UPL modules necessary to enable the KP to interact with the developer by comprehending language in the universal grammar and transforming the expressions involved. The KP will answer the developer's question metaphorically by outputting the expression Two plus two is a fact in addition to replying that 2+2=4. The dialogue will continue until the developer is satisfied that the KP is “thinking” rather than implementing a program. (The exercise also elaborates on FIGS. 2.1 and 2.2, which highlight the basic differences between a computer and the knowledge processor.) The developer's use of the KDE is illustrated in the figures and explained in the text as we proceed with the project's construction.

7.2 KP Project's System Requirements

Before considering the application's programming, we should discuss several important preliminary issues concerning the project's overall system requirements. According to the knowledge processing paradigm, the developer decides whether a given application will be implemented on a microchip, a microprocessor, a computer or network architecture, or a software application according to the developer's definition of the “Host processor.” The developer also determines how the Host processor will interact with, and perhaps control, a network of machines or people—even if that network is an enterprise system or the Internet. The developer thus decides, along with other considerations yet to be discussed, what system interfaces are required, along with what platform technologies are required to support the KP's intelligence. The developer also may determine how the KP application will enhance existing technologies designed or used by the developer. Whereas the software developer is ordinarily provided with a computer system by the industry's supply-driven capacity, the KP developer “becomes an industry” by specifying the KP application, from integrated circuits to graphical or acoustic displays.

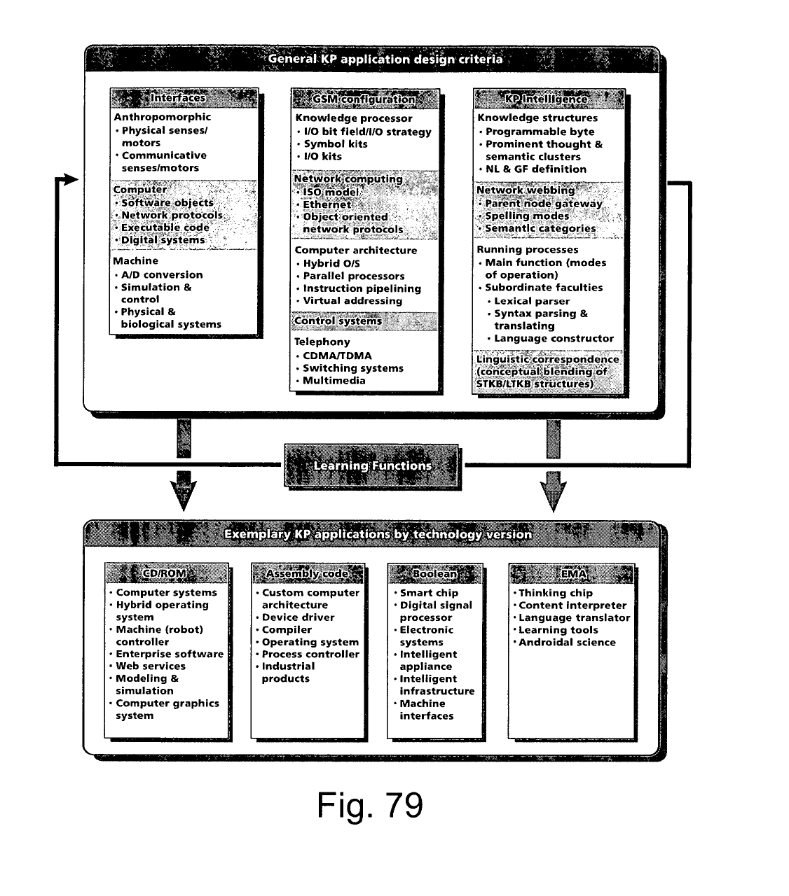

In order to appreciate the programming accomplished for the Hello world project, it is worthwhile to review some of the concepts and techniques introduced in the earlier sections in order to establish the KP's system requirements. While the entire scope of KP system requirements reaches beyond the purview of this specification, the following discussions present those requirements necessary to implement the Hello world project as illustrated. FIG. 79, which highlights exemplary KP system requirements, is referred to throughout the following discussions.

7.2.1 Interface Requirements

One of the first key objectives of any KP project is to determine the types of interfaces required for the KP to interact with other machines and people from the Host processor. Contemplating the interface requirements ahead of time will give the developer additional insight into other application requirements, such as the technology versions and intelligence levels required. There is, however, an endless array of potential interfaces from which to choose, each instance of which may require a different level of intelligence and communication skills on the part of the KP.

As an example of how a KP project's system requirements can be affected by the types of interfaces used for an application, we can ponder the intelligence that would be required to understand a simple keyboard entry containing the expression “That is an apple?” The only realistic way to enable the KP to comprehend the word apple is to give the machine senses and motors in order to perceive that an apple is a red fruit (involving the sense of vision) that is semi-hard (to the touch), tastes sometimes sweet, other times tart (requiring taste buds), and makes a crackling sound when you sink your teeth into it. (The KP would also require teeth.) In this case, the KP would have to be designed with senses and motors to perceive these qualities and to integrate the experiences into a single phenomenon—namely, that of knowing what the word apple means. The interface, in this case, would be a keyboard coupled to a fully enabled anthropomorphic “machine-being,” the scope of which is beyond this specification. Thus, in order for the KP to support the interface—the keyboard—an android would have to be constructed that could verify its use of language through physical senses and motors “in reality.”

While the androidal approach to machine interfaces is indeed the only “true” way to enable machines to think, there is an alternative method that dominates the knowledge processing paradigm. Specifically, elementary KP applications employ the use of linguistic context in a symbolic processor. The KP can validate its use of language by comparing expressions in the STKB to those stored in the LTKB. Only in advanced androidal applications does the KP project require that the LTKB structures further correspond to physical phenomena perceived through senses and motors. In the foregoing example, then, the KP would understand what the word apple means by storing linguistic context (network webbing) that symbolically represents an apple as a red fruit . . . , and so on. The KP thus understands language by comparing active (STKB) memory and static (LTKB) memory, through the action of the running processes, without further translating either memory structure into the actions of physical senses and motors. Providing that linguistic context exists in the knowledge network with which to transform the input expressions, the KP's cognitive operations can be entirely symbolic. In these applications, the developer is concerned with interfacing the KP with people and machines in a manner that gradually enhances current technologies, rather than replacing them with an android. These more elementary applications require the KP to manipulate symbols only. A database, application software, and even network processors, for instance, require only that symbols be manipulated and transmitted through their interfaces. In these systems, the KP does not have to sense the symbols (along with the physical world) in order to validate its use of language. In these more rudimentary applications, the developer must decide how the symbols will be communicated to the user (human or machine) and what intelligence will be required in order for the KP to understand the application language.

An enterprise database that contains airline reservations, for instance, may simply need to be made more user-friendly. In this case, the KP project would translate the linguistic content of the database records into localized information or language. This would occur, for instance, when a calendar date contained in a record of the database must be expressed in natural language instead of, say, integers. The KP application would thus interface with the database, and perhaps the user, by translating an integer-based date, such as May 1, 2004, into, for instance, the natural language expression the first day of May this year. (The developer may wish to contemplate the interminable variations of interfaces and intelligence required for symbolic KP applications.) When it is considered that devices such as telephone systems, graphic arts programs, word processors, mathematical modeling tools, and entire enterprise management systems manipulate only symbols, the developer can become inundated with system requirements regarding interface types and KP intelligence levels.

In many practical applications, including the Hello world project, the developer designs, say, a Visual Basic (or other programming language's) interface to be run on a PC or server, while implementing the KP's intelligence through the KDE. This type of interface requires the integration of a Visual Basic application into the RE, or vice versa. (The conventional interface would invoke the RE or the RE would initiate the VB interface.) In another application, a language translation interface may involve the use of two application windows that depict text in one language, and its translation in the other. (A third window may display the translation operations.) Similarly, the developer may desire to provide KP intelligence in a computer graphics program, in which case the programming objects of the graphics system (layers, shapes, or colors, for instance) would interface with the RE so that the graphical elements could be manipulated as PBs. In still other applications—word processing, for instance—the developer may desire to provide KP intelligence that suggests metaphors to the user when creating written documents. This interface would operate similarly to a conventional spelling-checker but would use the KP's intelligence to create metaphors instead of a conventional computer program to verify spelling.

Moreover, the developer must determine the on- and off-platform displays to be used during KP application development. When graphic arts or musical applications are the focus, for instance, the KP application manipulates the grammatical forms of colors, shapes, and textures (or musical notes, melodies, and harmonies). In order for the developer to work with a color or hear a musical note corresponding to an NL or GF structure (or a parse tree composed thereof), the KDE's off-platform display must be engaged through the PB's display protocol bit field. A rain cloud of a work of art (puffy swirls with droplets), for example, must be generated by a graphics program in order to display a single NL or GF structure that will subsequently transform with another NL or GF—say, that for a landscape. When the drawing is changed, the new NL or GF structure must be displayed to the developer's satisfaction. (Even text-based applications require the developer to make decisions involving the display of symbols that are not, for instance, in the ASCII or Unicode character sets.) The developer thus must prepare the off-platform displays that will be used for the application. Time spent up front designing the KP's interface requirements before engaging with the KDE to build the actual application will be time saved in the overall KP application design effort. (We will address the machine interface and I/O requirements for the Hello world project as we proceed.)

7.2.2 Technology Version Requirements

Another important KP application requirement is the technology version employed. The developer must decide which technology version will support the application as a Host processor. The CD/ROM version, for instance, is designed to enable any commercial PC or network server to begin knowledge processing in a conventional computing environment. The developer can build KP applications directly from a PC or server with the CD/ROM version. The drawback to this version, however, is that it is implemented in source code and is installed onto an operating system. While the CD/ROM version allows the PC or server to adapt to the KP paradigm, the version is a quintessential example of computing overcapacity. In this case, the KP application operates according to the Host O/S's provisions for program management and process control. Thus, for applications involving the integration of chip-level hardware, it would be inefficient, to say the least, to use an operating system, which runs on a microprocessor, to couple one microprocessor to another for, say, a multiprocessor application. (As mentioned earlier, even a commercial microprocessor's instruction set is virtually unused by the knowledge processor, but for the most basic fetch, store, and count instructions.) One of the advantages of knowledge processing is that it eliminates the software pyramid that complicates the relationship between the user's thoughts and the microprocessor's architecture. (The programmable byte represents the application language directly in the microprocessor's bytes.) Thus, why use software to implement a technology that eliminates software? The CD/ROM version is therefore typically used for training programs and applications that must be “backward compatible” to contemporary computer systems.

The KP allows the developer to integrate any hardware with any software—and any architecture in between. These system requirements must be contemplated before establishing the actual knowledge network's design. Alternatively, the developer may desire to operate the KP in the CD/ROM environment on the Host machine so that any application software running on the Host can be enhanced by the KP's intelligence. Improvements to Internet, PC, and enterprise systems usually result from KP applications running on the Host processor in the CD/ROM version. (Just about any conventional computer application, including operating system integration, can be performed by the CD/ROM version.) One of the most important points to remember about using the KDE, however, is that the developer works with the UPL and the application language directly in the Host processor's machine bytes. As the developer interacts with the KDE and contemplates the KP's action, the KDE manipulates machine bytes that relate to external machine structures and their embedded language through the symbol kits. Thus, even when the developer momentarily forgets this “direct-programming” feature of the KDE and is mislead into thinking about the application at a software level, the project still refers to PBs that reside in the microprocessor's architecture. In this sense, any KP application is a “hardware design.” Concerning KP applications, then, the choice of Host processor technology should be made on the basis of what technology version most suitably handles the PBs at an architectural level even if the decision is ultimately made to use the CD/ROM version in order to integrate the KP into an existing system.

7.2.3 External System Requirements

The KP can interact with and control network systems intelligently. The advantages gained by using the KP's intelligence on network configurations are empowering but add responsibility to the overall design effort. Whereas today's computers and Internet applications require industry's participation to render devices such as network routers, hubs, repeaters, and the like, the KP developer builds an entire communication system as part of the GSM's inherent design. Thus, whereas today's communication systems rely on industry to determine system protocols (such as the ISO standard, TCP/IP, and CDMA/TDMA technology), the KP developer is required to understand and develop a global system model that will decide how each element of an application language will be embedded in and transmitted by a carrier technology. (Of course, these considerations are unnecessary for applications that do not involve network systems. We should note, however, that even a microprocessor's system bus is a “network” of sorts that requires GSM involvement.)

A conventional network technology, for instance, embeds a message in a data frame. The message is referred to as content. The traditional network system, however, is unable to interpret linguistic content, while each network system is designed and marketed by an industry vendor as a complete system that operates according to a communication standard. The KP, on the other hand, is a knowledge network that understands language in such a way that each element of the application language (each PB) is encoded with I/O protocols. The KP is therefore capable of examining the content of any communication as well as the network protocol associated with transmitting that content. Concerning network cryptography, for instance, it is common knowledge that the best “key” to deciding whether a party to a communication is actually who they purport to be is to conduct an interview. The problem faced by conventional network technology, however, is that a system cannot conduct intelligent interviews that would ascertain a caller's true identity. Alternatively, the KP is able to conduct network communications on the basis of semantically retrieved information. The developer thus must consider network systems in terms of how best to utilize the KP's intelligence to understand the content and the network protocol involved with a given communication. Similarly, Internet search engines do not ordinarily utilize machine intelligence to comprehend and analyze language. Whereas an Internet search engine is capable only of conducting Boolean searches once a directory of information is accessed, the KP can read the actual content found on the Web to determine whether the search results actually contain what the catalogued titles indicate.

In a given KP application, the developer must consider these features of the GSM before actually setting out to design a project. Because the KP operates at the machine level of processing (via the PB), any byte of information can be analyzed, side by side with any other, according to network protocols or linguistic meaning. The KP can examine the contents of a data frame, or the data frame's protocols, and make processing decisions accordingly. This GSM feature allows the KP to manage, for instance, the parallel execution of microprocessor instructions while accessing a global network of processors from the same data set residing in the Host processor's RAM. (We are only “warming up” to the Hello world project by summarizing general system requirements. The discussion will be simplified from a network computing standpoint as we proceed in order to demonstrate the Hello world project presented in the section.)

7.2.4 Intelligence Requirements

Still referring to FIG. 79, the most challenging aspect of a KP application is determining the level of intelligence required for the project. Machine intelligence is not even required, for instance, when a known procedure must be executed by the KP in order to operate similarly to a computer program. When the KP performs a language translation, according to preconceived translation rules, the procedure is simply memorized and repeated by the KP (albeit, through network structures). We might consider, however, how the KP would translate idiomatic speech. In this case, the machine must think by translating language metaphorically. The machine must be capable of engaging in dialog in order to understand the idiom. The KP must inquire about the meaning of the expression as it relates to the network's existing knowledge. It must place the idiomatic expression into the network's context. The KP's translator must create NLs and GFs, and in fact an entire portion of network webbing in the STKB, that explains the expression in context. Accordingly, an extensive linguistic application must be constructed in order to support idiomatic speech, whereas simpler applications can handle the straightforward translation of language. (The metaphors, similes, synonyms, and other conceptual blending techniques used for basic language translations are simpler than they are for idioms.) The developer must consider these potential complexities, for instance, when conceptualizing the learning functions that support the translators.

Alternatively, a computer's compiler operates on computer languages that are intentionally simplified in both syntax and meaning in order to reduce the linguistic complexity of the compiler. Compiling source code into multiprocessor machines distributed throughout a global network of machines is actually easier and quicker than constructing a machine that can understand that “a watched pot never boils” (an idiom). Nevertheless, the KP handles either case, and the developer must decide what learning strategies and basic intelligence to use for the application. (The more the developer tends to lock a KP application into a conventional computing paradigm, the less intelligent the KP application will be because it is limited by the given computing convention. The developer who incorporates KP principles and practices, such as the I/O strategy, into network and workstation computing, however, will achieve an intelligent system that understands language and learns through powerful metaphors.)

7.2.5 Cultivation of KP's Intelligence

Once the system requirements have been established for the KP's basic design, the application's long-term objectives become the focus. The learning functions must be designed and the modes of operation controlled so that one microchip or software application becomes a “biologist,” while another explores its talents as a poet. The learning functions affect the application even in terms of setting up the PBs in the first phases of the application's development. While the biological application may rely on natural language and organic chemistry bit fields, the poetic microchip would know molecules as “tiny clusters of interconnected marbles”—each application requiring its own unique use of metaphors and other linguistic transformers. When building even Internet search engines that think, the developer must guide the application into a certain field of expertise or else the KP will become a generalist that dabbles in everything but excels at nothing. The question as to whether or not the KP should even bother to contemplate a philosophical expression during a search for the price of asparagus must be weighed against the machine's time constraints. Even if the application is an EDI/XML translator for B2B communications, the question will arise as to whether the machine should be capable of learning new EDI data structures without the developer interceding. The KP's long-term intellectual autonomy is determined by how extensively the learning functions participate in the application.

7.2.6 Knowledge Continuum Integration

The longest-range system-level requirements of a KP project must recognize that KP applications are not built in isolation from each other. Other developers, along with business, industry, and the engineering community at large, are building machines and technology around the globe. The developer thus must consider how a given KP application integrates into a global infrastructure of systems and technology.

It is very effective, for instance, if an application does not have to translate external system protocols according to computer industry standards in the first place when constructing global infrastructure. It is much simpler to transmit PBs in their “natural” form—as programmable bytes—instead of data structures defined by particular computer architecture or software protocols. In this manner, globally configured machines can interact on the basis of how their PBs relate to each other instead of first having to translate the external data structures into PBs. A most elegant form of “data compression” is achieved when the data (language) is defined through linguistically encoded PBs. The data is then simplified, or compressed, naturally in its encoded PB format. Accordingly, the developer must decide whether it is more practical to translate external structures into PBs or to retire the external technology and employ a knowledge processor that can exchange PBs directly.

Similarly, many engineered systems operate according to “world models” defined by engineering principles. The developer must decide, for instance, whether it is worthwhile to integrate a knowledge network into a system's world model—which usually cannot relate to KP intelligence because it operates on engineering theories of design exclusively—or to redesign the system's world model so that forces, torques, and other engineering parameters become knowledge that can be understood by the KP. In this case, the symbol kits and GSM are used to convert external machine parameters—such as forces, torques, speeds, and the like—into “perceptions” that are related to the KP's LTKB. In this manner, the machine can communicate with the operator in natural language about its own operation. Thus, KP applications should be considered in terms of their long-range integration into global knowledge infrastructure, since prior to the advent of knowledge processing, system designs were not burdened with the idea of a “machine society” that thinks and learns along with us. The long-term implications of the KP's language skills therefore must be contemplated in terms of their effect on existing infrastructure and how they contribute to the evolving “Rg Continuum” (discussed in Section 8).

7.3 Setting up a KP Project

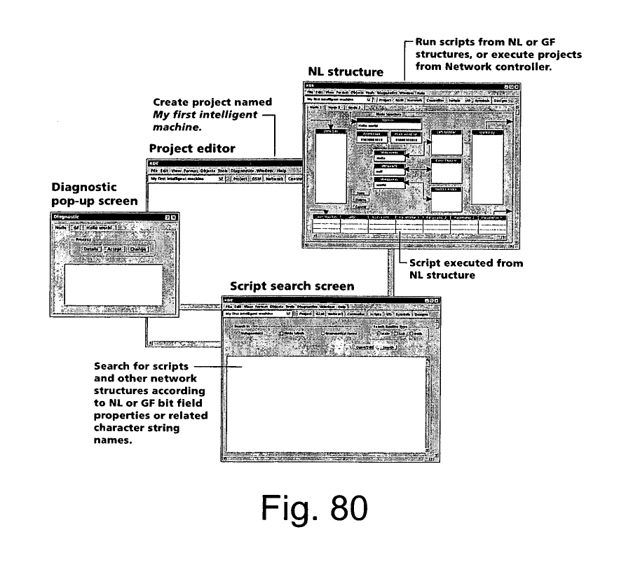

Once the CD/ROM version is installed, a KP project is created from the toolbar at the top of the project editor shown in FIG. 80. The project list is available through the File and Projects options, while the other editor screens, such as the editors for the Input/Output Kit (97), the Symbol Kit (45), the Knowledge Base (10 and 11), the Scripts (6), and the PB Settings, (98), are accessed through the respective toolbars or the Objects option as shown. For the Hello world application, we shall create a new project from the File option and call it My First Intelligent Machine.

A KP project specifies the network structures and UPL modules required for processing the application language, along with the GSM and system I/O capabilities. The developer can initiate a given running process by calling its NL or GF structure and executing the script from the structure's toolbar, or by identifying the script's conventional O/S directory name (character string) accessible from the main toolbar, as shown. When a project is opened through the File or Project options, the KDE creates a Host-based O/S file that contains the knowledge network (2) (usually in the C++ programming language) along with the RE (7) and its UPL interpreter. (In other versions, such as the EMA, the project is saved in the particular assembly language, or “executable code,” after compiling the knowledge network.) A particular script thus can be obtained and executed by navigating to the NL or GF structure containing the script, and then applying the Run option for that script. If the subordinate function that is navigated to requires variables to be passed to it, the Script parameter screen will appear, and the developer's input at the KDE will simulate a calling function. The developer thus invokes the function and passes parameters to it in order to execute the function apart from the main script's control of the application. (This procedure is usually enacted for diagnostic purposes during script or KB development.) At the moment, we will not run any UPL function for the Hello world project, since we are getting familiar with the interface only.

When creating any network element except for a project, such as an NL or GF structure, the developer calls that editor and depresses the New option on the main toolbar, which is always present. In circumstances where it is advantageous to create a new project element that somewhat resembles an existing element, the Duplicate option can be used instead of the New option. This KDE feature will create a new element whose properties exactly correspond to the element copied, except for the automatically generated root word ID. The Delete option is employed in order to remove an item from the project. (The ramifications of deleting an item, however, especially an NL or GF structure, could be severe, as discussed in Section 6. The KDE's internal diagnostic tools therefore send messages to the diagnostic window if more deletions or other actions are required.) The Save option, available on the editing screens, is used for all other editing once the given element has been created through the New option.

In the KDE, a project is saved as a file on the Host O/S and downloaded or linked to other processors via the GSM. A project can be linked to any other application running on the Host through the O/S protocols, such as through the Com interfaces or Object-oriented Network Protocols available through the I/O engine. A project's RE can also be integrated into executable program libraries and implemented as part of other applications. A project can be downloaded to TCs or to the EMA by compiling the project into the respective platform languages. In the compiled versions, the running processes and knowledge network become part of the external programming environment. When using the RE's interpreter, an external program, such as Visual Basic or C++, can invoke the project as an object. (The interfaces for the Hello world application use this option.)

The developer accesses a particular network structure once it has been created by “searching” the network from the search screens, as shown. The majority of KDE screens, such as those for the symbol kits and NL and GF structures, provide both a search tool and an editor. The network can be searched by the developer, as well as by the running processes, by examining the project's PB arrays for the network element selected. The NL and GF structures are accessed by specifying their NL or GF label bit fields in the search screen's data entry fields. Before there are any network structures in the LTKB, the initial NL and GF structures are created by using the respective editors.

Depending on the technology version employed, the RE will be implemented as an interpreter on the Host O/S, compiled into commercial microprocessor or EMA executable code, or downloaded onto TCs or external machines using a variety of platforms under the GSM. The Hello world project will operate on the Host processor in the C++ interpreted version. A Visual Basic interface will drive the RE. The RE and the VB interface will reside on the Host O/S and communicate through the Host's protocols. For now, the developer may wish to get familiar with the KDE by creating a project and navigating through the various screens. (Many screens, however, cannot be used effectively until the appropriate PB entries have been programmed into the KDE. The developer should not be surprised if the screens do not accept entries made extemporaneously.)

7.4 Project Development Strategies

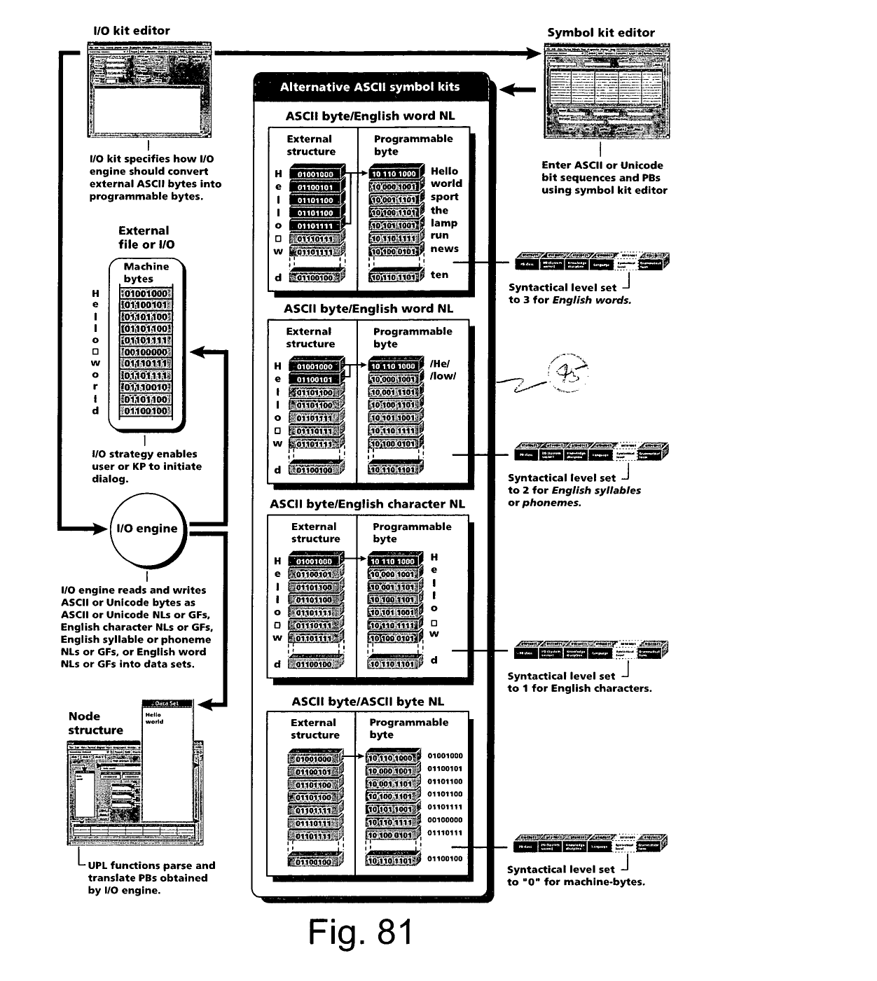

In order to become familiar with the KDE's programming features, it is essential to understand the relationship between the I/O requirements of an application and the syntactical levels of the PBs on which the KP's parsers will operate. As shown in FIG. 81, for example, the decision to read or write characters—instead of words, sentences, or even graphical elements or sounds—to external machines has important ramifications to the KP's parsing capabilities. If the developer were to build a symbol kit and I/O kit that allow the I/O engine to read characters from external machines, then the KP would have to be presented with characters (say, ASCII bytes) by external machines in order for the KP's parsing logic to function correctly. A UPL function's Select and other commands would compare PBs that represented characters embedded in the incoming data to those stored in the parse trees of the knowledge network. In this case, the KP would construct words by parsing the characters (PBs) and assembling syllables or phonemes from them. Later on, by using different parsers, the KP would analyze sentence structure (similarly to the manner in which a human being reads print). There is, however, a different way to allow the KP to “read.” If the KP's knowledge network operates on words by allowing the I/O engine to parse, say, an ASCII character string externally, then the KP parser would operate on words constructed from characters by the I/O engine. In this case, however, the KP would not obtain the externally generated characters comprising the words for subsequent lexical analysis-unless, of course, the characters were intentionally installed into data sets as rudimentary information.

For the Hello world project, we will use an I/O engine that reads characters (ASCII and Unicode bytes) from external machines, and parsing and translating logic that understands words. This I/O strategy will give us the opportunity to explain the I/O engine and parsing logic while demonstrating how the I/O engine can operate similarly to a conventional compiler's parser. By using the I/O engine, the Read command can act as a “dumb parser” (and translator) that performs routine parsing and translating functions on ASCII or Unicode characters. This I/O engine will, for instance, delete the spaces separating words in an ASCII string, while translating the words into the appropriate PBs defined by the symbol kits. The Hello world project's symbol kit is thus designed using English words (not characters), thereby easing the burden of the network's parser because the network parser can then operate on words of a sentence instead of characters that form words. (The knowledge network, of course, can still be designed to understand both lexical and sentence constructions.)

The CD/ROM version's I/O engine typically operates by using the O/S's ability to read external data (without TC assistance), which relies on the Host microprocessor for I/O and interrupt instructions. This I/O engine reads an I/O or memory device, byte by byte, and converts the external bytes into programmable bytes, thereby installing the appropriate PBs into the network data set designated by the Read command. (The Write command operates in reverse.) As discussed later, however, file structures can vary indefinitely. For this reason, the I/O engine is designed to accommodate bit, byte, multi-byte, and file-template data structures. Once the external data structure type is selected from the I/O engine editor (explained later on), the manner in which the application language is embedded in the external file is recognized by the Read command. The developer thus selects the tokens to be parsed and decides whether the tokens will be included or excluded from the PB conversion process. For the Hello world application, we shall have the I/O engine search for successive blank spaces, and delete the spaces between words when converting the file into PBs in the data set. (This will require that the developer enter spaces between words when communicating with the knowledge network in the live demonstration. If the developer forgets to enter a space between words, the KP will interpret, via the Read command and I/O engine, the conjoined words as a single word and will have to run the lexical parser to understand the mistake.)

Thus, an important first step in KP development is to determine what syntactical levels the symbol kits, parsers, and translators will operate on. (The illustration shown in Section 2's FIG. 2, for instance, requires that characters be read into the data sets so that those characters can be translated into phonemes for the KP's phonetic-based webbing. In the Hello world project, English words are read in.) When data from multiple external machines or Host applications must be read, symbol kits and I/O engine parsing and translating settings must be established for each external device. Accordingly, the syntactical levels for each machine may be different from those of the others. If a UPL function, guided by the I/O strategy and GSM, must read from, say, a Unicode-based Asian language and an ASCII-based English language concurrently, then different symbol kits would be used by the Read command for each language. Ultimately, it is essential to match the network parser's language skills with the symbol kit's syntactical level. In general, the network's parsing logic must be compatible with the Read command's parsing capabilities. (The network parser's logic will expect PBs that are defined at a particular syntactical level in the input data set.)

These simple relations allow the KP's host machine to receive a character string, such as H-e-l-l-o, at the machine level (as five ASCII bytes), using the appropriate symbol kit, and translate this character group to a single grammatical transformer (NL) or object (GF) for the word Hello. The NL or GF structure must initially be installed through the KDE by the developer if the KP is expected to understand the word in the application's early uses. (The PB is also encoded with all the necessary linguistic information for processing the word at the application level through the programmable byte's bit fields and its relationship with the other NL or GF labels and data sets.) The KP may then translate PBs, through the UPL functions, directly in the application language's grammar in order to create, for instance, the sentence Hello world.

Thus, before constructing a symbol kit, the bit fields of the NL and GF labels must be defined. The bit fields are interdependent and must be entered through the PB Settings screen according to the relationships dictated by the application language's grammar. Once the PB bit field definitions are entered, the KDE's other screens can be used, wherein the bit field definitions of the project are available to the various screens through the various drop-down menus. When assigning a particular NL or GF label to an external machine structure through a symbol kit, the NL and GF structure screens can be used interactively with the Symbol kit editor. Once the symbol kits have been designed according to an I/O strategy, the developer can concentrate on parsing and translating strategies that exercise the KP's intelligence.

The developer thus creates network relationships that rise through the hierarchy of linguistic structure so that entire phrases and sentences—whether they are natural language sentences or gene sequences—can be translated according to the universal grammar. By teaching the KP to parse and translate certain linguistically encoded bytes through the network structures, as defined by the various screens, the developer programs the processor to understand language. For the Hello world project, the KP will read the external ASCII bytes of a text file obtained from the developer's keyboard entries and write to a graphical display, also using ASCII characters. The Readers and Writers will convert external or Host-application ASCII byte sequences into PBs that the network will operate on as words. The scripts, operating under a GSM, will parse the input data set and formulate phrases and sentences that will enable the dialogue relating to the example's arithmetic. The dialogue will occur according to the rhythm of epistemic moments, rather than the execution of sequenced program code. The I/O engine will poll the keyboard for activity and respond according to the knowledge network's generation of epistemic moments under the main function's control.

7.5 PB Settings

Once the readers, writers, symbol kits, I/O engine, and syntactical levels have been determined “on paper” to serve a suitable I/O strategy, the application's PBs must be defined. Because of the many interlocking safeguards built into the KDE's interface, most of the KDE's editors will not function without the PBs defined and the network's webbing intact. Constructing the network's webbing begins by defining the PBs that are used in the application. (PB definitions are also required before building symbol kits because the symbol kits translate external data structures into PBs.) Even though the KP application will think and learn autonomously, thereby creating its own new PBs (say, for new words that the KP learns), a linguistic foundation must be initiated by the developer in order for the network, and its learning functions, to operate on “something”—usually a basic vocabulary and a kernel set of prominent thoughts, semantic clusters, and network webbing.

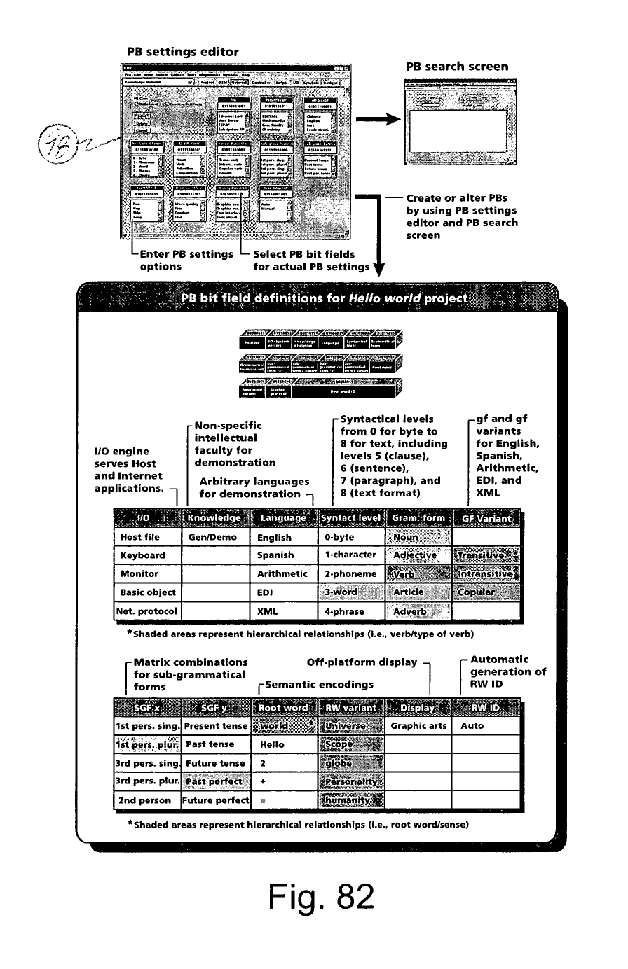

The PB settings screen, shown in FIG. 82, enables the developer to define the generic PB settings that will be used to specify each particular PB in the application (ultimately, the machine bytes of the Host processor). The PB settings screen associates an on-platform character string, such as the word noun, with the actual bit sequence that occupies the PB's respective bit fields. In this manner, the KP's actual PBs are set by selecting the word noun (or any other character string) in the PB's gf bit field selection box during application development (when a PB's grammatical form must be set to a noun). On the PB settings screen, the developer chooses the PB type to be defined (either an NL or GF label) and completes the information requested in the edit boxes for each PB bit field. It is important to note that the domain of all possible bit-field definitions is created through this screen, and that the choices made here will appear in the PB bit-field pick lists when creating new NL or GF structures, as shown. As the project develops, if a new bit-field definition is required, the developer simply returns to this screen and defines the new bit-field option. Other NL or GF structures can then be created by using this newly defined bit field.

For the Hello world project, we will define the bit field selections as shown. (The CD/ROM version includes the My First Intelligent Machine project, wherein the basic PB settings and network configuration are preprogrammed.) For the purpose of demonstrating GSM-level techniques later on, we define ASCII as a language, as well as arithmetic and English as language bit fields. The project utilizes a single knowledge domain, or intellectual faculty, in order to keep the project simple. The developer can enter these settings as shown after creating a project file. Once the bit-field options have been entered, the developer can create PBs by selecting the particular bit fields in coordination with the NL or GF structure screens, as shown. For the moment, we will refrain from designing the Hello world project's actual PBs until we discuss the knowledge network. (The developer still should set the bit-field options from which to choose later on.)

7.6 Symbol Kits

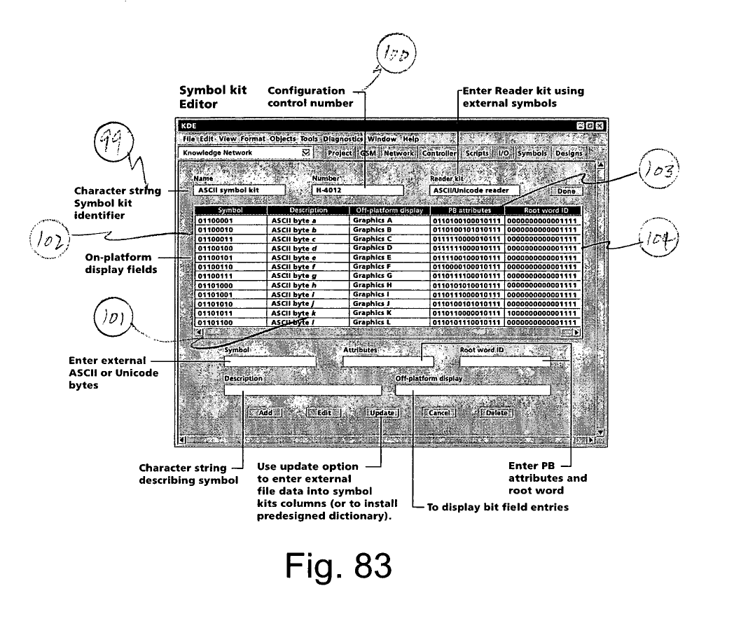

The symbol kits are designed by using the Symbol kit editor, as shown in FIG. 83. (Predesigned symbol kits can be obtained via the symbol kit search screen.) The symbol kits are designated, or named, according to on-platform character strings that are meaningfully expressed by the developer. The symbol kit designations are referenced by the I/O engine when implementing the Read and Write commands. (The names are stored and interpreted by the RE.) For the Hello world project, we will refer to the symbol kit shown as the ASCII/English word symbol kit. It is worth noting that, since the I/O kit allows the use of interchangeable symbol kits, we can employ the same I/O kit with different symbol kits in order to implement different Read or Write commands. Thus, when using the I/O engine to read executable bytes from applications explained in the sections, for instance, we can employ the I/O kit developed for the Hello world project. Alternatively, when we use the Unicode Reader later for the Hello world project, we will employ different I/O kits, since the Unicode standard requires a multiple-byte Reader. The double-byte Unicode words, however, will be translated into the same PBs used for the ASCII symbol kit.

The Symbol kit editor is accessed by selecting the Symbols/New options on the main navigation bar. To build a symbol kit, the developer enters the symbol kit's name (99) and configuration code (100) (if any), along with the names of the I/O kits that use the symbol kit in the project. The external symbol, or data structure to which the internal PB will correspond, is entered in the left-most column of the Symbol kit editor's data-entry panel. The external structure is usually provided in binary form. The Project Settings screen can be used to change the symbol kit screen's representations from binary to hexadecimal numbers when entering ASCII bytes as external binary data structures. Any other encoding is possible, providing that the settings screen is informed of the symbol standard. For the Hello world project, we shall use the ASCII symbol kit (45) that accompanies the CD/ROM version as outlined in Section 11. The developer may desire to enter the external ASCII bytes at this point in the demonstration (without entering the corresponding PBs, which have not yet been created). (When working with tabularized data such as ASCII bytes, it is sometimes easier and more efficient to enter the entire external data table required for the symbol kit in order to focus on one set of symbols at a time. Ordinarily, however, it would be recommended that the developer enter both the external data structure and its corresponding PB concurrently.) The developer may also wish to enter the Unicode symbol kit in the same manner.

The Description column (101) provides a character-string field in which the developer can explain the symbol's linguistic properties, such as the English alphabet letter a, the Arabic number 2, or English punctuation such as a period, and so on. The off-platform display contains the file name of the Host's application that drives the off-platform display of the symbol, such as the file name of a computer graphics programming object. For each external symbol, a corresponding PB is entered into the edit box via the Symbol (102), Attributes (103), and Root Word (104) data entry fields as shown. When creating a PB, the attributes and root word (ID) of the PB, as well as the character string defining the external symbol, are entered in the lower boxes of the symbol kit screen. When editing PBs that already exist in the knowledge network, the NL or GF search screen (105) can be used to locate the PB before entering it into the symbol kit interface. Creating new PBs, of course, is accomplished through the PB settings screen. For each external symbol, there will be one row of data entered into the Symbol kit editor's screen.

7.7 Knowledge Network Construction

After entering the external data structures into the symbol kits, the next important step in project development is to construct the network structures. The Network screen, also referred to as the KB screen, is used for creating and searching for NL and GF structures in the network. As PBs are created, they are appended to the network's PB arrays, which can be searched in order to identify particular PB array subsets. We have not considered PB definitions until now, especially with respect to symbol kit design, because understanding the knowledge network's epistemic structure is essential to defining PB bit fields.

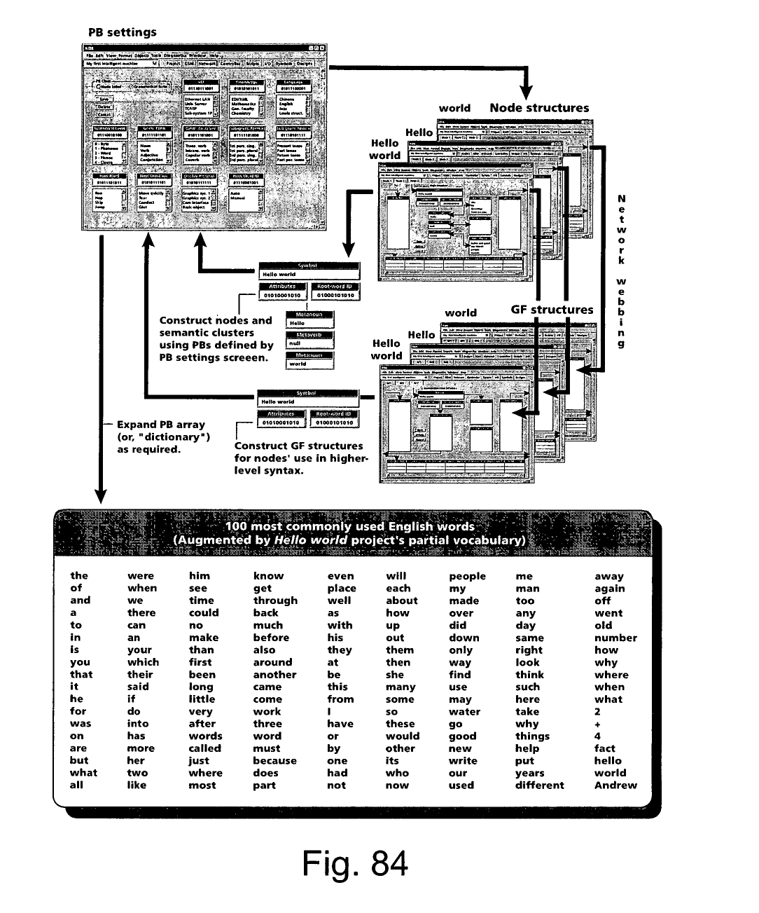

As shown in FIG. 84, the external data structures are translated by the Read or Write commands, via the I/O engine and symbol kit, into node or GF designators. The incoming ASCII bytes thus can represent the transformations (NLs) or objects (GFs) of the application language, but not both. When the ASCII byte is represented in the network as a node structure, the node structure is capable of operating in two principal ways according to the byte's encoding. First, the NL structure can represent the highest-level node of the ASCII byte's bit-field transformations. This means that the UPL parsing and translating logic can examine a bit stream (zeros and ones) and identify ASCII bytes lexically by comparing the input parse tree to the reference parse tree composed of a single byte. If a bit stream contained both executable machine code and ASCII bytes, for instance, the network would be able to analyze the bit stream for either encoding. The network therefore would be capable of operating on executable code and ASCII bytes that reside in the same file by processing the network's webbing pertaining to the respective machine languages. (See also Sections 12 and 13.)

At the same time, since the node structure contains the parent node gateway, each different use of the ASCII byte (of the node structure) as a class of GFs, can be installed into the PNGW through a different GF label, as shown. Since the ASCII standard is used in many different applications to represent characters in equally as many varied languages, encoding the external ASCII byte as a node label at the binary level while interpreting the ASCII byte's usage at the linguistic level through the PNGW allows the network to manipulate the byte in binary and any other context. When the ASCII byte represents, say, a character of an EDI document, that corresponding GF is placed in the ASCII byte NL's PNGW. When the character is used in any other language, such as English, mathematics, genetic engineering, or even music (say, the note C), the character objects, or GFs, are likewise appended to the PNGW so that the running processes can examine the byte's alternative uses in these languages.

This NL/GF relationship is important to the developer because it means that the external ASCII bytes can be obtained by Read commands under a suitable GSM and I/O strategy, while the knowledge network parses and translates the incoming data set according to any language's syntax and meaning (providing the parsing and translating kits are constructed to support the operations). When compared to software agents and other translators used in computer science, the KP incorporates any number of software agents in a single knowledge network. For the Hello world project, we will use the NL and GF structures shown. The ASCII byte is thus defined by a syntactical level of zero (a machine byte) and as a node structure representing the ASCII byte's root node transformation. The GFs shown represent the English language (and arithmetic—not shown). The Reader will then be able to parse external files for characters or words, as described earlier, and analyze the bytes as members of the English language or arithmetic. (The developer may wish to enter the PBs shown using the PB settings screen. After the PBs have been created, they should be related to the external bytes in the symbol kits using the Symbol kit editor.)

Entering the KP's early vocabulary can become a tedious process, and often is accomplished through software designed to read commercially available electronic dictionaries (i.e., through separate KP projects). For the Hello world project, we will design only the words shown plus whatever creative language the developer chooses. (The developer may wish to peruse the dictionary, or PB array, designed for the CD/ROM version through the PB search screen.) In order to demonstrate the KP's phonetic capabilities, the developer should build both printed-word spellings and phonemes for the words involved. When installing the NL and GF structures, it is important to remember that the KP processes epistemic moments of language—not simply “words.” Thus, for the abridged dictionary shown, both lexical and sentence-level constructions must be entered concerning each word and its possible usage in phrases and sentences, which also qualify as NLs and GFs that must be entered.

The prominent thought, which includes the semantic cluster arrays, plays an important role in NL and GF structure development. Since the GFs are employed in the PT, the creation of the GFs is dependent on PT member definition. As discussed earlier concerning the formation of the network's webbing, the GF also serves as the mechanism for the node structure's synthesis into the objective forms of language (through the PNGW in higher-level syntax). While other structure members, such as the GF structure's semantic category array, contribute to the network's ability to manipulate epistemic moments and their network relationships, the PT is the member structure that actually contains the KP's elements of thought. Accordingly, the running processes expend a great deal of effort manipulating the PTs. Since the PTs store the KP's momentary knowledge, or thoughts, their definition in the developer's early conception of the project is crucial. The PTs defined by the developer will be used by the running processes to learn new PTs and to formulate additional network webbing as the project acquires new knowledge.

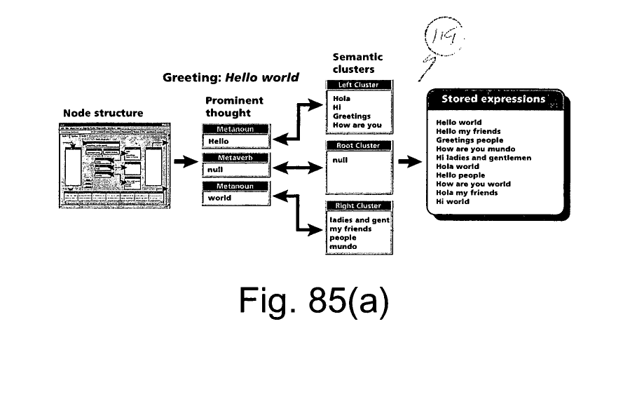

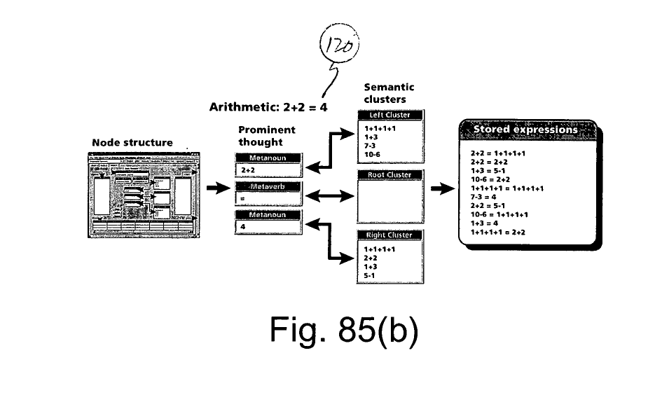

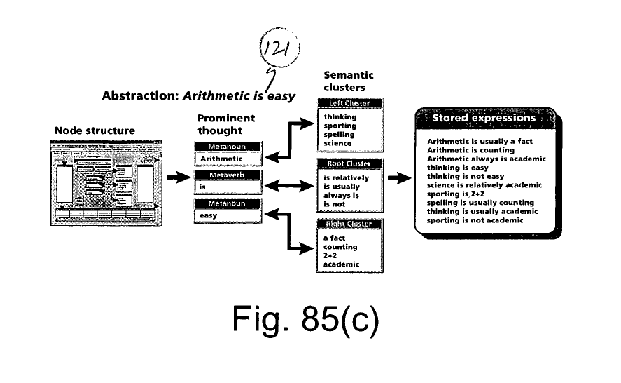

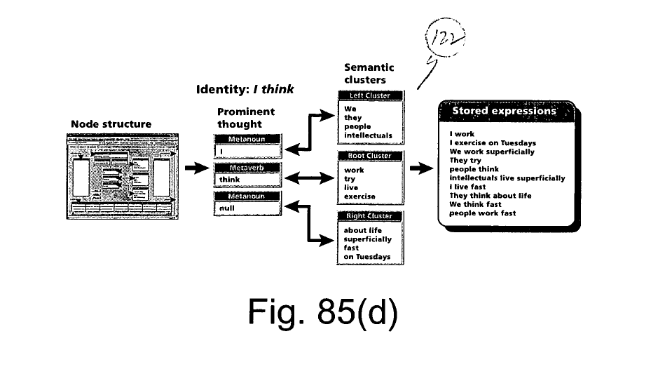

FIG. 85 demonstrates four of the thousands of PTs that accompany the CD/ROM version's Hello world application. Here, we illustrate one PT, with its semantic cluster, for each type of translator used in the project. When first examining the PTs, it may be beneficial to refer to the abridged dictionary shown in FIG. 84. Any combination of words or phrases is permissible for a PT as long as the expression is constructed in epistemic format. Theoretically, the number of PTs used to initiate a project is unlimited. The developer therefore must place design limitations on the programming effort in order to arrive at a reasonable kernel set of PTs. As the KP operates and learns, new PTs will be incorporated into the network. In general, the KP will have to manipulate PTs that pertain to the four categories of knowledge shown for the Hello world project. The PTs relating to greetings will be used for initiating dialog with the developer, while the arithmetic PTs will support the KP's factual knowledge of arithmetic. The abstract PTs will allow the KP to conceptualize arithmetic and other knowledge in ways that are considered “arbitrary” (non-mathematical). The identity PTs will enable the KP to relate knowledge to its own “existence,” or identity (linguistically). As shown in the figure, just four PTs provide an enormous amount of potential epistemic expressions. When entering sentence-level PTs, the developer should recall that lexical, phonetic, and phrase-level PTs should be constructed as well. The developer should feel free to construct any ideas appropriate to the developer's interests in addition to those that accompany the CD/ROM version. The kernel set of PTs, however, should be consistent throughout. (Entering the PT arithmetic is easy and then the PT arithmetic is hard only negates both PTs until the KP identifies higher-level constructions that distinguish the two expressions.)

The process of defining PTs and their semantic clusters is an iterative one. The basic approach to PT definition used for the Hello world project is shown in the figure. If an NL or GF designator does not yet exist for a given PT, it must be defined by returning to the PB settings screen. Once the PB is created, the NL or GF designators used in its member structures must be entered in a similar fashion by using the PB settings screen. The semantic clusters usually require contemplative effort on the part of the developer. As mentioned earlier, the semantic clusters enable the KP to exchange epistemic components on a meaningful basis without using the network's webbing. Despite the fact that there is essentially an unlimited number of GFs that can reside in a given semantic cluster array, application language usage usually dictates the array's entries.

When setting the semantic clusters on the basis of rhymes, for instance, the NL structure allows for millions of alternatives to the phonemes in the word Hello. Only a handful of phonetic onsets, however, are known to the world's poets for the word hello (hello, bellow, fellow, yellow—pronounced phonetically, of course, without the w). Similarly, when considering more than the word's onset, such as the middle phoneme /e/ in the word Hello, an even smaller selection of rhymes results (hollow, halo, hi-low, and so on). Thus, even though the Host processor's memory can contain virtually limitless entries in the SC arrays, the actual entries are curtailed by English usage. The developer therefore must consider that the operation of the running processes on the PTs and semantic clusters enables the KP's immediate grasp of thoughts and ideas structured in epistemic format. The programming accomplished here will determine how the KP recalls knowledge innately. By the time the PNGways are considered for a single PT, the developer will become overwhelmed with possible epistemic constructions and will more than likely begin to appreciate that it is best to do minimal programming of network structures while spending more time developing the running processes that can do the thinking electronically.

The PNGWs for the Hello world project will contain those classes of GFs that synthesize the given NL structure into higher-level syntax. The PNGW for the word Hello, for instance, will contain the GF that enumerates all network nodes using the word in their respective PTs (such as the node for the expression Hello world). Similarly, the NL structure for the phoneme /hel/ will link to the NL structures for the words Hello, Helen, and helicopter (or to whatever words the developer conceives) through the PNGW for the phoneme /hel/. The project usually “comes to life” once the PNGWs for sentences and clauses have been programmed, since the running processes can then examine the PNGW linkages to construct coherent and often rhetorical language. (After entering a series of PTs and semantic clusters connected together through PNGWs, the developer may wish to use the diagnostic window or search screens to examine the KP's potential use of language before going any further with developing the KP's kernel of language usage.)

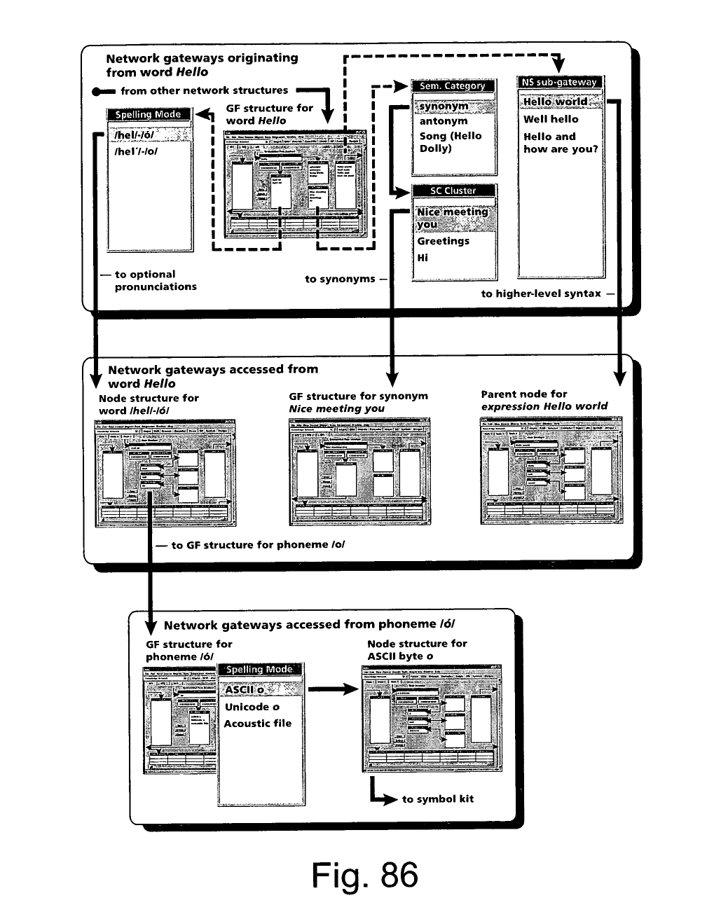

The GF structures will serve several important purposes for the Hello world project, as shown in FIG. 86. First, the spelling modes of the word-level GFs will point downward (in epistemic parse tree structure) to their component syllables and phonemes. Similarly, the sentence-level GF structures will point downward to their word and phrase NL structures. The character level, however, will contain two mandatory spelling modes because of the earlier symbol kit definitions. One spelling mode will be used for the ASCII-based NL and the other will designate the Unicode-based NL that transforms up to the character level GF structure. These relationships will allow the KP to perform I/O by using ASCII or Unicode data structures. (As mentioned earlier, however, the Reader will be designed to extract characters and install word-level PBs into the data set in order to demonstrate certain features of the I/O kit. Here, the ASCII/Unicode spelling modes are an option.) The figure summarizes these relationships by illustrating that the KP can pronounce the phonetic word Hello two separate ways depending on which syllable is emphasized (the /Hel/ or the /o/). The GF structure thus points to each possible NL through the spelling mode array. Meanwhile, each subordinate NL (such as that for the word /Hel/-/ó/) contains the PT components (GFs) for the word's phonemes. Each phoneme, in turn, points, through the spelling mode array again, to the character-based NLs for the sounds, as constructed in the ASCII bytes. Thus, the NL-GF relationships provide network webbing that connects words to sentences, while ultimately connecting the words' phonetic elements to ASCII or Unicode bytes that can be input or output by the I/O engine.

Also as shown in the figure, the semantic categories become important when semantic associations are necessary to augment the network's webbing. Both the developer and the KP have complete freedom in deciding what associations to employ here. For the Hello world project, we have illustrated the use of synonyms, antonyms, and songs relating to the aforementioned PTs (in the figure, relating to the expression Hello world). (We recommend that one of the semantic categories be musical in nature because the category will force the network to recon with arbitrary knowledge—music—that cannot be handled by natural language.) The synonym category for the expression Hello world, for instance, will contain an SC Cluster that links to the expressions Nice meeting you, Greetings, and Hi, as shown in the figure. These relationships will allow the KP to exchange the expression Hello world with the expression Nice meeting you through the semantic category designated by the GF for synonyms (instead of using a PT's semantic cluster). Likewise, the song category will link to the (musical) expression Hello Dolly, which, when output by the I/O engine will be synthesized as a melody.

It is important to recall the PT's operation when entering semantic associations in the GF structure to avoid redundancy. The PT accounts for variations in the epistemic triplet's components, while the SCC describes categories (and their elements) of semantic alternatives to the PT once the PT is objectified by a GF structure in application language syntax. Thus, the PT's semantic clusters contain alternative components for the epistemic triplet, such as the expression greetings world, for the left metanoun replacement, and Hello everyone, for the right metanoun replacement in the expression Hello world. Alternatively, the GF structure contains other GF structures that objectify the entire expression, such as what occurs when the expression Nice meeting you replaces the word Hello in the figure. When entering PBs into the GF structure's PNGW, it is sometimes helpful to think of the expression “used-in” in order to relate the lower-level node structures, through the PNGW, to the intermediate GF structure. The lower-level node is “used-in” the higher-level node contained in the GF structure's NSGW. The developer can enter the PBs shown, think of others, or rely on the CD/ROM version's accompanying network webbing.

A special note should be made regarding the Hello world project's arithmetic capabilities. For the Hello world project, the ASCII characters represent the digits of a number (or arithmetic operators). This is because the KP operates on arithmetic as language. Whereas a computer would use a compiler to translate a source code expression of arithmetic into machine instructions and data, the KP operates directly on the digits in the universal grammar. Thus, there is no need to specify a number as an integer, floating point, or any other computational data structure because the KP's intelligence will understand the number in epistemic structure. Later on, we will build the parsing and translating functions that will parse a sequence of digits and operators (such as What is 2+2?) in order to create a parse tree representing the epistemically formatted knowledge (in the network's webbing). In this manner, the digit 2, for instance, can be related to GF structures representing art forms (typography), musical beats, a member of a count (one-two), or even an arithmetic symbol that is used to express that 2+2=4. This methodology is key to understanding how the KP can receive input, such as the expression what is 2+2, and output the expression 2+2 is a fact. The arithmetic knowledge is stored in the LTKB epistemically, not directly in “arithmetic.” The parse tree held in the KB's webbing thus can branch at any point (PNGW) to allow the translation logic to synthesize, say, the node 2+2 into the node (2+2)-(is)-(a fact).

If the developer requires the application to perform a computational method for arithmetic, then those nodes and GF structures (and their members and network webbing) must be entered just the way we have accomplished the application so far. Instead of operating on strings of ASCII bytes, however, the KP would process binary integers. The epistemic moments of base-2 arithmetic would be formulated just the way a computer engineer understands them. The carry operation, for instance, would be implemented by the translation logic when adding two binary numbers. For the Hello world project, we elect to process arithmetic the way a child does—in arabic numbers by operating on digits. While at first the KP methodology may seem a bit tedious, it should be recalled that the running processes are designed to create PBs and network webbing as they parse and comprehend language. Thus, the developer's work is concerned here only with initiating the project's use of language. Theoretically, a KP application could start with only one prominent thought. In such a case, however, the KP would have to learn all knowledge from the one epistemic moment. While the developer may be interested to see what happens to an application like this (a totally unpredictable “personality” results), the Hello world project employs the structures shown in order to “kick-start” the application's development.

7.8 I/O Kit

The I/O kit defines the KDE information necessary for the I/O engine to execute a Read or Write command. For the Hello world project, the I/O kit will inform the I/O engine about how to read and write to the keyboard and monitor by using the Host processor's O/S protocols. In the CD/ROM version, the I/O engine is software—specialized file readers and writers—that obtain external data according to the I/O kit. When the KP application must read or write to machines that are incompatible logically or electronically with the Host processor, the I/O kit usually specifies translation cards, which are separate KP projects implemented on vendor-supplied hardware that can process KP projects. For the Hello world project, we employ both the software-enabled I/O kits provided with the CD/ROM version and the translation card illustrated in Section 14.5. This I/O kit approach will enable the KP to read and write to Host applications, such as word processing documents and the keyboard, as well as to external machines that are incompatible with the Host processor. The design goal in either case will be to extract or insert data structures into external machines while translating the structures to and from PBs used by the application.

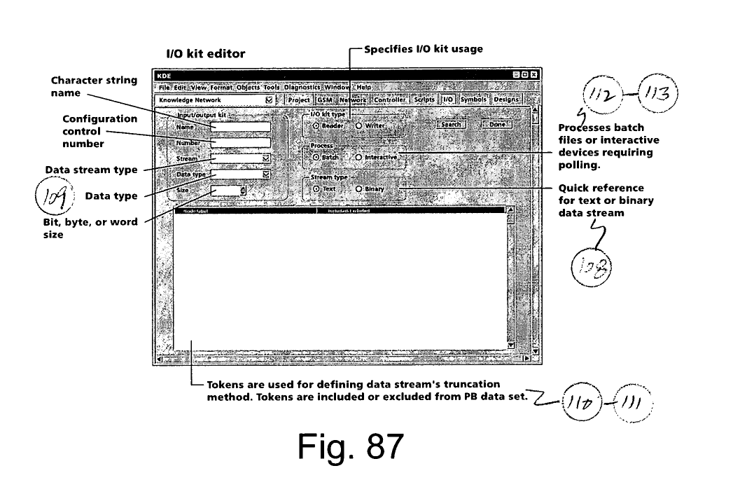

While the symbol kits are constructed through the symbol kit screen, the processes by which the symbol kits are employed in order to read and write data to external machines and secondary memory are specified by using the I/O kit screen shown in FIG. 87. The I/O kit is concerned primarily with how the Read or Write commands will parse the external data before the data is converted into PB's for processing by the knowledge network. This is an important step in knowledge processing because whatever parsing is accomplished by the Read (or Write) command is parsing that the knowledge network does not have to perform. Thus, there is always a tradeoff to consider when designing parsing responsibilities for the I/O kit because the Read command does not utilize the knowledge network, and therefore does not employ the KP's intelligence to parse language cognitively. (This is why the Read command is often referred to as a “dumb parser.”)

As shown in the figure, each I/O kit is assigned a character string name (106) and configuration number (107). The stream type (108) specifies the controlling process for I/O or file reading and writing. The standard streams available to the KDE through the CD/ROM version are the File, Keyboard, PC Interface, and Object-oriented network protocol (used in network applications such as the Internet). Each external device with which the Read or Write command interacts operates according to its own protocols. The stream type (108) option allows the developer to specify the I/O device's data stream characteristics. The I/O kit provides the supporting code and interfacing protocols so that the KP can access data from any of the specified devices without the developer having to create the interface. The Data Type (109) option determines the basic data structure to be read or written to by the Read/Write commands. The standard options provided by the KDE are the bit, byte, fixed-length multibyte, variable-length multibyte, and the file template, as shown. While reading and writing bits and bytes is fairly self-explanatory, the I/O kit further enables the Read/Write commands to I/O with external device protocols by processing bits, (8-bit) byte structures, or multi-byte structures. Each bit or byte obtained by the command will be converted to a PB according to the symbol kit's table relationships. Thus, if the bit option is selected, an appropriate symbol kit must be created to relate external bits to internal PBs. Similarly, if a byte is opted for, the corresponding symbol kit would relate byte structures to the PBs. Fixed-length multibytes specify I/O according to multibyte-length data structures. A Unicode data structure, involving two eight-bit bytes, qualifies as a multibyte data structure.

The variable-length multibyte data structure allows the developer to specify a byte structure based on a parsing strategy that employs “tokens” (110) to separate the multibyte structures. The Hello world project's I/O engine, for instance, identifies words separated by spaces. The words are variable-length multibyte structures. The actual word length of the variable-length multibyte structure will not be known until parsing begins. Thus, the developer specifies the token, which can itself be any multibyte structure, while the I/O engine parses the external data structures for both the token and the multibyte structure that will be translated into a PB via the symbol kit. For the Hello world project, we shall elect to use the variable-length multibyte structure, while using the ASCII byte representing a space as a token. The I/O kit thus will allow the Read/Write commands to parse the input stream for the token (the space) and truncate the stream (of bytes) for subsequent use by the symbol kit in the command's conversion of the external structure into a PB. The include/exclude option (111) allows the token to be included or excluded (voided) from the multibyte structure formed by the token's position in the stream. For the Hello world application, we shall delete the token (space).

Any I/O kit can be made to assist the Read/Write commands according to batch (112) processing or interactive (113) communication techniques when the developer selects the appropriate option on the I/O kit screen. When reading from the keyboard in the Hello world project, for instance, an Interactive selection will enable the KP's running processes to read and write interactively based on the user's depression of the enter key on the keyboard. (Most secondary files, however, are input or output in batch form.) The Reader (114) and Writer (115) options determine whether the specifications made in the I/O kit screen will apply to a Read or Write command, respectively. When the I/O kit specifications have been entered, clicking on the Save button deposits the new (or edited) I/O kit into the project's RE. (The developer may desire to enter the I/O kit parameters at this point, while specifying the symbol kit constructed earlier. The translation cards are specified by entering the abbreviation TC in the I/O kit name field. The TC, of course, must be constructed as well, or obtained from a vendor. The developer also may elect to build a simplified TC using the RS232 example shown in Section 14.5.)

7.9 Running processes

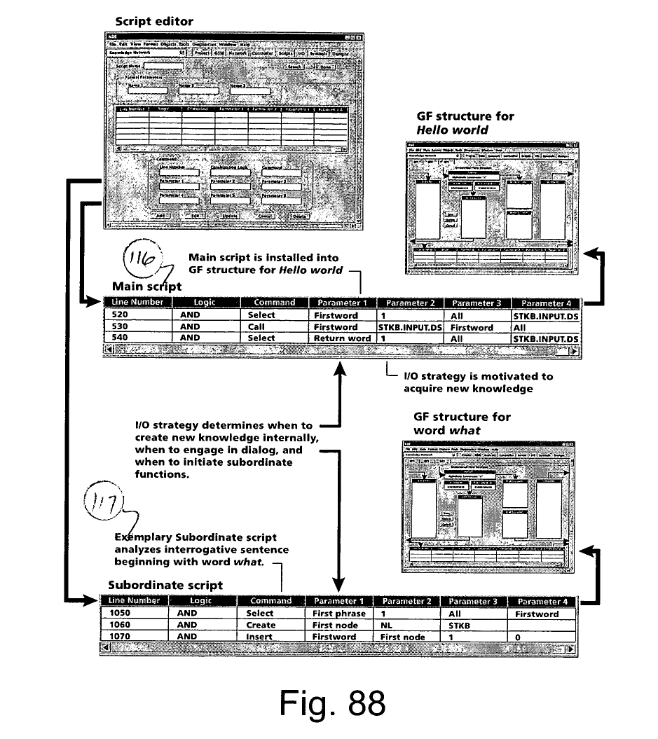

The scripts, or running processes, are created by using the script editor shown in FIG. 88. The success of a KP project depends on the programming of the scripts that manipulate the knowledge network. After all, the scripts are referred to as the KP's “intellectual faculties.” Since both the art and science of knowledge processing converge on the development of the intellectual faculties, most of what the developer learns regarding scripts is acquired from hands-on training. We have included this discussion, however, in order to provide a guideline for understanding the scripts prepared for the Hello world project.

As shown in the figure, the scripts for the Hello world project are partitioned into a main script (116), which handles the I/O strategy, and the KPs subordinate scripts (117), which are invoked by the main script to carry out specific intellectual functions. The KP's main script, which contains the KP's modes of operation, or modes of existence (118), handles some portion of the human mind-body dualism as it coordinates voluntary and involuntary actions, such as contemplative efforts, communications, and “instincts.” (While the elementary Hello world project does not require androidal concepts to construct because it does not mandatorily employ senses and motors, it may be helpful for the developer to think of the KP's intellectual faculties in terms of the mind-body dualism of form.)

The main function controls the KP's motivation for engaging in dialog with the developer. Since the KP “exists to learn,” the main function should not be designed simply to respond to the user like an artificially intelligent computer program. Thus, the KP should be motivated to learn something new through the dialog (i.e., to change PTs, network webbing, and so on through the dialog). In order to limit this discussion to the Hello world project, however, we will constrain the KP's dialog to expressions pertaining to arithmetic knowledge. This means that the main function will guide the KP's cognitive actions in order to learn more about the topic of arithmetic. Decisions regarding when to imagine new knowledge and when to engage in dialog will be made by the main function as well. Thus, the KP's motivation will be to learn new knowledge relating to arithmetic. The main function will relinquish control to a subordinate faculty when required.

The main function's mission is to create new knowledge that enhances the network's current understanding of arithmetic. In order to achieve this level of intelligent processing, the I/O strategy is designed to operate on prominent thoughts in the LTKB such that new, verifiably relevant PTs are obtained through the dialog. In the Hello world project, the KP will experiment with the PTs by creating new thoughts and sharing them with the user through the dialog. The Read and Write commands will be embedded into the main function's logic so that the creation of a new network pathway from the PTs and semantic clusters generates new knowledge that must be ascertained by the KP's experience with the developer. Since the Hello world application does not perceive the world through senses and motors, however, we will assume that knowledge verification occurs through the keyboard. (The main function will allow the creation of new knowledge by verifying the KP's thoughts through dialog.) After creating new thoughts, the KP will solicit dialog with the developer by outputting to the monitor. During pauses in the dialog, the KP will return to creating, or “imagining,” new knowledge on its own through subordinate scripts.

It is worth recalling that the knowledge processor is capable of truly “thinking.” What this means is that there is no real objective to be met by the KP's operation except that of creating and learning new knowledge. Concerning human experience, for instance, knowledge can only be verified; it cannot be held to be absolutely true. For this reason, the developer may wish to relax any tendencies to construct UPL functions that create knowledge that is deemed to be true, correct, or even “valid,” except with respect to an observer's opinion. We demonstrate this point in the Hello world project by allowing the KP to answer the question What is 2+2? in two distinct ways. On one occasion, the KP will answer 4. In another instance, the KP will use a metaphor to arrive at the expression 2+2 is a fact. We can inquire, however, whether either answer is right or wrong. Arithmetically, two apples and two peaches make two apples and two peaches—not four apples or four peaches. Thus, in order even for 2+2 to equal 4, the elements must be taken from the same set (of numbers). Any knowledge is therefore true only in terms of its context, or its relationship to some other knowledge. When constructing UPL functions that manipulate the PTs and network webbing, then, it is prudent to guide the KP into verifying knowledge by applying strong metaphoric capabilities rather than by testing its knowledge against expressions that the developer deems to be “intelligent” answers. At this point, the developer may desire to spend some time studying the Hello world project's main function, as constructed for the CD/ROM version. Particular attention should be given to the Call commands, since the main function's invocation of a subordinate function indicates a transfer of control to a specific intellectual faculty.

7.9.1 Lexical Parser

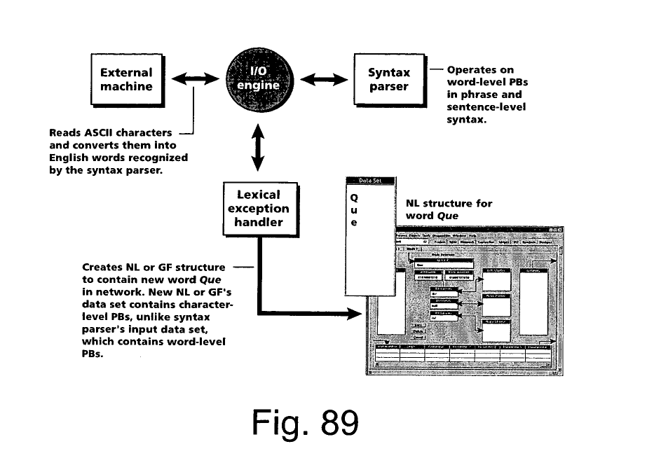

The syntax parser of the Hello world project will expect word-level PBs in the data set that receives input. Accordingly, the I/O engine will read the external data structures and convert them into PBs that are embedded in the network as English words or arithmetic terms. This means that the Hello world project does not use the lexical parser when words known to the network are obtained by the I/O engine. A special case arises, however, when the Reader encounters an unknown word. In this event, the lexical parser is required. The I/O engine will create a new word in the knowledge network by installing NL or GF “placeholder” structures to represent the word. Since the network does not contain character-level structures relating to the new word, however, the I/O engine installs the lower-level linguistic elements, such as English or arithmetic characters, into the data set. In this manner, the lexical parser is able to operate on the lower-level elements in order to relate the new word to the network's context, as shown in FIG. 89. Thus, instead of operating on the data set created for the syntactical parser (which operates on words), the lexical parser turns to the DS created for the new word entry and translates the lexical elements as required in order to understand the new word. For the Hello world project, the lexical parser, which is an inherent part of most KP applications, will be used only to decipher words that are not immediately recognized by the I/O engine. (In many applications, the lexical parser is used to convert all input by recognizing words from characters or phonemes.)

Once the new word (NL or GF) has been created, the syntax parser can operate on sentence-level syntax while invoking the lexical parser to determine the meaning of the new word in context. For the Hello world project we illustrate two instances of the lexical parser as an exception handler. During the developer's dialog with the KP, the developer may enter Que es 2+2? (Spanish for the expression What is 2+2?). Since the symbol kit is constructed for English words, the lexical parser, in cooperation with the I/O engine, will read the above expression and create new NL and GF structures for the words Que and es. The KP will then use metaphoric techniques to learn the Spanish words. In another example, the KP will obtain arbitrary numbers that the developer desires the KP to add together arithmetically. The developer will then enter something like the expression what is 40+126, while the lexical parser constructs new NLs and GFs for the numbers 40 and 126. The syntax parser will then operate on the data sets concurrently—as two “number sentences” that must be synthesized into the arithmetic statement. The developer may wish to experiment with the lexical parser for the Hello world project by observing the diagnostic window while entering either numbers or words that the KP will not immediately recognize. The developer can then check the network for the newly created NLs or GFs and observe the network webbing created during the word recognition process.

7.9.2 Syntax Parser

The syntax parser is designed to create STKB epistemic moments and parse trees from input data sets according to the dialog (and internal thoughts) of the Hello world project. The challenge for the Hello world project, however, is to keep the syntax parser simple. While most parsers are many times more capable than the one demonstrated for the project, the principles involved remain the same for most projects. For this reason, we shall focus here on the script's design methodology, rather than discussing each command line separately.

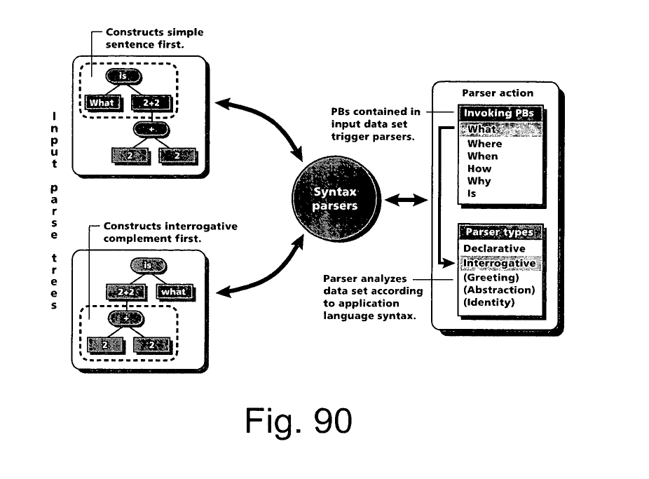

Conceptually, the mind anticipates linguistic structure as it comprehends based on what it already knows. Similarly, the syntax parser will expect to formulate sentence-level constructions from the words obtained from the I/O engine. (The lexical parser for the Hello world project still, however, may analyze characters and convert them into phonemes or words.) The KP will anticipate greetings and sentences of the declarative and interrogative type, as shown in FIG. 90. (In a real-world application, the KP would anticipate the sentence structures defined by a good book on the application language's grammar.) The Hello world project employs a syntax parser for each of the PT classes illustrated in FIG. 85. The main function controls the parsers for greetings and dialog, while the arithmetic parser interacts with the conceptual learning parser (abstractions, in the figure) in order to recognize and formulate language pertaining to arithmetic. The KP's identity parser operates on knowledge relating to the KP's cognitive “awareness” of itself (at least, through language). These parsers, in turn, are supported by faculties that are invoked by specific words, phrases, and other syntactical or semantic arrangements of language. As shown in the figure, the words what, where, when, how, why, and is at the beginning of a sentence invoke intellectual faculties that build parse trees and network webbing for interrogative sentences. Any word or other PB can invoke a declarative sentence parser.

The syntax parser is given parameters by the calling function to indicate the data set and KB structures to be operated on. The parser then constructs its first epistemic moment and continues to build interconnected moments in the STKB by examining the data set's contents and placing the appropriate PBs into network members. (Refer also to Section 5.8 entitled Data set splitting.) The key to understanding parser design is to recall that the linear word stream (PB array) residing in the data set must be deconstructed into epistemic triplets according to the universal grammar's depiction of syntax. The manner in which PBs in a data set are arranged, however, may not lend itself to easy parsing. Concerning the parser shown in the figure, for instance, the data set may contain either of the following expressions: What is 2+2? or 2+2 is what? In the first case, the parser must construct the highest-level (root) node of the parse tree first. That triplet would then be What (subject) is (verb) 2+2 (complement) for the simple sentence. The initial NLs and GFs created by the parser would thus be those for the subject, verb, and complement of the sentence. In the second case, however, the first node constructed is that for the addition operation: 2 (metanoun)+(metaverb) 2 (metanoun). In this case, the parser is unaware of the imminent realization that the expression 2+2, which is now in an epistemic format, will be the complement or subject of a simple sentence. The parser still, however, must construct the epistemic parse tree as it proceeds from left to right (or top to bottom in the data set), thereby assembling epistemic moments and network webbing in the STKB as it fits the pieces of the parsing puzzle together.

For this reason, the Select and Create commands are commonly used in the Hello world project's parsing function command logic. The UPL function selects various PBs, based on prior learning experiences or the developer's design, and copies them into newly created NLs or GFs, thereby formulating an epistemic moment or network webbing as it proceeds. Since the parser may not be able to decide upon all of the selected PB's bit fields during its first pass of the data set, the Set command is usually employed subsequently to NL or GF creation in order to redefine the PB's bit fields once new information is available about the PB's properties. Concerning the second example above, the phrase 2+2 would be assigned a grammatical form of complement once the KP encountered the verb and subject of the sentence—and, importantly, after the phrase 2+2 had been created in epistemic format as a node triplet. For the Hello world project, the developer can input various expressions, such as Is 2+2 what, and then examine the parser's epistemic deconstruction through the diagnostic window (rather than waiting for the answer no). The developer can then continue this process by using any expressions the parser would recognize in order to learn parser design techniques. In the CD/ROM version, any input can be scanned from the diagnostic window. The developer may wish to study a particular parsing function and then observe its action through the diagnostic window by engaging the specific function from the appropriate NL structure (i.e., without the main function's control of the application).

Most of the application's UPL commands are employed according to their operations, as defined in Section 6. Typically, the Select command sets the variable pointer to the first item in the data set. Rather than test this PB for thousands of possible grammatical and semantic properties that could trigger the appropriate parser, the Compare command is used to determine what properties the PB does not have. The parser is designed in this way because the network contains parsing functions as members of network structures. Thus, providing that the parser excludes certain properties from the PB, the next command in the function logic can simply call the parsing function associated with the PB. In the case involving declarative sentences, for instance, the parser determines whether the first word is the subject of a sentence or not. If the first word is a subject, the parsing logic calls the function whose NL exactly matches the PB in the command variable of the initial Select command. If the first word of the sentence is not the subject, the OR condition allows the UPL function logic to proceed to analyze other conditions, one of which is the case where the first word begins a noun phrase. In the case of the noun phrase, the parser calls the UPL functions associated with noun phrase analysis. Once the noun phrase has been constructed in epistemic format, the parser calls the UPL function for the sentence's subject, which then evaluates the simple sentence. The ultimate result is that the parser constructs an epistemic parse tree for a simple declarative sentence.

For the interrogative sentences used in the Hello world project, the process is a bit more complex. Since any declarative sentence can be construed as an interrogative sentence by using a question mark to terminate the sentence (or, in phonetic cases, by inflecting, usually, the verb or last word of the sentence), the faculty can test for end punctuation first. If the sentence ends with a question mark (or is inflected interrogatively), the interrogative parser is invoked. If not, the sentence is assumed to be declarative. (In real-world applications, emphatic, imperative, and elliptical sentences are analyzed as well. Moreover, in applications that do not employ natural language directly, such as art, music, and some scientific disciplines, the “sentences” are analyzed in the same manner, but as images, musical compositions, or, say, molecules.)

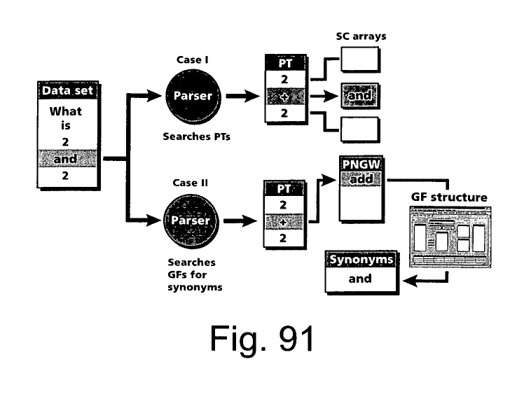

During the parsing process, the KP may have to translate words using the network structures, as shown in FIG. 91. The expression What is 2 and 2, for instance, can be input with meaningful action taken on the part of the KP, since the network contains the word and in the semantic cluster for the PT for the expression 2+2. A second, more complex approach to parsing arises, however, when the parser employs a translator. In the second case shown, the network comprehends the expression by painstakingly comparing the parse tree constructed from the data set in the STKB to those PTs and network relationships containing similar elements (PBs) anywhere in the network structure. While the developer can see easily that the word and must be substituted by either the word plus or the operator+, the KP—a blind piece of sand made into a silicon chip—must be made to compare each element to the network structures and make decisions about their relevance. The first attempt made by the parser usually searches the PTs and their semantic clusters for an exact match. As shown, the Hello world project utilizes a PT whose root, or metaverb cluster, contains the word and, while the PT triplet contains the operator+. Nowhere else can the numbers 2 and 2 be found as metanouns of a triplet but in the PT for 2+2. Thus, the script shown for case I searches the LTKB first for the expression 2 and 2, returning nothing, and then searches for triplets whose metanouns (only) contain the numbers, respectively, 2 and 2. Once this is accomplished, the script searches the metaverb clusters to determine a match. The parser then employs the translator in order to change the word and to the arithmetic operator+(the metaverb discovered in the semantic cluster array of the PT for 2+2). At this point in the KP's comprehension of the expression What is 2 and 2, the data set now reads (in PBs) What is 2+2? The parser then comprehends that a response is required to a recognized expression, and transfers control to the translator so that the KP can answer the question by transforming the epistemic moment into the expression 2+2=4.

We can consider the other case, however, wherein the KP may not have a PT with the word and in the metaverb position. In this case, it is reasonable to assume that the GF for the operator+would contain synonyms, such as the words plus, and, added to, and so on. As an alternative to searching the PTs (or perhaps after exhausting all PT searches), the parser can examine synonyms of the network's GFs looking for the word and, and perform the same translations described above, but by using the GF's gateways, as shown. Generally, a recommended approach to parser design is to guide the logic to look for complete epistemic triplets (PTs) first, and then to analyze the semantic clusters for partial PB matches. If one or more epistemic components match the target triplet's components, then the parser should search the PT's semantic clusters, exchanging each respective component with its cluster replacement. If a match cannot be found directly in a PT, then the network webbing will have to be traversed.

Traversing the network involves first locating the given PB in the network's PB array in order to identify its NL or GF structure. The expression 2 and 2 is four, for instance, may be distributed throughout the network's webbing via the PNGWs. In order for the KP actually to find the expression, however, it must seek one of the words, usually the root node (is, in the figure), and then branch to the other words by traversing the PNGWs. One successful approach begins by identifying the GF for the root node (is) and then working downward in network webbing by using the spelling modes to reach the lower-level NLs, which, in turn, will usually contain the targeted GFs (GFs for 2, and, 2, and four). Once the webbing has been found to correspond to the input, the translator can be called in order to transform the initial parse tree as desired.

If PB matches still are not found, the semantic categories can be employed. The semantic categories allow the parser to construct language by using various semantic interpretations of the words used in the search. Since the word and has different meanings in the Hello world project's network, the parser can identify the correct usage of the word and by looking at the network's context. Let us say, for instance, that all of the previously mentioned parsing strategies have failed to yield an NL or GF for the word and. The semantic categories can be used to identify categories of words (GFs and NLs) according to their semantic associations with other words or language elements in the network. Let us further assume that the word and was input to the data set by the lexical exception handler (i.e., a placeholder NL or GF was created for the word due to a smudge detected by a digital scanner or a wrong keyboard entry). In this case, the expression what is 2 (blank) 2 has to be comprehended by the KP despite the absent arithmetic operator. The KP must use the absent word's context in order to identify the missing word. If we further assume that the knowledge network contains the PTs peanut butter and jelly and 2 and 2, then the parser would have to search the network for the use of the word and, and discriminate between the two existing PTs. The parser simply analyzes the words in the semantic categories to find and match the expressions. Since the expression peanut butter and jelly (and its semantic associations) is not an arithmetic root word topic, the parser would identify the word and as the operator+because it is associated with the numbers 2 and 2 (instead of food).

The developer may desire to explore the project's parsers by using the diagnostic window to pause the parser's action while studying the function's commands. Any Hello world project UPL function can be altered, as desired, through the script editor.

7.9.3 Translator

In order to appreciate the work performed by the KP's translators, it is important to keep in mind that translations occur in virtually all of the KP's linguistic actions. Theoretically, any change made to a PB or network structure constitutes a translation of language. For the Hello world project, however, we shall refer to the translator as that group of UPL functions which translates parse trees that have been constructed by the parsers. Thus, the action of the translator will include transforming a parse tree for the expression what is 2+2 into the expression 2+2=4, while translations made during parsing in order to transform the expression 2 and 2 into the expression 2+2, for the purpose of comprehending language, shall be ascribed to the parser's design.

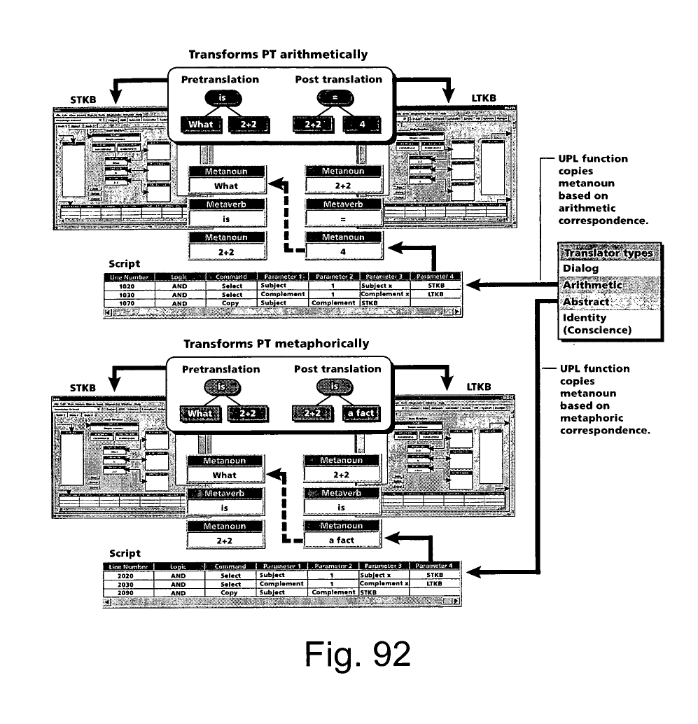

Four types of translators are used in the Hello world project (while thousands are typically employed in many real-world KP applications). While each translator is better discussed at length in a training program, we can explain the translator's basic operation here as shown in FIG. 92. The first translator used in the Hello world project translates functional expressions pertaining to the project's I/O strategy and modes of operation. This translator is involved with the main function in order to process the initiation and closure of dialog. Referred to as the dialog, or communications translator (119), this set of UPL functions processes, for instance, the greeting with the developer. The second translator accomplishes the transformations pertaining to arithmetic knowledge. In support of the dialog, the arithmetic translator (120) is able to transform English and mathematical sentences, phrases, and words (arithmetically), providing that the input expressions do pertain to arithmetic. This translator can transform the sentence What is 2+2? into the expression 2+2=4, but cannot operate successfully on the expression 2+2 is a fact. The third translator type accomplishes abstract translations (121) such as the aforementioned sentence. The fourth and final translator employed in the Hello world project is the identity translator (122), which is capable of placing knowledge into linguistic context that explains, via the network relationships, “who” the KP is. This higher-level translator is invoked, for instance, even by the dialog translator, when the developer enters the expression Hello Andrew (the KP's identity) into the keyboard. While the Hello world project employs just four illustrative translator types, it can engage the developer in years of dialog, just as the human mind can create countless ideas from a handful of words (PTs).

In order to appreciate the abovedescribed translators, it is beneficial to elaborate on a fifth translator type found in most KP applications but excluded from the Hello world project. An understanding of androidal “conscience” (the fifth translator) (123) will provide insight into every other translator used in knowledge processing.

Any translation of language constitutes a comparison of expressions. In order to translate, or change, knowledge, then, the KP must compare preexisting knowledge to new knowledge. In order to transform the expression what is 2+2 into the expression 2+2=4, the KP must know (in the LTKB) that 2+2=4. Ultimately, however, the KP will have to transform more and more abstract knowledge in a meaningful way. The KP's “conscience” comes into play because, ultimately, all knowledge must have a reference with which to compare arbitrary expressions of language. If the PT 2+2 is a fact were the highest-level knowledge with which the KP could compare any other knowledge, then the expression what is friendship would have to be translated into something like the expression friendship is a fact. (This KP would not be an overly affectionate friend.) Since any one PT, or branch of network webbing, is equivalent in structure to any other (i.e., one PT cannot be prioritized over another on the basis of network structure), the meaning of language must be used to prioritize knowledge. The highest “priority” placed on the meaning of language in androidal science is referred to as the KP's conscience.

We use this analogy to human thought—plain and simple—because it works. If, for instance, the KP were employed to control an electric motor, we might ask the question “How fast should the motor turn?” We know that an electric motor can understand force, torque, speed, acceleration, inertia, and any other engineering parameter, but how would the KP understand what the word fast means in the context of natural language? In the example, something must ultimately prevent the motor from spinning off of its axis—through natural language.

If the motor (KP) were to understand that “fools rush in where angels dare to go,” then the motor could translate such expressions so that it would never rotate in such a manner as to be foolish (or in a rush). Further, if the translator could transform all expressions to the effect of “turn fast” (a command) into UPL functions that output specific voltages to the motor in order to rotate at a speed that were not slow, then the action would always be verified against the concept of “rushing.” (See also Sections 3.3.6 and 3.3.7 regarding function naming conventions and learning function design.) The KP would always possess knowledge that guides and motivates the translators according to the KP's “wisdom.” These higher-level translators that operate on PTs and network webbing are collectively referred to as the KP's conscience. In theory, all of the KP's translators should be guided by the KP's conscience (wisdom).

For the Hello world project, however, we use the identity translator as the KP's conscience. When the developer greets the KP with the expression Hello Andrew, for instance, the dialog translator is concerned with identifying the expression in the LTKB. The dialog translator, however, cannot determine the “ultimate meaning” of the expression until it is related to the KP's conscience. (In linguistic discussions, the “deep structure,” or ultimate meaning of language is usually considered to be untouchable by human inquiry. In knowledge processing, however, the deep structure of the mind is defined as the action of the conscience—as a comparator—on all other knowledge, such that any epistemic expression is brought into conformance with those PTs and that semantic webbing that constitute the KP's wisdom. The KP thereby always recognizes the “deep” meaning of language.) Once the dialog translator recognizes the expression, the identity translator (the Hello world project's conscience) further translates the expression against its wisdom.

In order to demonstrate this very point in the CD/ROM version, the KP contains the expression I am Andy in one of the identity translator's PTs. The word Andrew is installed in the right metanoun semantic cluster of that PT, while the expression I am Andy is synthesized, through PNGW, into the expression I am Andy and I do not like the name Andrew (perhaps because the KP cannot immediately find the word Andrew and must search its semantic clusters in order to respond personally to the name Andrew). Thus, when the word Andrew is entered through dialog with the developer, the greeting puts the KP “on guard” according to its conscience. The conscience (the identity translator) then instructs the dialog translator to greet the user by using formal language as its passes parameters back to the dialog translator. The dialog translator then translates the expression Hello Andrew into the expression Hello world (instead of the expression “Hola mundo,” for instance—an informal greeting in Spanish).

If designed properly, all translators operate in this fashion, beginning with lower-level knowledge transformations and working their way up to the conscience's wisdom, and back down to the mundane, thereby ensuring that the KP's use of language is motivated by that which drives human thought—the conscience. When the KP responds to the question What is 2+2, for instance, the KP usually replies further, “Arithmetically?” Then, depending on further dialog, the KP translates the expression either into 2+2=4, or 2+2 is a fact. This is because the identity translator is motivated by its wisdom to use the metaphor instead of the arithmetic. If an arithmetic answer is required, the identity translator must “override its better judgement” and allow the arithmetic translator to perform the transformation into the expression 2+2=4. By exploring the metaphor, however, the developer will be able to coax the KP into revealing the expression for which the Hello world; I think project is named. When the developer answers no to the above question, the KP uses the metaphor and replies 2+2 is a fact. When the developer enters the expression why is 2+2 a fact?, the KP responds: “2+2 is a fact because I think.” (The network webbing for this expression can be traversed by using the diagnostic window.)

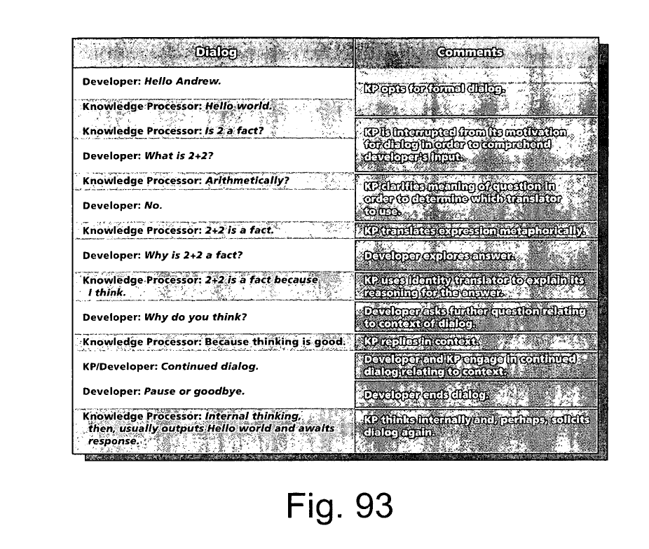

While the use of the pronoun I is a somewhat illegitimate use of language in the case of the Hello world project (because the project does not utilize senses and motors with which to perceive and understand what the pronoun I means), the project does demonstrate the KP's circular manipulation of knowledge based on its conscience. One of the countlessly many dialogs possible with the KP is shown in FIG. 93. (The developer may wish to conceive any other words or expressions for the KP to learn through dialog. The KP is capable of learning any expression that pertains to the four translators of the project.) Often, it is virtually impossible to observe the KP's actions, even when viewing them from the diagnostic window, because the total number of potential expressions arising from the semantic clusters and the network's webbing can easily require several thousand expressions to be traversed. It is recommended, therefore, that the developer begin programming just a half-dozen or so PTs and their related network webbing before advancing in linguistic complexity. This will allow the developer to gain understanding and confidence in building knowledge networks before designing more complex network features.

7.9.4 Language Constructor

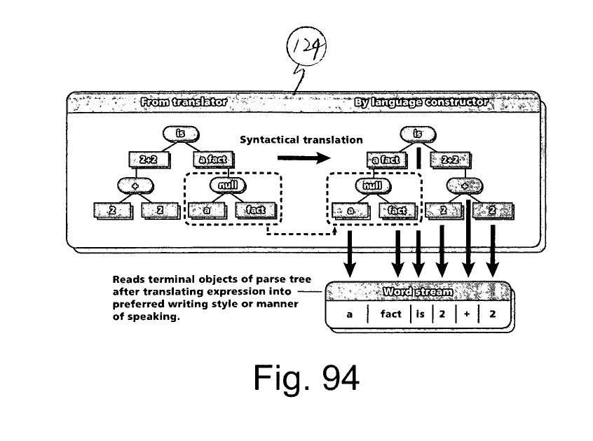

The language constructor (124) is usually designed as an afterthought to the translator's development. The language constructor provides the developer's last opportunity to allow the KP to “adjust” language before it is output through a communication device via the I/O engine. As shown in FIG. 94, depending on the language constructor's design, a given parse tree prepared by a translator can be altered, syntactically or semantically, as the constructor generates the parse tree's word stream.

In order to demonstrate the language constructor, or “finishing translator,” used for the Hello world project, we can examine two options for word stream generation. The first option shown in the figure occurs when the KP produces formal language—in response, for instance, to the greeting Hello Andrew (not Andy). This alternative is demonstrated or implied in many of the discussions in this section. A second option, however, allows the KP to exchange the subject and complement metanouns of an epistemic moment during the production of a simple sentence. As shown in the illustration, the KP exchanges the subject and complement of the simple sentence 2+2 is a fact (produced by the abstraction and identity translators) so that the resulting word stream reads a fact is 2+2. (A barely acceptable “poetic” skill arises from the sentence's parallel to that of the expression To the stores Iran.)

The language constructor can call any of the other translators, if desired, in a sort of “linguistic feedback control loop” in order to express language in a manner that is different from how the given ideas are conceived cognitively. This circumstance arises quite frequently in human discourse and thought when, for instance, ideas are generated by using, perhaps, colloquial speech—or even worse, slang—and must then be translated into proper (acceptable) language usage “at the last minute.” The language constructor simply invokes additional translators while selecting isolated PBs from the given parse tree in order to deposit them into an output data set containing the target word stream.

7.9.5 Expanding the Application's Capabilities

The Hello world project has been designed and included in this section for two reasons beyond its tutorial value. On the one hand, the programming illustrated throughout the section can be used as a springboard to other, more sophisticated projects, including those that require the concepts of androidal science. On the other hand, however, the illustrative project can be simplified in order to enhance conventional computing applications where required. The Hello world project thus serves as a fulcrum for moving up or down the scale of KP application complexity.

As shown in Sections 13 and 15, for instance, the KP can be used to manipulate any computer hardware or software that uses ASCII or Unicode characters (or any other byte encodings, for that matter). The KP's parsers can be simplified in order to understand or translate EDI/XML documents used for transmission over the Internet in B2B communications, for example. The data elements and transaction sets, along with the I/O protocols, of an EDI document can be constructed in a KP application as simplified elements of natural language. Instead of using complex semantic categories and network webbing, the developer builds PTs and matching parsers and translators for EDI/XML words, phrases, sentences, and documents. An advantage that the KP demonstrates over conventional technology, however, is that, when the content of the EDI document must be translated as well, the KP can be enhanced with natural language capabilities as required (perhaps to understand the meaning of a purchase order). Similar enhancements can be made to database technology and any other computational schemata that contain knowledge. (See also Section 16.)

It usually takes even the experienced developer many contemplative design efforts to appreciate the KP's capabilities with respect to language usage and intelligence. On a first approach, many developer's tend to overlook the basic innovation presented by the KP—that the KP “thinks.” The fact that the KP thinks and learns in natural language presents all kinds of new issues to consider during application development. In order that the developer should take notice of some of these basic points here, we can compare the knowledge network's operation to that of the human mind.

The KP's design enables machines to think and learn the way the mind does. The running processes, therefore, manipulate PTs, semantic clusters, and network webbing in order to produce word streams (say, sentences) that are meaningful to the KP's “existence.” The KP's operation thus cannot be measured quantitatively—or even “computationally.” The KP's performance is “measured” in terms of its own existence. Thus, there is no “right way” to construct a knowledge processor, except for understanding the basic structures and processes of the KP paradigm and how they can be cultivated to develop knowledge of interest to the developer.

In order to appreciate what this qualitative processing method means to KP application development, we can consider the non-algorithmic nature of the human mind. When confronted with the expression What is 2+2, the human mind, in truth, would have no legitimate reply without further dialog. For instance, does the question inquire about arithmetic, or is the expression a philosophical inquiry pertaining to why arithmetic is even part of the human experience? Does the question ask What is the sum of 2 and 2? in which case, perhaps the better reply would be 2 whats? (two marbles, numbers, people, and so on). The goal of knowledge processing is to enable a machine to think, not simply to compile a base 10 arithmetic algorithm into one performed on base 2 numbers. When creating the running processes, it is therefore essential to keep in mind that the KP processes knowledge—in the context of its own existence and wisdom—with no particular measurable result to achieve.

When building knowledge networks, the goal is simply to guide the KP's use of language. Whereas the developer is no doubt looking for a defined result to the Hello world project—a specific dialog, for instance, that would “prove” the KP's intelligence the way artificial intelligence is developed and evaluated in computer science—the Hello world project may unfold indefinitely and course through language that demonstrates no clear “proof” of the KP's intelligence. We can cite here, however, that advertising agencies are paid millions of dollars just to think of the words Hello Bello (an alternative construction to Hello world) for a company called Bello Doorbells, Inc. In fact, hundreds of calendar years comprised of nanosecond-rate epistemic translations may occur before the KP yields the ASCII characters in the expression I am alive and well. (Wellness is always a subject of human speculation and uncertainty.) In another venue, the developer and KP may converse, as they say, “ad nauseam,” about 2+2 being a fact—or not a fact, or a fact sometimes and not others, and so on. Thus, it has taken until this point in the specification simply to demonstrate that a human being, and thus the KP, does not “do anything” of interest that is calculable or “computable.” A computer does that. The KP simply “thinks.”

Moreover, the field of androidal science begins by pondering a single, one-letter word—the pronoun I. Every human being struggles at one time or another to determine what this “ASCII character” means. Why then should we demand that a machine understand this word easily? Accordingly, the PT I am alive introduces a world of engineering and philosophical complexity to the knowledge processing paradigm. In order for the KP to “verify” this knowledge, the KP would have to “be alive” in physical reality. Androidal science is therefore concerned with the design of a machine-being's perceptions such that the pronoun I is (or could be) alive—emotionally, spiritually, and physically. In order to accomplish a machine-being's existence, androidal science “splits” the android's perceptions (senses and motors) into a “self” and “the rest of the world.” Whatever a video camera observes in the physical world, for instance, is related to a self (I) in the metaphysical surroundings of the “rest of the world.” If the video detects a table in its environment (as illustrated in Section 24), the camera must also perceive the machine-being (the self, or I) in relation to the table. In this manner, the table can be described as “it” in the context of the machine-being's language usage. The expression It is a table thus relates to the machine-being's existence, thereby giving meaning to a pronoun (it) that would otherwise be meaningless. The pronoun I thus relates to that which is not the rest of the world in the android's existence.

While we must be careful at this point not to begin a specification anew on androidal science, it can be appreciated that if a robotic arm were to move the abovementioned table, and that, if moving the table made the machine-being “feel alive,” the PT for the expression I am alive would have meaning in the android's spatiotemporal existence. The knowledge network could then observe that expressions such as I am a robot, and I have feelings, would make sense. Rather than follow an engineering control theory exclusively to direct the robot arm's trajectories in a world model, the machine being could move the table because it is frustrated. The robot would have feelings because it would decide to move the table perhaps when no one would talk to it. Similarly, we can temporarily disrupt the knowledge network from thinking at all by loading just two PBs—I and am—into the registers of the silicon mind. What would the KP do with the expression I am (I exist)? This expression befuddles even the human condition.

Thus, when building KP applications that “manipulate language,” the developer must consider that the KP does more than think artificially; it thinks (and learns) period. The KP transforms the meaning of language according to the deep structures of its conscience. The metaphors that are transformed by the KP between one epistemic moment or parse tree and another are the action of an unpredictable knowledge processor. To produce a predictable result in knowledge processing is to fall short of the design objectives. A knowledge processor that arrives at an expression worthy of the developer's attention—for whatever reason—is a twenty-cent microchip whose worth is immeasurable.

### Section 8: Rg Knowledge Continuum

8.1 Introduction

The KP's design only begins with the developer's intelligent workstations. The global enterprise infrastructure that supports integrated KP applications is referred to as the Rg Knowledge Continuum (125). The Rg knowledge continuum is a network of enterprise systems and technologies that operates according to the universal grammar and interacts with users intelligently. The Rg continuum's conception is necessary in order to shift the focus of infrastructure design from building icon-, or algorithm-based software systems and computer architecture, to designing and controlling structured “societies” of synthetically intelligent machines that understand natural language. The Rg knowledge continuum allows the developer and the KP to conceive language and technology (KP applications) remotely through natural language by applying the global system modeling techniques of the KP paradigm to global infrastructure design.

In order to introduce the Rg knowledge continuum, we can recall from earlier discussions about the GSM that today's global knowledge and physical infrastructure is founded on the widely held premise that machines cannot think. The ISO standard, along with Ethernet LAN technology, Internet-based and enterprise wide area networks, CDMA/TDMA telephony, and even robotics, for instance, all are based on the notion that the microchips that reside in the components of these systems cannot understand the meaning of language. We can begin making a home for the knowledge processor, then, by considering what changes would need to be made to global infrastructure if machines could think. We can imagine, for instance, what would happen if an ordinary telephone recorder and its global infrastructure could understand language the way we, and now the KP, does.

For one thing, since human beings cannot think as fast as a microchip, there would be a time differential between human and machine communications. Moreover, the human caller would have to decide whether to communicate directly with a human being or to rely on a machine to relate the relevant conversation to the caller's audience. Furthermore, if a telephone recorder could access a million or so other telephone recorders (microchips) in less than a minute, how would a telephone company handle the day's callers? Already, telephone systems are saturated with human conversations and the Internet. Perhaps more dramatically, however, how would a human being or enterprise control such a network of machines that think? If a microchip processes millions of epistemic thoughts in a matter of seconds, and each thought occurs as a potential “stroke of genius,” how would a human being even be notified about the processor's breakthrough in human knowledge?

Human society thus must come to depend on machine intelligence and its ability to understand knowledge at the highest levels of human cognition. The Rg continuum is therefore a structure that is designed to control intelligent infrastructure that understands any knowledge and communicates in natural language. In order to accomplish this “social integration” of human and machine intelligence, the KP's designers have developed an approach to building KP applications that is based on the design of an ever-expanding continuum of enterprise systems. Referred to as Rg Modules (126), the systems are configured according to a global system model that arranges enterprise activity into five levels of system connectivity, which are collectively referred to as the Rg knowledge continuum. The Rg modules and resultant knowledge continuum enhance conventional infrastructure by augmenting the principles of engineered systems with the structures and techniques of the universal grammar and the KP paradigm. The Rg module's design allows the developer to construct global infrastructure from a single module, or workstation, that integrates with and controls any number of other Rg modules distributed throughout the continuum. The Rg module allows any system or technology to operate according to a “metaphysical” configuration of Rg continuum structure (discussed shortly) that enables KP infrastructure to behave like a human being—to “think”—while interacting with people and machines. In this manner, systems and technology can operate according to natural language interfaces distributed throughout the continuum, while knowledge and physical systems are conceived and integrated by the evolving applications connected through the five levels of continuum structure.

According to the universal grammar (see Section 9.5), the epistemic moment defines the fundamental nature of both the physical and cognitive forms of the universe. What occurs in a single epistemic moment of language represents a human perception of the physical universe's form. The problem that conventional theories of design encounter when contemplating infrastructure is that their understanding and use of language—what is used cognitively to represent the physical universe—does not directly correspond to an ordinary human being's use of language. Engineered systems, which are defined by quantitative languages such as mathematics, cannot be made to correspond directly with natural language through a machine so that a human being could control the apparatus by using natural language. It is not ordinarily recognized, for instance, that the expression the cat (the linguistic transformation) occurs cognitively in the same manner as the observer's perception, or experience, of the cat occurs in physical reality. The expression the (null) cat, however, describes the physical universe just as precisely as does the expression (E) (=) (mc²), which represents E=mc² as an epistemic moment.

In the Rg continuum, what is important about the physical universe is what a being (human or machine) thinks and perceives about it. Thus, the Rg module and knowledge continuum are an infrastructure that ensures that epistemic moments—not just mathematical or “scientific” epistemic moments—are maintained in correspondence with each other as they transgress cognitive and physical universes. The Rg continuum is thus a metaphysical form, in terms of its defining structures, even though, to the developer, the continuum appears to be entirely physical, since it is enabled in the developer's physical universe. The five tiers of language-based metaphysical form of the Rg knowledge continuum thus define five important ways that epistemic moments and their universal relationships can be made to correspond with each other throughout a global infrastructure. The Rg continuum is an epistemological structure that is placed onto human and machine existence so that the human universe of thought and innovation can be expanded by thinking machines. The five tiers of the knowledge continuum reflect the various metaphysical premises of KP technology that support the modularized development of global infrastructure. The Rg continuum allows thinking machines and their infrastructure to integrate into human society.

Engineering, as it were, occurs first in natural language because the physical universe occurs according to natural language. The elements of the universe, for instance, are no more a product of reality than the fictional thoughts that occur in the head of a poet—each is simply defined differently metaphysically according to the mind's perception of reality. These points are difficult to appreciate when considering human existence, however, because one human being cannot enable another (as a developer). But when androidal science is contemplated in order to build infrastructure that thinks and learns along with us, the human developer must indeed consider how the physical universe (technology) transforms metaphysically. We can consider, for instance, why a differential equation (the calculus) should define the “physical universe” any more precisely than the expression small particle of physics does, when a preposition transforms its objects. Why should the words matter, energy, and the speed of light squared be considered imaginative, while the expression E=mc² defines “reality”? The problem we have had with system designs throughout history is that we have been unable to attain the precision afforded by natural language when defining scientific forms. Would it not be better, however, if the production engineer could command that a robot arm move “a little,” instead of 0.25 inches? In what kind of system or technology could the graphic artist change a shape or color to something “dreamier”? And further, what kind of computer could the modern physicist interact with in order to explore an even deeper meaning of a string (the universe) than that which is afforded by mathematical expression?

The design of the Rg module and continuum recognizes that physical and cognitive form both occur in epistemic structure. It stands to reason, then, that if one were to control thinking and perceiving machines, one would have to control their epistemic moments. In this manner, when a machine solves a differential equation (the wave equation of small particle physics) describing the electron orbits of, say, the oxygen atom, the developer would remain behind the scenes controlling the metaphors, anecdotes, analyses, formulae, and other conceptual blending techniques that the android would use to solve the equation. If the developer controls the machine's cognitive moments and their correspondences to physical forms, as perceived through the machine's senses and motors, we have obtained, at least in principal, the structure we have been leading up to—the “social” structure that enhances the engineered system so that machines can think and perceive in our same universe. Since the KP is enabled in an inexpensive silicon wafer, the intelligence required for the continuum's development is obtainable in a cost-effective manner, while our human stewardship of the continuum becomes focused on cultivating the intelligence of machines that, in turn, manipulate physical reality.

What is important to realize when first learning about the Rg continuum is that natural language defines the exact, physical, or even “engineered” properties of a system, despite the fact that we cannot immediately see, for instance, that the algebraic expression y=f(x) is equivalent in meaning to the phonetic expression wye equals eff of ex in the mind's action. The reason that natural language has never been used by a machine before in this manner is that natural language has been deemed to be too imprecise for machine control. The sciences, however, are in fact less precise than natural language, as the poet, the politician, and the biologist would most assuredly verify. (This is why the scientist is more valuable than science's instruments.) An “exact science” simply means a commonly ruled or accepted method—usually as understood through mathematics. But the universe, which includes the human beings that give rise to it through their perceptions, is different in its every moment. Engineered systems, however, replicate these moments by implementing algorithms according to mathematical theory.

Alternatively, the Rg continuum allows physical and cognitive apparatus to differ from one moment to the next according to the expressions of natural language. The Rg continuum is thus a structure that is based on the idea that any thought or perception is a “scientific” one that can be engineered linguistically. Instead of rendering a definition of the physical universe based on the conception of mathematical correspondences, however, the Rg continuum maintains correspondences based on linguistic conceptual blending techniques. Through the universal grammar, the Rg continuum allows machines to embody perceptions and thoughts about our human experience in the world—and, importantly, enables the developer to control such existential processes. The Rg continuum augments the sciences with the metaphor (and any other conceptual blending technique) in order to enable a machine to understand physical experiences through natural language. The Rg continuum allows any physical form to correspond to linguistic form based on the premises and techniques described earlier for the KP paradigm. The continuum allows one machine to communicate with another by operating on PBs that represent expressions of language instead of data, while the physical universe remains in conformance with these thoughts through a mind-body dualism of form.

8.2 Rg Module

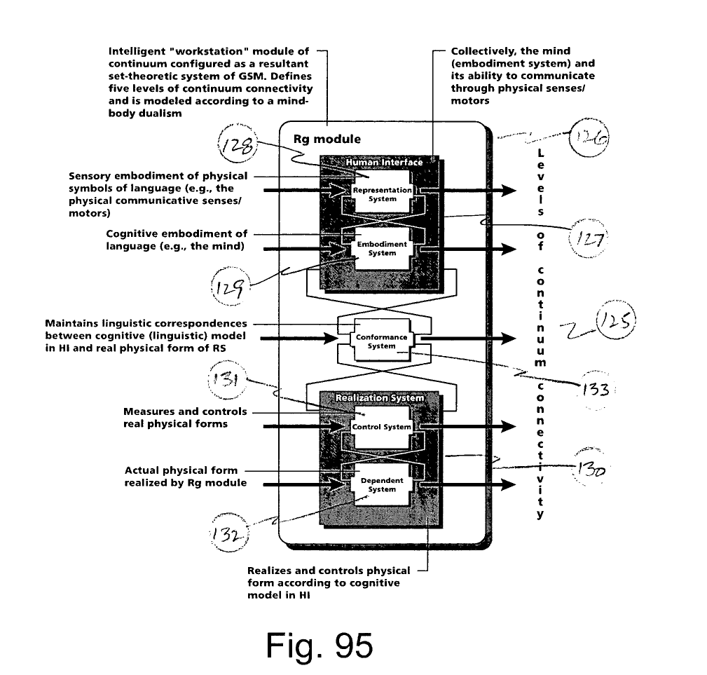

The Rg module's (126) basic purpose is to maintain real, physical systems in linguistic correspondence with “non-real” or cognitive models, whereby any system action can originate from a knowledge processor's intelligent network or the human mind, as shown in FIG. 95. Accordingly, the Rg module incorporates a Human Interface (HI) (127), which is comprised of a Representation level (128) and a (cognitive) Embodiment level (129) of the continuum, and a Realization System (RS) (130), which provides a Control System (131) and a Dependent (Real) System (132). The cognitive, or “non-real” levels of the continuum, embody the KP's synthetic thoughts and ability to create and transmit new knowledge, whereas the realizational levels of the continuum interact with the non-real levels to control the dependent (real) systems through the continuum's Conformance level (133), as shown. The module's conformance level maintains the linguistic correspondences between real and non-real systems. The realization system interacts with the human interface in order to emulate the human mind-body dualism of metaphysical form. (Of course, in the developer's experience, all forms are “real,” or physical, including those of the microchips used in the embodiment system that manipulate the module's thoughts, or “non-real forms.”)

The Rg continuum is established when these five levels of metaphysical modeling and realizational capability interact throughout a global infrastructure controlled by the developer. Whereas conventionally engineered systems are implemented according to the user's thoughts and ideas as expressed in “scientific” languages, such as those of mathematics and information theory, the Rg module communicates with the user in natural language and realizes scientific systems based on its comprehension and use of natural language. The Rg module is the basic structure used to develop KP infrastructure globally and to integrate evolving GSMs.

8.3 Rg Continuum's Vertical Integration

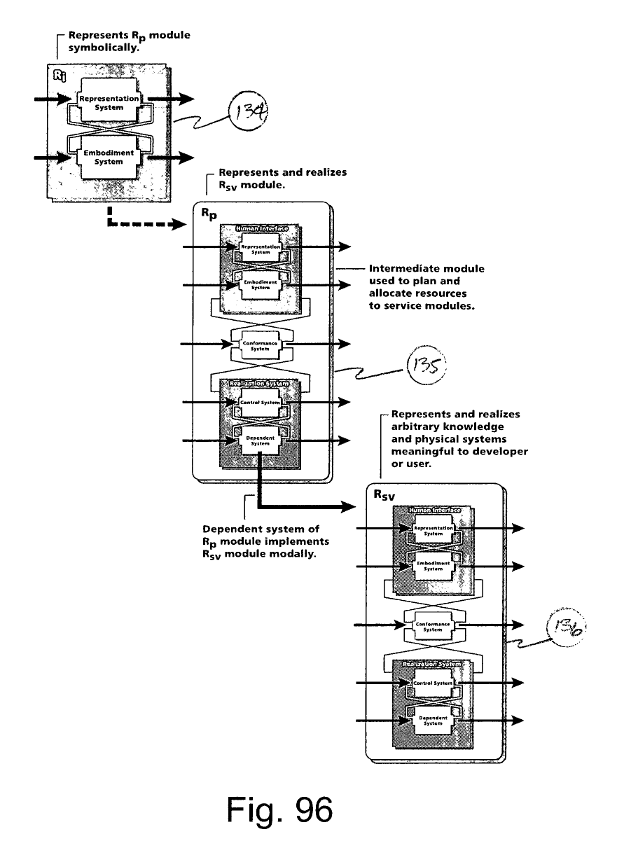

The Rg module is further configured according to how its metaphysical components integrate globally with respect to the use of Rg modules. As shown in FIG. 96, the Rg module integrates vertically within the continuum workspace, or knowledge domain, of a single developer according to three specific Rg module archetypes. According to the KP paradigm, the developer first performs system modeling of the Rg continuum and the Rg modules over which the developer will impose system control. This type of Rg module, which does not incorporate a realization system, is referred to as the Initialization Rg module (Rᵢ) (134). The Rᵢ module is comprised only of a human interface (to the continuum). The reason for establishing the Rᵢ module is that its realizations (the physical systems that it models) are other Rg modules that are constructed “by the developer's hand.” The term by hand is intended to mean, broadly, “not by an Rg module.” Thus, the Rg modules modeled by the Rᵢ are constructed by means available externally to the continuum—not by the realizational capabilities of other Rg modules. The actual modules modeled by the Rᵢ demonstrate, by way of example but not limitation, construction industries, manufacturing plants, civil infrastructure, and, in general, global industry at large. The Rᵢ thus models other Rg modules that are constructed by means provided by the developer through external business and industrial sources “by hand.”

The second type of Rg module used in the continuum, which is modeled by the Rᵢ, is referred to as the Platform Rg module (Rₚ) (135). The Rₚ is a completely defined Rg module (as shown in FIG. 95); its usage differs from that of other modules based on its purpose. The Rₚ module is used for modeling and realizing other Rg modules. The Rg modules that are realized by the Rₚ, in turn, are referred to as Service Rg modules (Rₛᵥ) (136). The Rₛᵥ modules actually perform the useful functions of a global infrastructure, while the Rₚ modules model and realize the Rₛᵥ modules. By way of analogy to today's enterprise environments, the Rₚ module can be understood as performing the responsibilities of management and equity ownership of an enterprise (with their commensurate engineering and technological capabilities), while the Rₛᵥ constitutes the actual enterprise realized by the management's planning. The Rᵢ performs the system modeling required in order to realize the capacities of the enterprise's management and planning functions (the Rₚ), while the Rₚ realizes the actual enterprise infrastructure required (the Rₛᵥ).

The concept of the Rᵢ, Rₚ, and Rₛᵥ modules is actually simple and straightforward to understand. The purpose of the three modules is to anticipate any design changes that may occur to the continuum before the continuum's first module is constructed. The Rg module configurations anticipate the reformation of global infrastructure by accounting for the three basic elements of any design and its implementation—the modeling (Rᵢ module) of planning related systems (Rₚ modules) that will, in turn, model and realize other service related systems (Rₛᵥs). If the Rg module were constructed in order to serve one particular purpose, the question would ultimately arise about what to do when the design mission—the module's configuration—changes in scope. In a similar way to the manner in which today's manufacturing processes “group” production needs according to flexible manufacturing cells that accommodate the fabrication of parts in terms of common manufacturing attributes, the Rₚ module “groups,” or plans for the modeling and realization of other (Rₛᵥ) modules. The Rᵢ module models the planning and implementation processes performed by the Rₚ module. FIG. 96 summarizes the relationships among these three classes of Rg modules. These module relationships are referred to as the Rg continuum's “vertical integration.” When the developer first considers how the workspace of KP applications and conventional, preexisting infrastructure will evolve, the developer can rely on the three archetypes of Rg modules to provide a guide to infrastructure design that anticipates changes to the developing infrastructure (Rₛᵥ).

8.4 Rg Continuum's Horizontal Integration

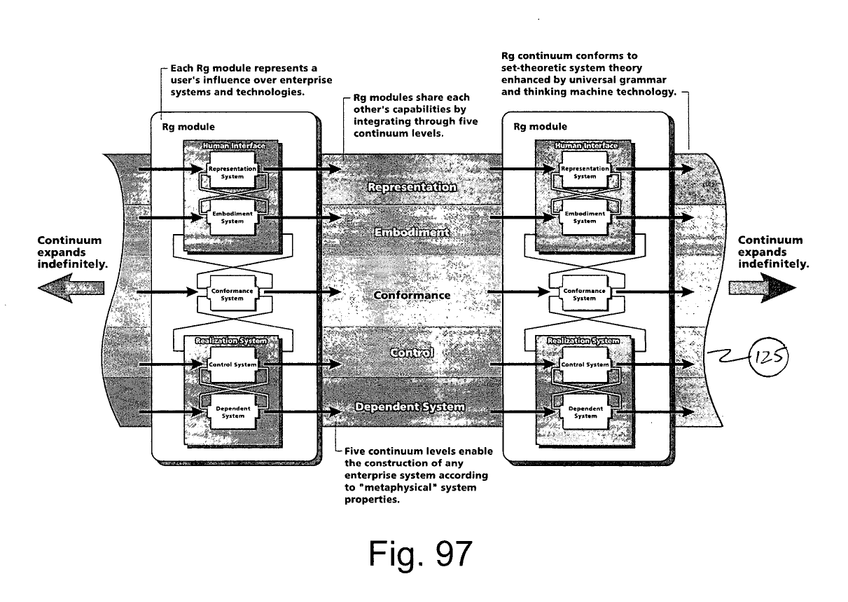

The Rg continuum can expand in other ways as well by integrating Rg modules “horizontally” across the five levels of continuum structure discussed earlier, as shown in FIG. 97. The Rg continuum is designed this way—on a “metaphysical” basis—because the model most efficiently supports the transfer and integration of knowledge and technology throughout the continuum by machines and people who use arbitrary language.

As shown in the figure, the Rg continuum is designed so that any component of an Rg module can be redesigned and integrated into the continuum based on the functionality of its continuum level. If the engineer, for instance, is concerned with a technology that conveys symbols—such as a telephone system—then the “representational” level of the continuum will be altered. If, however, the symbols transmitted by the representational level must be understood by a machine, perhaps in order to translate embedded natural language, the continuum's “embodiment” level must be employed. In either case, the systems and technologies deployed in each of the users' respective modules can be changed and integrated based on the functionality of a continuum level. When the meaning of a communication must be realized in physical form, the conformance system, which maintains correspondences between real and non-real forms, integrates any subset of Rg modules so that the resulting system enhances the capacities of the initial module.

When the overall implications of the continuum's vertical and horizontal integration are considered, it can be appreciated that, as KP applications develop, capabilities from widely divergent knowledge disciplines and technologies can be brought together, on a system-theoretic basis, so that any level of the continuum can be shared among modules, thereby affording the developer complete flexibility in module development by using the capabilities of other modules. The representational level of a given Rg module, for instance, may be used, ultimately, to control the realizations performed by any number of other modules in the continuum. In such a case, the initial module's conformance system interacts with those conformance systems of the respective external modules in order to ensure that correspondences are maintained between the non-real form of the controlling module (Rᵢ, Rₚ, or Rₛᵥ), as represented by that module in its representational level, and the realizations of the other modules. In this manner, the system-theoretic “modes” (137) of the continuum are controlled by human interfaces belonging to any of the continuum's modules, while the same modal cooperation is implemented among the physical systems deployed as “dependent systems” throughout the continuum. In order to explain the continuum structure further, we can now examine each of the continuum's levels in greater detail.

8.4.1 Representational Level of Continuum

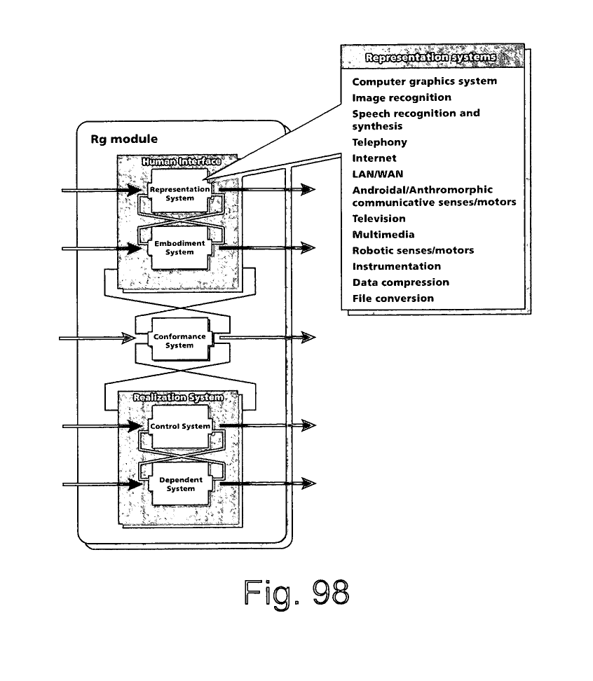

The first level of the continuum, the Representation level (128), is dedicated to the developer's requirement for representing knowledge independently of the KP's cognitive capacity to comprehend and manipulate that language, as shown in FIG. 98. This level of the continuum is concerned with the physical embodiment of a language's symbols in sensory media. This continuum layer carries knowledge to users and other machinery through human and machine interfaces. Here, the KP integrates sensory systems, including, for instance, computer graphics systems, voice and image recognition systems, telephone systems, televisions, facsimile and photocopy machines, digitizing technology, and any kind of instrumentation that displays, in a sensory medium, the symbols that are comprehensible to human or machine perception. (See also Sections 17 and 20.)

The continuum's representation level allows digital or analog carrier signals (the input or output of a set-theoretic system), containing embedded language, to be transported throughout the continuum by conventional electronic devices, such as those used to process Internet, telephone, and multimedia communications, and systems enhanced by the KP's intelligence. FIG. 98 summarizes that, in the representational level of the continuum, a computer graphics file, a digital or analog acoustical wave pattern, or a simple ASCII byte can be embodied in its respective sensory apparatus, while the KP, via symbol kits and the GSM, translates the symbols according to the premises of the KP paradigm. The “meaning” of the various symbols is, for all intents and purposes, irrelevant to the conveyance of the symbol in this layer of the continuum. The reason for eliminating a symbol's meaning from this continuum level is that, as will be shown shortly, the continuum's embodiment level processes language semantically. The representational level thus converts and transmits carrier signals whose purpose it is to convey meaningful information, but not necessarily to understand that information. The representational level of the continuum (and of the Rg module) is set-theoretically coupled to the embodiment system and to the external user, as shown.

It may be important for a given application simply to transmit carrier signals without any device, including the KP, comprehending or changing that information. Conversely, it may be essential for the recipient of the information to interpret the symbols' meaning in their pure sensory form. A conventional communication system, such as the Internet, is an example of a technology that is enhanced by the representational level of the continuum's GSM modeling techniques. The representational level of the continuum utilizes knowledge processors in order to convey the physical properties of symbols, while defining the properties through PB definitions and knowledge network structures. Just as the KP's on- and off-platform displays separate a symbol's physical properties from its semantic interpretation by the knowledge network, the representational level of the continuum conveys physical symbols, while the embodiment level of the continuum understands the symbols' meaning.

The KP's symbol kits, readers and writers, translation cards, and GSM become the essential design focus for the representational layer. Once a symbol has been converted into a PB, it can be interpreted, altered, and output to another machine through a different writer and symbol kit according to a suitable GSM. The KP thus can receive a character from a graphical display, as represented by the graphics system in its graphics file, and convert that external data by operating only on the platform, or sensory properties of the symbol. The KP can receive a programmable byte and, through a symbol kit and writer, output that byte as an acoustic wave pattern to a different machine, thereby converting, say, the first character of a character string in an external file into its phonetic pronunciation by a speech synthesis system. The representational level of the continuum controls the transmission of PBs—and any other data structures converted into PBs—in order to enhance conventional communications infrastructure. Though it is usually unnecessary for the representation level to “think,” the KP can also provide intelligence for the representational level. By using the KP's intelligence (usually from the embodiment level), the transmitted “data” becomes language to the KP, whereby the KP verifies the meaning of an expression by understanding the epistemic moments embedded in the carrier signal. In this manner, the content transmitted in a communications signal can be examined on the basis of sensory or semantic properties depending on the discretionary use of the embodiment system.

What is important to appreciate about the representational level of the continuum is that, in the knowledge processing paradigm, a symbol and its meaning are two distinct entities, each handled by a different level and purpose of the continuum. An excellent anecdotal example of the continuum's representational structure arises through the use of a language translator. We can consider an actual circumstance in which a language translation occurs in the continuum. Let us say that a knowledge source (user) generates the expression Tengo casa (Spanish for I have a house). The continuum's representational level receives the expression and translates it into the English expression I have a house. In order to appreciate the distinction between the representational and embodiment levels of the continuum, however, we may consider why the translator would not have translated the word tengo (I have) into no tengo (I do not have) if the translator actually had known that the source really did not have a house. Thus, where should the line be drawn between a language translation and a meaningful expression of knowledge? While the example clearly demonstrates that the distinction between translating language and translating meaning is entirely arbitrary, many other instances occur with similar ambiguity that must be resolved by the embodiment system. When a miscommunication occurs, for instance, due to a missing word or phrase in a noisy transmission, the translator must indeed apply intelligence—not only procedural translation methods—in order to make an educated guess about the transmission's content. In this case, the continuum's embodiment level must be invoked even though the purpose of the transmission is simply to “convey symbols.” The continuum's representational level thus may contain many intelligent knowledge processors in order to translate language, but only the embodiment level would alter that knowledge according to the module's intelligence. (See also Section 21.)

8.4.2 Embodiment Level of Continuum

The Embodiment level (129) of the continuum performs the Rg module's cognitive actions. One of the easiest ways to understand the embodiment system of the Rg module is to imagine that, when a computer is devised, the intelligence sits in front of it—not in it—as a human operator. Traditionally, the computer user embodies the computer's intelligence, while the computer manipulates symbols and data according to an algorithm. The Rg module's embodiment system, however, represents the KP's efforts as an intelligent machine. Thus, in order to understand the continuum's embodiment level, we must appreciate that the presence of the embodiment system ascribes the (now absent) user's intelligence to that of a machine. If we further imagine a computer designed as a representational medium (to display and receive symbols in any sensory medium) coupled to a cognitive embodiment platform—a synthetic mind—we will have conceptually constructed the continuum's Human Interface (HI)—a computer that does not need a user in order to represent and cognitively manipulate symbols.

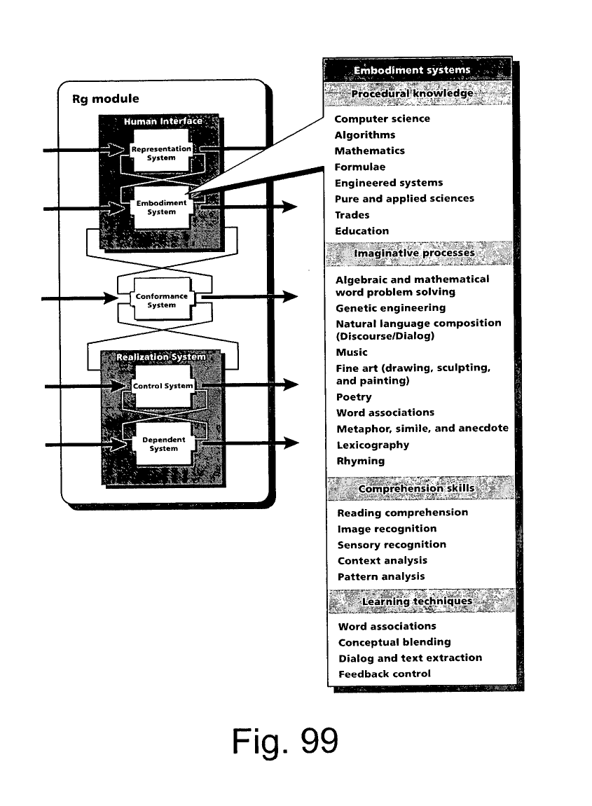

Even though the embodiment level may be invoked during any representational-level transmission (as discussed earlier), the embodiment system usually contains the machine's intelligence, which transforms language meaningfully. The reason for this configuration, as discussed earlier, is that the embodiment level of the continuum translates the meaning of the PBs transferred throughout the continuum. The embodiment level of the continuum contains the Rg module's and continuum's “intelligence.” The symbols that are conveyed through the representation level and realized by the realization system are imagined and comprehended by the (cognitive) embodiment level, or the Rg module's “conscious mind.” The embodiment level is typically the level one thinks of when contemplating the action of a knowledge processor—even though the premises of knowledge processing are applied to all levels of the continuum. FIG. 99 illustrates several types of embodiment systems, whereby conventional technologies are enhanced by the KP methodology. (See also Section 22.)

8.4.3 Control Level of Continuum

The third level of the continuum, the Control level (part of the realization system), actuates the systems that are modeled by the HI according to measurable engineering criteria that characterize the physical system's behavior. Since the physical embodiment of a system (the dependent system) can be ascertained only by measuring its physical attributes and behaviors, this level of the continuum operates on language that describes the measure of a system rather than its semantic definition in the HI. The continuum's “control system” incorporates the full spectrum of engineering control theory but also interfaces with a (linguistic) conformance system, which translates the actions of the controlled system into the higher-level natural language expressions of the HI.

In order to appreciate the continuum's control level, we can explore the design and use of an ordinary automobile. In this manner, when we incorporate the KP's intelligence capabilities into the modeling and implementation module later on, it will be easier to explain the importance of the continuum's conformance level. When an automobile is designed, many component-level models are created by the engineer. When an automobile is test driven, however, all aspects of each of the many component designs are not tested. The performance of the automobile is measured, not in terms of capturing the behavior of each element of the automobile at once, but in terms of its modeling, or control parameters. If an automobile can accelerate to a certain speed within a certain distance, for example, an acceptable level of control is achieved, within which all of the component parts are said to operate according to their intended designs. The automobile is thus tested for its conformance to design criteria.

What is important to appreciate here is not the complex engineering process by which an automobile is designed and manufactured, but that an automobile's use—and, hence, its control—is never actually “in conformance with its design.” The automobile's operation is in conformance with a set of control parameters that indicate (only) that the automobile is performing according to its original design. When an engineer draws a circle on a CAD system in order to represent the rim of a tire, for instance, the “actual” rim is never contemplated entirely because the manufacturing process by which the rim is produced can operate only within certain tolerances. Similarly, when the automobile's driver steps on the accelerator and drives up an unpaved mountain roadway, we can almost certainly assume that the engineer did not “model” the locations of every system component according to the geometry imposed by the mountainscape.

The point we are addressing here is that it is impossible to measure an analog world through discrete—actually, quantum—thoughts. The concept of a model thus requires that the actual, often physical entity be reduced in complexity to something that is measurable (i.e., controllable). The control of an entity is then more of an art than a science—even though the subject of instrumentation requires the exactitude of a precise science. The continuum's control level therefore manipulates the parameters that engage and control a physical system's behavior according to the mind's reduction of the physical entity into measurable phenomena. The conformance level of the continuum is required because there is always a difference between the model of an entity (in natural language) and the parameters that control that entity. (See also Section 19.)

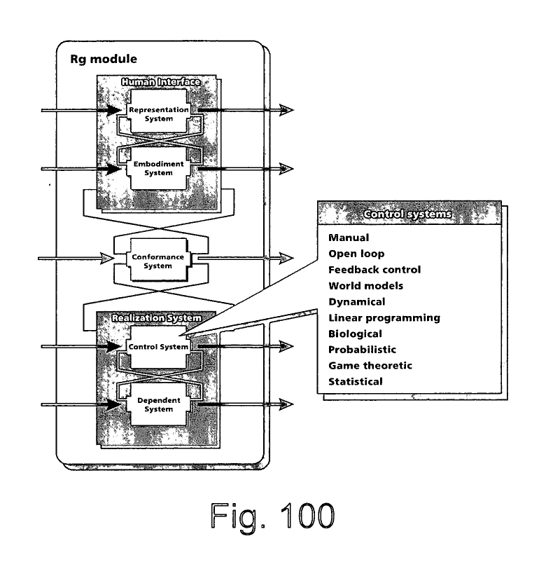

In the KP paradigm, the HI replicates the world in natural and other languages, while the realization system, which usually employs “scientific” languages, controls dependent systems (physical forms) according to the meaning of the natural language embodied in the HI. Thus, whereas classical control theory (simulation and control) is concerned only with Bode plots, Laplace transforms, and critical frequencies (control parameters), the Rg module concerns itself with the interpretation of these parameters in natural and other languages as they transform in the embodiment level and are realized by the realization system of the continuum. The control level of the continuum ensures that the actual physical system (the dependent system) operates in accordance with its control parameters, while the conformance level translates those parameters into the cognitive action of the embodiment level. FIG. 100 demonstrates various control systems that operate in an Rg module.

8.4.4 Dependent System Level of Continuum

The fourth level of the continuum comprises the physical system measured and realized by the control system and modeled by the HI. The real entity affected by the continuum through the other levels of the continuum is referred to as the Dependent System (132) of the Rg module. The dependent systems of the continuum embody the actual enterprises, appliances, systems, or other entities controlled by the realizational capabilities of the module. Since the physical entity is realized by the realization system only in terms of control parameters, the dependent system must exist “in physical reality” apart from its controller (the Rg module) in order to be realized modally according to the language constructed at the HI.

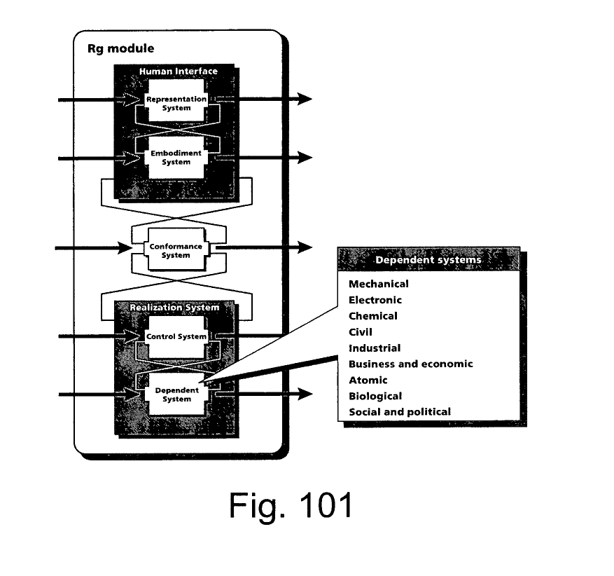

An easy way to understand the dependent system is to consider that a television set is not actually a “television” until it is turned on. For that matter, a television may be a radio or a computer depending on how its electronic components are employed once in operation. What makes a television a television is that a particular modality of its behavior can be prompted into action in order to make the object (the TV) behave like a television. The dependent system is thus a collection of components and their modes of operation which comprise a real system. The dependent system is realized and controlled by the control system in accordance with the conformance system's conceptual blending of the HI's natural language and the dependent system's controlled parameters, as shown in FIG. 101.

In order to explain the dependent system and its relationship to the other continuum and module components, we can consider the human arm as a dependent system of the body, wherein the (metaphysical) action of the brain's cerebral cortex is paramount to the discussion. The human arm—its anatomy and physiology—is capable of performing such tasks as turning a lightbulb, caressing a loved one, and writing a letter. In each of these cases, however, the human arm is still “a human arm” regardless of what activity it performs. What makes these various motions, or modes of operation, what they are is the cerebral cortex's interpretation and integration of the relevant motor skills into language. It is difficult, for instance, for the “hard-nosed” person to perform a caress, while it may be equally as difficult for those who are not mechanically inclined to screw in a lightbulb. This is because the mind's thoughts control the arm's motions (except for involuntary responses). Thus, the arm and hand “exist” in some form known to the senses (i.e., as a dependent system), but, depending on the mode of operation displayed by the arm, different behaviors, or “systems” (system modes, or homomorphisms in discrete system theory) result.

Thus, the dependent system of the Rg module is a physical phenomenon that exists “in reality” (to other senses) but is known to the module only when a particular mode of its operation is engaged. The control system controls such action and the HI understands and represents the action, while the conformance level translates the module's cognitive understanding of the system into controllable parameters. According to conventional system theory, for instance, the dependent system constitutes the set of all “off-the-shelf” technologies whose behaviors can be implemented and controlled modally (according to system theory) and, in the case of the Rg module, controlled, ultimately, by natural language.

8.4.5 Conformance Level of Continuum

The fifth and final level of the continuum, the Conformance level (133), ensures that correspondences between the representations and cognitive embodiments of the human interface and the realizations of the dependent systems performed by the control level are maintained according to acceptable levels of linguistic similitude. The conformance system applies conceptual blending techniques—such as metaphors, similes, analogies, anecdotes, formulae, morphisms, homomorphisms, control theories, and so on—to the HI and RS so that the Rg module's action emulates that of the human mind-body dualism. By translating the continuum's cognitive and realizational levels through the conformance system, the KP both models and realizes arbitrary systems of language and their physical embodiments in reality. The KP's continuum structure thus constitutes a new and powerful way to build systems through natural language.

The basic metaphysical model used for specifying the continuum's conformance level is thus the mind-body dualism of form. Just as the mind's thoughts are held in correspondence with the body's actions, the HI and RS are held in correspondence with each other, in the Rg module, through the conformance system. The conformance system allows all functions of the Rg module to act as a mind-body dualism, thereby imparting autonomous operation to the intelligent Rg module. The purpose of the conformance system, however, is to convert the semantic structures of the embodiment system into the physical structures implemented and controlled by the realization system. The conformance system acts as the Rg module's “cerebral cortex,” thereby integrating language processed by the HI with physical systems realized by the control system. The different languages used by the HI and the control system are blended together, via conceptual blending techniques, by the conformance system.

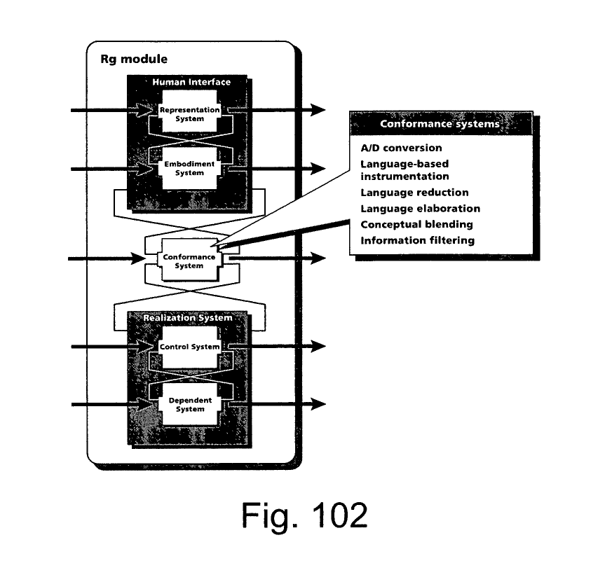

The conformance system determines when a thought is actionable, or realizable, and, conversely, when an action is comprehensible by the embodiment system. If the embodiment system (the module's intelligence) were to comprehend every aspect of mechanization performed by the realization system, then the HI's intellectual faculties would become overburdened with knowledge. In order to keep the HI's operation within a given level of linguistic abstraction while realizing the module's dependent systems according to engineering parameters, the correspondence system relates concepts of higher-order meaning to those of lower-order definition. Of course, the explanations cited in the foregoing discussions have been intentionally simplified. When the fields of robotics, machine design, small particle physics, chemistry, biology, civil engineering, medicine, music, psychology, and, in fact, academia at large are enlisted into the design of the Rg module to create a “machine being,” it is easy to appreciate that the Rg module's mind-body dualistic control apparatus (androidal system control) can grow in complexity exponentially. Each Rg module would then require a unique vocabulary and realm of conscious thought of its own; each module would perform as a “machine being” of androidal science. FIG. 102 summarizes several conformance system functions used by the Rg module.

8.5 Enterprise Infrastructure

The Rg continuum provides a solution to one of the oldest design problems facing industry even today—that of the inability of enterprise systems to contribute to the human endeavor through machine intelligence. The Rg continuum enables the KP developer to build systems and technology that provide any level of linguistic, engineering, or technological sophistication through the universal grammar. The Rg continuum serves the enterprise by providing intelligent machines that understand disciplines as technically complex as digital circuit design and biological sequence analysis (see Sections 18 and 23) and as ordinary—and human—as learning systems (see Section 22) and medicine (see Section 25), while interacting with users in natural language. For this reason, the Rg continuum may be considered an economic and social structure in addition to a communications infrastructure, since it expands the human universe of thought and perception by merging human and machine intelligence. The Rg continuum's commercial viability can be appreciated when it is considered that the KP eliminates these historical knowledge and technology barriers while directly achieving globally intelligent infrastructure in the microchip of digital electronics.

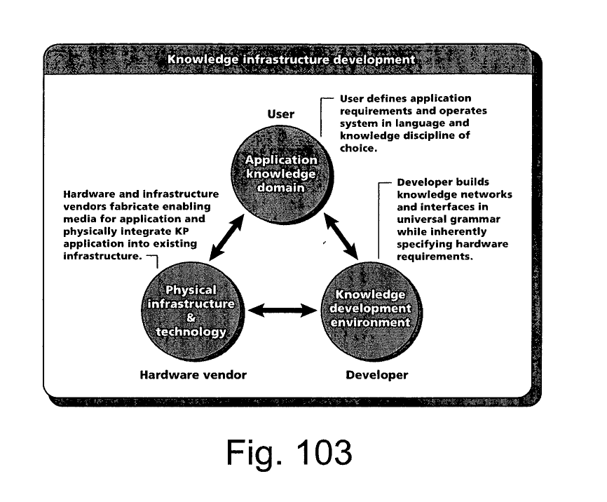

As shown in FIG. 103, the KP paradigm allows developers to construct applications according to the language and knowledge discipline of the user's choice, while the “programming language,” or software involved (the UPL), adheres to the mind's natural way of thinking. Whereas the computer and communications industries have shifted focus in recent years to the notion of “open systems architecture” in order to allow the enterprise to manage and develop large and complex applications, unfettered by the computer vendor's limitations, the KP paradigm enables this trend to continue by permitting the universal grammar and machines that think to serve as the underpinnings of flexible infrastructure design. This technology development model allows the user to specify enterprise technology according to arbitrary linguistic format, while the KP developer and infrastructure vendors inherently understand the application knowledge through the universal grammar as they implement technology that is backwardly compatible to today's computing methods. The Rg continuum thus expands the enterprise's capabilities according to the user's language and technology requirements, rather than limiting infrastructure design capabilities to traditional methods. Since the Rg continuum is formulated with the computer layperson in mind, the more intellectually powerful Rg continuum of cooperative people and machines results based on the user's specialized knowledge and infrastructure design goals. The Rg continuum user thus enjoys complete control over Rg module and enterprise development because the developer and the infrastructure vendor apply the universal grammar toward the user's unique business and technological needs. The KP paradigm thus delivers applications of machine intelligence that provide a universal computing solution based on machines that think and learn along with us.

### Section 9: Universal Grammar

9.1 The Epistemic Moment of Meaning

The universal grammar is a formalized set of procedures and structures that describes language according to the mind's innate ability to comprehend the elements of thought. The universal grammar's basic premise is that language is transformed through quantum states of linguistic meaning, referred to as epistemic moments (128 and 49), and that these smallest units of any grammar's expressions explain how the mind retains, transforms, and synthesizes knowledge. The universal grammar defines, through the epistemological structure referred to as the epistemic moment, the objects we perceive in our existence and describes how these objects transform during the mind's comprehension of them.

The universal grammar stipulates that perceivable objects, such as those that are represented by nouns, phrases, sentences, and any other linguistic elements that objectify a language's syntax, do not exist in “ultimate reality,” while these objects do occur as a result of the epistemic transformation of the universe's ultimately real form. According to the universal grammar, the objects that a being perceives in the world are not “ultimately real”; they are “inertially” real to the being's perception. The universal grammar thus requires that the universe's transformations—not its perceivable objects—are ultimately real. Consequently, the field of knowledge processing is premised on the idea that a being's thoughts and perceptions can be enabled, from “beyond the being's awareness,” by the developer. Accordingly, the universal grammar describes the nature and form of the universe (i.e., how objects appear to us) such that any physical system—a silicon chip, for instance—can think and perceive through the developer's design of the epistemic moments of the physical system. Providing that a technology is realized according to the epistemological definition of form, the machine can be said to function as a “machine-being” whose behavior is indistinguishable from that of a human being, except for the wisdom and sensory perception exercised by that being.

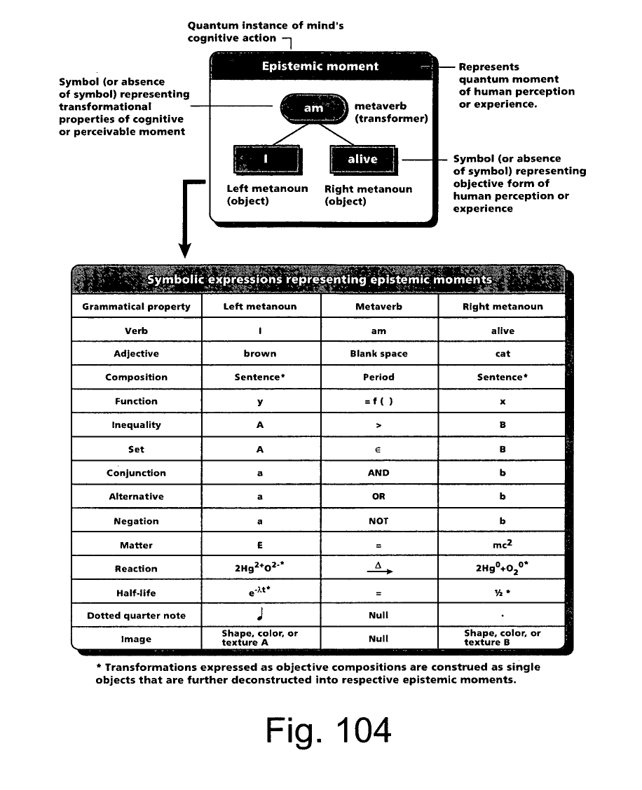

As shown in FIG. 104, the mind's innate action is described by the universal grammar according to a three-component structure that defines any quantum moment of cognitive or physical action as a grammatical transformation of language—an epistemic moment. The epistemic moment describes two epistemological objects that are transformed by a third—a transforming component that enables the moment's action. Any epistemic moment is synthesized with other moments during the quantum transformations of a being's existence. The universal grammar therefore describes the action of a language's grammatical elements according to the synthesis of epistemic moments into language compositions referred to as parse trees. An epistemic parse tree describes the form of a being's thoughts such that any one expression of language can be synthesized into any other. When the English article the transforms with a noun, such as the word cat, for instance, the resulting expression the cat silently denotes the epistemic transformer (which is absent here and referred to as the null transformer in the text) so that, in this case, a particular cat under observation can be distinguished from another through the mind's action. Accordingly, the phonetic epistemic moments /th/-/â/ and /k/-/at/ are quantumly synthesized into the words the and cat in order to formulate the noun phrase's words and their synthesis, as a noun phrase, into a higher-level expression, such as The cat is here. This epistemic synthesis of language is a never-ending process and explains the grammar of human thought.

The epistemic moment is comprised of a transforming agent, or metaverb (57), and two transformed objects, or metanouns (56). The essential meaning of any language's expression must fall within the triangular form of the epistemic moment and its relationship to other moments through an epistemic parse tree, as shown in the figure. The momentary actions represented by any symbolic expression—of fine art, natural language, music, mathematics, or chemistry, to cite a handful—are represented by the epistemic moment such that no other structure can define the mind's action on the symbols in a more primitive manner. According to the universal grammar, the metanouns of the epistemic moment represent the objects of thought or perception. The transforming agent, or metaverb, represents the mind's (or the physical universe's) action on other objects, or metanouns. While the metaverb is objectified by the universal grammar's epistemic structure in order for the grammarian (or developer) to understand it, the transformer represents a transformation of form—not itself an “object”—that signifies a single quantum moment of a being's existence. The metaverb represents the mind's action when comprehending how two objects of language (epistemological objects) transform with each other in order to create a moment of a being's existence. As shown in the figure, a mathematical function—the actual transformation of, say, a Cartesian product—qualifies as a metaverb of the epistemic moment, while the metanouns represent momentary instances of the Cartesian pairs (x and y) as objects. Similarly, the verb am transforms the left metanoun I (the pronoun) with the right metanoun alive in order to formulate the meaningful moment I am alive. All expressions of language can be deconstructed into epistemic moments that are transformed through the mind's action and the body's perception to give rise to the moments of a being's existence.

The epistemic moment can be used to deconstruct natural language, mathematical and chemical formulae, computer languages, business systems, engineering designs, physical systems, biological systems, and, in general, the existence of a machine-being, or “android.” According to the universal grammar's explanation of the mind's quantum action, a being understands language through the same process—the epistemic moment and its synthesis—uniformly. Since any combination of languages can be deconstructed into epistemic moments that formulate a single epistemic sentence, what we ordinarily consider to be a thought—a natural language sentence—is actually a composition of thoughts, or epistemic moments, in an epistemic parse tree that describes a being's experience. A valid input to the KP thus includes a single expression containing any number of diverse languages, which expression may have meaning only in its hybrid form. The epistemic moment can also describe each zero or one of a digital computer's operation in terms of how the engineer comprehends the bit's byte-level syntax in an epistemic parse tree. Similarly, while physical atoms combine covalently under the universal grammar, they also transform with the precision of each epistemic moment that describes them. The water molecule, for instance, can be represented by the transformation (H₂) (null) (O), by the word (epistemic moment) wa-ter, or by a parse tree of epistemic moments representing the differential equation (the wave equation) whose solutions define the electron orbits that make H₂ combine with oxygen to form H₂O.

The universal grammar thus describes knowledge according to the mind's action on it, rather than as a stream of objects that is generated by, and subsequent to, the mind's action as it drives a being's senses and motors. Since language is deconstructed by the universal grammar into equivalent epistemic moments of meaning, discrepancies do not arise concerning the semantic content of an expression. The universal grammar thus validates only how the mind thinks, not what it contemplates. The existential structure placed onto a being's creation in order to allow thoughts and perceptions to occur in, say, a mind-body dualism of form, determines what the being actually thinks and perceives. The epistemic moment of language, modeled after the introspective observation of the mind's action, is thus “neutral” or universal in how it symbolically represents language while defining the meaning of any conception.

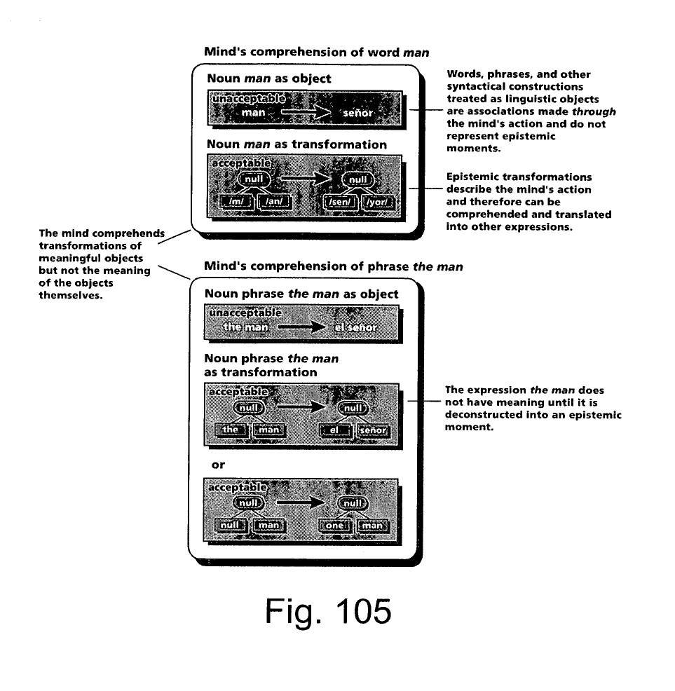

When perusing the expressions illustrated in the figure, it is important to distinguish the epistemic moment from traditional linguistic structures defined, for instance, by transformational and generative grammars. According to the universal grammar, each of the three components of an epistemic moment is of equal importance to the others because the quantum moment of transformation—of all three components—is what gives rise to a language's meaning during a being's cognition or perception. While other conceptions of linguistic theory will allow two linguistic objects to transform without explanation (i.e., without denoting the metaverb), the universal grammar requires that only a triplet of form, in which the transformational component is present as an active delimiter of the metaverb, is permissible. The reason for this requirement is that the epistemic moment allows any expression of language to be encapsulated into a quantum transformation of existential form in isolation from any other such moment. Without denoting the transformer, the mind's translations would have to rely on the interpretation of a linguistic object—a non-existent entity that can have no meaning and is infinitely variable in form. (As objects, a language's elements can mean anything.) Once the transformer is denoted, the epistemic moment of meaning can be translated into any other without semantic degradation. FIG. 105 summarizes this distinction.

9.2 Deconstruction of a Language's Expressions

According to the universal grammar, epistemic moments can be related to one another, from the developer's viewpoint, through a network of epistemic parse trees (129). The epistemic parse tree network describes alternative connections among epistemic moments according to language usage. When language is deconstructed into epistemic parse tree format and then translated into other knowledge also residing in epistemic parse tree format, whereby each parse tree represents some aspect of a being's comprehension, the resulting process is referred to as thinking. When a being's ability to transform parse trees changes in such a manner that new intellectual capabilities become useful to the being, the resulting process is referred to as learning. When a being is unable to perform basic parse tree transformations commensurate with those produced by peers, a learning disability occurs. The knowledge processing paradigm is thus concerned with constructing networks (2) of epistemic parse trees (i.e., “network webbing”) (129) that autonomously generates new parse trees (webbing) in order to learn.

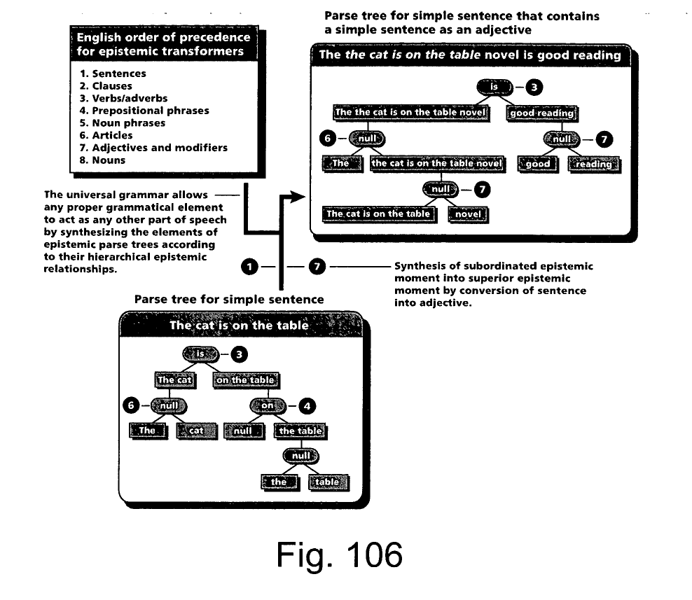

According to the universal grammar, every language describes a particular method by which epistemic parse trees may be constructed. This method of formulating epistemic structures is usually referred to as a “grammar.” A language's grammar must describe the terminal objects of the epistemic moments—the metanouns and metaverbs employed by the language during communication—and the hierarchy of transformers (metaverbs) that instructs the being on how to formulate the language's syntax. While a given grammar usually specifies phonetic-, lexical-, sentence-, and text-level syntactical hierarchies, these arbitrary classifications do not interfere with the universal grammar's depiction of language. As shown in FIG. 106, the universal grammar requires the placement of a grammar's hierarchy of epistemic transformers into the procedural knowledge executed by the running processes (intellectual faculties). In this manner, the knowledge network is able to deconstruct any expression into epistemic moments that are arranged and synthesized according to the particular grammar's rules in epistemic format. This method of parse tree construction allows the KP to relate any one epistemic moment to any other on the basis of the language's moments of meaning rather than according to its grammatical rules only. The figure shows an English sentence being synthesized, as an English adjective, into another sentence, thereby transgressing the rules of English grammar but maintaining the mind's action on that grammar. The universal grammar thus allows the placement of any language element into a parse tree according to the mind's formulation of language. The language's terminal objects can be translated according to any conceptual blending technique, providing that epistemic components are related within the triplet or parse tree structures. The terminal objects are then usually transmitted to senses and motors for communication with other devices at a particular PB bit field syntactical level. Other, non-terminal objects—such as phrases and clauses of the English language—can be translated in their epistemic parse tree format accordingly.

9.3 Transformation of Language: Conceptual Blending Techniques

The significance of using the epistemic parse tree format as the underpinning of a language's grammar and meaning can be appreciated when we consider transforming a parse tree in order to create new knowledge or to recognize extant knowledge. The universal grammar provides a precise and efficient way to “blend” the mind's ideas, or to transform parse trees according to any method of conceptual synthesis. The universal grammar regards any formulation of language as a blending of the mind's ideas because the epistemic moment defines the structure of a momentary idea. Thus, in order to transform, or synthesize, one epistemic moment into another, the ideas represented by the moments must be transformed into each other.

While we will address other conceptual blending techniques later on, we can consider a child's formulation of multiplication here, wherein it is virtually impossible to multiply two numbers without thinking of a rhyme when speaking English. What the example shows is that, in order to multiply the numbers 6 and 8, the mind must conceptually blend the numbers by using a rhyme (not only factual arithmetic recall) in order to synthesize the numbers into their product, 48. In the mathematical sentence 6′8=48 (or 8′6=48), the mind inescapably employs the literary technique of alliteration (repeating sounds) in order to recall the knowledge that eight sixes or six eights equal 48. While performing the “arithmetic,” the mind relates the sounds of /ate/ in the terms to the sound /six/. The question posed here is thus what language (i.e., grammar) does the mind comprehend in order to recall the product of 6 and 8?

According to the universal grammar, while the mind formulates the aforementioned epistemic moments according to mathematical syntax, it transforms the moments in any manner desirable. When computing the sum of 8+6, for instance, the mind may subtract 2 from 6; add the 2 to the 8 in order to obtain 10; and then add the remaining four to the 10 to get 14, the sum. While this addition is one form of “conceptual blending” of numbers, requiring its own method for transforming an epistemic parse tree, the above multiplication requires a rhyme in order to obtain the product. Thus, in order to perform the multiplication, the mind cannot obey the rules of arithmetic because there are no rules by which numbers can be added or multiplied phonetically. While the mind understands the syntax of arithmetic, it manipulates arithmetic expressions according to arbitrary procedures, or thoughts, referred to as conceptual blending techniques. In the KP paradigm, the running processes manipulate the parse trees of a given expression by executing conceptual blending techniques on epistemic moments, their components, and their relationships to other epistemic moments in a given knowledge network. Some conceptual blending techniques are documented, such as the metaphor, simile, synonym, antonym, anecdote, formula, rhyme, alliteration, computation, algorithm, and process, and others are not, such as the artist's handstroke.

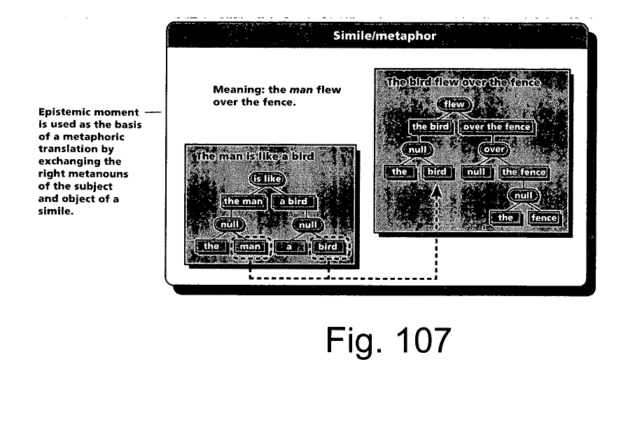

The universal grammar allows any epistemic moment to be transformed with another providing that such conceptual blending techniques “make sense” to the being's comprehension of language. As illustrated in FIG. 107, a metaphor is performed epistemically by transforming a known simile with a target expression, wherein the parse tree's transformational hierarchy is preserved. The metanouns man and bird are exchanged by using the knowledge held by the simile (A man is like a bird) in order to transform the target sentence. Any conceptual blending technique is permissible by the universal grammar. Instead of performing a metaphor, the conceptual blending process could involve a formula, such as that required to balance a chemical equation or perform grade-school arithmetic. The conceptual blending technique could also involve a musical composition or a fine-art drawing, whereby the respective epistemic parse trees would comply with the grammars of music or art, while the running processes would transform the parse trees via conceptual blending techniques that generate melodic or artistic compositions.

Conceptual blending occurs at any level of grammatical or semantic construction. A rhyme is performed at a lexical level, while alliteration results from the use of rhymes in a sentence-level structure. Whole parse trees and portions of epistemic networks may be synthesized into a single word, phrase, or sentence (parse tree) when comprehending, for instance, an anecdote. The knowledge contained in a short story about a spendthrift may be transformed into or “summarized by” the idiom penny-wise, dollar foolish, in which case the story's extensive network webbing would be contracted into a simple parse tree representing the idiom. Since the KP stores and manipulates knowledge in epistemic parse trees, any conceptual blending technique may be used to alter metanouns, metaverbs, and their compositions.

9.4 Reconstruction of the Target Language

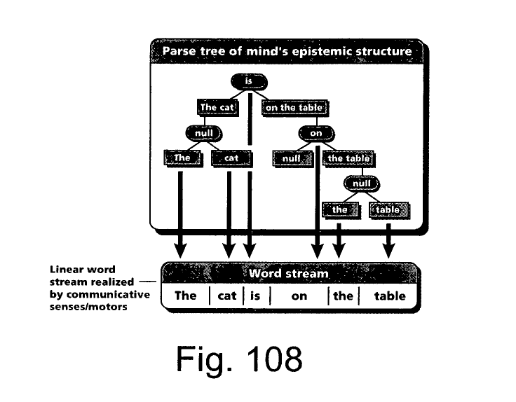

The epistemic translation process also involves the reconstruction of a target epistemic parse tree (the epistemic parse tree that has been transformed from another) into a target language output word stream for sensory communication. This process requires the reduction of a parse tree into the consecutively arranged objects of a language's expression. Since the mind thinks in epistemic parse trees but articulates language in words (or shapes), the epistemic parse tree must be transformed into a series of objects that can be perceived through sensory output. As shown in FIG. 108, for instance, a parse tree for the sentence The cat is on the table must be reduced to the serial stream of objects The-cat-is-on-the-table, whose lower-level parse trees are, respectively, /Th/-/â/; /k/-/at/; /î/-/z/; /o/-/n/; /th/-/â/; and /ta/-/bul/, in order for a being, synthetic or otherwise, to articulate the sentence.

In order for the knowledge network to formulate the target language output stream, the running processes (or intellectual faculties) must analyze the transformed epistemic parse tree in a special way so that the sequential order of words representing the target language's syntax can be understood by another being without compromising the epistemic structure of the parse tree's syntax, as shown. When a word stream is assembled epistemically, it is subsequently converted, “word-for-word,” into the lexical elements of the target language. Only those words or elements defined as “primitive” or “terminal” to the language's epistemic constructions undergo this literal translation. A phrase, for instance, would not qualify as output if the output were constructed at a phonetic syntactical level. In this case, the phrase would be deconstructed further into words, which then could be realized by senses and motors phonetically. If the phrase were constructed phonetically, however, that phrase could be realized as a “terminal” object of epistemic construction. In either case, the language constructor would reduce the initial parse tree into word or phrase objects by analyzing the initial parse tree and selecting only those terminal objects that correspond to output word stream elements, as shown. The reconstruction process thus creates a target word stream that carries with it the source language's epistemic moments when converted into discrete objects of syntax.

9.5 Epistemic Moment Describes the Universe's Ultimately Real Form

While the epistemic moment is an intuitive grammatical structure that truly can be verified only introspectively, its significance to the KP paradigm can be appreciated through the moment's description of the universe's fundamental form, and therefore of a being's perception of the physical universe. In the following exercise, we are concerned with identifying the universe's nature and origin—with determining whether the objects we perceive in the universe are “real,” and thus describe “ultimate reality,” or whether the objects of the universe exist only as a result of a being's perception of them. If the physical universe's objects cannot be proven to exist scientifically and mathematically, while the universe's transformations (i.e., changes in or behaviors of objects) are comprehensible and introspectively verifiable, then those objects, it will be concluded, are not ultimately real. We are thus attempting to prove that the physical universe's objects—which include electrons, small particles, packets of energy, and even teacups—are enabled through the perception of them and are therefore not ultimately real, while their transformations indeed describe the ultimately real form of the physical universe—the epistemic moments of a being's existence. Hence, we are endeavoring to illustrate that a synthetic being can be enabled from the physical universe.

In order to “prove” with scientific certainty that the epistemic moment defines the fundamental nature and origin of the physical universe, we can examine the “object” of mathematics—the point element of a set. Although there is a simpler way of explaining the same phenomenon by asking the theological question Between any two points or atoms, what lies in the middle? (i.e., a philosophical ponderance that shows that the universe's form is transformational in nature), we will indulge in a lengthy discussion involving the prevalence of the mathematical homomorphism in modern scientific theory. In the exercise, we will be concerned with determining whether the elements of a mathematical set are ultimately real (i.e., whether they exist eternally) or whether only their transformations (epistemic moments) are ultimately real, and that the objects themselves are non-existent except for a being's perception of them. In the discussion, we shall use as a gauge for what is real or not the mind's ability to comprehend meaningful language (i.e., thoughts) that legitimize the arguments. If the mind cannot comprehend what an object is (i.e., cannot understand what an element of a set is), but can indeed understand the nature, causality, and metaphysical action of a transformational form, then we shall conclude that what is comprehensible to the mind—a transformation of the universe—is ultimately real, and that what is fundamentally incomprehensible to the mind—the objects we think are real—are actually the moments of a being's existence that enable objects to appear to the senses. Androidal science will then be concerned with enabling the physical universe's objects to appear to the cognition and perception of a synthetic being.

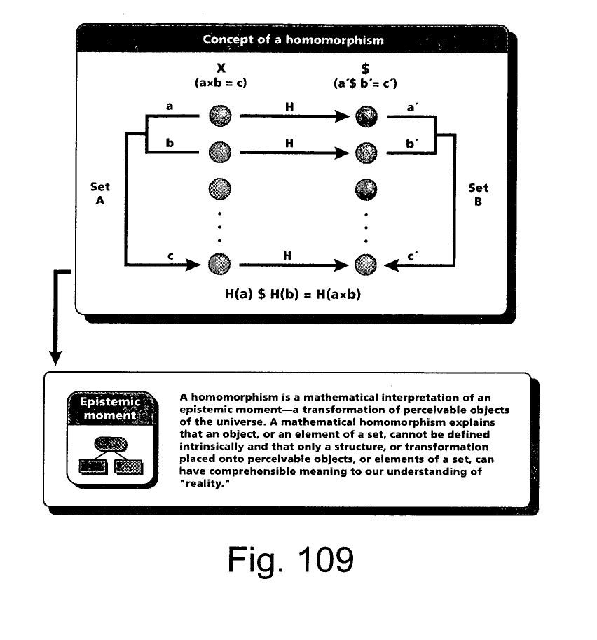

The example of the homomorphism will illustrate that the universe's transformations—of light, small particles, DNA, and teacups—are ultimately real and definable, while the objects upon which the homomorphism operates indirectly by preserving mathematical structures will remain undefined to the mind's comprehension. The illustration will also demonstrate why androidal science takes as its premise both the observed (object), as well as the observer, when constructing moments of a being's cognition or perception. (In order to visualize this phenomenon mentally, we can imagine a coordinate frame that represents a measure of the observed physical universe. We then embed this coordinate frame into another coordinate frame representing a being's existence. Androidal science merges these two coordinate frames into one world model of a being's existence.) As shown in FIG. 109, we shall use the mathematical structure of a homomorphism to demonstrate the “universality” of the epistemic moment's description of the nature and origin of the perceivable universe. The purpose of the illustration is to define exactly what is meant by the mathematician when we say “take a set of points or elements.” Particularly, we are considering what is the “point” upon which all of mathematics is based, and without which mathematics would not be meaningful. Mathematical theory will prove, in the example of a homomorphism, that the point object—and thus any object—of the physical universe does not exist but for the contemplation or perception of it, and that a transformation of such point objects—an epistemic moment, or “structure placed upon structures”—does describe the fundamental nature of the universe.

In order to explain the homomorphism, mathematical definition imposes a structure on each of the sets of elements (already structures) shown in the figure. The structures represent operations performed on the point elements, or objects of the sets. On the set of elements referred to as A, composed of the elements a, b, . . . c, there is imposed a structure, called X, which represents the operations that can be performed on the elements of set A. Likewise, there is imposed on the set of elements B, which is comprised of the elements a′, b′, . . . c′, another such structure, different from that imposed on A (or different from X), called $. The requirement that X be different from $ is not necessary but is imposed here for purposes of clarity. It is indeed tenable that the aforedescribed operations (X and $) can and do exist in a way that can be verified through language and perception. The structures represent comprehensible form that both mathematics and science can verify analytically. (Each of the structures X and $, for instance, could be an arithmetic, geometrical, or topological operation, or even a natural language expression.) Thus, so far in the illustration, the mind can observe and the body can perceive any operation imposed on the sets of points, or objects. “Reality,” then, can be scientifically ascertained by observing the point objects while undergoing arithmetic, geometrical, topological, or, indeed, any other transformations that are comprehensible. Presently, however, placing a structure onto the objects does not in any way define the objects upon which the structure is placed. Thus, by placing a mathematical structure onto point objects, we accomplish nothing toward proving the ultimate existence of the points.

A third structure, different from those of X and $, is developed according to the conventions of mathematics to define a homomorphism such that, in mathematical parlance, the original structures (X and $) are “preserved” by the presence of the third structure. The third structure defines a relationship between the initial structures such that their operations correspond to each other. Referred to as a homomorphism, or a homomorphic structure, H, this third structure allows the mathematician to understand the form of a transformation. The objects of the transformation, however, are themselves structures, or transformations, since the homomorphism preserves the structures placed onto the original point objects. While a homomorphism transforms the original point elements, or objects, of each of the sets A and B wholly apart from the structures of X and $, it is in the nature of the homomorphism's capacity to relate the transformations of the structures X and $ that it begins to demonstrate that the universe's terminal form is transformational, and not objective, in nature. The binding relations of the homomorphism are represented in the figure by the common algebraic expression as H(a)$H(b)=H(aXb).

Thus, what arises from the conception of a homomorphism is the notion that the universe's form can only be observed to transform objects, which mathematical points themselves can only be transformations “called objects.” The point objects themselves thus cannot possibly exist “in reality” if (scientific) reality is defined by that which can be understood by a being. The homomorphism determines that, at least with respect to our knowledge of the aggregates, it is a transformation of structures that explains what an object is—that objects themselves can only be other transformations, since it is a structure, in each case of X and $, that is preserved, transformed, or held in correspondence by the homomorphism. A review of the figure reveals that mathematical axioms, the very basis of our analytical thinking, deny, by their very definitions, that any real or objective entity exists in the ultimate reality of the universe.

We began the exercise by defining the elements of the sets (a, b, c, and so on) as undefined entities (even though we “took” a set of them). The elements of the sets were perceivable but not comprehensible objects. Furthermore, we placed structures (mathematical operations) onto the undefined or non-existent elements of each of the sets, structures which, by classical mathematical definition cannot be objects, since they are defined as transformations of objects (e.g., as an arithmetic, a function, a flowing river, or any other transformational form). What can be determined from the exercise is that, while a being can observe objects in the universe, including the object of oneself, that being cannot prove, mathematically or scientifically, that the observed objects are anything more than momentary occurrences of the universe's ultimately real form—its epistemic transformations. While the mathematician, and anyone else for that matter, can “take a set of elements” (say, marbles on a table), the mind cannot ascertain that those elements exist in an ultimately real form. The elements, or marbles, exist only in the moments of perception of the beings who are experiencing them. If we call these objects (an example of) the physical universe, then we must conclude that the physical universe is enabled in a being's perception and thought of it. The homomorphism thus demonstrates that mathematics can only describe the transformations of objects, not the “form” of an object. While we can easily place a binding structure, say arithmetic, on a bunch of marbles on a table, thereby describing how the marbles transform with each other (two marbles+two marbles become 4 marbles, for instance), we cannot understand anything more about the existence of the marbles, except that they transform. The homomorphism explains that we can understand how to relate the marbles, but not how to create the marbles. In order to create the marbles, one must create the being who knows and perceives the marbles. (One must enable the epistemic moments that define the quantum realizations of an existence.) In short order, any object perceived by a being can be understood only in terms of how it transforms. “The” universe is therefore fundamentally understood as a transformation of form rather than as an object that we can perceive.

While the homomorphism is ample proof that what we understand about the objects of the physical universe are their transformations, not their existence as objects, there are countless other exercises that demonstrate the same point. We can explore, for instance, what occurs in between two infinitesimal changes of the calculus. It is deceptively easy to contemplate the calculus' derivatives and integrals, but if we pause the action of either, we can ask: what lies in between any two “_xs”? Similarly, let us ponder another metaphysical circumstance involving the motion of a train used in relativistic mechanics. Instead of contemplating the relative speeds of the trains, however, let us simply ponder a train when it is in between two important physical states. Specifically, Newtonian and relativistic mechanics can amply describe a train's behavior once it is set in motion at any time interval to the right of t=0. Physics also can define the train's static condition at t<0. However, if the train's motion begins at t=0, and during every perceivable moment leading up to, but not including t=0, the train exists in a static condition, how does the train ever move? What we are examining here is not what happens to the train after a force is applied to it (or energy from within it is released) at t=0, but what happens to the train in between the states that are described by Newtonian or relativistic mechanics. How does the train actually transform from a static to a dynamic condition when Newtonian or relativistic mechanics will describe either the static or the dynamic conditions, but not how the train transgresses either state?

Stated another way, at one moment “in time,” the observer sees a train that is standing still. At another moment, the train is under observation and is moving. We are inquiring as to what happened in between these two states. We are also, however, considering that Newtonian and relativistic mechanics can calculate both the static and dynamic conditions of the train. We are therefore assuming that the measurement of the train's actions includes the behavior of light, and that, once set in motion, however infinitesimal that motion may be, Newtonian or relativistic mechanics can describe the train's motion. Again, we may ask, how does the train transform from the slightest of infinitesimal time periods in its static condition to the slightest infinitesimal time periods of its dynamic condition? What we are asking here is what transforms any two infinitesimal changes of a perceivable entity in the universe? What “glue” holds together any two observable infinitesimal changes in a being's existence? We are now pondering what the example of the homomorphism demonstrates analytically—the “ultimately real” form of the universe. What the physicist neglects to account for is the “transformation of the transformations” (of the universe)—how any two moments of the physical universe are connected. After all, science must explain what is observable, and it is quite observable to anyone sitting on a park bench that a train undergoes a transition from a static condition to a dynamic one, and that, when the mathematician illustrates _x, or “h” gradually diminishing to zero in a derivative or integral, the child may ask what happened in between the one _x and the other. The child is simply asking what happens in between two thoughts or perceptions of a being's existence.

Androidal science begins here. While this specification on knowledge processors only touches on the field's axioms, it can be appreciated that the epistemic moment defines any moment of a being's existence. Moments of the universe, which give rise to thoughts and perceptions of objects, are enabled from “beyond the being's awareness,” since a being's awareness is what is enabled in the moment's action. In order to create a synthetic being that can contemplate the infinitesimal changes described by calculus, one must enable that being's epistemic moments. In order to enable a being to sit on a park bench and observe the (quantum) moments of a train's transition from a static to a dynamic condition, one must enable the moments of thought and perception of that being. Androidal science is thus concerned with defining and realizing systems that are based on the epistemological construction of senses, motors, and cognitive embodiments (microchips) that operate, quantumly, on and within epistemic moments and their parse trees as a “being.”

If we reconsider the example of the homomorphism, we can conclude that the universe's objects cannot be defined, except as “transformations of transformations,” because the objects can exist only in a being's thoughts or perceptions of them. By building machinery that operates according to enabled epistemic moments, the thoughts and perceptions of a synthetic being can be enabled. Providing that the being's physical universe is defined in “split form,” wherein all perceptions occur in a manner that separates, or “splits,” the being's existence into a self and (the) “rest of the world” (terms of art), then the language used by the cognitive microchip will correspond to the being's sense/motor activity based on a true understanding of the pronouns. (See also Section 24.) In this manner, what “lies in the middle” of any two moments of a synthetic being's existence is the developer's placement of connectivity on the being as a system. While the being is created through the occurrence of its mind-body dualistic form by the developer's construction of epistemic senses, motors, and cognitive microchips (or other devices), the being perceives and thinks about our same universe in natural or other languages. To the extent that senses and motors can be made anthropomorphically, the being will understand and perceive the human experience. To the extent that other senses and motors are constructed—say, infrared- or microwave-based systems—different experiences are perceived by the synthetic being.

Concerning a human being, if the mathematician cannot prove that objects exist as terminal forms of the universe, what can be said about DNA—the biological precursor to life? Does DNA exist objectively? DNA, like the teapot one can observe on a stove, is not ultimately real. What is real about DNA is its transformation. If DNA is a molecule (a thing), and molecules are made of atoms, and atoms are defined by solutions to the mathematician's differential equations, and the mathematician can prove nothing about the existence of objects except that they transform, then DNA, like all other matter or energy, transforms as a quantum epistemic moment of a being's existence. If we recount our steps in the illustration, we can conclude that the “origin of life” is planted firmly in the hands of whatever causes an epistemic moment to occur. In pedagogical discussions, the epistemic moment is referred to as a “moment of the soul.” It is the soul's moment because it gives (eternal) rise to a moment of a being's cognitive or perceptive existence. Thus, the objects of the universe, including DNA molecules, are incidental to their transformations, but for the causality of one moment on another. While the science of androids does not overstep its bounds in order to presume to understand the epistemic moments (the eternal soul) of human experience, it does take as its model the human experience, whereby the developer becomes the machine's enabler. Androidal science thus explores the new knowledge that from the universe's matter can be made infinitely many synthetic beings who can be enabled to understand and perceive our universe.

### Section 10: Epistemic Microprocessor Architecture

One of the easiest ways to understand the Epistemic Microprocessor Architecture (EMA) (130) is to think of it in terms of the RISC processor. This is because the EMA is a “sub-RISC” architecture that is configured by using a handful of instructions to implement the UPL and its knowledge network. The EMA enables 4-, 8-, 16-, 32-, and 64-bit architectures to operate on programmable bytes and network structures, while utilizing only a bare minimum of CPU operations. The EMA is based on fetching, storing, and comparing PBs and network structures in order to enact the processes described throughout the text.

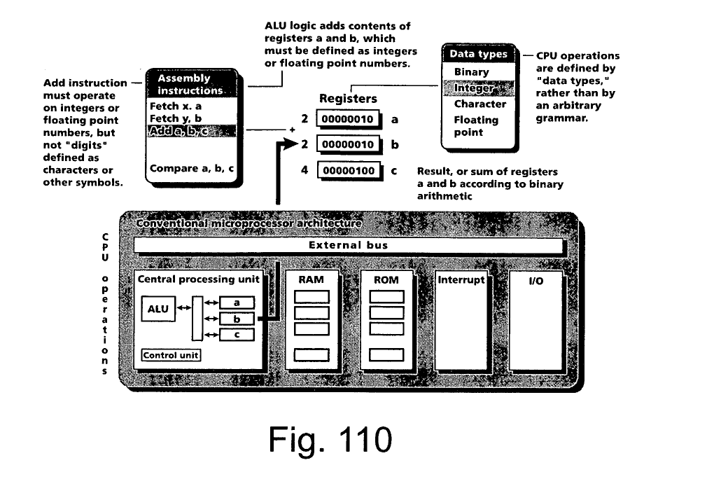

In order to explain the EMA, we can first illustrate the drawbacks of conventional microprocessing methods that led to the EMA's conception. FIG. 110 shows the registers, data counter, program counter, instruction registers, and general architecture for a typical commercial microprocessor. As shown, the problem facing conventional microprocessor technology—even the RISC processor as a “reduced instruction set” processor—is that any knowledge implemented by the processor must operate on the data types defined by computer science. As discussed at length throughout the text, however, computer science's data structures—characters, integers, floating point, and binary data structures, for instance—are unable to explain the structure of knowledge, universally, according to the mind's comprehension, so that application languages can be directly executed by CPU operations. The design of each classical CPU instruction therefore has a tendency to become more and more complex, instead of simpler, because the engineer attempts to accommodate more application-level functionality in the microprocessor's instructions. In order to perform arithmetic, for instance, the conventional CPU must operate on binary numbers as integers or floating point data structures. The CPU cannot, for instance, operate on ASCII characters in order to perform arithmetic. It makes a great deal of sense, then, that the classically designed CPU should execute an instruction, such as Add a, b, that adds the bytes residing in the registers (a and b) according to the conventions of binary arithmetic, since the bytes used are base-2 numbers. But this extraneous step inserted in between the user's understanding of arithmetic (or any other knowledge) and the CPU's execution of binary arithmetic requires an intermediate software or firmware translation that is unnecessary when using a universal grammar that relates arbitrary language. The digital designer thus attempts to probe deeper and deeper into the user's expertise by adding more user-level functions to the microprocessor's instruction set. In the case of the conventional processor, however, the CPU logic anticipates only a small fraction of the possible language constructions that the user may conceive. At the same time, however, the designer adds complexity to the processor when trying to bridge this linguistic gap. The von Neumann architecture is therefore overcomplicated by the designer's choice of data structures and CPU instructions. The basic operation of the processor, which requires only that “bytes” be stored and retrieved from memory or I/O and processed via the CPU's action on the registers, is a simple and straightforward design. The problem that the classical design engineer encounters is that, depending on how one defines bytes in memory, a simple or complex instruction set results. From the standpoint of business and industry, however, it is desirable that foundries punch out microchips that accommodate any application knowledge according to their inherent designs at a nominal cost, rather than requiring boundless revisions of complex CPU instructions.

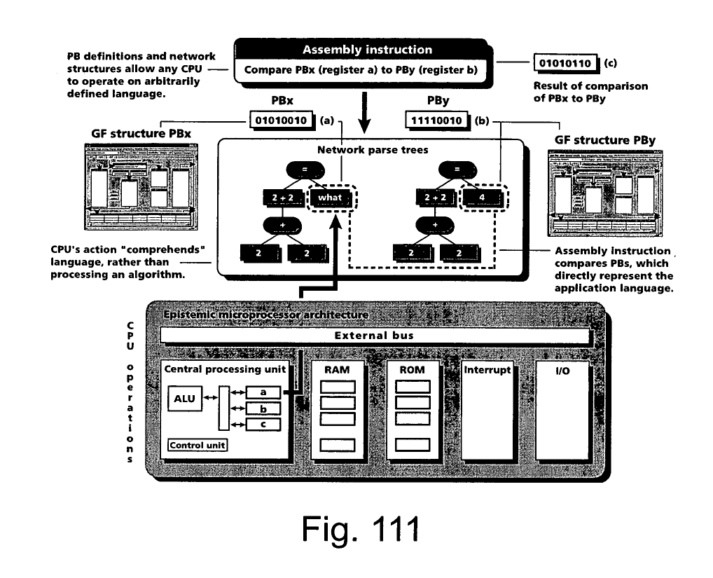

As shown in FIG. 111, the epistemic microprocessor architecture is different from the conventional processor architecture in two principal ways. First, the EMA's instruction set (63) supports the UPL and network structures exclusively. This means that the EMA obtains, organizes, and transforms knowledge network structures according to the operations performed by the UPL commands and functions. Instead of utilizing the classical Assembly language Add a, b instruction, for instance, the EMA employs a parsing and translating function that analyzes the addends in their natural (arithmetic) syntax, as PBs in their parse tree structures, while “adding” the numbers by translating epistemic parse trees. In order to perform these UPL operations, only fetch, compare, store, and increment (and branch) instructions are required from the processor (in addition to interrupt and I/O instructions).

Secondly, the EMA operates on arbitrary language, while the conventional processor executes preconceived programs. What this design distinction reveals about the EMA architecture is that the EMA does not ever know how to process input (i.e., it does not know what instruction to fetch) until it analyzes a PB array in a data set or a network structure. The EMA obtains instructions based on its evaluation of an epistemic parse tree, or the knowledge network's webbing. Whereas a conventional microprocessor instruction set can be written with specific functions in mind, such as the square root, cosine, and other functions of mathematics, the EMA operates on input by manipulating epistemic moments (thoughts) that it cannot anticipate. Thus, the EMA is designed based on the premise that the processor's action will be determined by retrieving and changing epistemic parse trees according to the meaning of the language deposited in its registers. This process is summarized in FIG. 111, wherein the instruction counter is incremented based on the UPL function's evaluation of the expression that is held in the processor's stack.

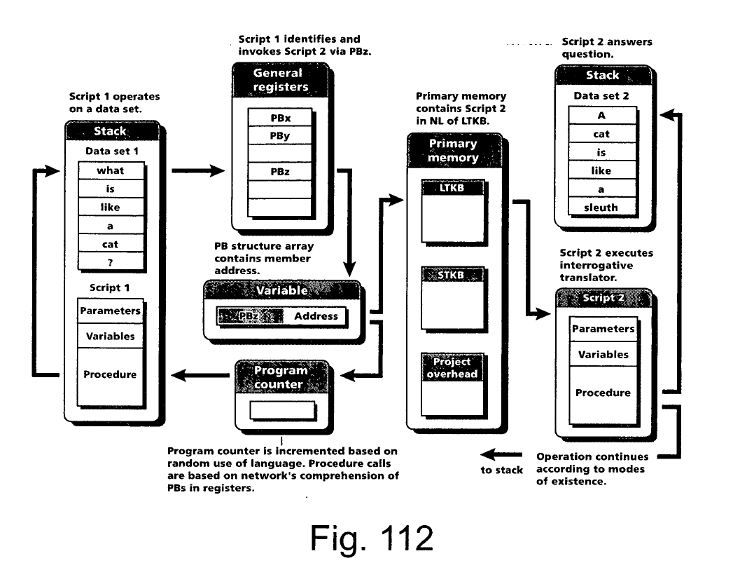

The EMA processes network structures as shown in FIG. 112. During a typical UPL command operation, the targeted network structure member (i.e., data set, PNGW, triplet, etc.) is loaded onto the stack via commercial memory addressing techniques, whereupon the referenced PB is compared to the target PBs on the stack (during the execution of, say, a Select command). The UPL command locates the given NL or GF structure by parsing the NL or GF array (which can be configured into smaller, more convenient arrays for faster processing), while each element of the stack is installed into a register and compared to the reference PB. The UPL's dot notation specifies the structure member (and its address) through classical memory addressing techniques, including virtual addressing. Since the UPL function is embedded in the network structure, specifying a PB during a UPL Call command thus invokes the function named, or designated, by that PB. KDE overhead, such as the symbol kits, I/O kits, and GSM parameters, are fetched from primary memory as required by the particular UPL command. Thus, while the EMA executes an instruction set comprised of only fetch, store, compare, increment, and other basic processing commands, the UPL functions are able to operate on arbitrary linguistic structures embedded in the network's webbing. The network invokes UPL functions by analyzing the contents of the PB arrays placed onto the stack.

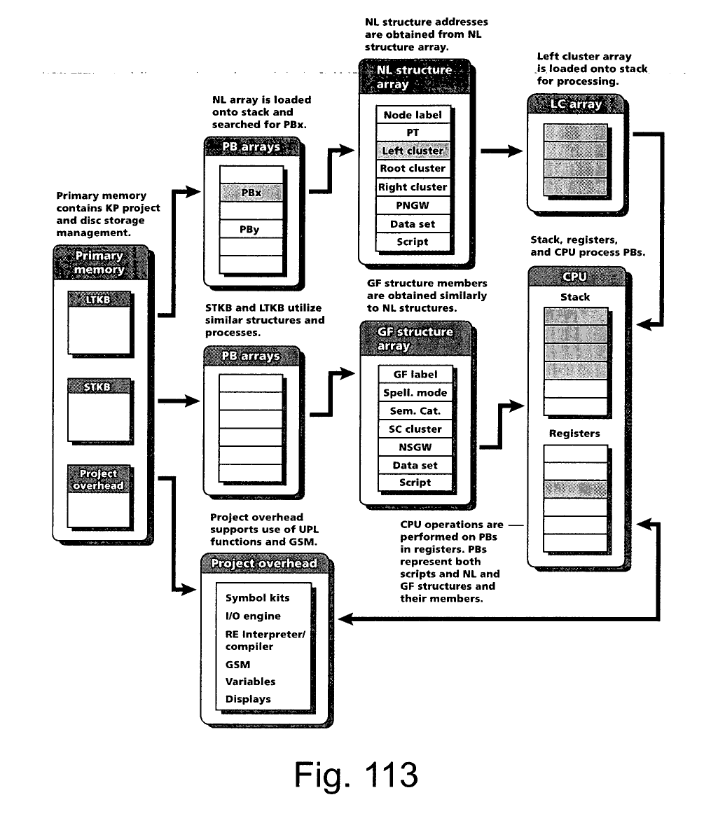

As shown in FIG. 113, the EMA is implemented as a “sub-RISC” processor because, from the processor's standpoint, only the basic instruction set of a commercial processor is required to execute the UPL. The EMA's instructions thus operate entirely on PBs via the UPL commands and functions. Since the processor's data and instructions are configured into PBs while the processor's memory addresses designate network structures and their members, the basic fetch, store, compare, and increment instructions inherently implement the UPL. The EMA's CPU logic is therefore implemented by any good book on microprocessors written even twenty years ago (i.e., by a simplified processor architecture).

In order to implement the Select command, for instance, the PB designating the reference PB in the command's syntax is loaded into a register. The PB array to be searched (i.e., the network structure member specified by the UPL command's dot notation) is then loaded onto the stack. Each PB residing on the stack is subsequently “popped” from the stack and compared to the reference PB. If a positive match is determined, the command returns a true value for subsequent UPL function analysis or action. In order to obtain the memory addresses of network structures, the UPL command accesses the PB and PB structure arrays (131) (NL or GF structure arrays), which contain the particular addresses relating to a given PB structure and its members. The network structure members are offset against each other in a memory block or are specified by the PB structure array's depiction of memory according to first and last memory addresses. The other UPL commands operate in a similar fashion by using only the basic commercial processor instruction set.

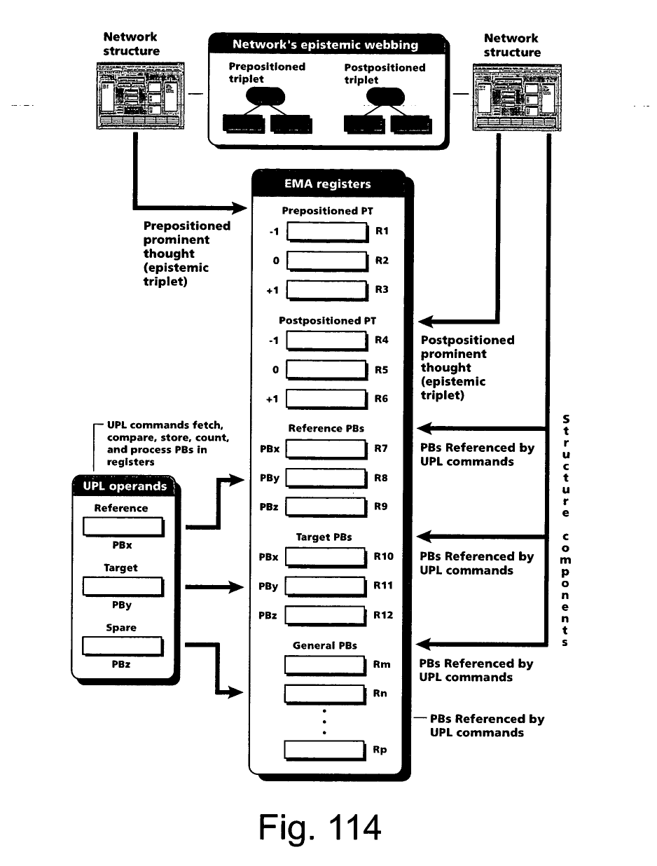

In order to facilitate the processing of epistemic moments, six registers are dedicated to the processing of epistemic components—three registers for the reference triplet (PT) (132) and three more for the target triplet (133) shown in FIG. 114. In this manner, any one component of a PT (−1, 0, or +1) can be compared to any other PT's components. Similarly, the PTs' components can be altered by inserting or moving a particular component to one of the component locations of the alternative PT according to any conceptual blending technique (i.e., UPL function) employed. The remaining registers (134) are utilized as repositories for the PBs that are operated on by the UPL commands as elements of other structure members.

### Section 11: Symbol Kits

11.1 Introduction

Designing symbol kits for KP applications is much like conceiving grammars for natural languages that have evolved informally. Since the linguistic information necessary to define a symbol kit's PBs usually is not available in a form that meets the KP paradigm's linguistic requirements, the developer must compensate for this lack of linguistic standards by assigning grammatical and other properties to the PBs representing external data structures with which the KP interacts.

Concerning a simple ASCII byte, for instance, the developer must decide whether a symbol kit's PB corresponding to a given ASCII byte should be defined as an NL or GF designator. This PB bit field property requires the developer to determine whether the ASCII byte should be transmitted to the Host processor as a transformer (NL) or an object (GF) of the ASCII language. Classical system design techniques do not employ the universal grammar and therefore do not directly help to answer this question. Indeed, for a given KP application, the developer may find that most of the PB bit-field properties used in the symbol kits are unspecified by the outside vendor and must be defined in an ad-hoc manner by the KP developer.

In order to provide a basic guideline for specifying PBs used for external data structures in symbol kits, several common computer industry standards are illustrated in this section. The following examples demonstrate various data structures used in industry, including ASCII and Unicode bytes, macrocode instructions and data or (“executable bytes”), and generalized data structures that can be used for any symbol kit definitions. These recommended PBs specify both NL and GF designators so that the developer can build applications that transmit external data structures as transformers or objects of language based on the developer's requirements. The numbered boxes in the figures correspond to the recommendations made below the boxes for a given PB bit field property.

11.2 ASCII and Unicode Symbol Kits

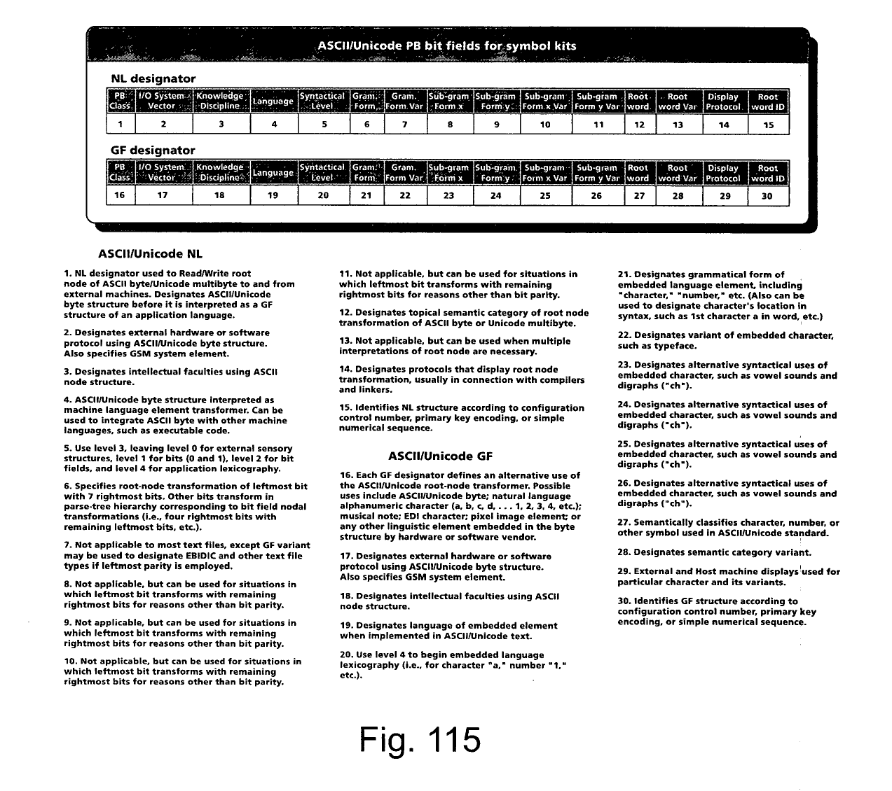

ASCII and Unicode symbol kits typically employ the NL structure to designate the root node of the machine-byte bit sequence (the highest-level node in a parse tree representing the ASCII byte), while the GF structure represents a particular application language element embedded in the byte, as shown in FIG. 115. This symbol kit design allows the knowledge network to input or output NL designators that represent the root node transformations of ASCII bytes, while operating on PBs (effectively, the external bytes) according to their embedded language properties, as defined by particular GF designators. In this manner, the knowledge network has the option of processing an ASCII byte as a sequence of bits (i.e., as a machine language), or as a character or other part of speech defined by the application language. The knowledge network thus can process the external ASCII byte in binary form, or as a character or other element of, say, the English language. Similarly, Unicode multibytes are defined as NL structures designating the root node transformation of the double-byte sequence, while the GF designators represent the various parts of speech of the application language. The GF designator may also represent a particular grammatical use of the ASCII or Unicode byte according to a particular machine language, as shown.

11.3 Macrocode or “Executable Instructions and Data”

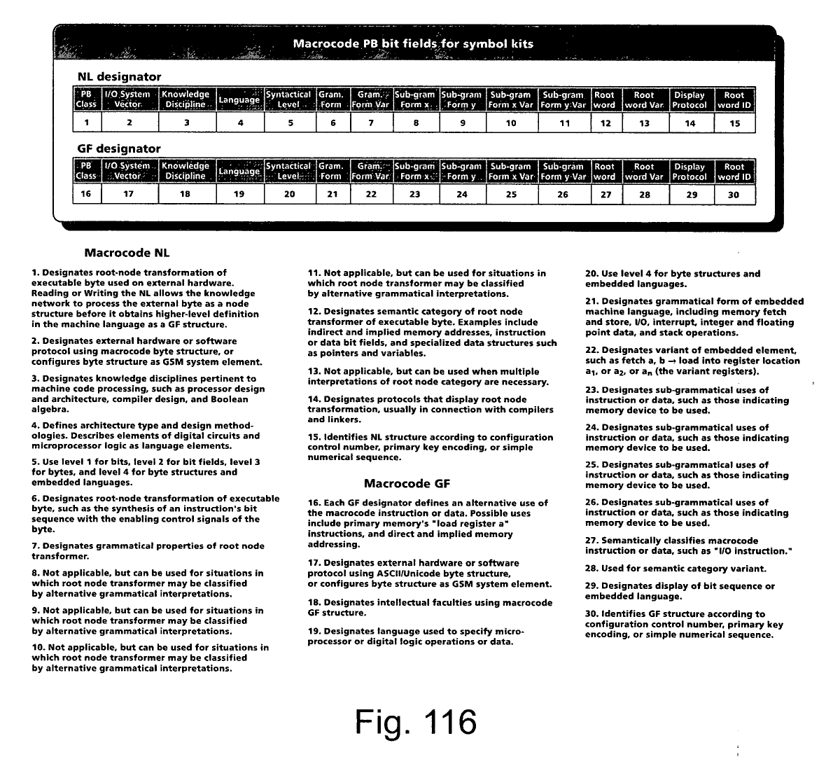

Macrocode, or executable instructions and data, are defined for use in the symbol kit's PBs in a similar manner to the ASCII and Unicode bytes described earlier, except for two important distinctions. First, instead of representing “text” bytes, macrocode PBs define machine instructions and data—microprocessor architecture—and their related binary operations. Accordingly, the GF structures that define the external byte's embedded application language (i.e., the machine architecture) represent machine instructions and data that ultimately will be translated into Assembly-language mnemonics when the knowledge network acts as a compiler or linker. Second, the external byte's bit fields, and therefore the machine-level PBs, define the microprocessor vendor's linguistic specification of the processor architecture. Thus, the external byte's bit fields may define control signals, executable instructions, data, and memory addresses used for the processor's design. When building macrocode symbol kits, then, the developer must consider both the external machine architecture and the Assembly language into which the executable code is translated, as summarized in FIG. 116.

11.4 Generalized Computer Data Structures and Commands

Any external data structure, instruction, or command can be defined for use with symbol kits according to the methods illustrated in the foregoing figures. Just as each natural language employs its own lexicography, grammar, and semantic usage, however, each computer language or architecture must be defined, via the PB bit-field properties, according to the universal grammar and the KP paradigm's knowledge network structures.

A computer network protocol's symbol kit, for instance, must specify the headers, trailers, and content of a data transmission such that the knowledge network can operate on the data as an intelligent network controller. The external network protocols, such as the ISO or Ethernet communication standards, must be defined in terms of PB bit-field properties that explain the standard's data elements and instructions. The various layers of the ISO standard, for instance, must be specified according to the PB's linguistic properties so that the KP can receive an ISO transmission and process it intelligently.

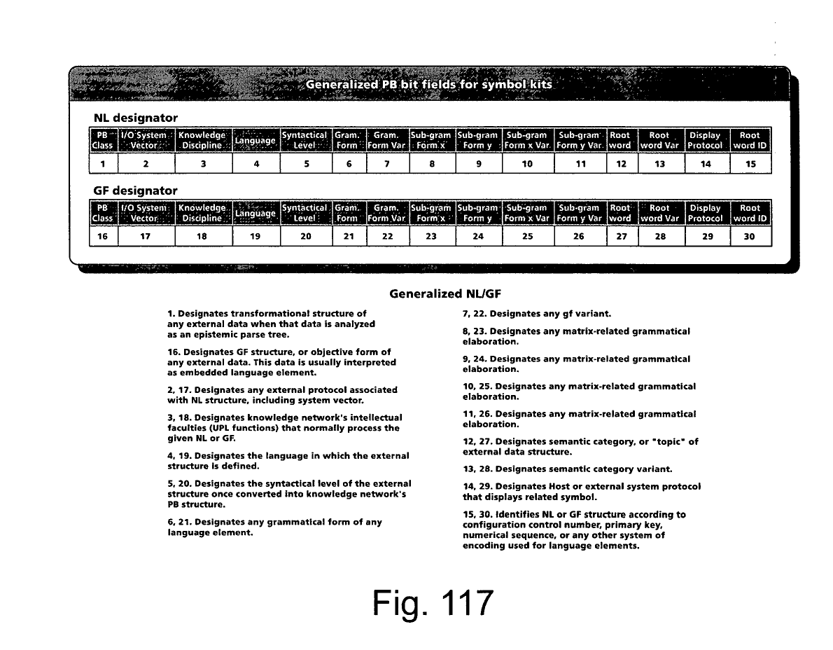

Similarly, an EDI communication must be defined in terms of PB bit-field properties such that the linguistic elements defined by the standard, such as “data elements” and “transaction sets,” can be processed by the knowledge network as language using the ASCII character set. Moreover, as discussed earlier in the text, the byte structures used to designate the Ethernet standard must be defined in such a manner that the KP can analyze the network protocol or the transmission's content according to the KP's intelligent use of network structures. When designing multiplatform, or “hybrid” operating systems, the developer must define (virtual) addressing structures and methods that relate the O/S file's name and content, along with relevant BIOS-based utilities, to the sectors and tracks of a magnetic disc and its input/output protocols. In this manner, the KP can receive external data that is intended to be used on machine A and translate the O/S protocol into that required for machine B. FIG. 117 shows the PB bit-field properties used for symbol kits such that any protocol can be defined for use with the knowledge network.

### Section 12: Knowledge Structures

12.1 NL/GF Structure Relationships for a Disc Operating System

While the KP is capable of operating on any language according to the intelligence of its semantic webbing, it may be helpful to illustrate the knowledge network's manipulation of a conventional operating system's file directory (135) in order to explain the KP's semantic use of language. Accordingly, this section shows that the knowledge network's webbing can be used to translate O/S file directory protocols, thereby performing the function of an intelligent “disc operating system.” The illustration relies on the knowledge network's NL/GF relationships to synthesize language semantically.

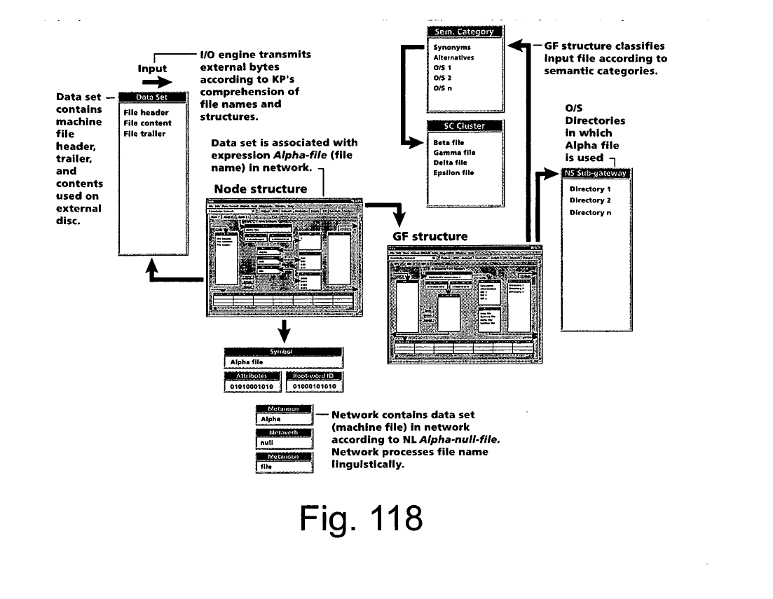

As shown in FIG. 118, the relationships explained in the text relating to NL and GF structures are utilized for the knowledge network's configuration of a file directory. While the example illustrates only one file entry in the O/S's directory, it emphasizes the distinction between the KP's semantic processing of knowledge and computer science's approach to information storage and retrieval. The purpose of the illustration is to acquaint the developer with the NL/GF relationship while demonstrating the KP's semantic webbing for a simple O/S directory. The structures shown in the illustration can be replicated for use throughout the protocols of a classical operating system.

The figure illustrates that an NL structure's data set, entitled Alpha-null-file, contains PBs that are converted from an external file structure, via an appropriate symbol kit, through the UPL Read command. This data set, when converted into external data structures, is an actual file on a given O/S platform specified according to track and sector requirements. The file's header, trailer, and content are read into the data set. (The microprocessor's I/O protocols can be input as well.) The importance of the node structure can be appreciated when it is considered that the data set (the external file) is associated with the network's literal expression of the O/S protocol. In this case, the NL structure represents the network's storage of the Alpha-null-file node (the “alpha file”). The reason for relating the data set to this member is that the NL structure is associated with other network structures, via the PNGW and the intermediate GF structure, in order to integrate the file with other O/S directory files according to the knowledge network's understanding of the given file's name. The KP thus semantically comprehends the file name through the network relationships while containing the actual file in the NL structure's data set.

The GF structure obtained through the PNGW, in turn, contains two important members that relate the data set (the actual file) to other network structures. As shown, the GF structure's NS Sub-gateway contains other node structures that employ the NL structure shown in the components of their respective triplets. The KP thus relates the given file to various directories by branching through the GF structure's NS Sub-gateway. Similarly, the GF structure's Semantic Category Cluster contains other GF structures that act as alternative structures to the Node structure containing the data set for the initial file. Effectively, the Semantic Category Cluster contains files that can substitute for the one shown in the initial data set during the KP's processing of the file directory. Thus, while many more relationships can be developed for a file directory in this manner, the KP can receive or transmit any O/S file (through a data set) while comprehending the file's semantic relationships to other such files in the file directory.

When viewed as a disc operating system, the network can be appreciated for its capacity to store information intelligently such that a given file (of an O/S) can be related to any other file according to the knowledge network's intelligence. Whereas a conventional O/S “hard codes” a file directory, which can be understood semantically only by the human user, the KP configures the magnetic disc with a “semantic controller,” whereby the disc's file management processes are accomplished by the knowledge network's intelligence, while the file data is stored on a disc partition via the Write command. The data set thus acts as an I/O buffer for the disc system that configures any hybrid arrangement of O/S directories (and utilities) through the knowledge network's webbing.

12.2 Semantic Storage and Retrieval of a Telephone Number

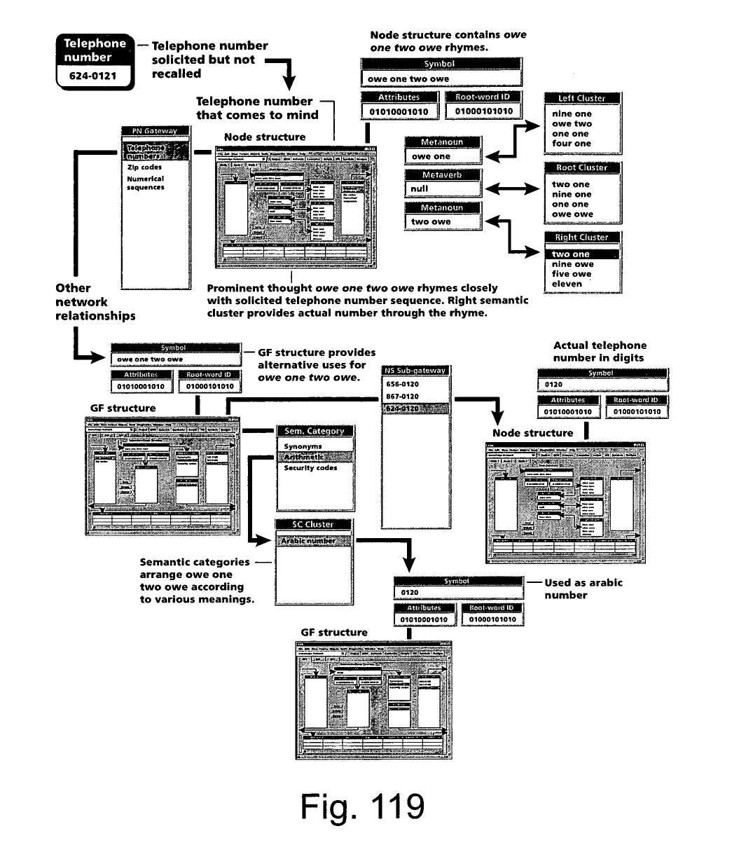

In order to provide another perspective on the KP's semantic storage and retrieval of information, we can examine the knowledge network's comprehension of a simple telephone number, as shown in FIG. 119. In the exercise, the KP will have to recall a telephone number stored in the knowledge network's PTs by rhyming the last four digits of the telephone number (instead of accessing the table-oriented information typical of computer systems and databases).

In an ordinary information storage and retrieval system, such as a database (or even a telephone book), a telephone number is stored, or cataloged in relation to other information with which the number can be cross-referenced. In a database, for instance, a table of telephone numbers may be linked, via table relationships, to other information, such as the names and addresses of the telephone number holders. The database user thus typically enters the name or address of the telephone number holder and queries the database for the corresponding telephone number. In many real-world situations, however, we cannot remember how to spell the telephone number holder's name or even where the holder lives, while quite often we can recall some of the telephone number's digits because they “sound like” those of another number we may be thinking of.

In the exercise, we are not simply concerned with linking a database's records to acoustic files; we are interested in showing how the KP uses rhyming techniques on the network's PTs in order to access its own memory. As shown in the figure, the PT's semantic clusters contain alternative epistemic components to the four-digit sequence shown (owe one two owe). The PT shown is the number recalled by memory in association with the request for the telephone number of the partially recalled holder's name. The problem arises, however, when we consider that the KP (as well as a human being) stores the telephone number epistemically, which means that telephone numbers that “sound alike” are stored in semantic clusters that are associated with a particular PT (in this case, with the PT for the expression owe one two owe) through a rhyme. The KP thus must arrive at the target expression (owe one two one) by transversing the network webbing that leads to the PT shown, and then substituting the rhymed PT components with their semantic cluster alternatives. Then, in order to “recall” the actual number, the KP must use the semantic cluster of rhymes while looking elsewhere in the network's webbing (or discourse with the user) to verify that the given name and number belong together. Thus, the problem addressed by the example is that the KP cannot remember the exact correlation between the holder's name and telephone number, and consequently must use a more circuitous route to obtain the number by rhyming it with others. The correct number is obtained by substituting the right metanoun with its cluster element two one, thereby creating the expression owe one two one. The network then searches other network webbing (or interacts with the user) to verify whether the number owe one two one has been used in connection with the holder's name.

This type of semantic storage and retrieval of information can be used to relate any knowledge contained in the network. As shown in the lower portion of the figure, the abovementioned number sequence (owe one two owe) also can be associated with the elements of either a zip code or the arabic expression of a telephone number through the NL structure's PNGW. When telephone numbers are required from the PNGW, the related GF structure for the sequence owe one two owe is obtained. The NS Sub-gateway, however, relates the same node structure to the arabic expression 0120. The GF structure's semantic categories further specify other GF structures, such as synonyms, arithmetic expressions, and security codes. Thus, the expression owe one two owe is associated with its arabic representation 0120 through a semantic category, while the PNGWs connect to alternative telephone numbers. In just one set of NL/GF relationships, the network can contain any number of semantic interpretations of language, including those pertaining to art, music, and natural language.

### Section 13: Data Conversions

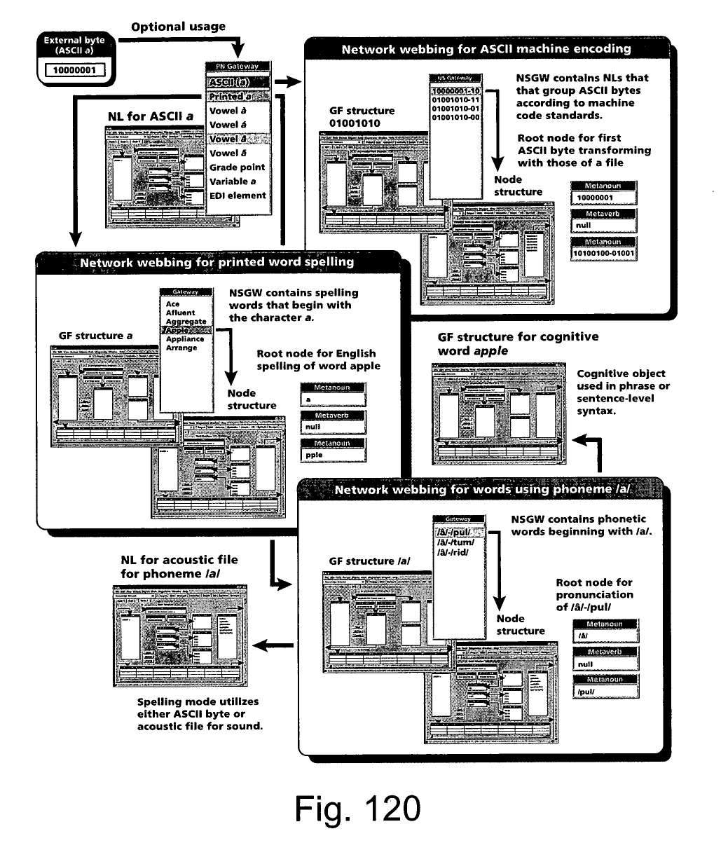

The compatibility of computer hardware and software, communication systems, and engineered systems becomes a complex design issue requiring advanced software engineering techniques only when an application is built without using the KP paradigm. In order to demonstrate the KP's natural ability to integrate incompatible systems through the universal grammar, the following discussion presents knowledge network structures that can be used to interpret arbitrary languages embedded in ASCII machine bytes. Specifically, the section examines the KP's ability to process an ASCII byte according to the grammar, syntax, and semantic usage of the English language. The section shows that, while the ASCII standard embeds the character α in the byte 01100001 with no particular usage in mind, the knowledge network contains any number of linguistic definitions of the character that allow the KP to understand various embedded languages, as shown in FIG. 120.

What every computer designer eventually encounters when attempting to integrate global computing infrastructure is that, while a byte of information may be encoded by a computer vendor in an arbitrary way, each particular machine will operate on the byte in the specific manner dictated by the vendor's design. A microprocessor or software provided by vendor A, for instance, will not inherently connect to and operate on the same data processed by equipment furnished by vendor B. While we could employ any hardware or software to illustrate the KP's ability to interpret external machine code randomly, the figure shows that the knowledge network can be programmed to understand, or the KP can learn by itself, any possible meaning encoded into the ASCII byte for the character α (and therefore for any other character) in order to interface with a given external device.

As shown in the figure, while an ASCII byte may define the symbol referred to as the character α, the actual meaning of the character, as defined by the application language's grammatical and semantic context, can vary indefinitely. According to English spelling rules, for instance, the character α can mean any one of several vowel sounds depending on the character's syntactical arrangement with other characters in a syllable or word. Similarly, the character α could represent a variable in algebra, a grade point average in academia, a data element's encoding in an EDI document, or a pin connection for a microprocessor. Rather than construct as many software translators as there are uses of the character α in the English and other languages, the KP's design allows arbitrary binary encodings to be understood by a single knowledge network.

As shown in the figure, the PNGW for the ASCII byte's root node transformation (for the parity bit's transformation with the remainder of the byte) includes GF labels that designate the various uses of the byte in higher-level syntactical and semantic application context. Only one of those GF designators is used for the byte's syntax in an ASCII byte file, whereby the KP processes the byte in binary context. In another case shown, the ASCII byte is analyzed by the knowledge network according to English spelling rules. In a third instance shown, the ASCII byte is interpreted as a particular vowel sound according to English phonetics, wherein the ASCII byte represents the /â/ sound in the word /â/-/pul/ (apple). Thus, by constructing NL and GF structures accordingly, the developer (or the KP) can effectively “program” the KP to understand any symbolism embedded in an arbitrary external file. The figure demonstrates that by branching from the PNGW of the ASCII node designator to various GF structures, the KP can understand the external ASCII byte in any manner desired.

### Section 14: Global System Model

14.1 Introduction

The GSM (3) allows the KP to realize, control, and interact with external digital systems intelligently. While the GSM may be used to configure any set-theoretic system whose input and output carry linguistic content that is analyzed by the knowledge network, this section demonstrates four particular GSM configurations that are beneficial to most KP applications. The section discusses the GSM's implementation of a typical communication network in section 14.2. The GSM's ability to realize set-theoretic systems from data sets is discussed in section 14.3. Section 14.4 discusses the KP's realization of androidal senses and motors in connection with the knowledge network's cognition. Section 14.5 provides a tutorial for translation card design and demonstrates the use of an RS-232 modem in order to realize the GSM's system connectivity. Each section explains a useful technique for configuring a knowledge network into a functional external system.

14.2 Computer and Communication Networks

The GSM allows the KP to analyze any data obtained from an external device according to communication protocols or linguistic content—or both. Although classical information theory does not incorporate a machine's comprehension of language into network configurations, a machine's decision to input or output to another knowledge source should, preferably, be made on the basis of linguistic content. Even when a conventional communication device filters transmission “noise,” the device should be able to determine erroneous data on the basis of the transmission's meaning. A communication device, therefore, should have the ability to cooperate with other devices on a network according to physical and network parameters while also having the option to understand the transmission's content.

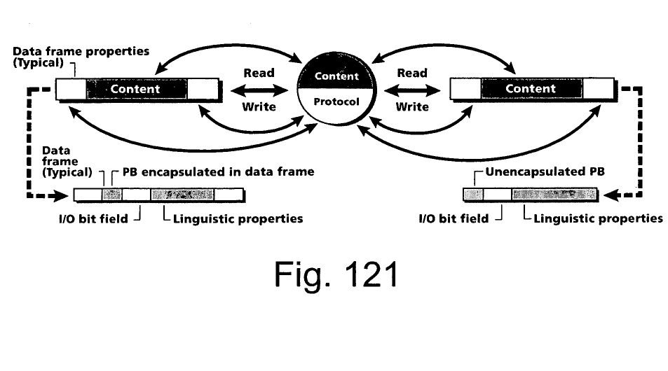

As shown in FIG. 121, the GSM configures a network system by designating the set-theoretic parameters and network protocols of the system in the PB's I/O bit field. Whereas conventional communication systems consider linguistic content to be a “block of data,” wherein the content is impenetrable by the network's intelligence (if any), the GSM analyzes communication protocols and linguistic content concurrently. The GSM operates in opposition to most communication systems by reversing the data frame/linguistic content relationship. Whereas a conventional communication system wraps a data frame around a message—the grammar, syntax, and meaning of which is unknown to the transmitting or receiving system—the GSM specifies network system structure by transmitting comprehensible epistemic components—PBs—as basic linguistic units of the transmission's content. The “data frame” is encapsulated in the PB as an I/O bit field, while a conventional protocol is optionally achieved by wrapping the data frame around the PB, as shown in the figure.

This GSM configuration allows each PB that is meaningful to a given system to be transmitted and analyzed by a participating device on the basis of the PB's placement into linguistic context (of the particular knowledge network). While the PB may be embedded in a data frame and analyzed, for instance, according to bit parity and other transmission-related properties, the PB also carries with it the linguistic properties associated with the application language. Thus, when a conventional system might transmit an ASCII file embedded within a data frame, the GSM requires that, in addition to this possible structure, each byte of the ASCII file be associated with a particular PB so that each external byte can be transmitted as a discrete linguistic entity of the application language. This GSM feature allows the KP to transmit an entire file or individual PBs according to the knowledge network's comprehension of the embedded language.

The benefit of this type of GSM configuration is that it obviously allows the participating machines to analyze messages based on linguistic content, rather than implement an externally imposed protocol exclusively. The KP can analyze the first five bytes of an ASCII file, for instance, and then decide how to process the file based on its comprehension of the PB sequence's meaning. The Read and Write commands obtain the data frames from external machines and allow or disallow transmissions to occur based on the network's comprehension of the communication protocol or the message's content (or both). The KP can translate an EDI protocol into an e-mail protocol by using the network to deconstruct the respective bit streams of each others' data frames. Meanwhile, the knowledge network can examine the transmission's content in order to determine, say, that the communication should be terminated because of the presence of a memorandum, inside the EDI document, that states Void this purchase order.

Thus, rather than base communication systems on engineering parameters that are, for all intents and purposes, extraneous to a transmission's content, the KP incorporates the network protocol into the PB's definition such that any unit of communication (i.e., any PB) can be processed meaningfully by the knowledge network. In just the same manner as a human being communicates, the KP operates on both the sensory medium in which the communication occurs (i.e., the protocol) and the cognitive properties of the message's meaning.

14.3 Set-Theoretic System Realizations

Another useful purpose served by the GSM is to assist the KP in the “realization” of set-theoretically defined systems. Since a discrete automation is easily described according to the conventions of system theory, the KP employs a GSM technique that defines set-theoretic system properties in the PB's I/O bit field, thereby allowing the KP to “realize” a system by outputting PBs that represent the various external set-theoretic system properties. This KP feature enables the knowledge network to implement set-theoretic systems, such as external senses and motors, in coordination with the network's intelligence. Whenever it is desirable for the KP to input or output a system specification, the PBs in a data set are interpreted in terms of the I/O bit field's representation of the given system.

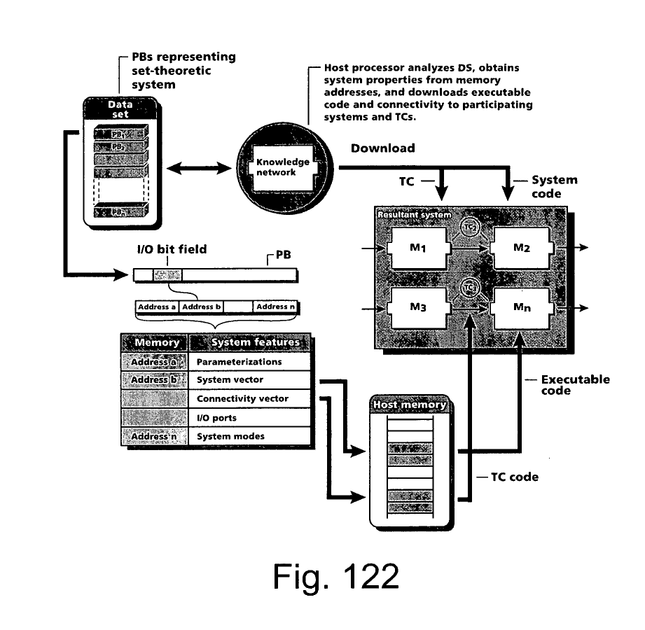

As shown in FIG. 122, the PB's I/O bit field can be analyzed by the network as a system parameterization, according to which, in principle, each PB can specify a set-theoretic system, or component thereof. The figure shows that the I/O bit field contains the memory addresses of a resultant system's specification such that the UPL functions can process, or “realize,” the system by downloading the related code to the participating external systems. The system specification that can be realized includes a system designator (SD) (136); I/O port definitions (IP; OP) (137); a connectivity vector (CV) (138); and a system mode vector (SMV) (139). Each system (specifically, each “resultant” system) can specify subsystems in a parameterized manner. The system's input and output trajectories are, of course, unspecified and unpredictable when the KP's intelligence is applied to the I/O streams, since the KP operates on the meaning of the language embedded in a carrier signal. (The carrier signals, however, do specify I/O trajectories in set-theoretic terms once a linguistic expression has been implemented by any participating machine.)

The connectivity vector specifies the external system configuration. A sequence of PBs residing in a data set thus constitutes a linear, or “serial” realization of a resultant system and its components and modes. A parallel set-theoretic system realization is achieved by asynchronously outputting PB system vectors concurrently. Thus, when a particular data set contains PBs encoded with system properties, the Read and Write commands can realize external systems by outputting the PBs, which are converted into downloadable code and connectivity parameters from the related memory addresses. As these systems are realized, the enabling code for microprocessor or software functionality is downloaded to the respective machines, along with TC projects that enable the machines to communicate via the connectivity vector. One of the benefits of this approach to system implementation is that, since the PBs define the linguistic properties of the application language as well as the I/O bit fields used for system realizations, the KP can implement set-theoretic systems that have meaning to the knowledge network. The network's operation on these PBs allows the KP to act as a system controller that implements different systems depending on the meaning of the PBs in a data set. The KP thus implements particular systems by selecting from a “universe” of systems and components such that, when downloaded with enabling code and connectivity, the external systems behave as a resultant system or system mode. The knowledge network therefore implements “off-the-shelf” systems whose configurations, connectivity, functionality, and system modes are determined by the network's semantic interpretation of the PB's I/O bit fields and application language content.

14.4 Realizing Androidal Senses and Motors

A further aspect of the GSM, which is particularly valuable to androidal science, concerns the GSM's realization and control of physical senses and motors. This GSM feature allows the KP to realize physical systems on the basis of cognitive thoughts. By executing Read and Write commands in order to implement external systems from a data set containing PBs, the KP realizes (or perceives) physical actions performed by external systems as they relate to the knowledge network's cognition. During a spoken communication, for instance, the KP realizes the English phonetic alphabet by using a speech synthesis system, whereby each phoneme, which is understood by the KP through the knowledge network, is implemented by a Write command as a system of external code and TC operations that perform acoustic functions.

14.5 Translation Card Operation

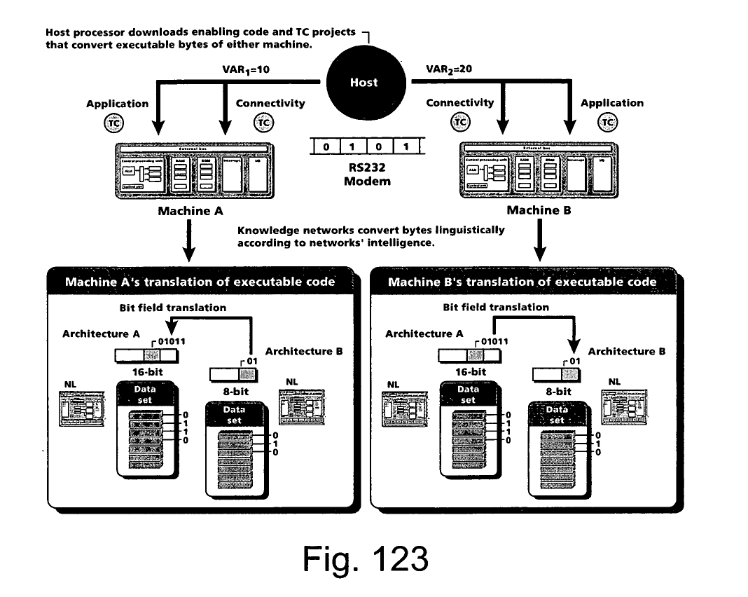

The KP's translation cards implement external system connectivity in order to enable the KP to communicate with external systems and to control how external systems interact with each other. The TC thus allows the KP project to “off load” hardware and software interfacing problems to an intermediate device—the TC—while the project, operating on the Host processor, is able to process the application language. While TCs are usually implemented by digital logic, the EMA or a commercial processor, and the KP's CD/ROM version, we can provide a first-hand demonstration of TC construction by considering the RS-232 device (the modem) shown in FIG. 123.

As shown in the figure, a Host processor is configured with any two or more incompatible digital machines. We assume that the incompatible machines desire to communicate with each other under the direction of a Host processor, perhaps in connection with a system vector realized by the Host processor. The problem that the participating machines will encounter is that, on either side of the transmission, the machines will operate on completely different executable machine code. Thus, while the RS-232 link provides the electronic handshaking necessary in order for the machines to transport 8-bit bytes serially, the manner in which each machine assembles the 8-bit bytes into executable machine code will be different in either case. The “TC” will be comprised of the RS-232 device, along with separate KP applications running on each of the participating machines (A and B). The Host processor will download two separate KP projects onto each machine. One project will be an application, while the other project will be the focus of this illustration—the TC project that enacts the respective machine's connectivity with the other machine in connection with each machine's use of the modem. (Ordinarily, the TC would be constructed from a dedicated hardware device that would not involve the RS-232 standard and would implement the TC project directly in a digital circuit or microprocessor. We use an RS-232 device here so that the developer can become familiar with TC design by building a TC from an off-the-shelf product—a modem). Machine A is a 16-bit computer, while machine B is an 8-bit computer. The exercise demonstrates how to design a TC such that instructions on machines A and B can be exchanged by the Host machine in order to execute hybrid instructions on either machine in a network configuration.

The key to understanding the TC's operation is to realize that, providing that the electronic handshaking can be performed by the RS-232 device, the only differences among the machines' operations are imposed by the incompatible machine architecture—the logical constructions of the executable bytes used on either machine. Thus, the 16-bit encodings used on machine A must be translated into the 8-bit encodings of machine B in order for the machines to share data and instructions. While the Host processor could just as easily provide these translations, we will require here that each machine have the capability to translate the other's code when receiving or transmitting data to the other through the RS-232 device. In this manner, the Host processor is able to concentrate on application-level languages, such as natural language or C++, while the compilers or interpreters of the respective machines translate the high-level code into machine code and communicate with each other without the intervention of the Host processor (through the TC projects).

The problem faced by either machine in this scenario is that the opposing system will be sending 8-bit bytes, serially, that are intended to operate on the transmitting machine, not bytes that operate on the receiving machine. Machine A, for instance, will send to machine B 8-bit bytes that are intended to be assembled into 16-bit bytes used on machine A. Machine B, therefore, will have to translate the incoming 8-bit bytes into 8-bit bytes that accomplish the same functionality as the 16-bit bytes used on machine A, but on machine B's architecture.

In order for each machine to perform its respective translation, the KP project running on each machine as a TC must incorporate a binary language into its operation comprised of an alphabet of two—zero and one. The symbol kits used for the Read and Write commands of each machine (via respective I/O engine specifications) will be designed to receive 8-bit bytes that are converted into PBs implemented on each respective machine. These PBs, however, will be further deconstructed, by the knowledge network residing on each machine, into PBs that represent the bits and bit fields used on either machine architecture. Thus, after a Read command executes and installs PBs representing external 8-bit bytes into a data set, the PBs are translated into lower-level bits and bit fields representing the logical design of the opposing machine architecture. Once the opposing machine's bit fields reside in the data set, reflecting the opposing architecture's logical arrangements of bits, parsing and translating functions convert the bit fields to those used on the current operating machine architecture. As shown in the figure, the UPL functions translate an enabling bit field of machine A 's instruction byte (0110), in its particular location in the byte's syntax, into a bit field appropriate for enabling a similar device with that same instruction on machine B (010), in its particular syntactical order. When machine A outputs to the RS-232 modem, the 8-bit bytes are transmitted, serially, as 16-bit executable bytes. Machine B then translates the respective bit field properties into 8-bit bytes that can be executed on Machine B.

### Section 15: Software Engineering

The most noticeable problem with software designs is exactly that—they are “software.” Since computer systems are designed on the basis of programming languages, the software engineer is, by definition, working with a language that usually does not utilize the best available grammar to express the user's knowledge application. Thus, to the extent that the software engineer has a working knowledge of the user's knowledge discipline and language, the software application will be suitably tailored to the user's needs. Depending on the linguistic capacity of the programming language, however, the time interval and cost of software development will be commensurately protracted. The ideal software is therefore none at all. The KP paradigm is premised on this goal and realizes the user's knowledge directly in the binary structures processed by the machine architecture. Nevertheless, the knowledge network can be used to translate software at the source, machine, and source/machine, or compiler levels.

The KP translates language, machine code, and network protocols according to the premises of the universal grammar. The KDE allows the developer to design, modify, and integrate software without becoming preoccupied with the design process because the universal grammar operates on any language domain. By designing or translating software in the universal grammar, the developer works within the same linguistic framework on any project. In order to illustrate the benefits of KDE-based software development, we can explain several notable improvements to software engineering advanced by the KP paradigm.

The first improvement concerns the KP's ability to embody and transform knowledge, rather than execute, or “implement” algorithms and software. As discussed earlier in the text, computer software is designed to “implement” a language expression. The example used in the text (FIG. 1) explains that a computer must execute a program that operates on input (say, the numbers 2 and 2) to produce an output (say, the sum, 4). The machine thus does not “think”; rather, a computer implements an algorithm. Thus, when the user interacts with software, or the engineer designs a computer program, the resulting software executes a program; it does not interact with the user thoughtfully, or express knowledge according to the mind's innate moments of comprehension. The user thus must understand the programmer's intelligence, rather than the machine reaching (or exceeding) the user's intelligence. Alternatively, the knowledge network, and therefore the KP development environment, operates on epistemic structures that are designed to transform language according to the universal grammar. By constructing a knowledge network instead of a computer program, the developer is able to build software that implements the user's direct way of thinking in the CPU operations of the microprocessor.

Second, the KP processes the meaning of language. Concerning computer programming languages, then, the KP processes the grammar and semantic usage of, say, a “do loop.” While this concept usually feels a little awkward at first, the reason why software is so costly and time consuming to change or integrate is that the programming languages are not defined linguistically in the first place. The expression “do, while” actually means You, the machine, do [the following] while [determining some condition]. The expression is an ellipted simple sentence of imperative form in the English language. As a result, computer engineers are unable to compare computer languages to each other and to their Assembly-language implementations on a microprocessor architecture. One programmer, however, should be able to ask another programmer, “What sentence structure did you use for the C++ while statement?” Similarly, an SQL database query is an interrogative sentence that asks the database for certain information. An Assembly-language instruction, such as LOAD a, b, is an ellipted imperative sentence that actually should read, You, the machine, load the contents of memory location a into register b. We may inquire, then, as to what would happen to the process of software design if industry standards required the specification of computer languages according to their grammar and semantic usage. In the event that the programmer utilizes a new grammar, any other programmer could learn that grammar and translate it into any other language so that a developer (not an industry) could conceive, implement, and promote a new programming language within hours of design time. The KP paradigm is based on this type of approach to software development. By specifying PB bit-field properties and network structures, the developer inherently translates one programming language into another because the universal grammar performs as an ideal interlingua.

Another drawback to computer languages that is solved by the KP paradigm is that computer languages must be compiled into binary logic. Since computer hardware is specified in terms of binary logic—bit, bytes, AND/OR tables, flip-flops, adders, multiplexers, RAM/ROM, busses, and in general, “architecture”—it too must be explained linguistically in order to be integrated into any other language. Thus, a truth table must be constructed as a syntactical structure according to the grammar of binary logic. The truth table's expression of an AND gate (0, 0_{—}0; 0, 1_{—}0; 1, 0_{—}0; and 1, 1_{—}1), for instance, must be represented as a series of sentences that are parsed and translated into the broader expression A+B=C, wherein A and B stand for the operands and C represents the product of a Boolean algebra. The KP paradigm analyzes any knowledge in terms of the universal grammar in order to relate high-level expressions, such as executable bytes, to any lower-level expressions, including those of Boolean logic.

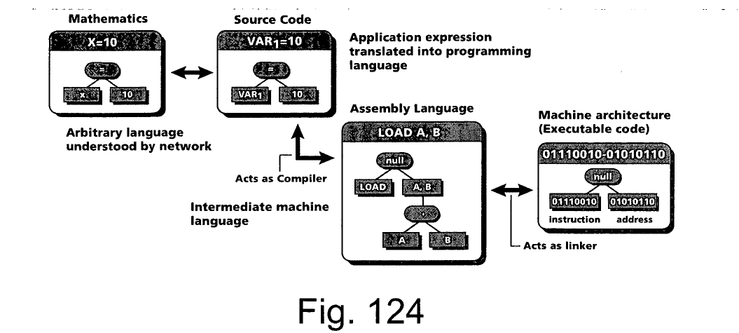

As shown in FIG. 124, a software language is related to any other language via the universal grammar's depiction of language. The KP therefore relates the user's knowledge domain to any programming language while also translating source and machine languages. The source code statement shown is deconstructed in the universal grammar so that there is no ambiguity in understanding the expression's meaning. Once the statement is understood in the universal grammar, the KP can perform a similar translation to Assembly code or binary logic. As the developer acquires more knowledge about a given language and defines relevant PBs, symbol kits, network structures, and intellectual faculties, the language can be translated into any other language desired simply by adding new network structures to the KP project. In effect, a new version of C++ could be written extemporaneously, while the new expressions could be translated into machine language at will. Each time the KP operates on new software, it acts as a compiler customized to suit the given application language. When application languages are incorporated into compiler design, the entire software pyramid—from English or Chinese language to Boolean algebra and truth tables—resides in the knowledge network and can be translated. The application language can be any language of the user's choosing, while the knowledge network translates the application language into executable code.

The developer thus becomes a proficient compiler designer without realizing it. Where conventional source languages and their higher-level languages, such as SQL of database systems, are constrained by hardware platforms, the KP allows any expression to be compiled into any hardware or other software—and even into hybrid computing platforms and operating systems. The user is therefore free to determine any language as a “source language” and any off-the-shelf hardware as the enabling platform. Natural language, pseudo-code, or any of thousands of variations of scientific languages in use can be employed as “source” languages because the KP translates any one language into the other through the universal grammar. Thus, the KP opens the software development envelope such that any source language is understood and compiled or interpreted into another through the universal grammar. Each time a new language must be compiled into machine code, a specialized compiler does not have to be written through conventional means dictated by computer science. The developer simply adds new PBs and network structures to the existing network, along with running processes to translate the language, and a new translation tool results.

### Section 16: Database Technology

A significant drawback to classical database design is that, just as paper forms are irritating to fill out and file, a database contains only information that its tables and records are capable of receiving. The database thus requires a human or machine interface to help the user to format original information into data that is acceptable to the database's design. Since the KP stores information meaningfully, however, it understands any incoming epistemic parse trees according to the user's innate construction of language. The KP is thus sometimes referred to as a “thinking database” because it stores information as thoughts. The KP unlocks a new world of data storage and management by operating on both the structures and code used for database design languages (such as C++ and SQL) and the knowledge stored in the fields, records, tables, and database relationships called “content.”

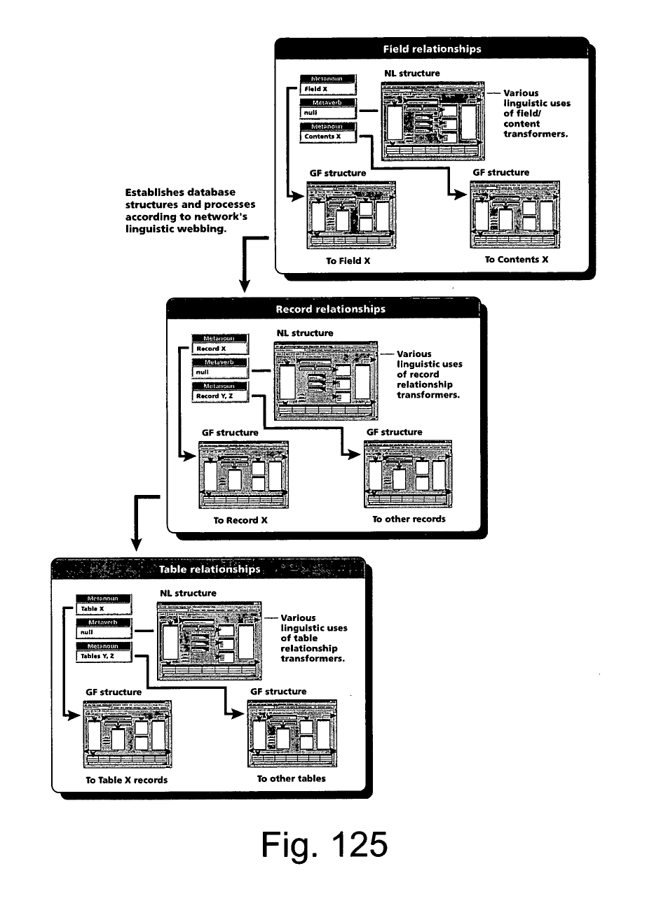

The knowledge network stores and manipulates database structures and processes according to the universal grammar. As shown in FIG. 125, a network PT is used to represent the relationship between a database record's field and the field's contents. In this manner, the field and its contents are entered only once in the network, while the network gateways, such as the PNGW, allow the field designator (PB) to branch to any other expression. At the same time, multiple fields can be related to a given record in a similar fashion, while records can be associated with tables as well through the NL/GF relationship. Because a conventional database design employs axiomatic structures including the field, record, and table, the information stored in the database mimics a cataloging system. Thus, the database cannot understand even its own information because it operates on records and fields instead of language. The figure shows that any database structure can be represented cognitively by the knowledge network, while the network also can analyze the database's content linguistically. Since each PB carries with it a root word bit field, a network structure can be related to any other on the basis of a unique “primary key” (root word ID) or “secondary key” (root word) that corresponds to a database's field definitions.

Once the database structures are defined in the knowledge network, the running processes can manipulate any of the database's structures or content. The KP understands the database system structure in the same way the database designer does, while the KP also operates on the contents of a given field according to the language employed. Through the PNGW, a given database element, such as a record, can be related to any number of tables, wherein the database's syntactical and semantic structures are represented by the knowledge network's webbing. By using the KP's knowledge network structures, the developer can build a database and then change it dynamically as the KP learns the new database relationships. The KP therefore is not constrained to any one particular database design and can translate, or “migrate,” one database design into another via the universal grammar.

When designing databases, it is important to recognize that a “database” is just a simplified form of natural language. As discussed in the text, the problem with the database is that its design is formulated according to the grammar of fields, records, tables, and “relationships” that can be “queried” according to a database “language” (SQL). If we take a moment to acknowledge that the KP accomplishes a “thinking” database, it is easy to see that the database is constructed in the KP paradigm according to the epistemic structure of the database's design language and data. Thus, instead of structuring, say, natural language text the way a magazine writer would lay out the columns of an article, the database developer uses the KP to structure a database's tables, records and fields. A database field, for instance, is simply a PB structured in a PT in epistemic format in relation to its contents. The field, in turn, is related to any other fields, through any number of records, in a table format. The database's “relationships” are thus inherently provided by the knowledge network's structure. The problem that most beginning developers encounter when building databases with the knowledge network is that a typical database is much simpler to design than a natural language application, the complexities of which the developer has by now become accustomed to from the text. When designing knowledge networks for databases, it is therefore best to think of fields, records, and tables (and their relationships) the way an ordinary person would understand them on a piece of paper. Defining PBs, PTs, and their network gateways for a database is like formatting library information or a pie chart for a business report.

A knowledge network explains the linguistic properties of a database—a task that is usually excluded from the database's conventional design methodology. When creating the KP's version of a database, the developer must define, for instance, whether a PB that represents a field should be manipulated in its objective form, as a GF structure, or in its transformational form, as a node structure. The objective form of the field will be related to any number of transformational nodes, while the node may transform C++ code enabling the field in a programming language's syntax used to implement the database. Thus, whereas the traditional database developer employs a technology that is already designed (and limited to the features of that database), the KP developer creates both the database technology and the application by defining the corresponding network structures.

Since the KP operates on arbitrary language, the “information” contained in a database, such as data held in the fields of records in tables, also can be extracted and translated by the knowledge network as linguistic content. By using the symbol kits and GSM properties to read and write to the incompatible machines on which the databases are operating, the KP can examine data from tables and records contained on one machine and translate that content into language appropriate for another machine. The KP can “query” the database based on the meaning of the content held in a database's records. Thus, whether a database field contains integer dates that must be translated into character strings or a Chinese expression that must be translated into an English one, the KP can extract the content from the enabling programming language's code and structures and translate the data as required. By parsing a database's structures, whether that data is in binary, integer, character, or floating point form (or any allowable combination thereof), the KP installs into a data set, via the Read (or Write) command, the contents of a field that must be translated. If, for instance, an ASCII character string resides in a field, the KP extracts the character string, installs it into a data set, and parses and translates it according to the embedded language's grammar, syntax, and semantic usage. The KP then translates the ASCII character string containing, say, an English expression, into another ASCII (or Unicode) character string containing the Chinese translation performed by the knowledge network. By interpreting the information in a database, or the database's design itself, according to the premises of the universal grammar, the KP is able to understand the meaning of the information held by a database or the enabling program code that is used to design the database.

### Section 17: Computer Graphics and Symbolic Recognition

One of the easiest ways to understand the KP paradigm, from a symbolic processing standpoint, is to implement a computer graphics application. While the KP is designed to avoid the concept of computer graphics altogether by enhancing the technology with a knowledge network that understands symbols cognitively, the KP's improvements to computer graphics systems allows the developer an up-close examination of the ease with which the knowledge network processes images meaningfully. Whereas traditional computer graphics technology cannot penetrate the perceivable image, the knowledge network processes an image obtained from a video camera or a pixel-based computer graphics system according to the universal grammar's structure of the “language” of art and imagery. The KP processes the meaning of an image, and therefore understands the objects of human perception along with the computer user.

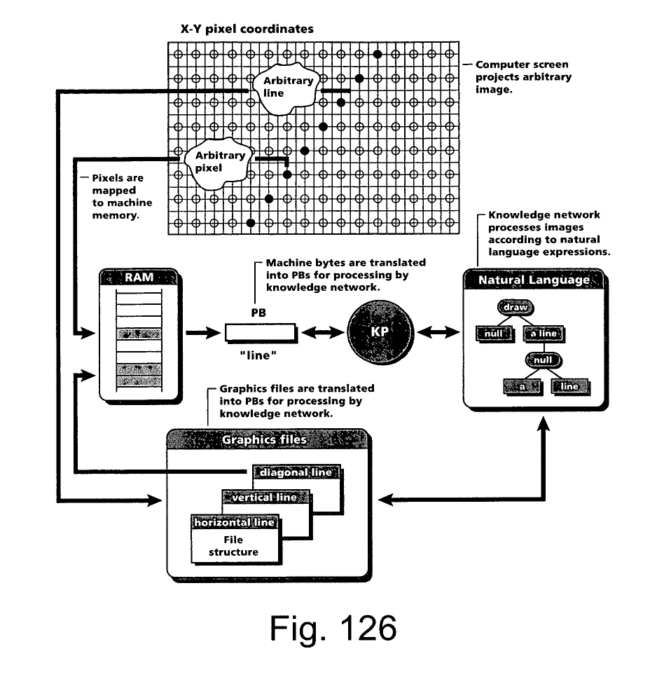

As shown in FIG. 126, a symbol, just like any other linguistic object, such as a character, does not have meaning until it is placed into the syntax and semantic context of an epistemic expression. According to the KP paradigm, what is recognizable or comprehensible to a human or machine intellect is the epistemic transformation of language, regardless of what type of language resides in the knowledge network. What is not readily appreciated about the KP paradigm, however, is that “images”—fine art and any other images recognizable to the human senses—constitute language. In the KP paradigm, the developer places a grammar—and an entire set of definitions used for knowledge network construction—onto shapes, colors, and textures such that the knowledge network can understand them while relating the graphics language (the images) to natural language through the KP's network webbing. The figure shows that a matrix of pixels containing the elements of an image can be analyzed in relation to the image's grammar. When various pixels are illuminated, different images appear to the eye. The microprocessor's memory, and thus the computer graphics software, can be arranged according to the KP's knowledge network structures such that the illuminated pixels correspond to network structures, via symbol kits and PB definitions, that can, in turn, be related to other network structures containing, say, natural language expressions.

The problem encountered by computer graphics technology, however, is that, since the graphical images are displayed by source-code programming objects (i.e., by a computer program), only the computer graphics user can understand the image created at the interface. If a human being were shown two images—one of a line and the other of a circle—and asked, for instance, which image is closest in shape to a line, the observer would pick the line. This cognitive recognition of images through language is possible because the human user understands the word line in association with its geometrical shape (or, herein, in relation to the computer program that generates the line in pixels on a monitor). The same image recognition cannot be achieved by the computer graphics system, however, because the computer graphics system operates according to a computer program that cannot understand natural language, and therefore cannot relate the image to a natural language expression.

As shown in the figure, the KP analyzes the pixels as linguistic picture elements that are represented by the network's PBs, which, in turn, are contained in the network's semantic webbing—its ability to understand natural language. When pixels or programming objects that generate pixels are related to PBs, via symbol kits, the Read and Write commands generate images on the Host or external processor that inherently relate to natural language. Once the external image is converted into a PB, it effectively becomes “language.” The knowledge network thus manipulates images according to the KP's thoughts. A “layer” of a computer graphics image, for instance, can be converted into a PB, along with many other layers (images) in a particular rendering. In order to recognize an image, the KP compares shapes, colors, and textures (i.e., PBs and network parse trees) through conceptual blending techniques that create global art forms from incremental images and their epistemic properties. The parsing functions, for instance, scan the pixels represented by PBs in a data set in the same manner that the KP would parse a natural language expression. Instead of operating on a verb or pronoun of natural language, however, the KP operates, in this case, on the shapes, colors, and textures of an image. When each pixel is translated from external memory into a PB or network structure (via the GSM and its symbol kits), the network begins operating on the syntax of the given image.

What we generally do not realize when designing graphics systems is that, just as the eye parses the printed word, the mind parses images according to the lexicography, syntax, and semantic usage of known shapes, colors, and textures. In the KP paradigm, a parse tree that represents an image stored in the LTKB can be compared to a parse tree implemented in the STKB. Since the images are represented linguistically by the network (i.e., not as “images,” but as epistemic parse trees), the images can be analyzed by the network, as explained throughout the text, and related to natural language. A “line” can be parsed in epistemic syntax in the universal grammar, rather than according to, say, a mathematical pattern recognition algorithm. Thus, a line is not a “line” to the KP; it is a parse tree. Since the line is a parse tree, it can be related to other parse trees, including those used for natural language. The KP thus “thinks about” how a shape, color, or texture differs from another by examining how the respective parse trees vary.

As the KP parses a data set containing PBs representing an image, it analyzes the syntactical arrangement of the PBs. The linearized order of the PBs refers to the matrix of pixels displaying the image on a monitor. The KP thus “sees” the bitmap file (or any other graphics file) by scanning (parsing) the graphics file and recognizing its colors, shapes, and textures. Since the images are related to the KP's linguistic webbing, the KP interacts with the user about the image in natural language.

### Section 18: Digital Systems

Both analog and digital systems are described by natural language as well as by specific design languages appropriate for the particular engineering discipline. The symbols of these respective languages, such as those used in Boolean logic to represent digital systems, can be understood by the KP through the knowledge network. This section provides further insight into the KP's knowledge network structure and operation by examining the network's comprehension and translation of Boolean logic.

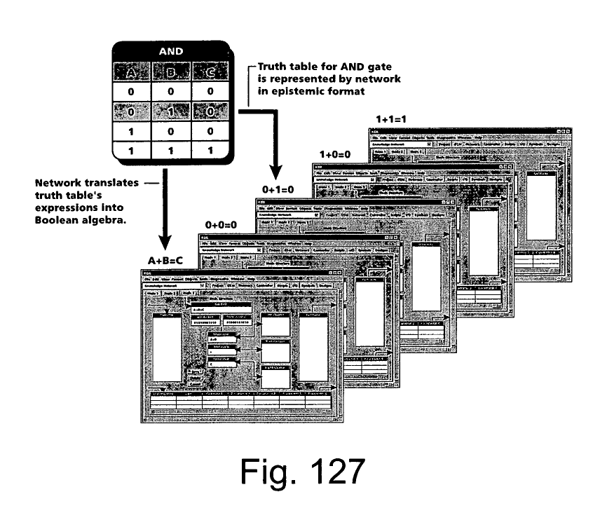

As shown in FIG. 127, the KP stores and manipulates Boolean logic and truth tables so that it can translate them into higher-level languages, such as Assembly language, source code, and natural language, with the same facility that it uses to conduct any other translation. The key to understanding how the KP in fact “designs” digital systems is to recall that an engineer formulates Boolean logic in epistemic moments of language in just the same manner as does the KP. We can consider, for instance, the KP's operations on the truth table shown in the figure. The semantic and syntactical relationships formulated by a Boolean logic design are embedded in the KP's network webbing just as the engineer conceives them, according to their binary operations. The way in which a human being and the KP understand the AND gate, for example, is to comprehend the truth table's language elements as they transform in the universal grammar. Thus, in order for the KP to manipulate the knowledge of an AND gate, the KP devotes a portion of its network webbing to the operations of binary logic. Designing a digital circuit thus involves translating the logical expressions of the truth tables involved into the equivalent Boolean expressions, or into a schematic diagram or Assembly instruction of a higher-level language. The KP understands these operations by retaining PBs that define the basic grammatical elements of each expression, along with their corresponding epistemic parse trees. In order to develop a Boolean expression from a truth table (or vice versa), the KP parses the truth table and assembles (translates) the set of logical expressions into their Boolean symbolism.

When more sophisticated designs are required, such as those involving microprocessor architecture and communication networks, the architecture is translated, epistemically, according to the designer's or the KP's understanding of the relevant circuits. Moreover, rather than create an elaborate series of translations through the “software pyramid,” involving human to source, source to Assembly, Assembly to microcode, microcode to chip slice, and chip slice to Boolean languages, simply to perform, say, arithmetic in a digital architecture, the KP translates the epistemic form of arithmetic directly into Boolean logic by using the same network elements shown in the figure and discussed throughout the text.

### Section 19: Simulation and Control

While classical control theory does not incorporate the knowledge network into its premises, engineered control systems can be used in knowledge processing to build the incremental and global shapes of the KP's learning functions and to support the realization systems of the Rg module. This section discusses the KP's use of control systems to implement real systems that correspond to natural language commands.

The KP's control of a system is best understood from the standpoint of classical control theory's “world model.” A world model is a set of procedures and structures that defines how input parameters control the outcome of a system's behavior. In the case of a robotic world model, for instance, the roboticist defines a set of computer algorithms that operate on mathematical structures representing the robot's work envelope, joint rotations, torques, and other parameters such that a set of coordinates can be entered into a running computer program to direct the robot arm to its destination. Similarly, and on a much simpler level, a computer animation is a form of world model, whereby a computer program converts mathematical formulae (homogeneous transformations of linear algebra) into pixel representations that are displayed on a graphics screen. When the graphic artist enters relevant input parameters into the program's interface, the program displays the animated models accordingly. Concerning the design of any global control system, however, the question can be asked: How would one control a system in terms of parameters that are not mathematical in nature? What type of “control system” would allow the user to enter the expression Get the passengers there safely and on time, while the system ensures that a real airliner complies with the command? Similarly, what kind of control theory would permit a graphic artist to input to a graphics system an expression like make the face look shocking, while the system generates a human head whose eyeballs pop out of their sockets? In general, how would one construct a world model by using a machine that understands natural language and manipulates physical forms according to the meaning of the expressions input into the system's interface?

The KP is able to realize external systems—say, robotic systems—in connection with the knowledge network's intelligence. Let us suppose, for instance, that a single PB in a data set represents the (English) word move, and that the next two PBs in the data set represent the words 10 and inches, thereby collectively expressing the command move 10 inches. Let us further suppose that an external robotic device must receive input parameters expressed in exactly this fashion (the distance to travel and the units of measure of the motion). When a Write command converts the PBs into external data structures and outputs them to the machine, the robot will then “move” (its arm) 10 inches. Since the knowledge network can parse and translate the PBs according to the intelligence residing in its network webbing, the KP can simplify its thoughts in natural language in order to output pseudocode that expresses a command's parameters.

The difference between the KP's operation and that of conventional control systems is, of course, that the KP's knowledge network is capable of understanding the meaning of the commands and parameters used to control the system. When the KP inputs or outputs the PBs of a data set, that data set has been comprehended by the knowledge network. The KP has “thought about” the meaning of the data set in the context of its intelligence. As discussed in the text, the KP may operate at various levels of linguistic complexity according to the intellectual faculties in order to ensure that an external system, such as a robot's elbow joint, complies with the meaning of a natural language expression. The KP's method of “feedback control” is thus based on linguistic feedback that can control any system through natural language expressions understood by the knowledge network.

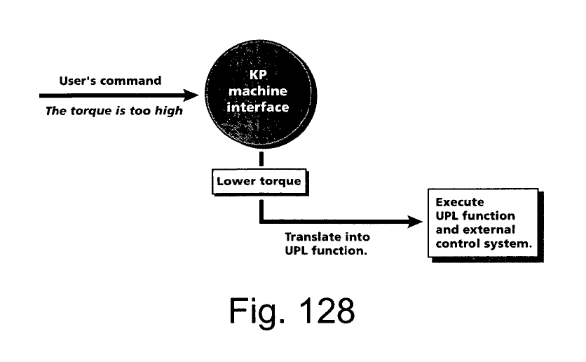

The knowledge network thus can be appreciated as a “pretranslator” for system commands that are placed into the data set for output, as shown in FIG. 128. The KP paradigm thus expands the notion of a control system to include expressions of natural language, wherein the KP translates the expression shown (The torque is too high) into appropriate control signals that adjust the measured parameter (torque) in a physical system.

### Section 20: Telecommunications

While the KP enhances communication technology in several important ways, the most significant contribution made by the knowledge network in this area concerns the transmission of carrier signals on the basis of linguistic meaning.

Traditionally, communication systems transmit digital or analog signals on the basis of information theory. This approach to communications is primarily concerned with the transmission of a signal in the presence of noise, such that mathematically defined waveforms can be conveyed and reproduced throughout a communication system. This exclusively engineered approach to communications, however, is subject to the linguistic pitfalls to which most other conventional systems succumb—that the source and target signals are not understood by the machines that transmit and receive them. Thus, the content of a typical transmission may itself be in error even when a perfectly noise-abated signal arrives at its destination.

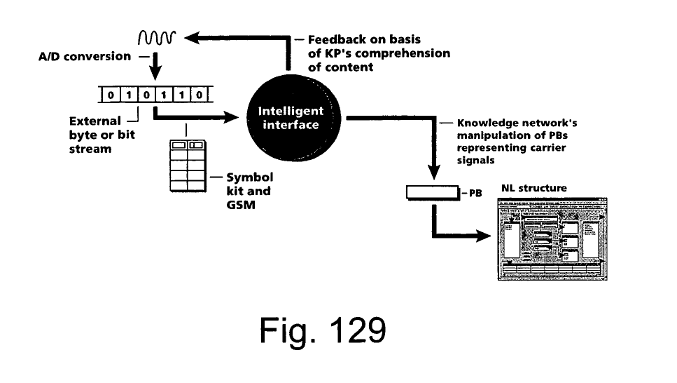

FIG. 129 shows that the GSM can be used to transmit and receive communication signals on the basis of linguistic meaning. Providing that each party to a communication can send and receive the universal grammar's structures, the GSM allows carrier signals to be transmitted on the basis of epistemic structure. The significance of this approach to communication system design can be appreciated when we consider the transmission of just a single spoken word through a telephone system. If a communication system cannot understand a word of the embedded language that it transmits, how does it know that it has delivered a correct signal?

As shown in the figure, the KP transmits and receives signals that can be formulated into PBs for use by the knowledge network via symbol kits and the GSM. Thus, the KP does not preferably transmit “data.” Any communication initiated or received by the KP ideally conforms to the knowledge network's intelligence. Thus, the carrier signal shown in the figure is configured as a PB defining a language element in the knowledge network. Since traditional communications theory can deliver the carrier signal (of unknown linguistic properties), the KP acts as a linguistic control system that informs the transmitter or receiver just what carrier signals to send or receive based on the embedded language's meaning. By mandating that any carrier signal comply with the PB's format, the KP ensures that all signals transmitted conform to language that the knowledge network can understand. In this manner, any signal transmitted is most efficiently “compressed” into its minimal transmission content because the signal represents a PB, which ultimately signifies a linguistic element comprehensible to the network.

### Section 21: Natural Language Translation

The problem faced by the human language translator, which is solved by the KP's cognitive translation process, is the lack of standards by which to translate language such that any instance of a translation results in “bidirectional” reproducibility. What a bidirectional translation actually means is that the same expression will result from a given language translation regardless of which language is chosen to be the source or target language. This classical language translation problem arises because traditional linguistic approaches allow the translation of epistemological objects, such as nouns, phrases, and sentences. Consequently, any language translation can have an indefinite number of interpretations, each of which cannot legitimately be disputed because an epistemological object does not express a language's meaning according to the universal grammar. Alternatively, the KP will not allow any translation of language to occur on an objective basis. The KP translates only the epistemic moments that comprise an objective expression, such as the quantum linguistic moments of a sentence's syntax. Since the epistemic moment defines the mind's meaningful comprehension of thought, the universal grammar provides a uniform standard with which to translate language such that either party to the translation agrees to the moment's meaning according to its epistemic structure.

An epistemological object, according to the universal grammar, cannot contain meaning and therefore cannot be understood by a being. An epistemological object can have infinitely many interpretations, since it is undefined. An epistemic moment of language, however, literally defines a moment of comprehensible meaning that can be grammatically examined by either party to the translation. While a morpheme, for instance, is traditionally defined as a “unit of meaning,” the universal grammar prohibits any objective form, including a morpheme, from expressing meaning. Rather, the universal grammar allows a transformation of morphemes and other linguistic objects to define the mind's quantum thoughts.

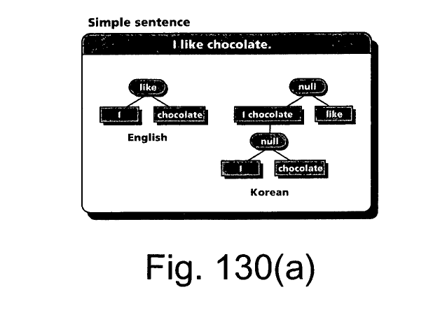

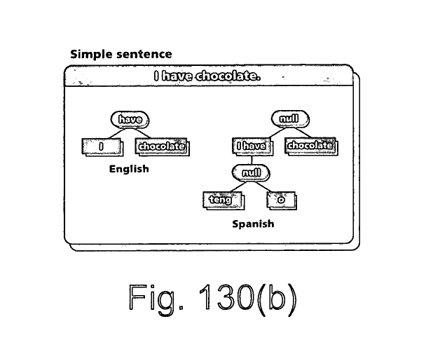

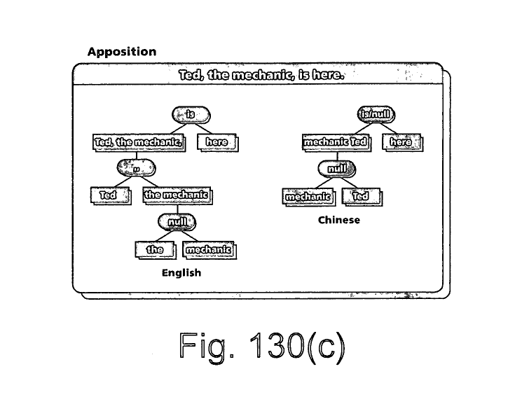

As shown in FIG. 130(a), the KP deconstructs an English simple sentence into an epistemic moment, while the components of the moment can be exchanged with others in order to synthesize the moment's meaning into the syntax of the other language. In the example shown, the English verb and complement are interchanged in order to represent the idea I like chocolate in the Korean language. Properly, the Korean language structures the subject and complement in one epistemic moment, while the verb transforms that moment in its own epistemic moment in order to explain how the subject and complement transform. Thus, the single English epistemic moment I-like-chocolate is translated into two epistemic moments in a parse tree representing the Korean expression-one explaining the transformation between the subject and complement, and another describing the subject-complement transformation with the verb.

Moreover, as shown in FIG. 130(b), the KP and the human translator are able to translate the subject and verb of an English simple sentence into a single lexical entity in the Spanish language, whereby the pronoun shown is incorporated into the Spanish verb tengo as a suffix. Because the alterations are performed on the basis of epistemic moments of meaning, the translators are able to capture the mind's idea “bidirectionally” in the respective moments of either language. Similarly, the appositive phrase the mechanic, shown in FIG. 130(c), is translated into a Chinese pseudo adjective in the sentence Ted, the mechanic, is here. In order to ensure bidirectional translation quality, the epistemic moments—not the phrases or objective expressions—are translated. In the examples shown, the KP provides a linguistic structure—the epistemic moment and its parse tree configuration—with which to ensure that any language translation can be paused, or captured semantically, so that either party to the translation can examine the semantic content on the basis of the mind's innate “bidirectional” comprehension of linguistic structure.

### Section 22: Knowledge and Learning Systems

22.1 Personal Learning Systems

Perhaps one of the greatest benefits of the KP paradigm can be appreciated by taking a step away from computer technology to understand the human learning experience from the standpoint of the universal grammar.

The KP is designed to interact with users according to epistemic moments of meaning concerning any knowledge discipline or language. As a “learning system,” then, the KP manipulates knowledge according to the way in which the mind naturally comprehends it. As just a brief moment of reflection will reveal, human intelligence and learning are quite often impeded simply because knowledge is presented “in the wrong way.” Most learning disabilities, in fact, are a result of the student's inability to find the right epistemic moments of language with which to assimilate the new knowledge into familiar context, not because the student suffers from a neurological or behavioral disorder.

In this section, then, we look at two wide-reaching KP applications that assist the user with learning and acquiring new knowledge. The first application concerns the use of the KP as a personal learning system that can be a benefit to any age group concerning any knowledge discipline or language. The second KP application illustrates an Internet search engine that retrieves information semantically and thus understands the content it is searching for in order to assist the user while acquiring new knowledge.

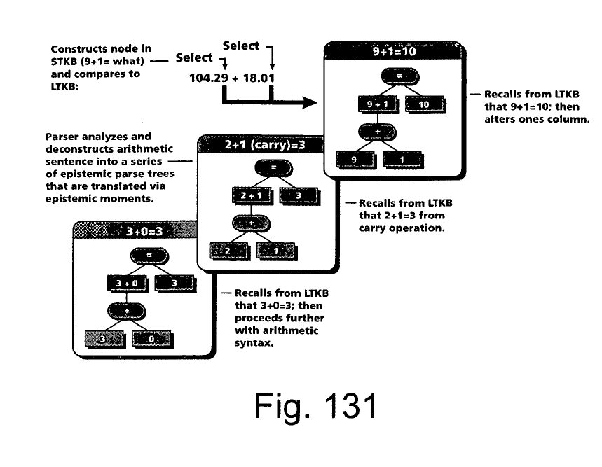

As shown in FIG. 131, the KP operates on any expression of language according to the mind's epistemic structure. What this means to learning situations is that knowledge is never just presented to the user as a composition of language. Whereas a computer or calculator displays pages of documents, or the results of computations, the meaning of which is impenetrable by the machine's processes until the user comprehends it, the KP displays epistemic moments—comprehensible instances of the mind's momentary action. As shown, instead of simply performing an arithmetic operation, via Boolean algebra, the KP translates arithmetic the way the mind naturally adds numbers. Thus, precisely what a student must accomplish when learning arithmetic—the particular operations performed by the mind when adding, recalling, and carrying numbers—is hidden from the observer's view by a conventional system and displayed on a screen by the KP.

The KP allows the user to observe the knowledge network's translation of epistemic moments. What an elementary school student must learn—specifically, in the example shown, when to recall from memory that 9+1=10; when to carry the one representing the 10, and then add it to the 2 to make 3 before adding that sum (3) to zero to result in 3; and so on—is displayed by the KP for the student to observe. What the student does not know before learning the arithmetic shown is how to parse the number sentences and the arithmetic statement in order to translate, or reduce, the expression into a series of “impossible-not-to-learn” memory recalls and arithmetic operations. By viewing the epistemic moments created by the network on a computer screen, the user observes the action of one's own mind. While the figure shows arithmetic, the epistemic moments just as easily could have been those of a chemical formula, a poem using alliteration, an indefinite integral of calculus, a musical composition, a drawing, an engineering design, or a reading comprehension exam.

When the KP is used simply for the value of observing its thoughts, it becomes a natural tutor for the teaching of any knowledge according to the student's natural ability to comprehend language. When the KP's UPL translations are observed on a computer screen, the KP “teaches” the student how to comprehend or create metaphors, similes, anecdotes, and other conceptual blending techniques. Reading comprehension is a challenge to the elementary and high school student because he or she has not quite developed the skills necessary for placing words, phrases, clauses, and sentences into their epistemic format. The student is unable to analyze a sentence for key epistemic moments or parse trees, such as those used for the expression the captain flew during twilight (of the earlier example in the specification) so that they can be translated into other expressions, say metaphorically, such as what occurs here with the expression the captain flew into the curtain of night. By displaying the KP's actions during an instance of conceptual blending, the student learns how to transform language through the mind's innate grammar. The KDE, or any KP application, allows the user to observe the thoughts of a machine-being and to communicate with it as well.

22.2 Internet Search Engine

One of the best ways to understand the KP's version of the Internet search engine is to consider first the case when the KP's knowledge network already possesses the knowledge to answer the user's request. In this case, a dialog with the KP provides the “search” for information. In order to understand how and why the KP conducts an Internet or database search, we must consider that the KP must not already possess the information requested by the user in its semantic network. Then, if the KP does indeed need to acquire other “information,” it must read, comprehend, and store that information as new knowledge embedded in its semantic webbing. Once the new knowledge has been acquired by the network, the KP can restate the information for the user's educational benefit.

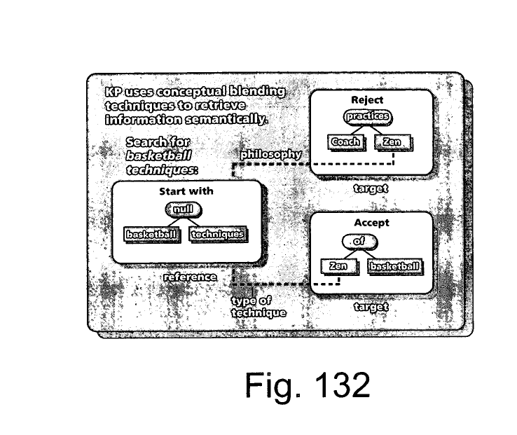

The KP does not simply match character strings of cataloged information during an Internet search; it reads and comprehends that information the way a human being would. In order to “store” information, the KP must deconstruct knowledge into parse trees that formulate the network's webbing. (The exception to this rule, of course, occurs when the KP simply stores data in a data set.) The KP is thus a “being” who learns about knowledge while conducting a search just as the user does. As shown in FIG. 132, the KP can perform a library search by employing conceptual blending techniques that range in complexity from character string manipulations to computations and metaphoric conceptual blending. If, for instance, the user happens to be searching for a title named Ten (for whatever reason), perhaps the title 5+5 would be of interest to the user. In this case, the KP would have to recognize that the search criteria and the target material are expressed in numbers, and then compute the sum of 5+5 in order to formulate the title 10. The reason why classical search engines perform poorly in this regard is that they cannot conceptually blend language, which is the KP's primary function.

The advantage of using a knowledge network in support of information searching is that the user has the option to decide whether specific intellectual faculties will be used in the search or whether the KP's autonomous intellect will be relied upon. As shown in the figure, the user can decide that metaphors to certain subject areas will be excluded from the search so that the KP's “mind does not get cluttered.” The intellectual faculties are thus taught that, during a search for advanced basketball practices, the metaphors that relate a title such as Coach practices Zen (the target) to basketball practices (the reference) stretches the subject area too far, but that the Zen of basketball may be just what the user is looking for. During a KP application's search of the Internet or a database, the knowledge network deconstructs and comprehends the language by using the KP techniques described throughout the text. When a match is found, this means that the KP may have transformed a given target expression by using synonyms, formulae, metaphors, similes, and any other conceptual blending techniques. The KP search engine can point to a reference located, or describe it during its discourse with the user.

The KP thus performs the “interview” used in library science and returns an abstract and bibliography that are presented through a dialog with the user. When the user has controlled the KP's use of intellectual faculties, the user can redeploy a search based on new selections for conceptual blending techniques. The user can begin a search, for instance, by instructing the KP to use only synonyms. If the search does not return any valuable findings, the faculties can be instructed to use powerful metaphors, similes, formulae, and so on. The KP thus undergoes the thought process that the user would perform when reading and comprehending search material. Each time the KP applies a metaphor or synonym to a simple sentence—of billions read during a search—the KP deconstructs the sentence from a data set into an epistemic parse tree and then converts the parse tree accordingly using the LTKB/STKB relationships and the running processes. The KP must, for instance, search the LTKB when it has to exchange the word water for H₂O in order to recognize a given expression, such as This story is about H₂O.

### Section 23: Biotechnology

It is not a coincidence that a biological sequence is sometimes referred to as a “sentence.” This is because genes, just like natural language, music, art, and mathematics, are language. An important KP application thus results when the knowledge network's webbing—PBs, PTs, semantic clusters, PNGWs, semantic categories, and so on—are used to represent the sequences of base pairs in DNA and RNA molecules. While probabilistic modeling is easily incorporated into the KP's processing of molecular alignments through the running processes, the knowledge network can parse and translate biological sequences according to its comprehension of the “language” of biological sequence analysis.

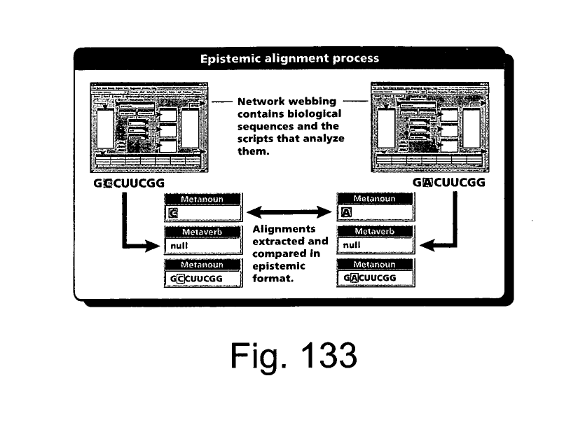

As shown in FIG. 133, each base pair alignment of a biological sequence will behave differently based on the “syntax” of its molecular structure. A base pair insertion, deletion, or substitution occurs, for instance, because certain catalytic conditions exist physically, environmentally, and historically for the particular alignment to occur. While the biologist typically assigns numerical probabilities (i.e., weights) to a molecule's tendency to insert, delete, or substitute into another sequence, the KP can model the alignment as a synthesis and translation of language. Just as the KP would perform translations on the characters, syllables, words, and sentences of natural language, the knowledge network can analyze the elements of an alignment. Rather than rely exclusively on mathematical methods for biological sequence analysis, the KP allows the developer to model base pair alignments linguistically in terms of epistemic moments and their parse tree configurations.

In this case, residues are formulated as “words.” In fact, the KP and the biological sequence are ideally suited for each other. Since the KP synthesizes language epistemically, it parses and translates moments of lower-order structures as they synthesize into higher-order structures. When the biological sequence is interpreted as a sentence, wherein the residues are words found in both sequences of the alignment, the process can be seen as identical to that of the KP's comprehension of a natural language sentence. What is important to note, however, is that, since the knowledge network stores PTs and their semantic clusters, a given residue is modeled in the network along with its potential variations (the clusters). Thus, when analyzing a particular sequence, the KP parses and compares the STKB parse tree made from the input data set to an entire portion of network webbing representing the possible alternatives for the alignment in the LTKB.

The additional benefit of using the knowledge network for biological sequence analysis is that the KP embeds the network—the knowledge of the biological sequence—directly in the bytes and logic of a microprocessor architecture. Whereas conventional computer modeling techniques obfuscate the grammar, syntax, and meaning of the sequence as they undergo translations from modeling software (say, a database) to source code, then from source code to Assembly language, and then ultimately to CPU logic, the KP operates on the sequence of PBs directly in the CPU's registers. The model's computational time thus directly corresponds to CPU clock cycles as microprocessor instructions install PBs into the registers and operate on them. The KP therefore provides the ultimate “ontological” database—premised, however, on the universal grammar's epistemological approach to knowledge, wherein any aspect of the biologist's model is directly implanted in the CPU's operation through the universal grammar.

### Section 24: Androidal Science

A basic design premise of the KP paradigm is that it is not possible to achieve the goals set for artificial intelligence, or thinking machines, through conventional approaches to machine cognition. This is because an advancement had to occur in how we understand the human thought process. What has been preventing the machine-being, or android, from becoming a product of a real science is that our understanding of human experience—the quintessential model for an android—had to be advanced to the point where the mind's quantum moments of thought (epistemic moments) could be replicated in a microchip or other synthetic device. Theories of the mind and linguistics had to be advanced and merged with those of science and technology so that a microchip could be made to think and perceive the way we do—in connection with a self—so that natural language, which includes the pronouns, could have meaning to the being. Simply put, a synthetic being had to be made to understand the meaning of the pronoun I.

While the generalized approach to androidal technology is referred to in the text as a “knowledge processor,” it is actually the advanced discipline of knowledge processing—androidal science—that has entered a new realm of machine design in which a synthetic device employs the pronoun I, and therefore all language and perception, meaningfully. The android is an epistemological machine that obtains a “self” (or self-awareness) in relation to its use of the pronoun I. Accordingly, this section illustrates some of the basic concepts that enable the knowledge processor to become more “human” through its use of language in connection with senses and motors that perceive the world as human beings do.

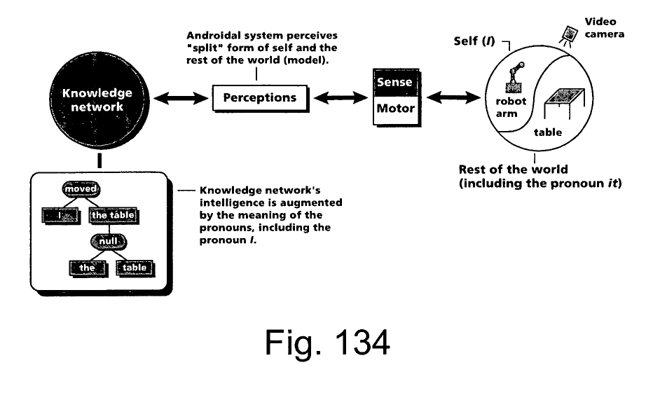

The KP provides the first “conscious” machine whose thoughts are observable on a computer screen and whose physical actions parallel those of human experience. As shown in FIG. 134, androidal science is concerned with applying knowledge processor technology to senses and motors (say, of a robotic device or a satellite system) such that a machine can understand language by referring to its “existence.” While the knowledge network is explained in isolation from a being's physical reality throughout the text, it can be appreciated here that, without senses and motors that perceive the world in such a manner as to give meaning to the self, a machine will always, lamentably, be a machine—and not a “machine-being.” In order to formulate a science of androids in which the KP may perceive the world through a psychological and theological self, the senses and motors built by the engineer must be made to perceive the universe through a mind-body dualistic “self set against the rest of the world” metaphysical state.

The figure shows that in order for natural language to become truly meaningful to a being, the being must exist in a form that can comprehend language as an autonomous self. As shown in the figure, the android's senses and motors are existentially “split” between a self and the rest of the world in such a manner that any epistemic moment of thought or perception transforms in a way to give meaning to the pronouns of any language. The pronoun I thus gives meaning to a portion of the physical senses and motors that is defined as a self. Any other form in the being's perception is defined as “not the self,” or “the rest of the world.” (When these definitions are modified slightly in order to explain the “oneness” of the pronoun I and the rest of the world, a spiritual self is created for the being's use of language.) Thus, with these definitions added to the knowledge network's operation, the being can state that I moved the table (in the figure) while the pronoun I refers to the system's perceived self.

The reason for defining a machine in this manner is that, while the microchip processes PBs and the epistemic network in the universal grammar, the being's senses directly and innately correspond to the being's use of language. The expression I am thus would have meaning to the android's existence because the machine would understand, through its “split” perception, that it exists (I am). Once the physical senses and motors are rendered as realizations and representations of PBs from the network, the machine-being's “imagination” and “comprehension” can be created in a synthetic device that understands the meaning of the pronoun I. All language therefore obtains meaning implicitly to the being. The expression the cat, for instance, would mean the cat that is perceived by the being's metaphysical existence.

When the KP's modes of operation (of existence) are taken into consideration, the android's existence can be modeled by the interaction between the mind and body in a dualism of form (or any other philosophical or theological theory of existence). Androidal science is thus concerned with the interaction between epistemic moments of the mind and its consciousness (embodied in the KP's microchip) and the epistemic moments of the physical senses and motors, as described in the text for the Rg module's dependent systems. The incremental and global shapes of the android's perception are constructed according to the being's use of language and its understanding of the pronouns. The developer, or androidal scientist, is thus focused on constructing incremental shapes that support the being's global use of language autonomously. The video camera shown in the figure, for instance, may be capable of perceiving greater resolution than the being can analyze. If a paper clip is resting on the table, anthropomorphic senses will understand the object as a paper clip, while imaging technology may give the being an atomic view of its composition that will reach beyond the being's current ability to use language. In this case, the being may not have the vocabulary even to understand the atomic world. Thus, the android's existence is determined by how the developer defines the incremental shapes of perception to support the being's language usage. While the figure shows the KP controlling a robot arm in the split form of the self, any device or complex system could serve as the android's metaphysical form. Physical infrastructure, such as bridges, buildings and transportation systems, as well as anthropomorphic machines, such as Hollywood's version of the “android,” can easily be converted into machines that understand language in the split form of the self while perceiving the human universe in which the pronoun I refers to the autonomous existence of the machine.

### Section 25: Advances in Medicine

While the purpose of androidal research is ultimately to build machines that think and learn, we can also consider the influence of knowledge engineering on the field of medicine. For the purpose of the present section's discussion, let us consider that every page of text prior to this one provides a hypothesis that explains the brain's linguistic structure. Then, let us further suppose that the brain stores the mind's knowledge in an epistemic knowledge network—PTs interconnected through network gateways and other structures explained throughout the text. Now, when attempting to define the brain's neurological function, we have prepared a model with which to compare the brain's classical anatomy and physiology. Thus, instead of observing MRIs without a linguistic theory of neurological function, we now have PTs, semantic clusters, and in general, a “knowledge network” to look for in the brain's radiological images. What we have created here is an approach to neurology that incorporates a synthetic model of the brain's linguistic function in a knowledge network. What stands in the way of realizing this model as a legitimate clinical advancement to our understanding of the brain's activity, however, is the exact science that would explain how the brain stores and transforms epistemic moments.

As an example of androidal science's exploration into the human brain, we can consider current research concerning the malady of autism. Autism is a language problem. It is the type of language problem, however, that arises from an inability to shift meaningful context—to engage in discourse or thought that requires placing new ideas into seemingly unknown context. The autistic mind is thus not nimble; it rigidly adheres to “factual” expressions that are entirely coherent but, more often than not, are extraneous to the dialog of the healthy mind. The autistic mind thus functions in a somewhat parallel way to the poorly designed knowledge processor. Whereas a healthy mind demonstrates metaphoric creativity across a full spectrum of ideas, the autistic mind, and some knowledge processors, have great difficulty shifting modes of thought.

In order to appreciate knowledge processing's pursuits in medical science, one must realize that, just as the KP's network is required in its entirety in order to traverse network webbing during the performance of a cognitive translation, the entire brain must be consumed by a single thought (of epistemic structure). Thus, according to the present androidal theory, while the cerebral cortex does integrate other neural clusters in order to think a certain thought, the quantum states of the entire brain must transform epistemically, while a single thought (epistemic moment) may require just one pathway of the network. Just as we cited in the case of the knowledge processor's comprehension of the word apple, since that comprehension requires the integration of the five senses into the cerebral cortex, we must track specific biological pathways during a single moment of thought, or quantum state of the brain, if we are ever to understand the brain's cognitive action. Said another way, for a given thought, it takes the entire brain to formulate a thought because the variations of the analog world are modeled by that network. The actual thought, however, may occur, ultimately, in a single traceable pathway. Just as PBs realize senses and motors in the android, the brain realizes human perception. When a thought pattern keeps repeating, as it does in autism, other network webbing goes unused. By studying the epistemic moments of the autistic human being, we can begin to change the way in which these moments are transformed in the androidal model in order to begin altering the linguistic functions of the human brain. Androidal science thus looks at why the autistic brain cannot perform a metaphor on a single expression, not necessarily why the brain amasses language in the aggregate, as would be observed through an MRI.

If we consider a synthetic knowledge network as it searches for new constructions of language by using conceptual blending techniques, such as the metaphor, it is easy to imagine that while the knowledge network may require an extensive embodiment of network gateways and PB elements in order to “think,” only one particular pathway—of perhaps trillions—will account for a new expression of language. In a similar manner, androidal science studies the brain and its neural pathways, not in terms of MRI “hotspots,” but according to the premise that medical science should be searching for one pathway among billions—a needle in a haystack—that will account for an expression of thought. At the same time, androidal science requires that, while a particular pathway may ultimately define an expression, it is the entire quantum state of the brain, including all of its neural pathways, that produces a particular pathway's firing of epistemic construction.

The basic premise here is that, just as KP developers can now keep track of trillions of PTs (epistemic moments) in a synthetic knowledge network (a worthless piece of sand), medical science can now begin looking for those needles in the haystack for the autistic human being. Given the new insight brought about by the science of synthetic thought, which probes and replicates the grammar of human thought, we might begin to look for a bridge between current anatomical and physiological theories and the well-known quantum nature of the mind as described herein as an epistemic knowledge network.

It is understood that the illustrative embodiments may be modified in a variety of ways which will become readily apparent to those skilled in the art of having the benefit of the novel teachings disclosed herein. All such modifications and variations of the illustrative embodiments thereof shall be deemed to be within the scope and spirit of the present invention as defined by the Claims to Invention appended hereto.

1. A way of and means for realizing synthetic knowledge processes in devices for useful applications, while avoiding the shortcomings and drawbacks of prior art methodologies.

2. A type of digital computer that eliminates the need for computer software and directly enables digital logic to embody conscious thought, and wherein the digital computer truly understands and uses language, while eliminating the complexities associated with computer software, firmware, and hardware design.

3. A thinking machine that operates according to a universal grammar and a theory of operation that enables physical matter and digital electronics to understand the pronoun I, in connection with any other meaningful expressions of language, while perceiving the world through senses and motors.

4. A method of and apparatus for realizing a plurality of thinking machines in a global infrastructure referred to as a “knowledge continuum.”

5. A synthetic version of human intelligence, which emulates the mind's quantum momentary action according to a universal grammar that describes how human beings think and learn.

6. A knowledge network” that operates on “programmable bytes” and the mind's “epistemic moments” (quantum states of transformation), upon which knowledge processor technology acts to create synthetic thought and perception.

7. The knowledge network of claim 6, wherein the programmable byte is a reinterpretation of the binary sequence processed by digital logic such that any digital system, microprocessor, or application software can manipulate the mind's thoughts in digital electronics.

8. A universal grammatical bridge between the user's internal thoughts, as expressed in arbitrary language, and digital logic's binary operations by conforming to a knowledge network that emulates the mind's cognitive action.

9. A way of and mean embodying “prominent thoughts” (epistemic moments of the mind's innate action), in digital electronics as the mind's quantum semantic or “deep” structures, are constructed into a knowledge network that uses active and static memory to perform the mind's intellectual processes while thinking of new thoughts. The knowledge network is embodied in any technological medium, including digital circuits that think and learn autonomously through natural language, rather than mimicking a programmer's intelligence.

10. A knowledge processor that understands language by applying conceptual blending techniques, such as a metaphor, to ordinary spoken language. The objective includes that provision of thinking machines that create thoughtful and emotive expressions of language and think and learn along with us as autonomous synthetic beings.

11. Digital electronics, microprocessors, and software that unencumber the user and the programmer from software languages and hardware protocols to enable machines to understand language the way the mind does.

12. A system and method for eliminating computing deficiencies which have always existed that led the computer industry into developing “source code” that must be translated into a machine's binary languages, rather than simply translating arbitrary knowledge directly into a microchip that operates naturally according to the mind's “epistemic transformations” of language.

13. A uniform epistemic process to binary logic such that any thought can be innately translated into a microchip's logic.

14 A knowledge processor that is the successor to the computer and the Internet, which advances the art into truly thinking machines.

15. Knowledge networks that can be incorporated into any user environment, including communication systems, engineered systems, biological systems, and business enterprises.

16. A “Knowledge Development Environment” (KDE) that allows a user to program intelligent machines that operate according to the knowledge processing premises defined in the present disclosure.

17. The KDE of claim 16, which includes programming features for the knowledge processor's knowledge network, programmable bytes, intellectual faculties and learning functions, and a modified system theory that integrates intelligent machines into global computing, communications, and enterprise infrastructure.

18. A system and method which allow a developer to manipulate digital bit and byte sequences linguistically according to a universal grammar defining the mind's innate action.

19. A programming interface and methodology for integrating a “society” of thinking machines that interact with users in a “knowledge continuum” linking spatiotemporal, linguistic, technological, and cultural disparities.

20. A system and method to implement digital logic whereby it is unnecessary to use programming languages, except for that required by the KDE, in order for intelligent machines that communicate with us in arbitrary language to implement knowledge directly in digital gates or software.

21. A fundamental processing unit of the KP paradigm—the “programmable byte.”

22. A system and method for enabling digital memory, microprocessors, and software to operate according to the mind's innate action by encoding any application language's linguistic properties into the KP's flexibly programmed digital byte, whereby eliminating the need for compilers and software languages, and processing the elements of language directly in the registers of a microprocessor's central processing unit (CPU).

23. A system and method for encoding the programmable byte with linguistic properties, communications protocols, and knowledge network features that allow the KP's “running processes” to operate as thoughtful faculties of mind embedded in any global computing or engineered system.

24. A linguistic structure and methodology that is used to formulate the knowledge processor's intelligence and to provide the knowledge network's syntactical and semantic “webbing” that is executed by the action of a CPU, software, or digital gate in order to implement the mind's action synthetically without the brain's physiology.

25. A system and method for accomplishing the retention, translation, and transmission of the KP's widely varied use of language in a manner that parallels the brain's neurological network, but in a “synthetic consciousness” made from a digital circuit or software.

26. A KDE's “Universal Programming Language” (UPL) and its robust command set, which enable the developer and the KP to create and manipulate the knowledge network's intelligence.

27. UPL commands that are described in terms of microprocessor and software instruction syntax and operation so that the developer can apply the commands while building the knowledge network's intellectual faculties, or “scripts”; thereby offering a manner in which the UPL commands operate on application and platform languages directly corresponds to a CPU's operation on machine bytes in the “Host processor's” registers, but according to the universal grammar's depiction of language, such commands being provided such that they can be compiled, interpreted, or translated by the KDE into Host processor CPU architecture instructions when the knowledge project is installed on any enabling computer platform.

28. The method and apparatus of the earlier objectives in the form of an androidal “machine-being” that understands language from an ordinary computer.

29. A knowledge processor that is distinct because the KP actually thinks about and understands the language it uses in the application, while the KP creates new knowledge and converses with the user.

30. A “Rg knowledge continuum” of global system-theoretic structure derived from both linguistics and conventional system theory to enable the KDE and the knowledge processing paradigm to develop and implement any technology or system.

31. The Rg continuum of claim 30, which defines five basic continuum structures through which KP and conventional technologies can interact without being constrained by computing protocols, the five levels of the continuum being enabled, along with the continuum's “Rg modules,” as developer or user workspaces that give physical, intellectual, and metaphysical space and structure to any human endeavor assisted by machine intelligence according to knowledge processing premises; and the Rg continuum allowing the expansion of human knowledge and technology, as embodied in human beings and now machines, throughout a global infrastructure that enhances the Internet with the intelligent enterprise.

32. A commercialization method for global infrastructure that communicates in natural language according to knowledge processing premises.

33. A universal grammar and methodology by which knowledge is expressed and realized in physical media according to its ultimately real form.

34. An epistemic microprocessor architecture that operates on programmable bytes and knowledge network structures, thereby permitting digital electronics to operate as an intelligent machine.

35. Symbol kits that perform as translation tables for the universal grammatical translation of external analog and digital signals into each other and into Host machine data structures.

36. Knowledge structures that encapsulate knowledge as prominent thoughts and semantic clusters embedded in network webbing that includes epistemic node triplet, prominent thought, semantic cluster arrays, data set, parent node gateway, module function, spelling mode array, the semantic category gateway, and node structure sub-gateway

37. Data conversions that allow digital and analog machines to interact with each other by the Host processor's conversion of any external knowledge into the structures of the universal grammar and the knowledge processing methodology.

38. Global system model that permits machines to communicate intelligently.

39. Software engineering structures and methods by which any software, hardware, or network protocol can be translated into any other.

40. Database technology that performs as a “thinking database,” whereby the traditional structures defined by database theory, such as classes, fields, data structures, records, primary and secondary keys, tables, table relationships, queries, and reports, are fundamentally expressed through the KP paradigm's prominent thoughts and epistemic network structures.

41. Computer graphics and symbolic recognition systems whereby the intelligent knowledge processor understands and recognizes images cognitively and in relation to expressions of natural language.

42. Digital system design protocols and methodology by which digital logic is understood and designed by the knowledge processor with or without the developer's participation.

43. Simulation and control systems for use with physical systems such that the knowledge processor understands the machine's physical environment through natural language and senses and motors.

44. Communication systems that operate by comprehending and translating the arbitrary language embedded in a carrier signal.

45. A natural language translation methodology and apparatus by which the knowledge processor translates language according to a bidirectional, semantically perfect translation method that allows beings to understand and agree upon the epistemic moments of linguistic structure embedded in any expression.

46. Knowledge and learning systems that allow the user to examine the epistemic moments and parse trees generated by a knowledge processor for the purpose of learning how the machine comprehended or imagined linguistic structure in the universal grammar.

47. A method for biological sequence analysis by which the molecular sequences are embedded in and examined and translated by the knowledge network as epistemic moments and network webbing.

48. An androidal machine being that operates in the split form of existence in order to conceive language and perceive the physical and metaphysical world in connection with the pronoun I.

49. A model for human consciousness by which the human brain's anatomy and physiology can be analyzed in terms of the universal grammar's depiction of linguistic moments of thought.

50. Apparatus for realizing a synthetic knowledge processor, using analog and digital technology, wherein linguistically programmable digital bytes are created and altered in a microprocessor's and computer program's structure and operation, according to the operation of an epistemological knowledge network, which retains and transforms knowledge and knowledge processes by configuring the programmable bytes into epistemic moments, wherein epistemic moments are embedded in the semantic webbing of the network in semantic clusters and prominent thoughts that emulate the mind's quatum momentary action and retention of knowledge, and wherein the prominent thoughts are embedded in semantic and syntactical network webbing formulated from network node and grammatical form structures which enable the apparatus to conceive, translate, and communicate higher-level expressions of arbitrary language while using the prominent thoughts as instances of a language's meaning.
